(19) United States
(12) Patent Application Publication
(10) Pub. No.: US 2012/0242218 A1
(43) Pub. Date: Sep. 27, 2012

(54) ORGANIC ELECTROLUMINESCENCE DISPLAY DEVICE AND MANUFACTURING METHOD THEREOF

(75) Inventors: Tadahiko Yoshinaga, Kanagawa (JP); Toshiki Matsumoto, Kanagawa (JP)

(73) Assignee: SONY CORPORATION, Tokyo (JP)

(21) Appl. No.: 13/406,769

(22) Filed: Feb. 28, 2012

(30) Foreign Application Priority Data
Mar. 25, 2011 (JP) 2011-068246

(51) Int. Cl. H01J 1/62; B05D 5/06

(52) U.S. Cl. 313/504; 427/66

(57) ABSTRACT

An organic electroluminescence display device includes: a first electrode provided over a substrate for each of first and second organic electroluminescence elements; a hole injection/transport layer provided over a whole surface of the first electrode, having at least one of hole injection and transportation characteristics; a second organic light emitting layer provided on an area on the hole injection/transport layer except an area opposed to the first organic electroluminescence element; a first organic light emitting layer provided over whole surfaces of the hole injection/transport and second organic light emitting layers; an electron injection/transport layer, provided over a whole surface of the first organic light emitting layer, having at least one of electron injection and transportation characteristics; a second electrode provided on the electron injection/transport layer; and a color filter provided over the second electrode, having a color or colors in an area above the second organic electroluminescence element.

### BACKGROUND

The present disclosure relates to an organic EL display device that emits light by utilizing the organic electroluminescence (EL) phenomenon and a manufacturing method thereof.

As development of the information communication industry is accelerated, display elements having higher performance are required. Among the display elements, the organic EL element, which is attracting attention as a next-generation display element, has not only advantages of having a wide viewing angle and being excellent in the contrast as a self-luminous display element but also an advantage of having a short response time.

As systems to achieve a full-color display device using this organic EL element, there are e.g. the following systems: filter system in which an organic EL element that emits while light is employed as the light source and light is emitted via a color filter having red (R), green (G), and blue (B) disposed separately from each other; system in which a blue organic EL element is employed as the light source and a color conversion material (CCM) is used; and three-color-independent emission system in which red light emitting element, green light emitting element, and blue light emitting element are disposed in parallel over a substrate.

Among them, the filter system is attracting attention because it is free from the need to dispose the light emitting layers in different areas separately from each other on a color-by-color basis by using a metal mask etc. and provides high productivity. However, it has a problem that the light use efficiency is low and accordingly the power consumption increases because light is output via the color filter.

As a method to reduce the power consumption, an organic EL display device including red light emitting element, green light emitting element, and blue light emitting element in addition to a white light emitting element is reported in US Patent Application No. 2002/0186214 and Japanese Patent Laid-open No. 2004-311440 (patent documents 1 and 2, respectively) for example. In this display device, white and grayscale color are displayed by using the white light emitting element, which has high light use efficiency. Furthermore, only when red, green, or blue is necessary, the light emitting elements of the respective colors are used. Thereby, the emission efficiency is enhanced and the power consumption is lowered.

On the other hand, the three-color-independent emission system is excellent in aspects of the power consumption and the color reproducibility because the material, the element configuration, and so forth can be optimized on a color-by-color basis. However, the three-color-independent emission system has a problem that the emission efficiency is lowered if the color reproducibility of the respective colors is enhanced. This is attributed to the luminosity of the human. In the human vision, the luminosity differs on a color-by-color basis. The luminosity is the highest for a wavelength around 555 nm and becomes lower as the gap from 555 nm increases. Therefore, the emission efficiency of the respective colors, particularly red and blue, whose peak wavelengths are distant from 555 nm, is low.

Therefore, a four-color-driving organic EL display device obtained by adding an intermediate color between red and green (i.e. yellow) to red, green, and blue is proposed in Japanese Patent Laid-open No. 2007-95444 (patent document 3) for example. As described in ISSN-L 1883-2490/17/1353 (non-patent document 1), among the colors that appear on TV, generally white has the highest appearance frequency and part near the black-body radiation line connecting blue and yellow has the second highest frequency. In the technique of patent document 3, the color of the black-body radiation line is expressed by using yellow, which yields high luminosity and high emission efficiency, to thereby keep the color gamut and enhance the emission efficiency of the whole organic EL display device.

### SUMMARY

However, in the filter system, the color needs to be divided by a dark color filter to reproduce a wide color gamut. Furthermore, there is a problem that the light use efficiency is lowered and the power consumption greatly increases in the case of expressing three primary colors and intermediate colors. In the three-color-independent emission system, red light emitting layer, green light emitting layer, and blue light emitting layer need to be disposed in different areas separately from each other. In the case of four-color driving like in the technique of patent document 3, a step of separately disposing a yellow light emitting layer is added besides the steps for the above-described three colors. Therefore, there is a problem that the material cost and the manufacturing cost increase and the productivity is lowered due to the increase in the number of steps.

There is a need for a technique to provide an organic EL display device allowing power consumption reduction with cost suppression and a manufacturing method thereof.

According to an embodiment of the present disclosure, there is provided an organic EL display device including the following constituent elements (A) to (G).

(A) a first electrode configured to be provided over a substrate for each of a first organic EL element of blue and a second organic EL element of another color;

(B) a hole injection/transport layer configured to be provided over the whole surface of the first electrode and have a characteristic of at least one of hole injection and hole transportation;

(C) a second organic light emitting layer of another color configured to be provided on an area on the hole injection/transport layer except an area opposed to the first organic EL element of blue;

(D) a first organic light emitting layer of blue configured to be provided over the whole surfaces of the hole injection/transport layer and the second organic light emitting layer;

(E) an electron injection/transport layer configured to be provided over the whole surface of the first organic light emitting layer and have a characteristic of at least one of electron injection and electron transportation;

(F) a second electrode configured to be provided on the electron injection/transport layer; and

(G) a color filter configured to be provided over the second electrode and have a single color or a plurality of colors in at least part of an area above the second organic EL element.

According to another embodiment of the present disclosure, there is provided a manufacturing method of an organic EL display device. The method includes the following (A) to (G).

(A) forming a plurality of first electrodes over a substrate for each of a first organic EL element of blue and a second organic EL element of another color;

(B) forming a hole injection/transport layer that is provided over the whole surfaces of the first electrodes and has a characteristic of at least one of hole injection and hole transportation by coating or evaporation;

(C) forming a second organic light emitting layer of another color on an area on the hole injection/transport layer except an area opposed to the first organic EL element of blue by coating or evaporation;

(D) forming a first organic light emitting layer of blue on the hole injection/transport layer and the second organic light emitting layer by an evaporation method;

(E) forming an electron injection/transport layer having a characteristic of at least one of electron injection and electron transportation over the whole surface of the first organic light emitting layer by an evaporation method;

(F) forming a second electrode over the whole surface of the electron injection/transport layer; and

(G) forming a color filter that is provided over the second electrode and has a single color or a plurality of colors in at least part of an area above the second organic EL element of another color.

In the organic EL display device and the manufacturing method thereof according to the embodiments of the present disclosure, the second organic light emitting layer of another color is provided on the area on the hole injection/transport layer except the area opposed to the first organic EL element of blue, and the first organic light emitting layer of blue is provided over the whole surfaces of the hole injection/transport layer and the second organic light emitting layer of another color. Furthermore, the color filter having a single color or plural colors is provided. Thereby, the manufacturing step of the organic EL display device is simplified.

In the organic EL display device and the manufacturing method thereof according to the embodiments of the present disclosure, the second organic light emitting layer of another color is provided on the area on the hole injection/transport layer except the area opposed to the first organic EL element of blue, and the first organic light emitting layer of blue is provided over the whole surfaces of the hole injection/transport layer and the second organic light emitting layer of another color. Furthermore, the color filter having a single color or plural colors is provided over this first organic light emitting layer. Thus, the step of separately disposing the light emitting layers in different areas on a color-by-color basis is reduced, so that the manufacturing step of the organic EL display device is simplified. This can enhance the productivity with power consumption suppression.

### BRIEF DESCRIPTION OF THE DRAWINGS

FIG. 1 is a diagram showing the configuration of an organic EL display device according to a first embodiment of the present disclosure;

FIG. 2 is a diagram showing one example of a pixel drive circuit shown in FIG. 1;

FIG. 3 is a sectional view showing the configuration of a display area shown in FIG. 1;

FIG. 4 is a diagram showing the flow of a manufacturing method of the organic EL display device shown in FIG. 1;

FIGS. 5A to 5G are sectional views showing the manufacturing method shown in FIG. 4 in the step order;

FIG. 6 is a sectional view showing the configuration of an organic EL display device according to a second embodiment of the present disclosure;

FIG. 7 is a diagram showing the flow of a manufacturing method of the organic EL display device shown in FIG. 6;

FIG. 8 is a diagram showing the configuration of an organic EL display device according to a third embodiment of the present disclosure;

FIG. 9 is a sectional view showing the configuration of a display area shown in FIG. 8;

FIG. 10 is a sectional view showing the configuration of an organic EL display device according to a fourth embodiment of the present disclosure;

FIG. 11 is a plan view showing the schematic configuration of a module including the display device of the above-described embodiment;

FIG. 12 is a perspective view showing the appearance of application example 1 of the display device of the above-described embodiment;

FIG. 13A is a perspective view showing the appearance of the front side of application example 2 and

FIG. 13B is a perspective view showing the appearance of the back side;

FIG. 14 is a perspective view showing the appearance of application example 3;

FIG. 15 is a perspective view showing the appearance of application example 4; and

FIG. 16A is a front view of the opened state of application example 5, FIG. 16B is a side view of the opened state, FIG. 16C is a front view of the closed state, FIG. 16D is a left side view, 16E is a right side view, FIG. 16F is a top view, and FIG. 16G is a bottom view.

### DETAILED DESCRIPTION OF THE PREFERRED EMBODIMENTS

Embodiments of the present disclosure will be described in detail below with reference to the drawings.

1. First Embodiment (organic EL display device made based on three sub-pixels)
2. Second Embodiment (organic EL display device having connection layer between first organic light emitting layer and second organic light emitting layer)
3. Third Embodiment (organic EL display device made based on four sub-pixels)
4. Fourth Embodiment (organic EL display device having connection layer between first organic light emitting layer and second organic light emitting layer)

### First Embodiment

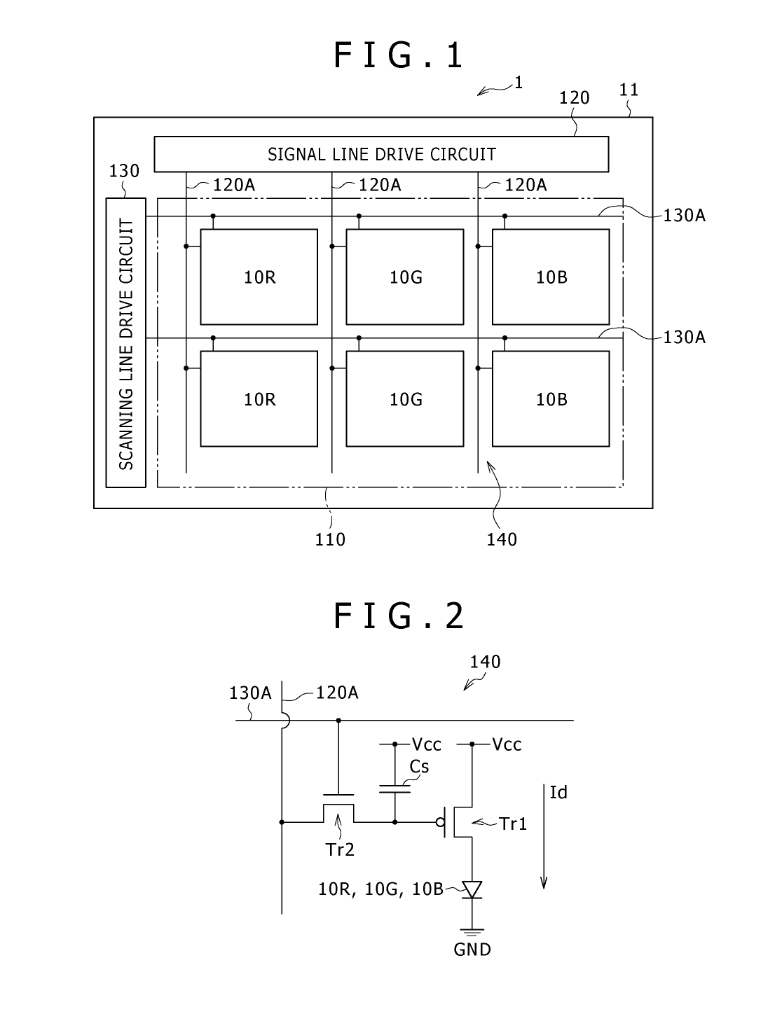

FIG. 1 shows the configuration of an organic EL display device 1 according to a first embodiment of the present disclosure. This organic EL display device 1 is used as e.g. an organic EL television device, and is obtained by disposing, over a substrate 11, plural red organic EL elements 10R, green organic EL elements 10G, and blue organic EL elements 10B to be described later in a matrix manner as a display area 110 for example. A signal line drive circuit 120 and a scanning line drive circuit 130 as drivers for video displaying are provided around the display area 110.

A pixel drive circuit 140 is provided in the display area 110. FIG. 2 shows one example of the pixel drive circuit 140. The pixel drive circuit 140 is an active drive circuit formed under lower electrodes 12 to be described later. Specifically, this pixel drive circuit 140 has a drive transistor Tr1 and a write transistor Tr2, a capacitor (hold capacitance) Cs between these transistors Tr1 and Tr2, and the red organic EL element 10R (or green organic EL element 10G, blue organic EL element 10B) connected in series to the drive transistor Tr1 between a first power supply line (Vcc) and a second power supply line (GND). The drive transistor Tr1 and the write transistor Tr2 are formed of a general thin film transistor (TFT). The configuration thereof may be e.g. an inverted-staggered structure (so-called bottom gate type) or a staggered structure (top gate type) and is not particularly limited.

In the pixel drive circuit 140, plural signal lines 120A are disposed along the column direction and plural scanning lines 130A are disposed along the row direction. The intersection of the signal line 120A and the scanning line 130A corresponds to one of the red organic EL element 10R, the green organic EL element 10G, and the blue organic EL element 10B (sub-pixel). Each signal line 120A is connected to the signal line drive circuit 120 and an image signal is supplied from this signal line drive circuit 120 to the source electrode of the write transistor Tr2 via the signal line 120A. Each scanning line 130A is connected to the scanning line drive circuit 130 and a scanning signal is sequentially supplied from this scanning line drive circuit 130 to the gate electrode of the write transistor Tr2 via the scanning line 130A.

In the display area 110, as described above, the red organic EL element 10R to generate red light, the green organic EL element 10G to generate green light, and the blue organic EL element 10B to generate blue light are disposed in turn in a matrix manner as a whole. The combination of the red organic EL element 10R, the green organic EL element 10G, and the blue organic EL element 10B adjacent to each other forms one pixel (sub-pixel). The red organic EL element 10R to generate red light and the green organic EL element 10G to generate green light show red and green emission colors based on the passage of light from a light emitting layer that generates yellow through a color filter 18 (red filter and green filter).

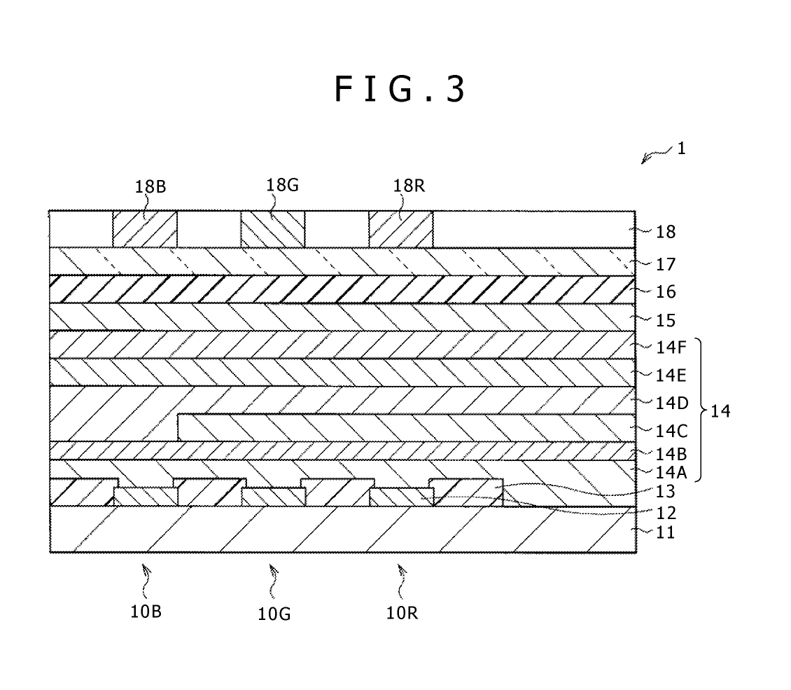

FIG. 3 shows the sectional configuration of the display area 110 shown in FIG. 1. Each of the red organic EL element 10R, the green organic EL element 10G, and the blue organic EL element 10B has a configuration obtained by stacking the lower electrode 12 (first electrode) as the anode, a partition 13, an organic layer 14 including light emitting layers (yellow light emitting layer 14C and blue light emitting layer 14D) to be described later, and an upper electrode 15 (second electrode) as the cathode in that order from the side of the substrate 11 with the intermediary of the drive transistor Tr1 of the above-described pixel drive circuit 140 and a planarization insulating film (not shown).

Such red organic EL element 10R, green organic EL element 10G, and blue organic EL element 10B are covered by a protective layer 16. Furthermore, a sealing substrate 17 composed of e.g. glass is bonded over this protective layer 16 across the whole surface with the intermediary of an adhesion layer (not shown) composed of e.g. a heat-curable resin or an ultraviolet-curable resin. Thereby, the respective organic EL elements are sealed.

The substrate 11 is a support body on which the red organic EL element 10R, the green organic EL element 10G, and the blue organic EL element 10B are arranged on its one main surface side. A publicly-known component may be used as the substrate 11. For example, a film or a sheet made of quartz, glass, metal foil, or resin is used. Among these materials, quartz and glass are preferable. If a component made of a resin is used, examples of the material thereof include methacrylic resins typified by polymethylmethacrylate (PMMA), polyesters such as polyethylene terephthalate (PET), polyethylene naphthalate (PEN), and polybutylene naphthalate (PBN), and polycarbonate resins. However, in this case, laminated structure and surface treatment to suppress water permeability and gas permeability should be employed.

The lower electrode 12 is provided over the substrate 11 for each of the red organic EL element 10R, the green organic EL element 10G, and the blue organic EL element 10B. The thickness of the lower electrode 12 in the layer stacking direction (hereinafter, referred to simply as the thickness) is e.g. 10 nm to 1000 nm. Examples of the material thereof include elemental metals and alloys of metal elements such as molybdenum (Mo), chromium (Cr), gold (Au), platinum (Pt), nickel (Ni), copper (Cu), tungsten (W), and silver (Ag). Alternatively, the lower electrode 12 may have a multilayer structure formed of a metal film composed of an elemental metal or an alloy of these metal elements and a transparent electrically-conductive film composed of e.g. an oxide of indium and tin (ITO), indium zinc oxide (InZnO), or an alloy of zinc oxide (ZnO) and aluminum (Al). If the lower electrode 12 is used as the anode, it is preferable that the lower electrode 12 be composed of a material having high hole injection ability. However, even a material having problems of the existence of a surface oxide coat film and a hole injection barrier due to a low work function like an aluminum (Al) alloy can be used as the lower electrode 12 by providing a proper hole injection layer 14A.

The partition 13 is to ensure insulation between the lower electrode 12 and the upper electrode 15 and make the light emitting area have a desired shape. Examples of the material of the partition 13 include inorganic insulating materials such as SiO₂ and photosensitive resins such as positive photosensitive polybenzoxazole and positive photosensitive polyimide. Apertures are provided in the partition 13 corresponding to the light emitting areas. The organic layer 14 and the upper electrode 15 may be provided not only in the apertures but also over the partition 13. However, light emission is caused only in the apertures of the partition 13. Although the partition 13 has a single-layer structure formed of one kind of material in the present embodiment, the partition 13 may have a multilayer structure formed of plural materials. Alternatively, only the lower electrode 12 may be patterned without forming the partition 13 and the hole injection layer 14A and the subsequent layers of the organic layer 14 may be provided as common layers.

The organic layer 14 of the organic EL elements 10R, 10G, and 10B has e.g. a configuration obtained by stacking the hole injection layer 14A, a hole transport layer 14B, the yellow light emitting layer 14C, the blue light emitting layer 14D, an electron transport layer 14E, and an electron injection layer 14F sequentially from the side of the lower electrode 12. Among these layers of the organic layer 14, the layers other than the yellow light emitting layer 14C, i.e. the layers 14A, 14B, and 14D to 14F, are provided as common layers of the respective organic EL elements 10R, 10G, and 10B. The yellow light emitting layer 14C is provided not over the blue organic EL element 10B but over the red organic EL element 10R and the green organic EL element 10G.

The hole injection layer 14A is to enhance the efficiency of hole injection to the yellow light emitting layer 14C and the blue light emitting layer 14D and is a buffer layer for preventing leakage. The thickness of the hole injection layer 14A is e.g. preferably 5 nm to 100 nm and more preferably 8 nm to 50 nm.

The material of the hole injection layer 14A is appropriately selected depending on the relationship with the materials of the electrode and adjacent layer. Examples of the material include polyaniline, polythiophene, polypyrrole, polyphenylenevinylene, polythienylenevinylene, polyquinoline, polyquinoxaline, and derivatives of them, electrically-conductive polymers such as a polymer including an aromatic amine structure in the main chain or the side chain, metal phthalocyanine (such as copper phthalocyanine), and carbon.

If the material used for the hole injection layer 14A is a polymer material, the weight-average molecular weight (Mw) of the polymer material is typically in the range of 5000 to 300000 and preferably about 10000 to 200000 particularly. Alternatively, an oligomer whose Mw is about 2000 to 5000 may be used. However, if Mw is lower than 5000, possibly the hole injection layer is dissolved in forming the hole transport layer and the subsequent layers. If Mw surpasses 300000, possibly material gelatinization occurs and the film deposition becomes difficult.

Examples of the typical electrically-conductive polymer used as the material of the hole injection layer 14A include polyaniline, oligoaniline, and polydioxythiophene such as poly(3,4-ethylenedioxythiophene) (PEDOT). Other examples include a commercially-available polymer as Nafion (trademark) made by H.C. Starck Ltd., a polymer that has a product name Liquion (trademark) and is commercially available in a dissolved form, ELsource (trademark) made by Nissan Chemical Industries, Ltd., and an electrically-conductive polymer Berazol (trademark) made by Soken Chemical & Engineering Co., Ltd.

The hole transport layer 14B of the red organic EL element 10R, the green organic EL element 10G, and the blue organic EL element 10B is to enhance the efficiency of hole transportation to the yellow light emitting layer 14C and the blue light emitting layer 14D. The thickness of the hole transport layer 14B is e.g. preferably 10 nm to 200 nm and more preferably 15 nm to 150 nm although depending on the whole configuration of the element.

As the polymer material to form the hole transport layer 14B, a material that is soluble in an organic solvent is used. Examples of the material include polyvinylcarbazole, polyfluorene, polyaniline, polysilane, derivatives of them, polysiloxane derivatives having aromatic amine in the side chain or the main chain, polythiophene and derivatives thereof, and polypyrrole.

Examples of the more preferable material include a polymer material represented by formula (1), having solubility in an organic solvent and favorable adhesiveness with the hole injection layer 14A and the yellow light emitting layer 14C, which are the lower and upper layers in contact with the hole transport layer 14B.

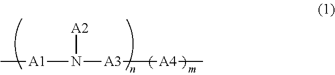

(A1 to A4 are each a group in which 1 to 10 aromatic hydrocarbon groups or derivatives thereof are bonded or a group in which 1 to 15 heterocyclic groups or derivatives thereof are bonded. Symbols n and m are each an integer of 0 to 10000, and n+m is an integer of 10 to 20000.)

The arrangement order of unit n and unit m is arbitrary, and the material of formula (1) may be any of a random polymer, an alternating copolymer, a periodic copolymer, and a block copolymer. Moreover, n and m are each preferably an integer of 5 to 5000 and more preferably an integer of 10 to 3000. Furthermore, n+m is preferably an integer of 10 to 10000 and more preferably an integer of 20 to 6000.

Specific examples of the aromatic hydrocarbon group indicated by A1 to A4 in the compound represented by formula (1) include benzene, fluorene, naphthalene, anthracene, derivatives of them, phenylenevinylene derivatives, and styryl derivatives. Specific examples of the heterocyclic group include thiophene, pyridine, pyrrol, carbazole, and derivatives of them.

If A1 to A4 in the compound represented by formula (1) has a substituent, this substituent is e.g. a linear or branched alkyl group or alkenyl group with 1 to 12 carbon atoms. Specifically, it is preferably e.g. the following group: methyl group, ethyl group, propyl group, isopropyl group, butyl group, isobutyl group, sec-butyl group, tert-butyl group, pentyl group, hexyl group, heptyl group, octyl group, nonyl group, decyl group, undecyl group, dodecyl group, vinyl group, or allyl group.

As specific examples of the compound represented by formula (1), e.g. compounds represented by the following formulas (1-1) to (1-3) are preferable. Specifically, they are poly[(9,9-dioctylfluorenyl-2,7-diyl)-co-(4,4′-(N-(4-sec-butylphenyl))diphenylamine)] (TFB, formula (1-1)), poly[(9,9-dioctylfluorenyl-2,7-diyl)-alt-co-(N,N′-bis{4-butylphenyl}-benzidine-N,N′-{1,4-diphenylene})] (formula (1-2)), and poly[(9,9-dioctylfluorenyl-2,7-diyl)] (PFO, formula (1-3)). However, the compound represented by formula (1) is not limited thereto.

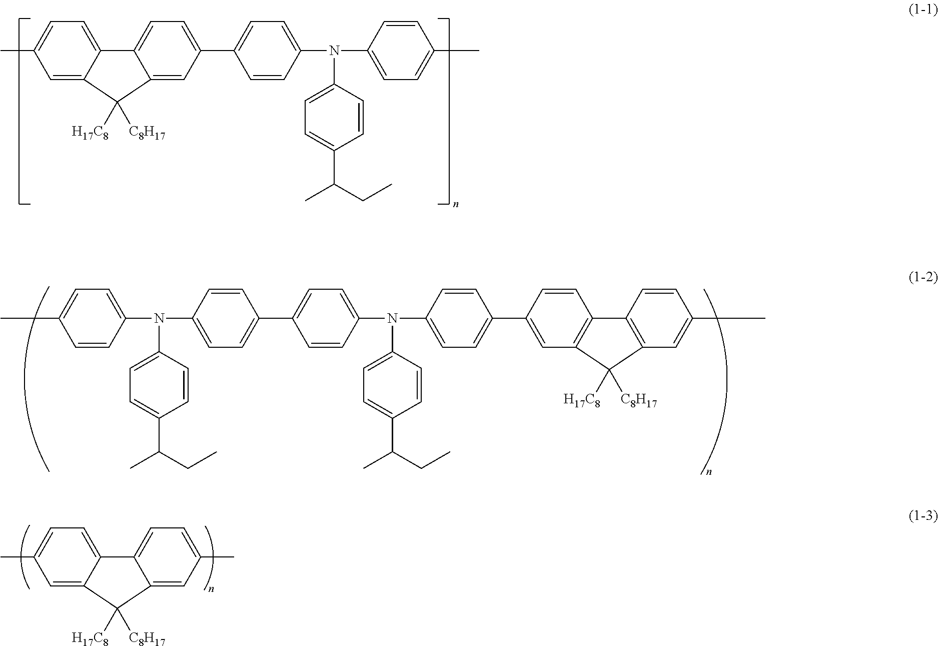

When the hole injection layer 14A and the hole transport layer 14B are formed by an evaporation method typified by resistance heating, it is preferable to use e.g. any of the following materials: α-naphthyl phenyl phenylenediamine, porphyrin, metal tetraphenyl porphyrin, metal naphthalocyanine, hexacyanoazatriphenylene, 7,7,8,8-tetracyanoquinodimethane (TCNQ), 7,7,8,8-tetracyano-2,3,5,6-tetrafluoroquinodimethane (F4-TCNQ), tetracyano-4,4,4-tris(3-methylphenylphenylamino)triphenylamine, N,N,N′,N′-tetrakis(p-tolyl)p-phenylenediamine, N,N,N′,N′-tetraphenyl-4,4′-diaminobiphenyl, N-phenylcarbazole, 4-di-p-tolylaminostilbene, poly(paraphenylene vinylene), poly(thiophene vinylene), and poly(2,2′-thienylpyrrole). However, the material is not limited thereto.

In the yellow light emitting layer 14C, recombination of electron and hole occurs due to electric field application, so that light is emitted. The thickness of the yellow light emitting layer 14C is e.g. preferably 10 nm to 200 nm and more preferably 15 nm to 100 nm although depending on the whole configuration of the element. The yellow light emitting layer 14C is composed of at least one kind of light emitting material having at least one peak wavelength in any region in the region from 500 nm to 750 nm.

As described in detail later, the yellow light emitting layer 14C is formed by a coating method such as an ink-jet method. In this forming, high-molecular material and low-molecular material are dissolved by using at least one kind of e.g. the following organic solvents to form a mixed solution: toluene, xylene, anisole, cyclohexanone, mesitylene(1,3,5-trimethylbenzene), pseudocumene(1,2,4-trimethylbenzene), dihydrobenzofuran, 1,2,3,4-tetramethylbenzene, tetralin, cyclohexylbenzene, 1-methylnaphthalene, p-anisyl alcohol, dimethylnaphthalene, 3-methylbiphenyl, 4-methylbiphenyl, 3-isopropylbiphenyl, and monoisopropylnaphthalene. The yellow light emitting layer 14C is formed by using this mixed solution.

Examples of the light emitting material to form the yellow light emitting layer 14C include phosphorescent host materials and fluorescent host materials shown in the following formulas (2) to (4).

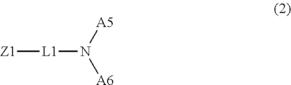

(Z1 is a nitrogen-containing hydrocarbon group or a derivative thereof. L1 is a group in which 1 to 4 divalent aromatic ring groups are bonded, specifically a divalent group in which 1 to 4 aromatic rings are connected or a derivative thereof. A5 and A6 are each an aromatic hydrocarbon group, an aromatic heterocyclic group, or a derivative thereof. A5 and A6 may be bonded to each other to form a cyclic structure.)

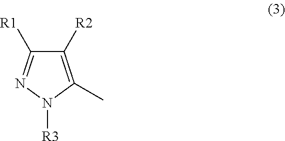

(R1 to R3 are each independently a hydrogen atom, an aromatic hydrocarbon group in which 1 to 3 aromatic rings are condensed or a derivative thereof, an aromatic hydrocarbon group in which 1 to 3 aromatic rings having a hydrocarbon group with 1 to 6 carbon atoms are condensed or a derivative thereof, an aromatic hydrocarbon group in which 1 to 3 aromatic rings having an aromatic hydrocarbon group with 6 to 12 carbon atoms are condensed or a derivative thereof.)

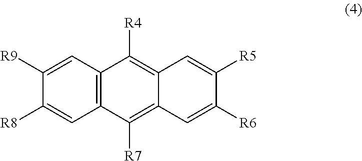

(R4 to R9 are each a hydrogen atom, a halogen atom, a hydroxyl group, or a group having an alkyl group, an alkenyl group, or a carbonyl group with 20 or less carbon atoms, a group having a carbonyl ester group, a group having an alkoxyl group, a group having a cyano group, a group having a nitro group, or a derivative of them, a group having a silyl group with 30 or less carbon atoms, a group having an aryl group, a group having a heterocyclic group, a group having an amino group, or a derivative of them.)

Specific examples of the compound shown in formula (2) include compounds of the following formulas (2-1) to (2-96).

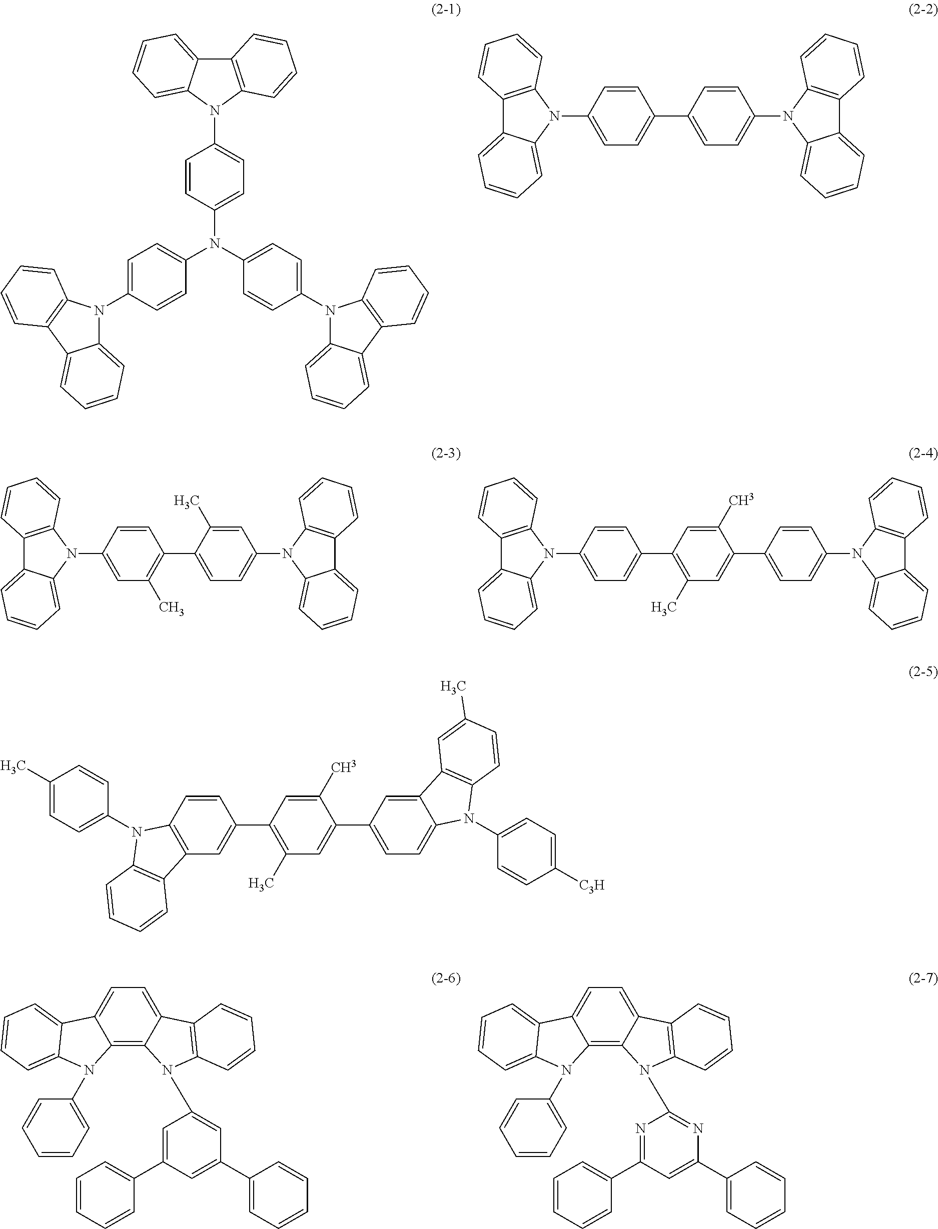

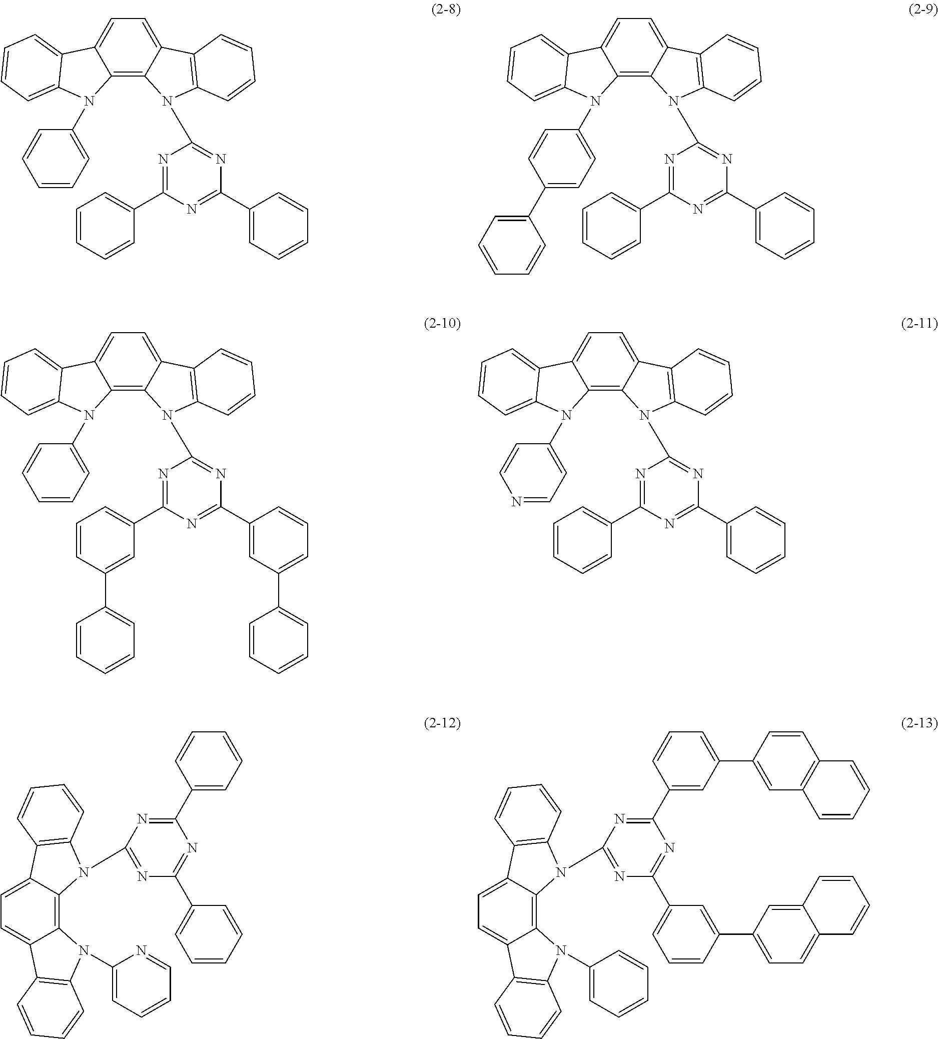

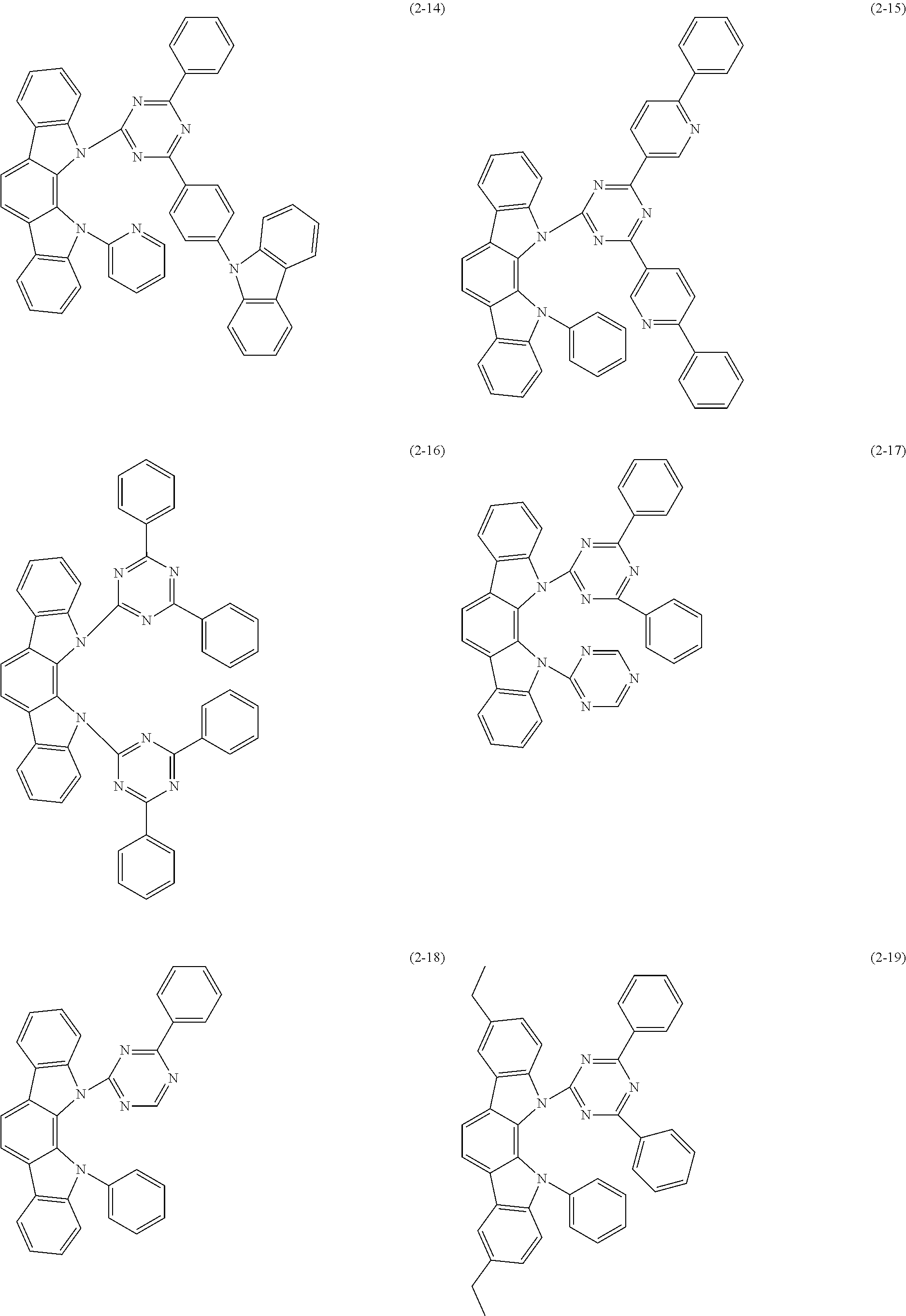

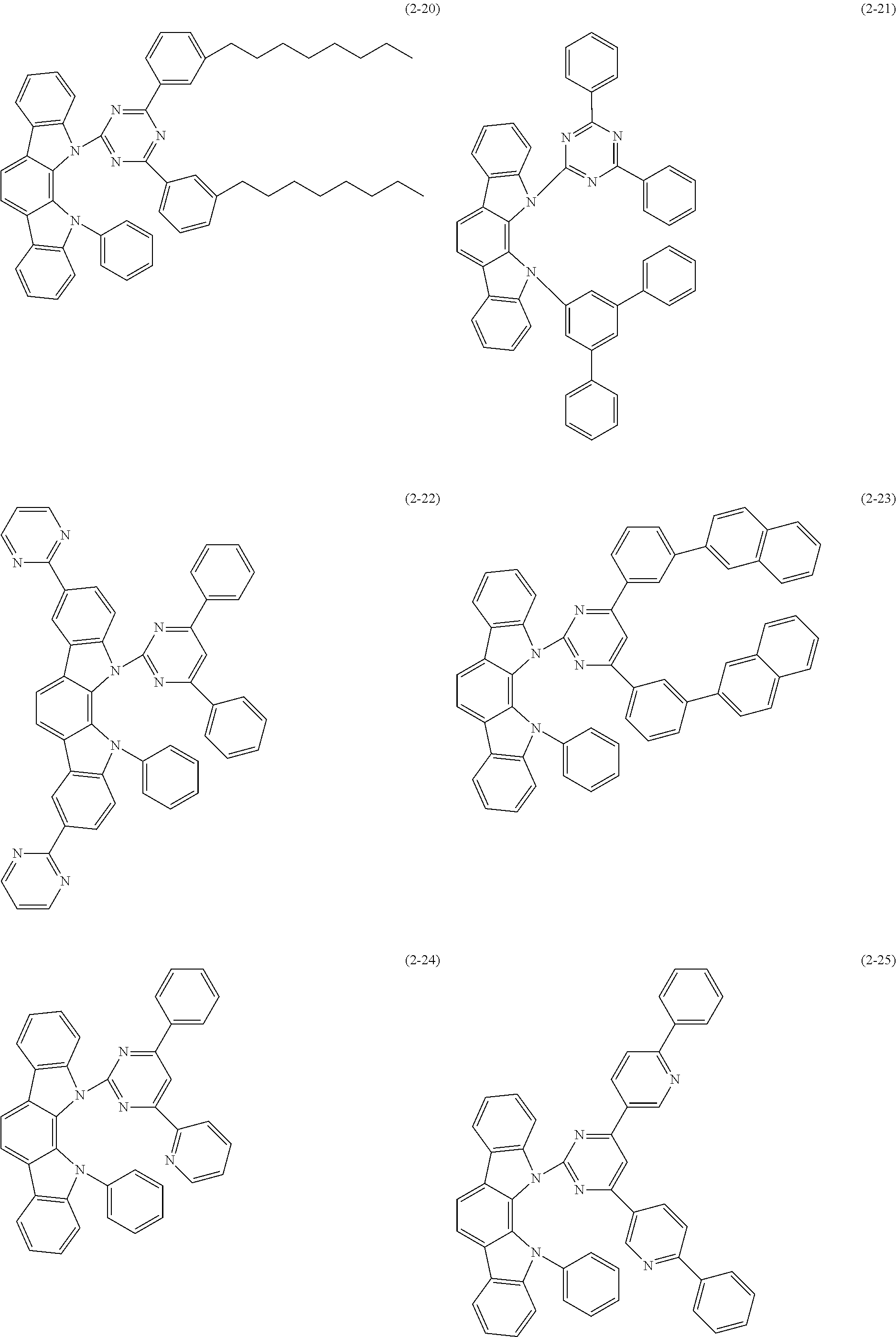

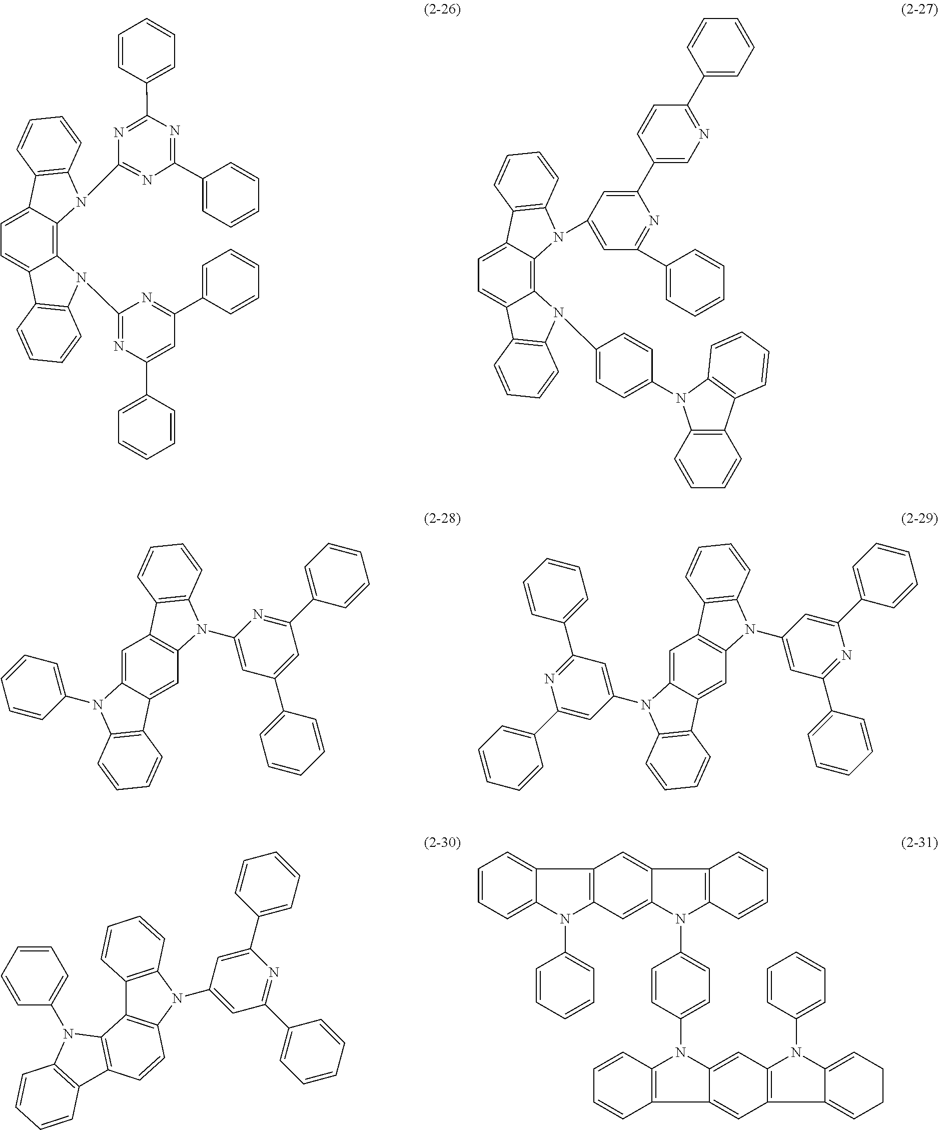

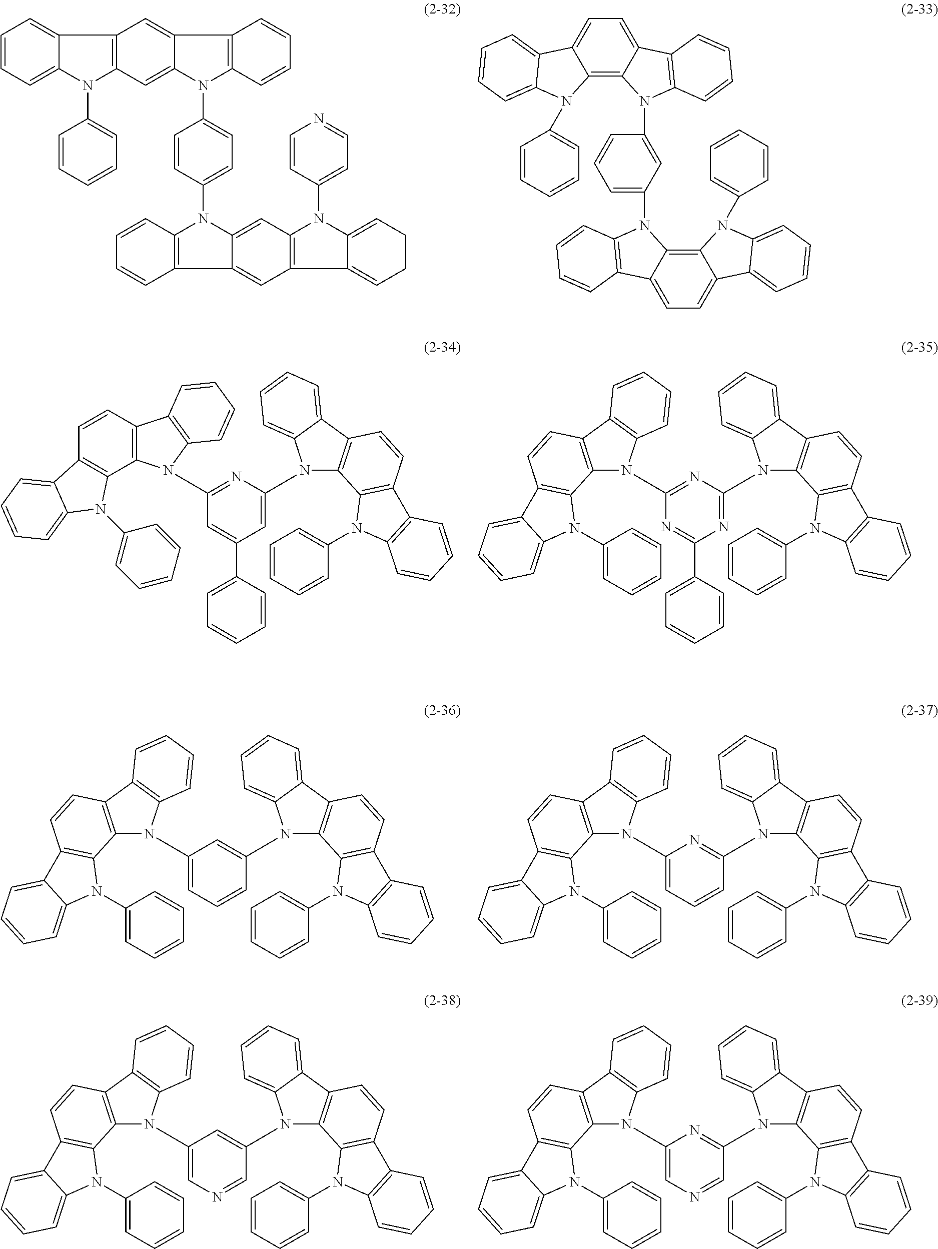

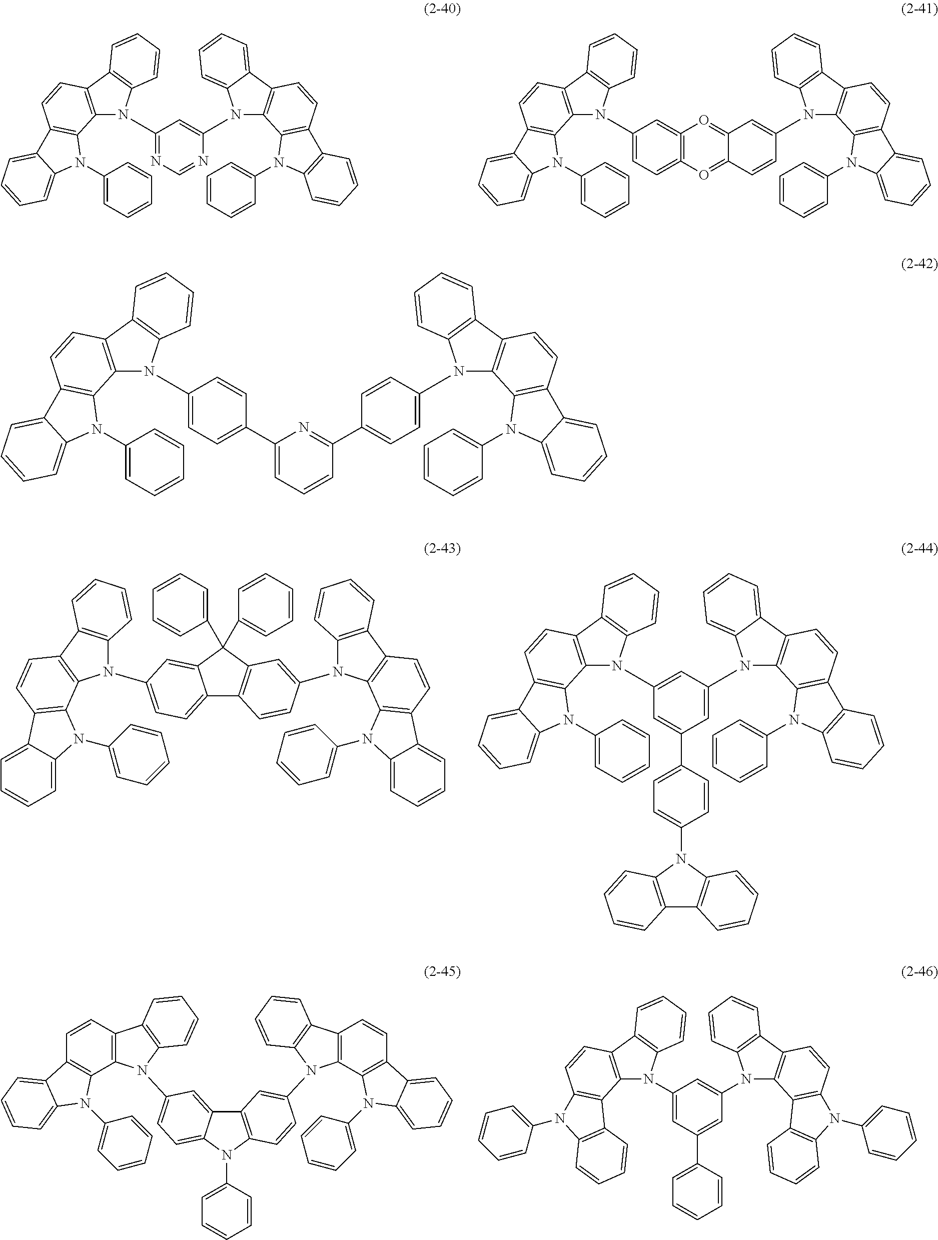

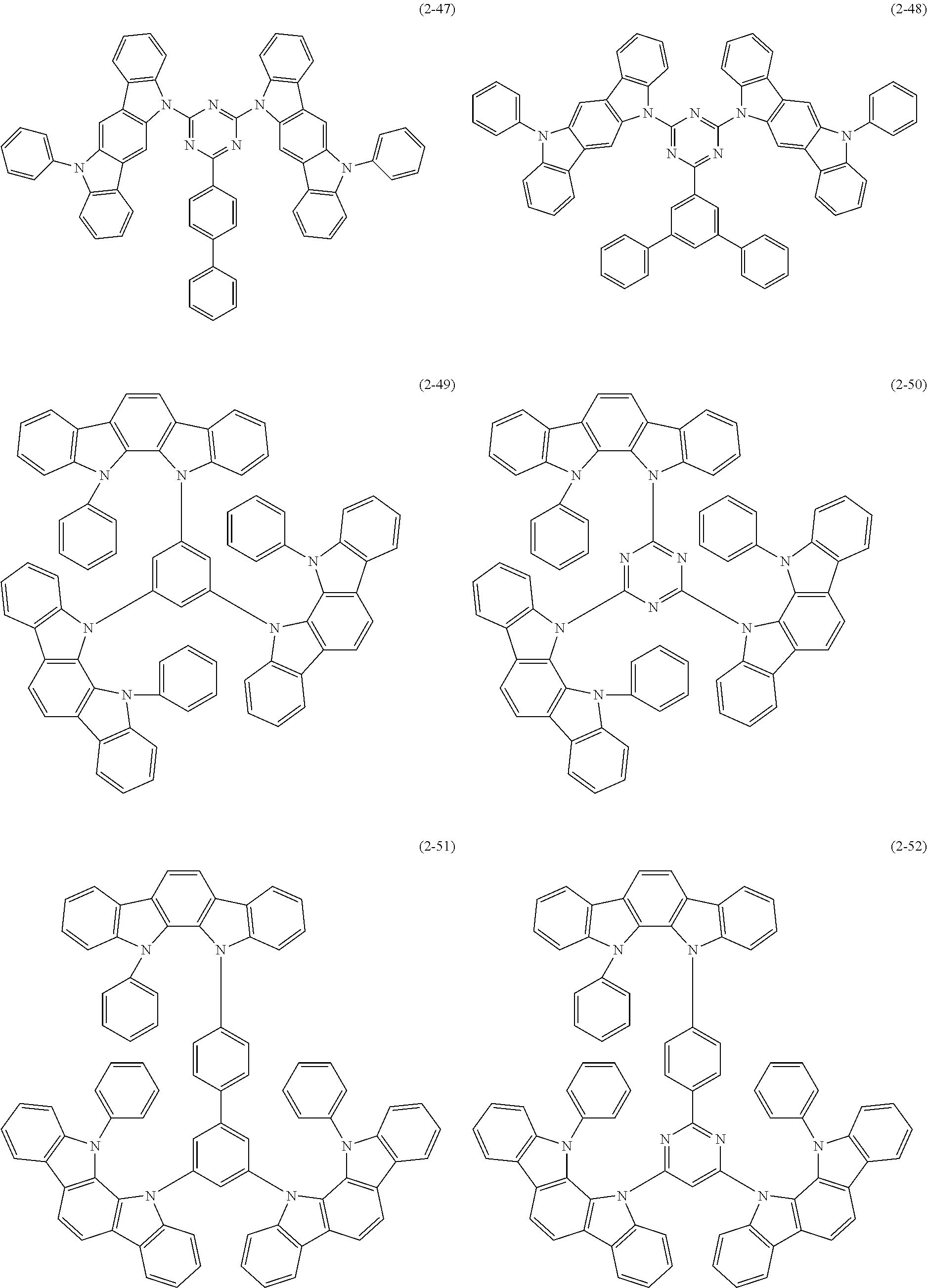

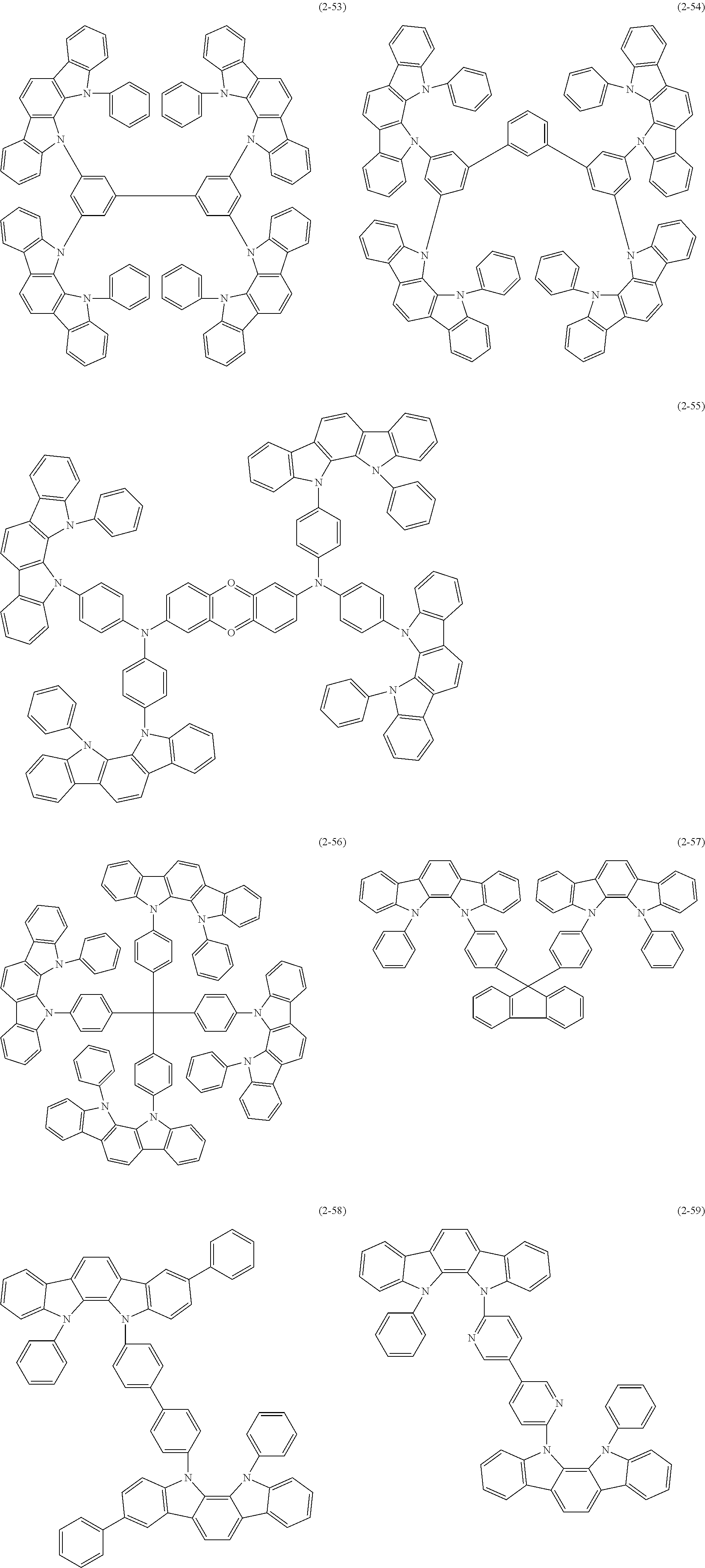

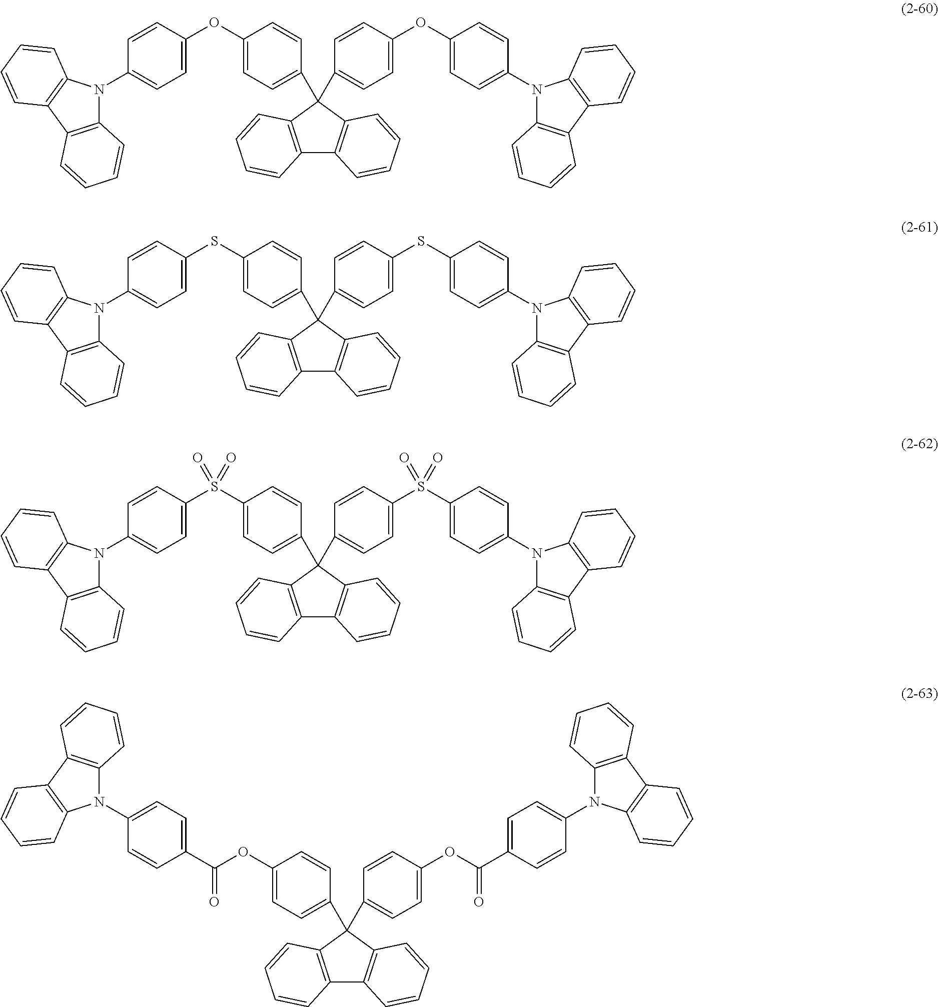

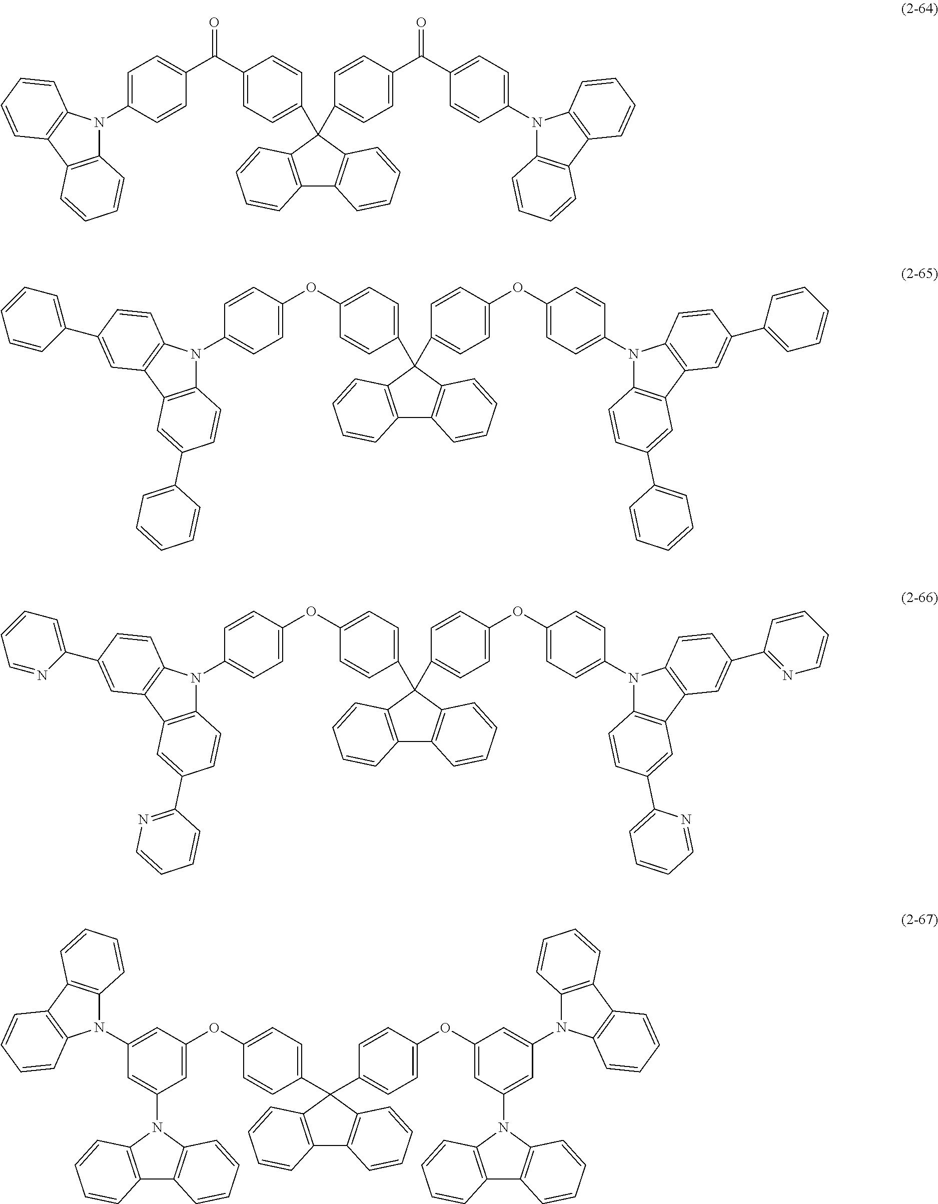

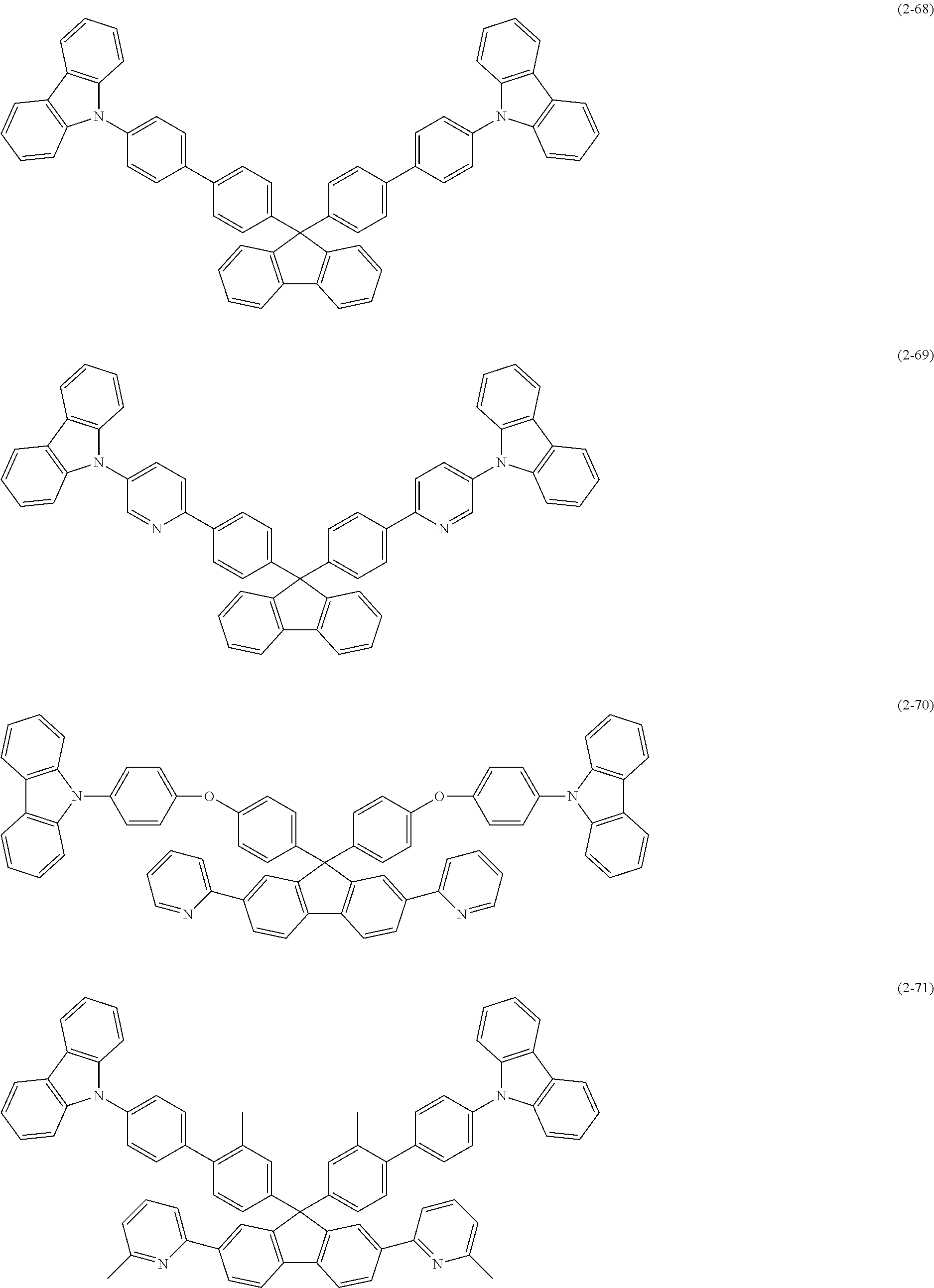

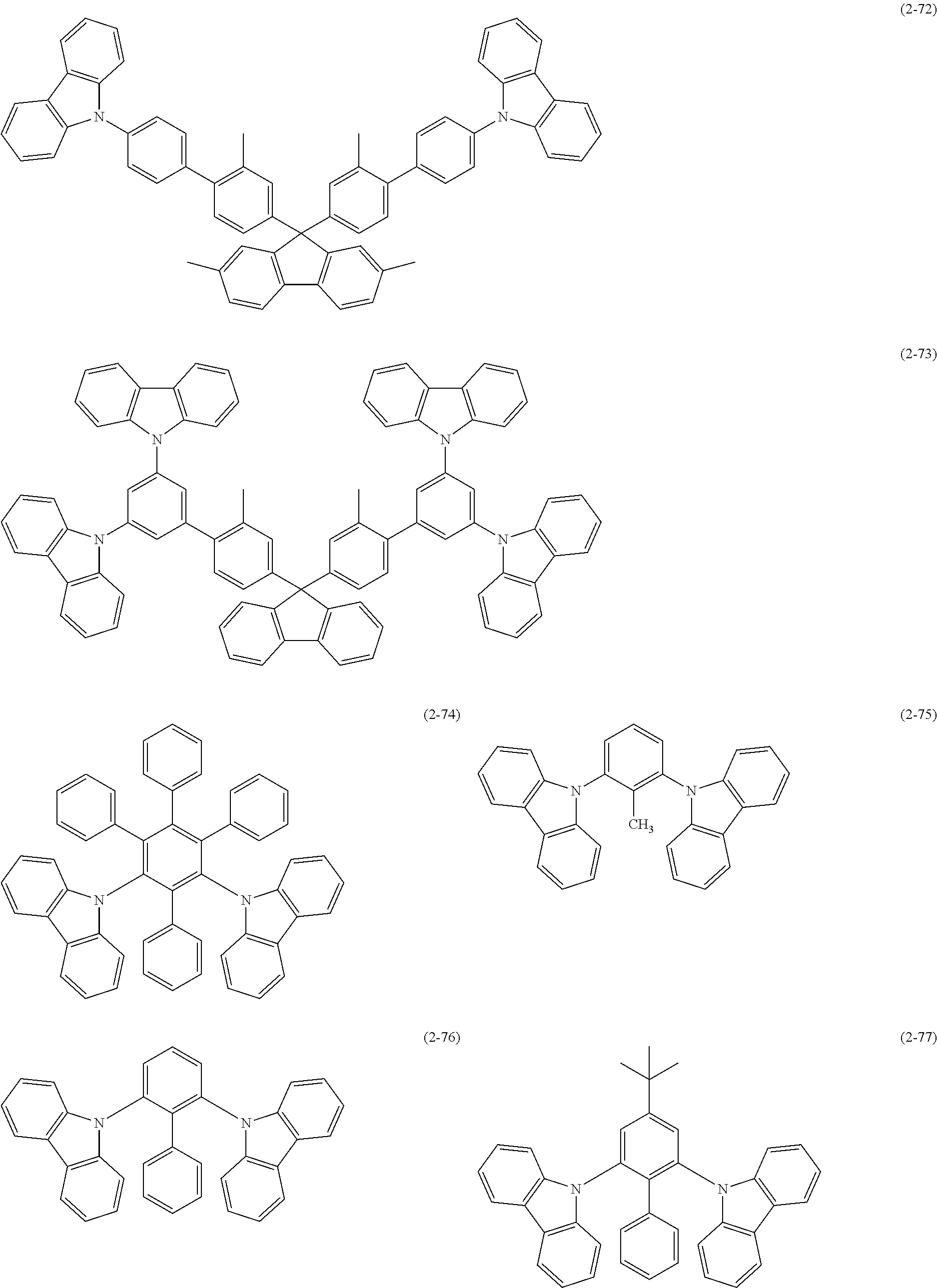

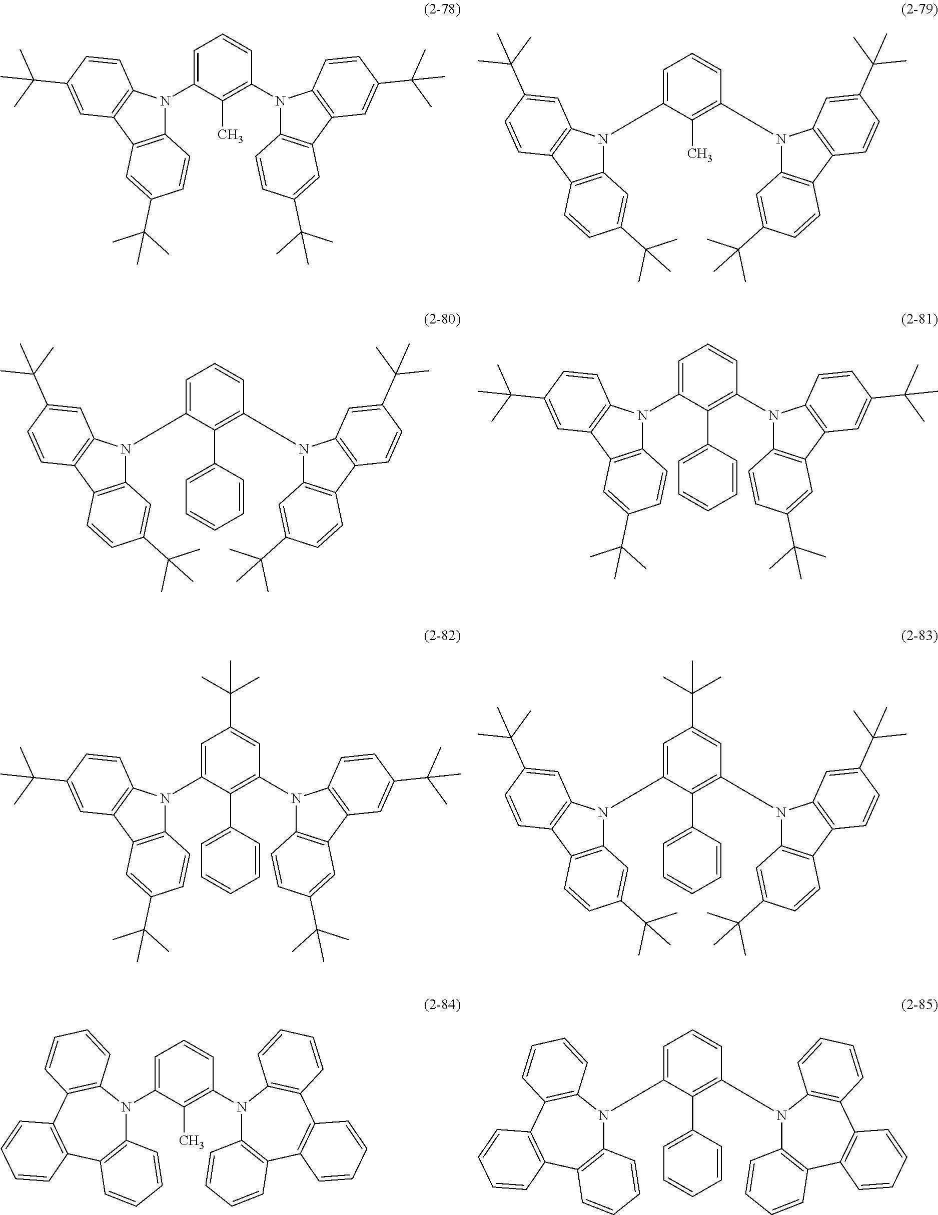

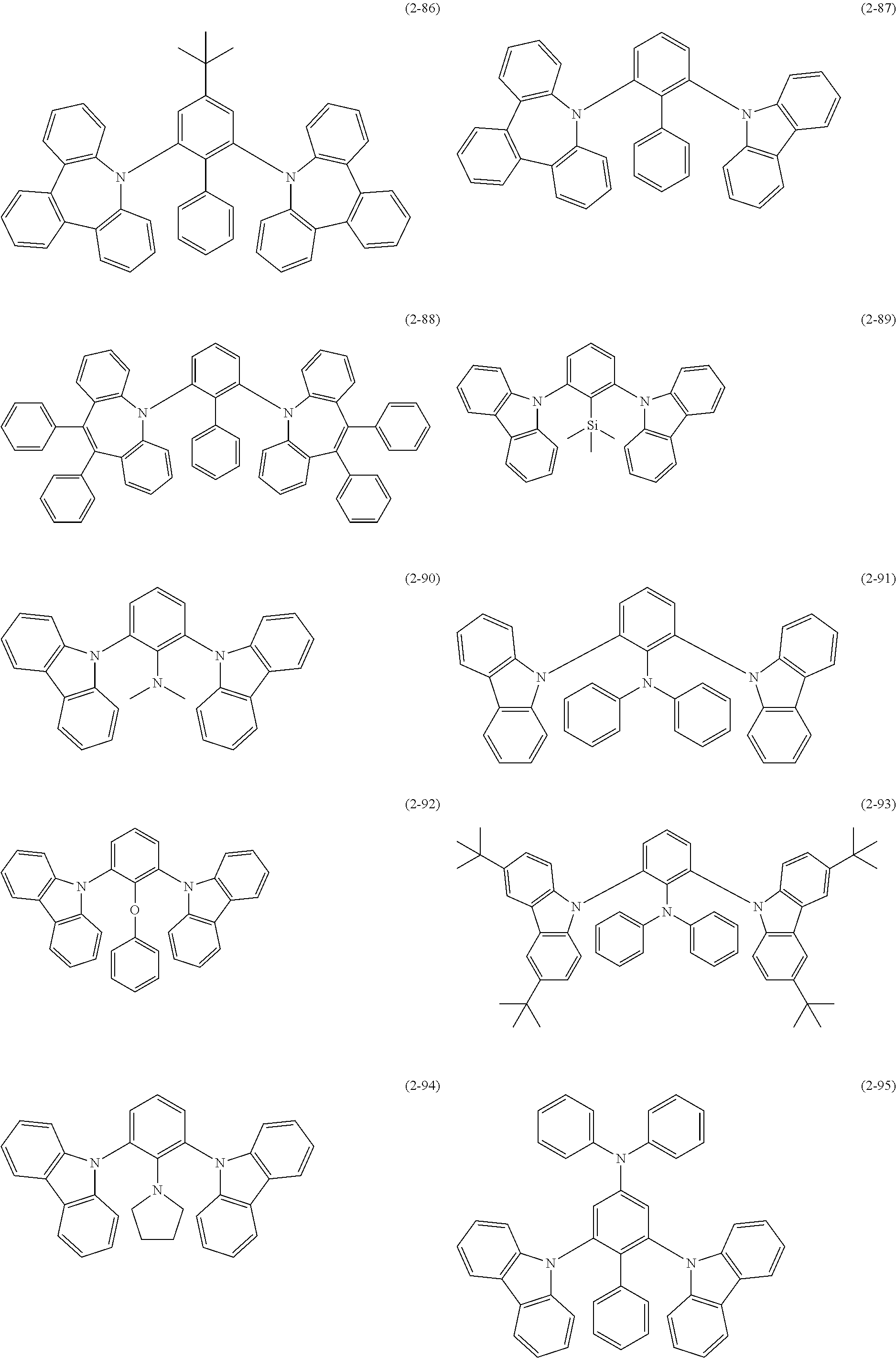

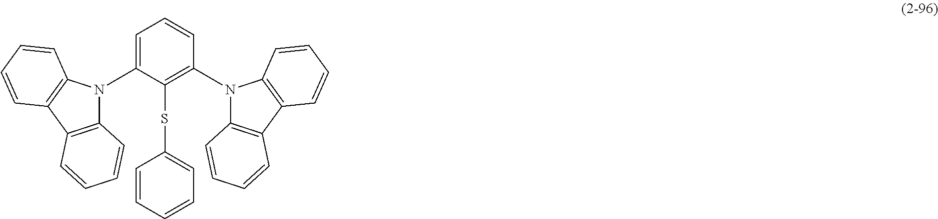

Specific examples of the compound shown in formula (3) include compounds of the following formulas (3-1) to (3-5).

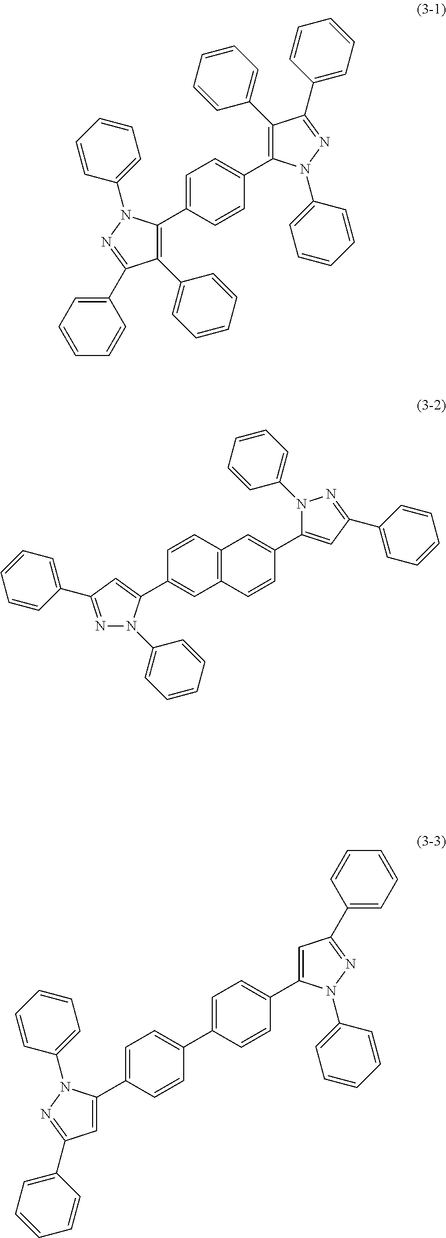

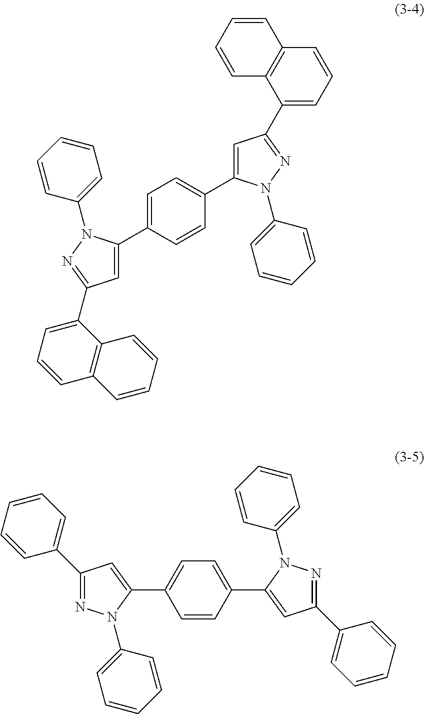

Examples of the group having an aryl group indicated by R4 to R9 in the compound represented by formula (4) include phenyl group, 1-naphthyl group, 2-naphthyl group, fluorenyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 1-chrysenyl group, 6-chrysenyl group, 2-fluoranthenyl group, 3-fluoranthenyl group, 2-biphenylyl group, 3-biphenylyl group, 4-biphenylyl group, o-tolyl group, m-tolyl group, p-tolyl group, and p-t-butylphenyl group.

Examples of the group having a hetereocyclic group indicated by R4 to R9 include a condensed polycyclic aromatic ring group with 2 to 20 carbon atoms as an aromatic ring group with a five-membered ring or six-membered ring containing an oxygen atom (O), a nitrogen atom (N), and a sulfur atom (S) as hetero atoms. Examples of such a heterocyclic group include thienyl group, furyl group, pyrrolyl group, pyridyl group, quinolyl group, quinoxalyl group, imidazopyridyl group, and benzothiazole group. Representative examples include 1-pyrrolyl group, 2-pyrrolyl group, 3-pyrrolyl group, pyrazinyl group, 2-pyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-isoindolyl group, 2-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, and 9-acridinyl group.

The group having an amino group indicated by R4 to R9 may be any of e.g. an alkylamino group, an arylamino group, and an aralkylamino group. It is preferable that they have an aliphatic hydrocarbon group with 1 to 6 carbon atoms and/or 1 to 4 aromatic ring groups. Examples of such a group include dimethylamino group, diethylamino group, dibutylamino group, diphenylamino group, ditolylamino group, bisbiphenylylamino group, and dinaphthylamino group. The above-described substituent may form a condensed ring formed of two or more substituents and may be a derivative thereof.

Specific examples of the compound shown in formula (4) include compounds of the following formulas (4-1) to (4-51).

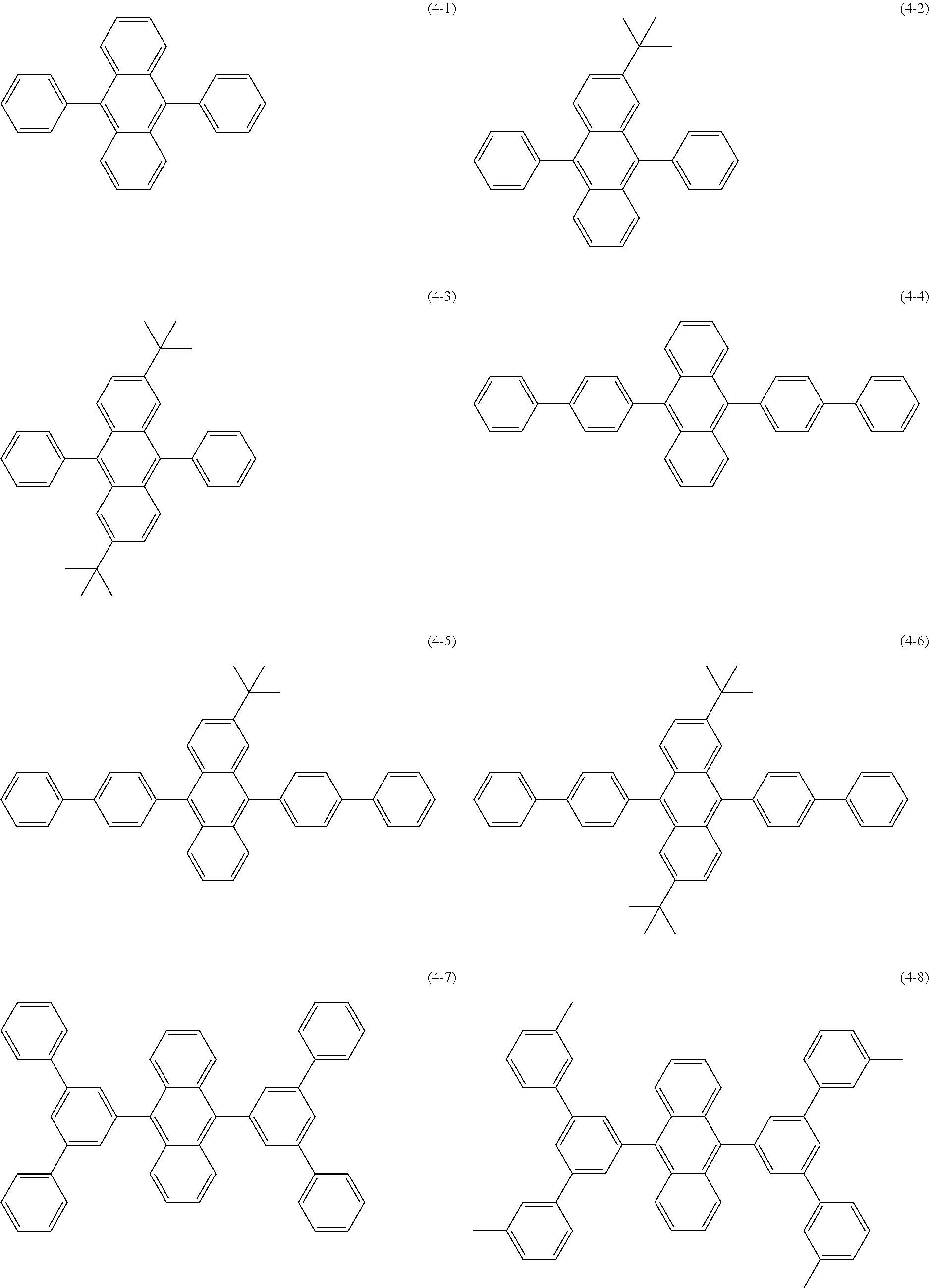

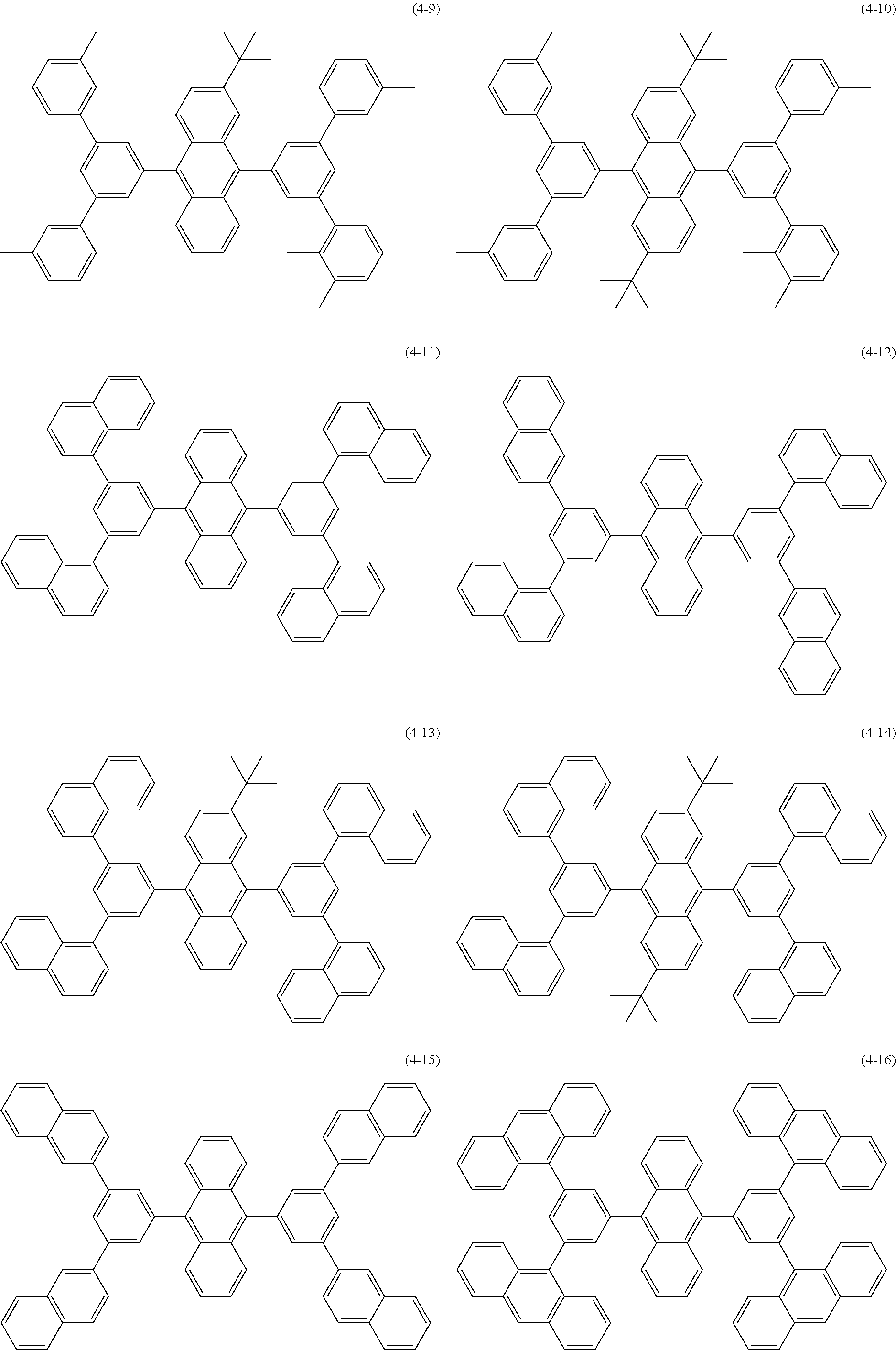

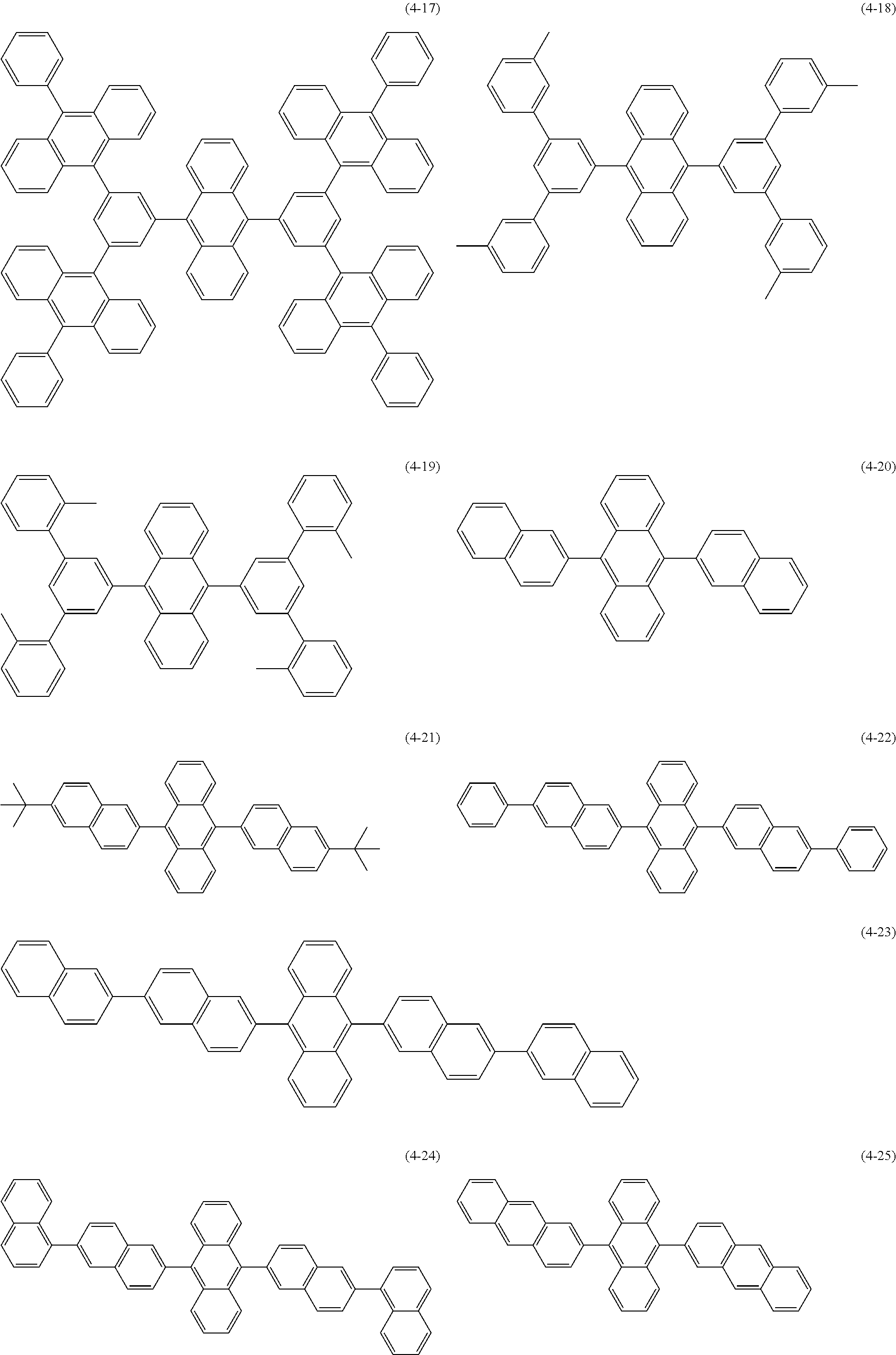

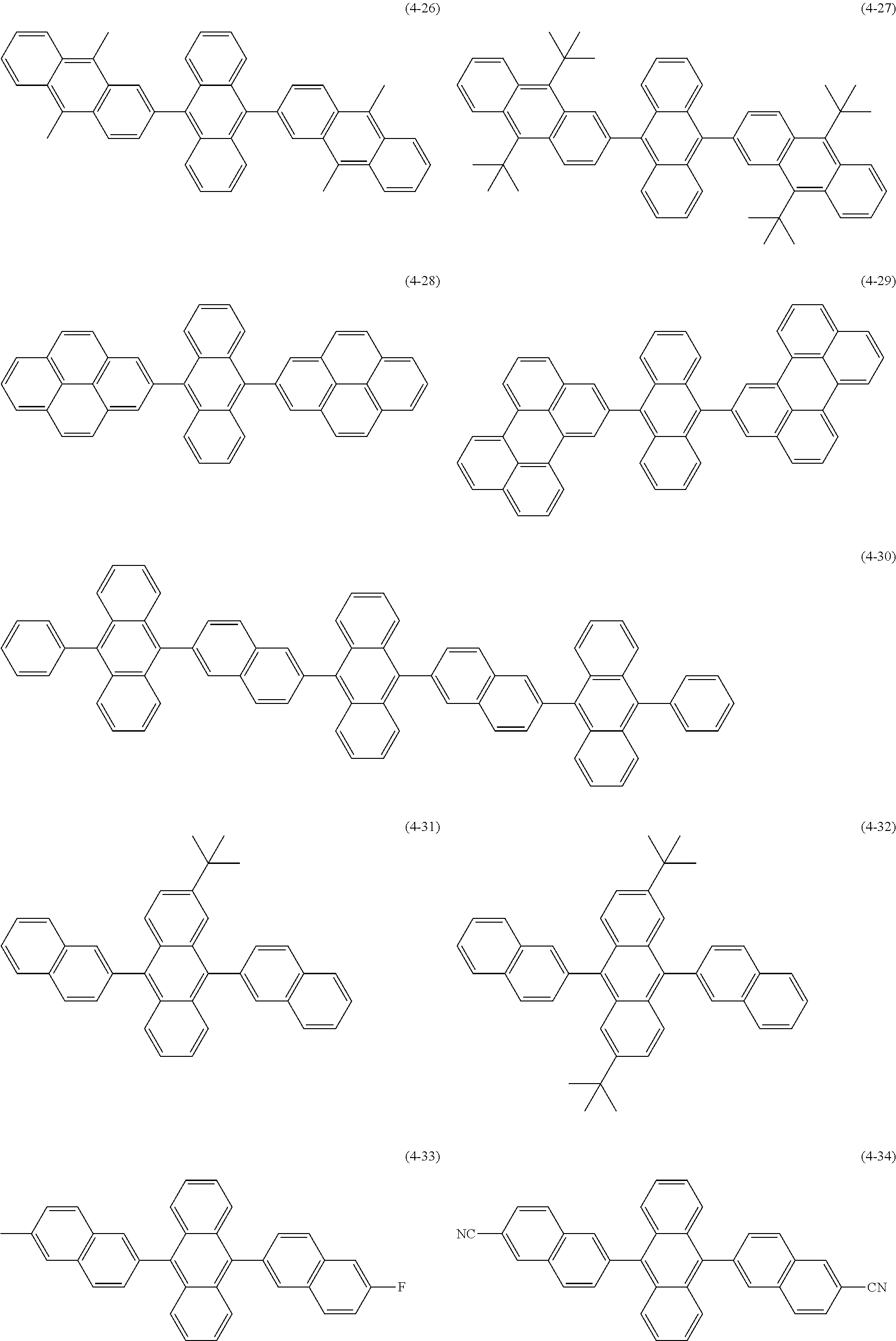

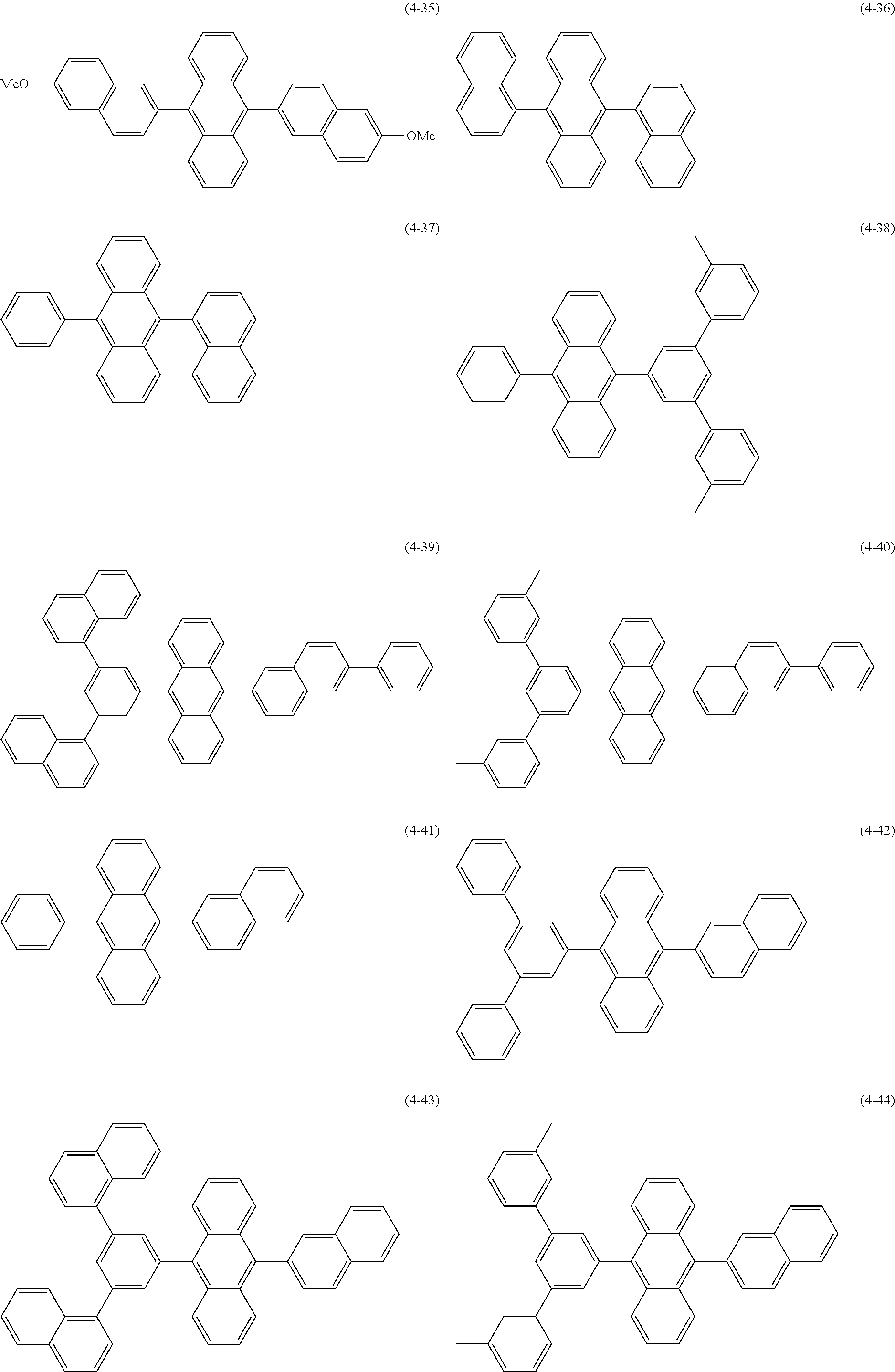

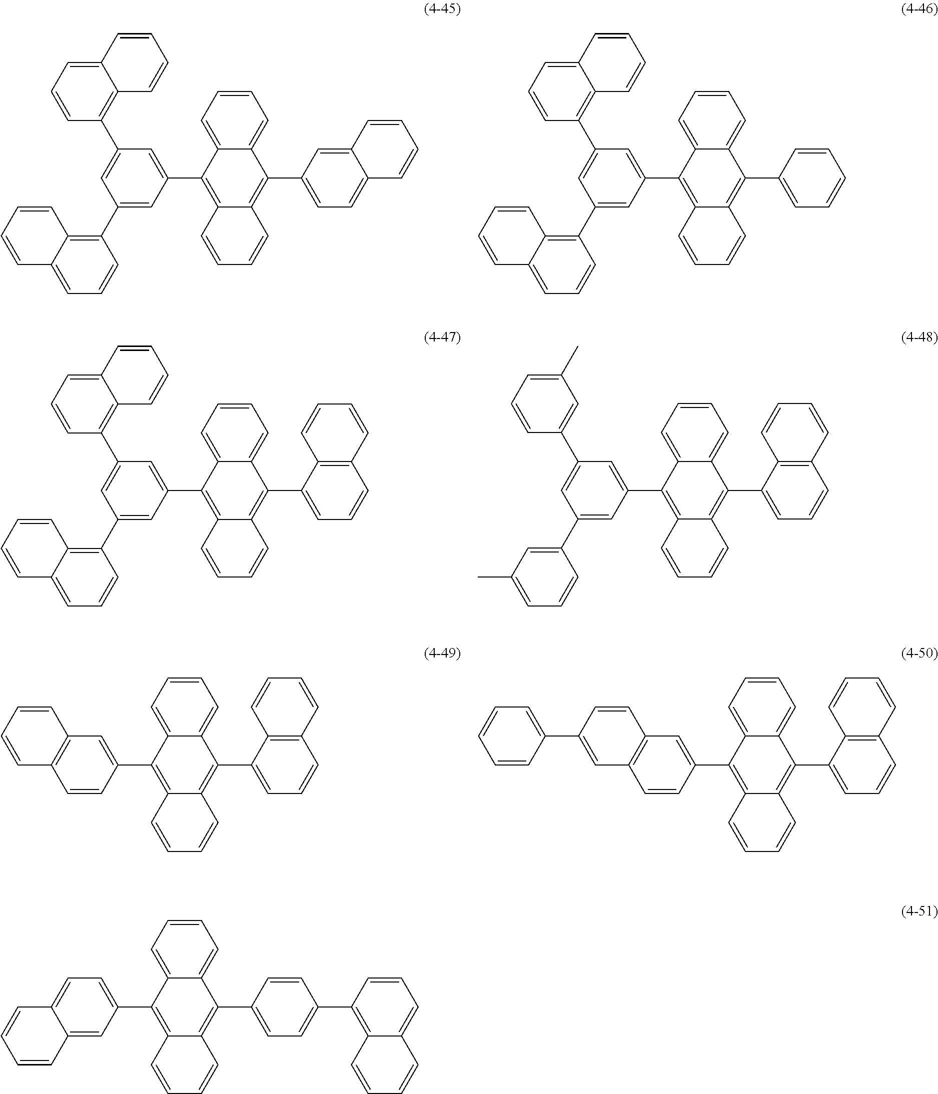

It is preferable to use a phosphorescent metal complex compound as a dopant. Specifically, it is preferable that the central metal thereof be a metal selected from Groups 7 to 11 of the periodic table. Examples of the metal include beryllium (Be), boron (B), zinc (Zn), cadmium (Cd), magnesium (Mg), gold (Au), silver (Ag), palladium (Pd), platinum (Pt), aluminum (Al), gadolinium (Ga), yttrium (Y), scandium (Sc), ruthenium (Ru), rhodium (Rh), osmium (Os), and iridium (Ir). More specific examples of the dopant include compounds represented by formulas (5-1) to (5-29). However, the dopant is not limited thereto. One kind or two or more kinds of the above-described dopant may be used. Furthermore, dopants having different central metals may be combined.

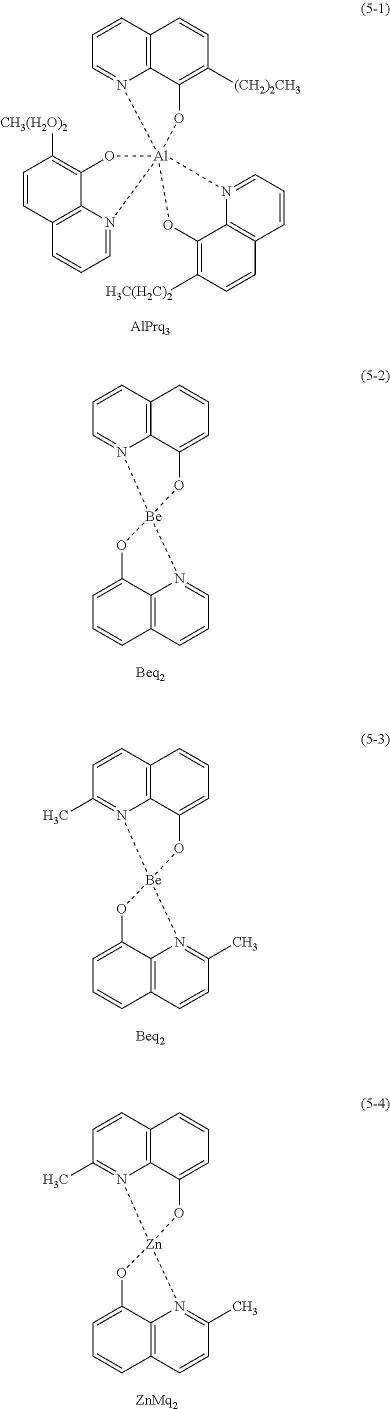

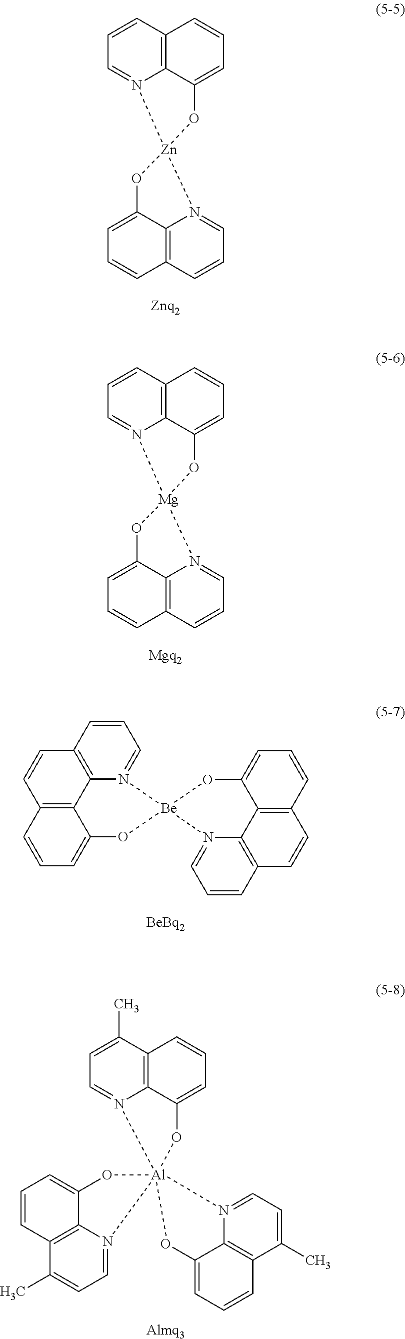

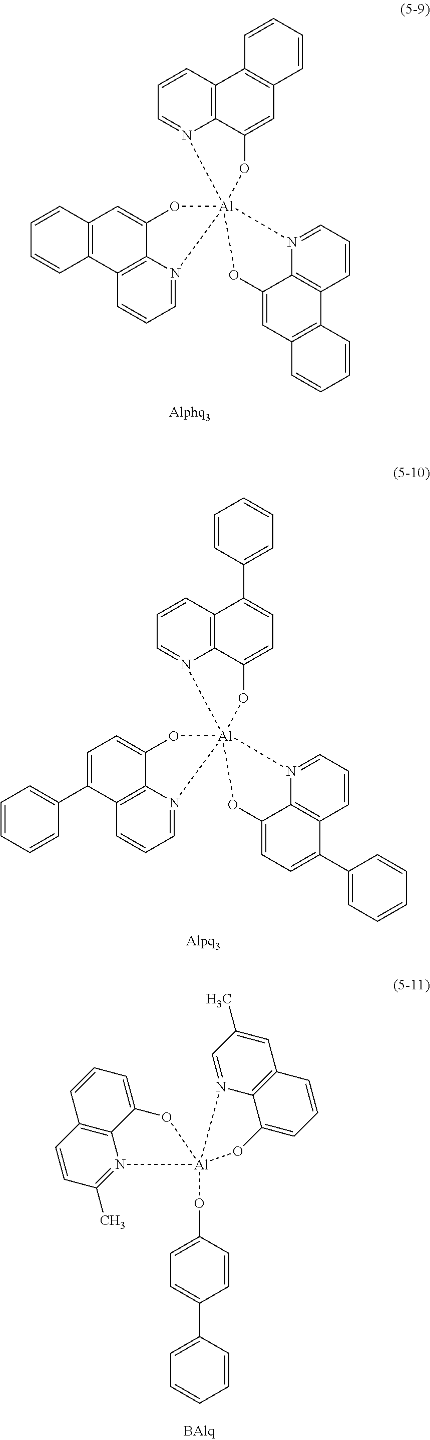

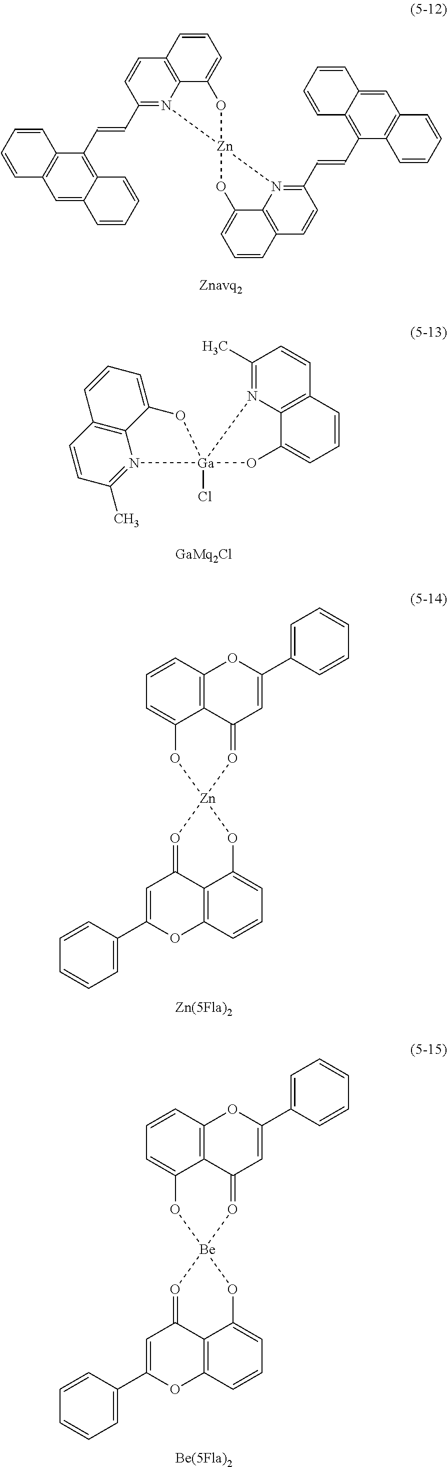

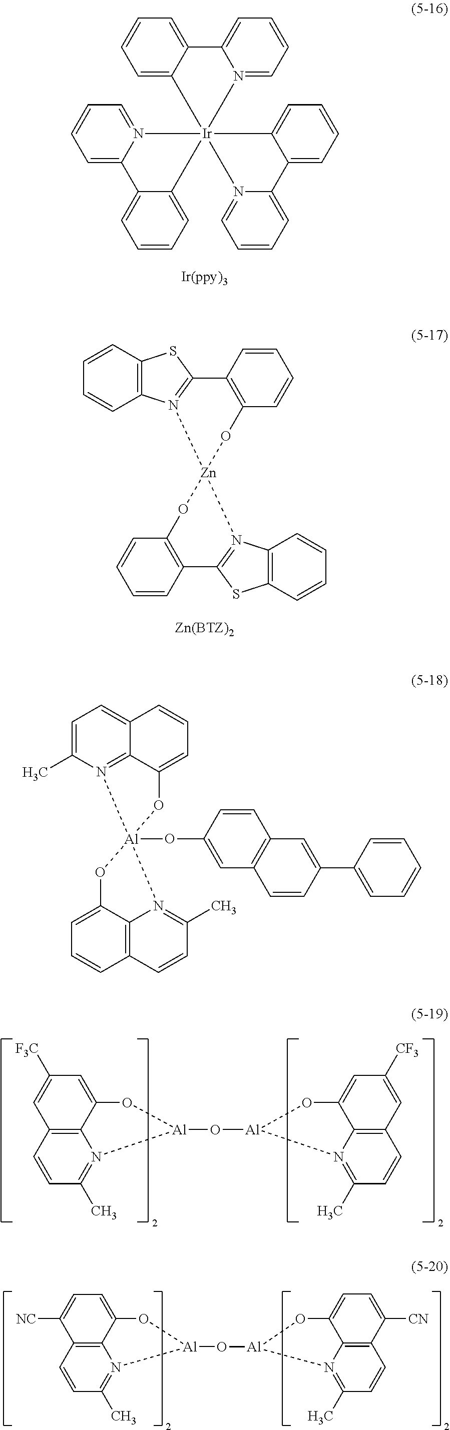

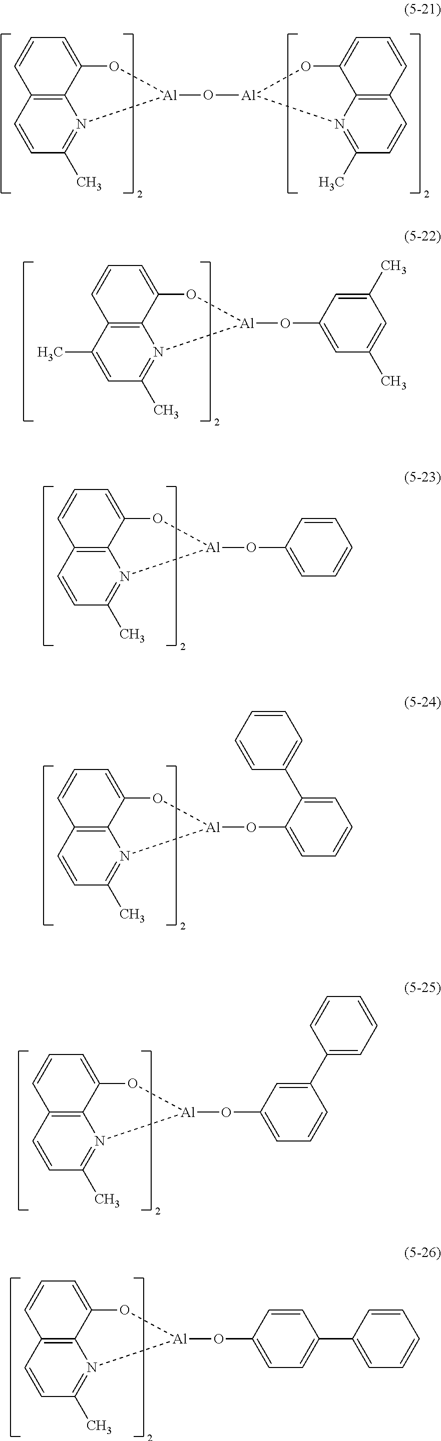

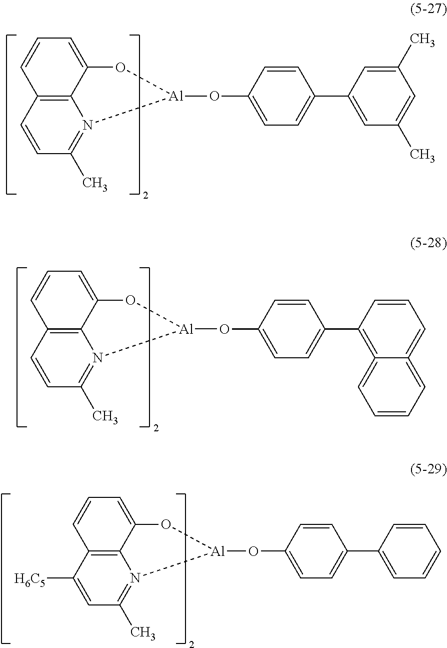

Besides the above-described low-molecular materials, particularly as materials that emit yellow light, bis(2-2′-benzothienyl)-pyridinato-N,C3)iridium(acetylacetonate) (formula (6-1), hereinafter abbreviated as btp2Ir(acac)), which emits phosphorescence through the triplet state, and bis(8-hydroxyquinolato)zinc (formula (6-2)) are available. Furthermore, an emission method such as a method of adding a yellow light emitting material to tris(2-phenylpyridine)iridium (formula (6-3), hereinafter abbreviated as Ir(ppy)3), which is a representative of green light emitting materials, to synthesize yellow light is also available. However, the material and the method are not limited thereto.

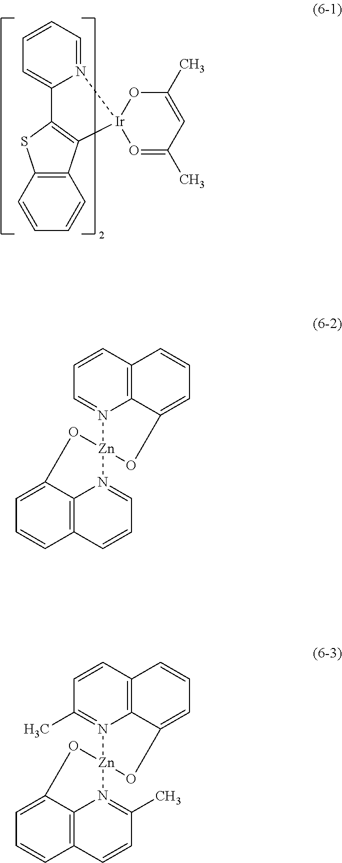

The material to form the yellow light emitting layer 14C is not limited to the phosphorescent and fluorescent low-molecular materials shown in the above-described formulas (2-1) to (2-96), (3-1) to (3-5), (4-1) to (4-51), (5-1) to (5-29), and (6-1) to (6-3). For example, the yellow light emitting layer 14C may be composed of a mixed material obtained by doping a polymer material with a phosphorescent luminescent low-molecular material. Besides this, a material obtained by mixing e.g. polyvinylcarbazole shown in the following formula (7) (n is an integer of 10 to 5000) and the phosphorescent low-molecular material shown in formulas (6-1) to (6-3) may be used. Furthermore, the yellow light emitting layer 14C may be formed by using a phosphorescent luminescent polymer material containing a phosphorescent luminescent light emitting unit. Specific examples of the material include luminescent polymers such as polyfluorene-based polymer derivatives, polyphenylene vinylene derivatives, polyphenylene derivatives, polyvinylcarbazole derivatives, and polythiophene derivatives. The polymer material used for the yellow light emitting layer 14C is not limited to the conjugated polymer. It may be a dendrimer-type polymer light emitting material, which is being developed in recent years. It contains a pendant-form unconjugated polymer and a dye-mixed unconjugated polymer and is composed of the central molecule called the core and a side chain that is so disposed as to cover the core and is called the dendron. Regarding the emission site, there are substances that emit light from the singlet exciton, substances that emit light from the triplet exciton, and substances that emit light from both. In the yellow light emitting layer 14C of the present embodiment, it is preferable to use a substance that emits light from the triplet exciton.

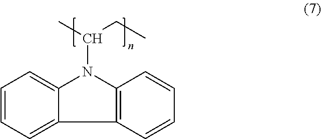

The forming method of the yellow light emitting layer 14C is not limited to the coating method and it may be formed by using an evaporation method or a thermal transfer method typified by e.g. laser transfer. It is preferable to select and use e.g. a material whose molecular weight is up to 2000 among the phosphorescent and fluorescent low-molecular materials shown in formulas (2-1) to (2-96), (3-1) to (3-5), (4-1) to (4-51), (5-1) to (5-29), and (6-1) to (6-3) as the material of the yellow light emitting layer 14C when it is formed by an evaporation method or a thermal transfer method. In the case of a low-molecular material whose molecular weight is at least 2000, possibly the material is denatured because heating with higher energy is necessary in the evaporation and transfer. Specifically, e.g. a stripe-manner mask having the aperture in the area corresponding to the yellow light emitting layer 14C is formed and thereafter the yellow light emitting layer 14C is deposited by evaporation. In the case of forming it by using a thermal transfer method, an existing thermal transfer method can be used. Specifically, for example a transfer substrate over which a transfer material layer is formed is disposed opposed to a transfer-target substrate over which the layers to the yellow light emitting layer 14C and the hole transport layer 14B of the blue organic EL element 10B are formed in advance, and light irradiation is performed. Thereby, the yellow light emitting layer 14C corresponding to the transfer pattern is formed.

In the blue light emitting layer 14D, recombination of electron and hole occurs due to electric field application, so that light is emitted. The thickness of the blue light emitting layer 14D is e.g. preferably 2 nm to 50 nm and more preferably 5 nm to 30 nm although depending on the whole configuration of the element.

The blue light emitting layer 14D is formed from a low-molecular material and is composed of at least two kinds of materials, i.e. host material and guest material. Specific examples of the host material include the compounds shown in the above-described formulas (4-1) to (4-51).

As the guest material, a material having high emission efficiency is used. Examples of the material include organic light emitting materials such as low-molecular fluorescent materials, phosphorescent dyes, and metal complexes. More specifically, the material is a compound having a peak wavelength in the range of about 400 nm to 490 nm. As such a compound, an organic substance such as a naphthalene derivative, an anthracene derivative, a naphthacene derivative, a styrylamine derivative, or a bis(azinyl)methene boron complex is used. In particular, it is preferable that the material be selected from an aminonaphthalene derivative, an aminoanthracene derivative, an aminochrysene derivative, an aminopyrene derivative, a styrylamine derivative, and a bis(azinyl)methene boron complex.

The electron transport layer 14E is to enhance the efficiency of electron transportation to the yellow light emitting layer 14C and the blue light emitting layer 14D and is provided as a common layer over the whole surface of the blue light emitting layer 14D. The thickness of the electron transport layer 14E is e.g. preferably 5 nm to 300 nm and more preferably 10 nm to 170 nm although depending on the whole configuration of the element.

Examples of the material of the electron transport layer 14E include quinoline, perylene, phenanthroline, bisstyryl, pyrazine, triazole, oxazole, fullerene, oxadiazole, fluorenone, and derivatives and metal complexes of them. Specific examples of the material include tris(8-hydroxyquinoline)aluminum (abbreviation, Alq3), anthracene, naphthalene, phenanthrene, pyrene, perylene, butadiene, coumarin, C60, acridine, stilbene, 1,10-phenanthroline, and derivatives and metal complexes of them.

The organic material used for the electron transport layer 14E is not limited to one kind of material and plural kinds of materials may be so used as to be mixed or stacked. Furthermore, the above-described compound may be used for the electron injection layer 14F to be described below.

The electron injection layer 14F is to enhance the electron injection efficiency and is provided as a common layer over the whole surface of the electron transport layer 14E. As the material of the electron injection layer 14F, e.g. lithium oxide (Li₂O), which is an oxide of lithium (Li), cesium carbonate (Cs₂CO₃), which is a composite oxide of cesium, and a mixture of these oxide and composite oxide can be used. The electron injection layer 14F is not limited to such a material. For example, a single substance of the following materials may be used: alkaline earth metals such as calcium (Ca) and barium (Ba), alkali metals such as lithium and cesium, metals having a low work function, such as indium (In) and magnesium (Mg), and oxides, composite oxides, and fluorides of these metals. Alternatively, a mixture or an alloy of these metals and oxides, composite oxides, and fluorides thereof may be formed for enhanced stability and be used. Moreover, the organic materials described as the material of the above-described electron transport layer 14E may be used.

The upper electrode 15 has a thickness of e.g. 2 nm to 15 nm and is formed of a metal electrically-conductive film. Specifically, it is composed of e.g. an alloy containing Al, Mg, Ca, or Na. In particular, an alloy of magnesium and silver (Mg—Ag alloy) is preferable because it has both electrical conductivity in a thin film and smallness of absorption. The ratio of magnesium to silver in the Mg—Ag alloy is not particularly limited but it is preferable that the film thickness ratio of Mg:Ag fall within the range of 20:1 to 1:1. The material of the upper electrode 15 may be an alloy of Al and Li (Al—Li alloy).

Furthermore, the upper electrode 15 may be a mixed layer containing an organic light emitting material such as an aluminum quinoline complex, a styrylamine derivative, or a phthalocyanine derivative. In this case, the upper electrode 15 may additionally have a layer having optical transparency like an MgAg layer as the third layer. In the case of the active-matrix driving system, the upper electrode 15 is formed in a blanket film manner over the substrate 11 in such a state as to be insulated from the lower electrode 12 by the organic layer 14 and the partition 13 and is used as a common electrode of the red organic EL element 10R, the green organic EL element 10G, and the blue organic EL element 10B.

The protective layer 16 has a thickness of e.g. 2 to 3 μm and may be configured by either an insulating material or an electrically-conductive material. As the insulating material, an inorganic amorphous insulating material, specifically e.g. amorphous silicon (α-Si), amorphous silicon carbide (α-SiC), amorphous silicon nitride (α-Si₁₋ₓNₓ), or amorphous carbon (α-C), is preferable. Such an inorganic amorphous insulating material forms no grain and thus has low water permeability. Therefore, a favorable protective film is obtained.

The sealing substrate 17 is located on the side of the upper electrode 15 of the red organic EL element 10R, the green organic EL element 10G, and the blue organic EL element 10B and is to seal the red organic EL element 10R, the green organic EL element 10G, and the blue organic EL element 10B together with the adhesion layer (not shown). In the top-emission system, in which light is extracted through the sealing substrate, the sealing substrate 17 is composed of a material, such as glass, that is transparent to light generated in the red organic EL element 10R, the green organic EL element 10G, and the blue organic EL element 10B. The sealing substrate 17 is provided with e.g. the color filter 18 and a light blocking film (not shown) as a black matrix. Based on this configuration, light generated in the red organic EL element 10R, the green organic EL element 10G, and the blue organic EL element 10B is extracted. In addition, ambient light reflected by the red organic EL element 10R, the green organic EL element 10G, the blue organic EL element 10B, and interconnects among them is absorbed. Thereby, the contrast is improved. In the bottom-emission system, in which light is extracted through the lower electrode, the color filter 18 is formed under the sealing substrate 17 similarly.

The color filter 18 has a red filter 18R, a green filter 18G, and a blue filter 18B. They are disposed in turn corresponding to the red organic EL element 10R, the green organic EL element 10G, and the blue organic EL element 10B. The red filter 18R, the green filter 18G, and the blue filter 18B each have a rectangular shape and are formed without gaps for example. These red filter 18R, green filter 18G, and blue filter 18B are each composed of a resin in which a pigment is mixed. By selecting the pigment, adjustment is so carried out that the optical transmittance in the intended red, green, or blue wavelength region becomes high whereas the optical transmittance in the other wavelength region becomes low.

Furthermore, the wavelength range of high transmittance in the color filter 18 corresponds with the peak wavelength λ of the spectrum of the light desired to be extracted from a resonator structure MC1. Due to this feature, among ambient light beams incident from the sealing substrate 17, only light beams having the wavelength equal to the peak wavelength λ of the spectrum of the light desired to be extracted are transmitted through the color filter 18 and ambient light beams having the other wavelengths are prevented from entering the organic EL elements 10R, 10G, and 10B of the respective colors.

Although the color filter 18 has the red filter 18R, the green filter 18G, and the blue filter 18B in this configuration, light emitted from the blue light emitting layer 14D may be directly used without forming the blue filter 18B.

The light blocking film (not shown) is formed of e.g. a black resin film that contains a black colorant and has optical density of at least 1 or a thin film filter utilizing thin film interference. The light blocking film formed of a black resin film is preferable because it can be easily formed at low cost. The thin film filter is obtained by stacking at least one layer of a thin film composed of a metal, a metal nitride, or a metal oxide for example, and is to attenuate light by utilizing the interference of the thin film. Specific examples of the thin film filter include a component obtained by alternately stacking Cr and chromium oxide (III) (Cr₂O₃).

This organic EL display device 1 can be manufactured in the following manner for example.

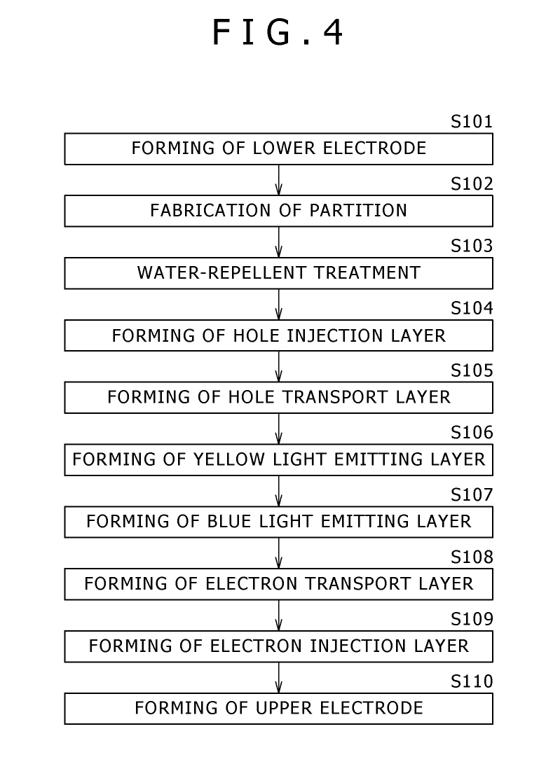

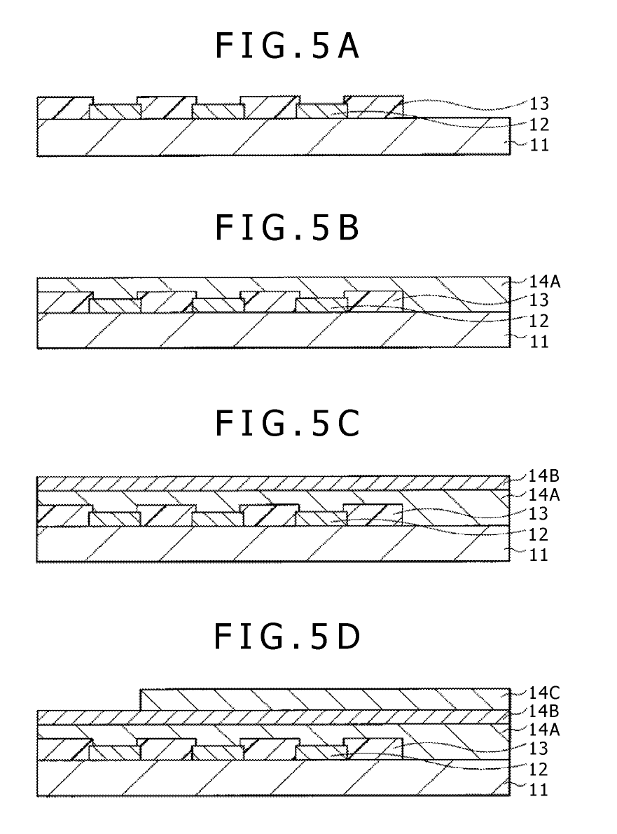

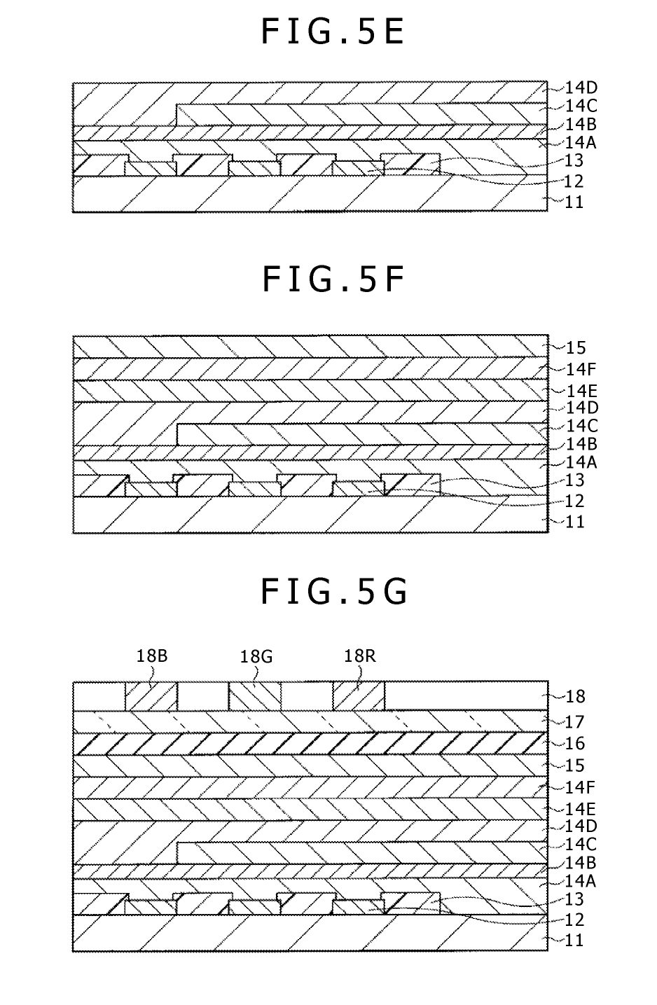

FIG. 4 shows the flow of a manufacturing method of this organic EL display device 1. FIGS. 5A to 5G show the manufacturing method shown in FIG. 4 in the step order.

First, the pixel drive circuit 140 including the drive transistor Tr1 is formed over the substrate 11 composed of the above-described material and the planarization insulating film (not shown) composed of e.g. a photosensitive resin is provided.

### (Step of Forming Lower Electrode 12)

Subsequently, a transparent electrically-conductive film composed of e.g. ITO is formed over the whole surface of the substrate 11 and this transparent electrically-conductive film is patterned. Thereby, as shown in FIG. 5A, the lower electrode 12 is formed for each of the red organic EL element 10R, the green organic EL element 10G, and the blue organic EL element 10B (step S101). In this forming, the lower electrode 12 is electrically connected to the drain electrode of the drive transistor Tr1 via a contact hole (not shown) of the planarization insulating film (not shown).

### (Step of Forming Partition 13)

Subsequently, as shown in FIG. 5A, the partition 13 is formed by depositing an inorganic insulating material such as SiO₂ over the lower electrode 12 and the planarization insulating film (not shown) by e.g. chemical vapor deposition (CVD) (step S102).

After the partition 13 is formed, oxygen plasma treatment is performed for the surface of the substrate 11 on the side on which the lower electrodes 12 and the partition 13 are formed. Thereby, contamination such as organic substances adhering to the surface is removed to enhance the wettability. Specifically, the substrate 11 is heated to a predetermined temperature, e.g. about 70 to 80° C., and subsequently plasma treatment (O₂ plasma treatment) with use of oxygen as the reaction gas is performed under atmospheric pressure (step S103).

### (Step of Forming Hole Injection Layer 14A)

After the plasma treatment is performed, as shown in FIG. 5B, the hole injection layer 14A composed of the above-described material is formed in the area surrounded by the partition 13 (step S104). This hole injection layer 14A is formed by a coating method such as a spin coating method, slit printing, and a droplet discharge method. In particular, the forming material of the hole injection layer 14A may be selectively disposed in the area surrounded by the partition 13. In this case, it is preferable to use a method of selective printing based on an ink-jet system or a nozzle coating system as a droplet discharge method or gravure printing, flexo printing, etc.

Specifically, a solution or a dispersion liquid of e.g. polyaniline or polythiophene as the forming material of the hole injection layer 14A is disposed on the exposed surface of the lower electrode 12. Thereafter, heat treatment (drying treatment) is performed to thereby form the hole injection layer 14A.

In the heat treatment, heating is performed at a high temperature after the solvent or the dispersion medium is removed by drying. If an electrically-conductive polymer such as polyaniline or polythiophene is used, an air atmosphere or an oxygen atmosphere is preferable. This is because electrical conductivity is readily developed due to oxidization of the electrically-conductive polymer by oxygen.

The heating temperature is preferably 150° C. to 300° C. and more preferably 180° C. to 250° C. The time is preferably about five minutes to 300 minutes and more preferably 10 minutes to 240 minutes although depending on the temperature and the atmosphere. The film thickness after the drying is preferably 5 nm to 100 nm and more preferably 8 nm to 50 nm.

### (Step of Forming Hole Transport Layer 14B)

After the hole injection layer 14A is formed, as shown in FIG. 5C, the hole transport layer 14B containing the above-described polymer material is formed on the hole injection layer 14A (step S105). This hole transport layer 14B is formed by a coating method such as a spin coating method, slit printing, and a droplet discharge method. In particular, the forming material of the hole transport layer 14B may be selectively disposed in the area surrounded by the partition 13. In this case, it is preferable to use a method of selective printing based on an ink-jet system or a nozzle coating system as a droplet discharge method or gravure printing, flexo printing, etc.

Specifically, a mixed solution or a dispersion liquid of high-molecular polymer and low-molecular material as the forming material of the hole transport layer 14B is disposed on the exposed surface of the hole injection layer 14A by e.g. a slit printing system. Thereafter, heat treatment (drying treatment) is performed to form the hole transport layer 14B.

In the heat treatment, heating is performed at a high temperature after the solvent or the dispersion medium is removed by drying. As the atmosphere of the coating and the atmosphere of the solvent drying and heating, an atmosphere composed mainly of nitrogen (N₂) is preferable. The existence of oxygen and water possibly lowers the emission efficiency and lifetime of the fabricated organic EL display device. In particular, attention is necessary in the heating step because the influence of oxygen and water is large. The oxygen concentration is preferably 0.1 ppm to 100 ppm and more preferably up to 50 ppm. If oxygen more than 100 ppm exists, possibly the interface of the formed thin film is contaminated and the emission efficiency and lifetime of the obtained organic EL display device are lowered. If the oxygen concentration is lower than 0.1 ppm, although the characteristics of the element have no problem, there is a possibility that the apparatus cost for keeping the oxygen concentration of the atmosphere lower than 0.1 ppm becomes significantly high as the current mass-production process.

Regarding water, the dew point is e.g. preferably −80° C. to −40° C. Furthermore, it is more preferably up to −50° C. and much more preferably up to −60° C. If water with a dew point higher than −40° C. exists, possibly the interface of the formed thin film is contaminated and the emission efficiency and lifetime of the obtained organic EL display device are lowered. If water with a dew point lower than −80° C. exists, although the characteristics of the element have no problem, there is a possibility that the apparatus cost for keeping the dew point of the atmosphere lower than −80° C. becomes significantly high as the current mass-production process.

The heating temperature is preferably 100° C. to 230° C. and more preferably 150° C. to 200° C. It is preferable that the heating temperature be at least lower than the temperature when the hole injection layer 14A is formed. The time is preferably about five minutes to 300 minutes and more preferably 10 minutes to 240 minutes although depending on the temperature and the atmosphere. The film thickness after the drying is preferably 10 nm to 200 nm and more preferably 15 nm to 150 nm although depending on the whole configuration of the element.

### (Step of Forming Yellow Light Emitting Layer 14C)

After the hole transport layer 14B is formed, as shown in FIG. 5D, the yellow light emitting layer 14C is formed (step S106). As the forming method of the yellow light emitting layer 14C, e.g. a coating method such as a spin coating method and a droplet discharge method is used. In particular, in the case of selectively disposing the forming material of the yellow light emitting layer 14C in the area surrounded by the partition 13, it is preferable to use an ink-jet system or a nozzle coating system as a droplet discharge method. Specifically, for example by an ink-jet system, a mixed solution or a dispersion liquid obtained by dissolving a phosphorescent host material doped with e.g. 1 weight % of a phosphorescent dopant as the forming material of the yellow light emitting layer 14C in a solvent obtained by mixing xylene and cyclohexylbenzene at a ratio of 2 to 8 is disposed on the exposed surface of the hole transport layer 14B. Thereafter, heat treatment based on method and condition similar to those of the heat treatment (drying treatment) explained in the step of forming the above-described hole transport layer 14B is performed to thereby form the yellow light emitting layer 14C. The yellow light emitting layer 14C may be formed by using a method of selecting printing based on gravure printing, flexo printing, etc. as a printing system with use of a plate.

The yellow light emitting layer 14C may be formed by an evaporation method. In this case, the substrate is moved into vacuum evaporation apparatus and then film deposition is performed at an evaporation rate of e.g. 0.1 to 2 Å/s.

### (Steps of Forming Blue Light Emitting Layer 14D, Electron Transport Layer 14E, Electron Injection Layer 14F, and Upper Electrode 15)

After the yellow light emitting layer 14C is formed, as shown in FIG. 5E, the blue light emitting layer 14D composed of the above-described method is formed over the whole surfaces of the hole transport layer 14B and the yellow light emitting layer 14C by an evaporation method (step S107). Subsequently, as shown in FIG. 5F, the electron transport layer 14E, the electron injection layer 14F, and the upper electrode 15 are formed over the whole surface of the blue light emitting layer 14D by an evaporation method (steps S108, S109, and S110).

After the upper electrode 15 is formed, as shown in FIG. 5G, the protective layer 16, the sealing substrate 17, and the color filter 18 are formed. Specifically, first the protective layer 16 is formed by a film deposition method in which the energy of the film deposition particle is so low as not to have an influence on the underlying layers, such as an evaporation method or a CVD method. For example, in the case of forming the protective layer 16 composed of amorphous silicon nitride, it is formed to a film thickness of 2 to 3 μm by a CVD method. In this forming, it is preferable to set the film deposition temperature to an ordinary temperature to prevent luminance lowering due to the deterioration of the organic layer 14. In addition, it is preferable to perform the film deposition under a condition that minimizes the stress of the film to prevent delamination of the protective layer 16.

The blue light emitting layer 14D, the electron transport layer 14E, the electron injection layer 14F, the upper electrode 15, and the protective layer 16 are formed as blanket films over the whole surface without using a mask. Furthermore, preferably the forming of the blue light emitting layer 14D, the electron transport layer 14E, the electron injection layer 14F, the upper electrode 15, and the protective layer 16 is consecutively performed in the same film deposition apparatus without being exposed to the air. This prevents the deterioration of the organic layer 14 due to water in the air.

If an auxiliary electrode (not shown) is formed in the same step as that of the lower electrode 12, the organic layer 14 formed as a blanket film above the auxiliary electrode may be removed by a method such as laser ablation before the upper electrode 15 is formed. This makes it possible to directly connect the upper electrode 15 to the auxiliary electrode and enhances the contact.

After the protective layer 16 is formed, for example the light blocking film composed of the above-described material is formed on the sealing substrate 17 composed of the above-described material. Subsequently, the material of the red filter 18R is applied on the sealing substrate 17 by e.g. spin coating and the applied material is patterned by a photolithography technique, followed by baking. Thereby, the red filter 18R is formed. Subsequently, the green filter 18G and the blue filter 18B are sequentially formed similarly to the red filter 18R.

Thereafter, the adhesion layer (not shown) is formed on the protective layer 16 and the sealing substrate 17 is bonded to the protective layer 16 with the intermediary of this adhesion layer. Through the above-described steps, the organic EL display device 1 shown in FIG. 1 to FIG. 3 is completed.

In this organic EL display device 1, the scanning signal is supplied from the scanning line drive circuit 130 to the respective pixels via the gate electrode of the write transistor Tr2 and the image signal from the signal line drive circuit 120 is held in the hold capacitance Cs via the write transistor Tr2. That is, the drive transistor Tr1 is on/off-controlled depending on the signal held in this hold capacitance Cs. Thereby, a drive current Id is injected to the red organic EL element 10R, the green organic EL element 10G, and the blue organic EL element 10B and light emission occurs due to recombination of hole and electron. In the case of the lower-surface light emission (bottom emission), this light is extracted after being transmitted through the lower electrode 12 and the substrate 11. In the case of the upper-surface light emission (top emission), the light is extracted after being transmitted through the upper electrode 15, the color filter 18, and the sealing substrate 17.

In the related-art organic EL display devices, full-color displaying is achieved based on the filter system using white light, the three-color-independent (or four-color-independent) emission system, etc. as described above. However, the filter system has a problem that the light use efficiency is lowered and the power consumption increases because the light is output through the color filter. Furthermore, in the organic EL display device having a stack structure (tandem structure) that is obtained by stacking plural organic layers having a light emitting layer and synthesizes white light, the emission efficiency is enhanced and the necessary current is reduced. However, the tandem structure has a problem that the driving voltage increases and sufficient reduction in the power consumption is difficult because the plural organic layers are stacked with the intermediary of a charge generating layer. In addition, using white light will be useful because the color having high appearance frequency in the display device is white and part near the black-body radiation line as described above. However, in practice, red light emitting element, green light emitting element, and blue light emitting element need to be driven for chromaticity point adjustment. Thus, there is a problem that the power consumption further increases.

The three-color-independent (or four-color-independent) emission system has a problem that the color reproducibility and the emission efficiency are in a trade-off relationship. As a countermeasure against this problem, there has been reported a method of achieving both keeping of the color gamut and the emission efficiency by using yellow, which yields high luminosity and high emission efficiency. However, in the three-color-independent emission system, at least disposing the light emitting layers of the respective colors in different areas separately from each other is necessary and therefore the number of steps is larger than that of the filter system. Furthermore, in the case of adding the yellow light emitting layer to enhance the color reproducibility, the number of steps further increases, which results in a problem that the facility cost and the material cost increase and the productivity is greatly lowered.

In contrast, in the organic EL display device 1 of the present embodiment, the yellow light emitting layer 14C is provided on the area on the hole transport layer 14B except the area of the blue organic EL element 10B, and the light emission color is divided by the color filter having red, green, and blue. This reduces the step of separately disposing the light emitting layers.

As just described, in the organic EL display device 1 of the present embodiment, the yellow light emitting layer 14C is provided on the hole transport layer 14B except for the area of the blue organic EL element 10B and the blue light emitting layer 14D is provided over the whole surfaces of the hole transport layer 14B and the yellow light emitting layer 14C. Furthermore, the light emission color is divided by the color filter having red, green, and blue. Thus, the step of separately disposing the light emitting layers is reduced and the manufacturing step of the organic EL display device is simplified. That is, a power-saving organic EL display with suppressed cost and enhanced productivity can be fabricated.

Second to fourth embodiments of the present disclosure will be described below. The same constituent element as that in the first embodiment is given the same numeral and description thereof is omitted.

### Second Embodiment

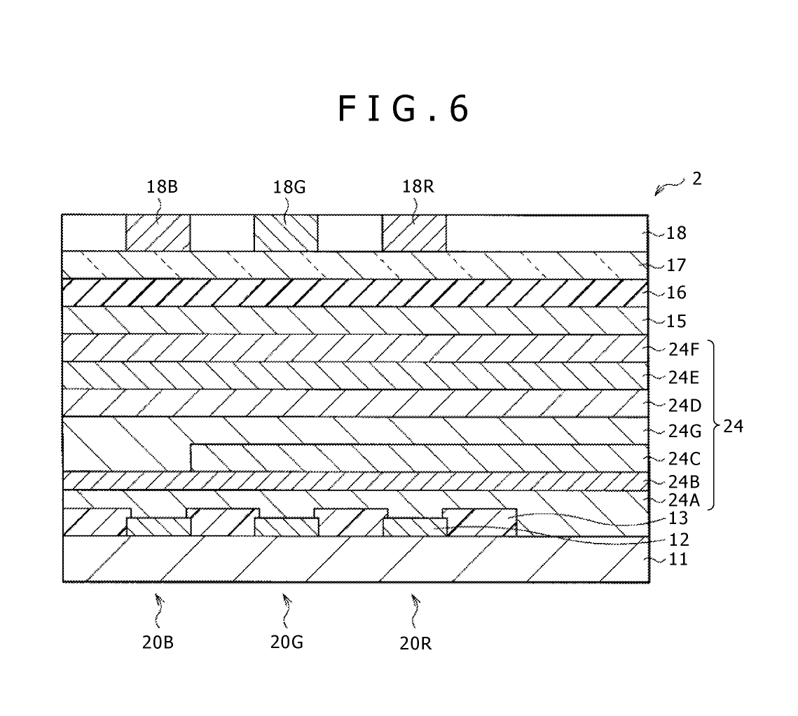

FIG. 6 shows the sectional configuration of the display area of an organic EL display device 2 in the second embodiment. Each of a red organic EL element 20R, a green organic EL element 20G, and a blue organic EL element 20B has a configuration obtained by stacking the lower electrode 12 (first electrode) as the anode, the partition 13, an organic layer 24 including light emitting layers (yellow light emitting layer 24C and blue light emitting layer 24D) to be described later, and the upper electrode 15 (second electrode) as the cathode in that order from the side of the substrate 11 with the intermediary of the drive transistor Tr1 of the above-described pixel drive circuit 140 and a planarization insulating film (not shown). The organic EL display device 2 of the present embodiment is different from the above-described first embodiment in that a connection layer 24G exists between the yellow light emitting layer 24C and the blue light emitting layer 24D.

The connection layer 24G is to improve the interfaces between the hole transport layer 24B and the blue light emitting layer 24D and between the yellow light emitting layer 24C and the blue light emitting layer 24D to enhance the hole injection efficiency, and confine excitons generated in the yellow light emitting layer 24C to enhance the emission efficiency. The thickness of the connection layer 24G is e.g. preferably 2 nm to 30 nm and more preferably 5 nm to 15 nm although depending on the whole configuration of the element.

Examples of the material to form the connection layer 24G include benzine, styrylamine, triphenylamine, porphyrin, triphenylene, azatriphenylene, tetracyanoquinodimethane, triazole, imidazole, oxadiazole, polyarylalkane, phenylenediamine, arylamine, oxazole, anthracene, fluorenone, hydrazone, stilbene, and derivatives of them. Other examples include monomers and oligomers of the heterocyclic conjugate system, such as vinylcarbazole-based compounds, thiophene-based compounds, and aniline-based compounds. By using such a material, contamination and injection barrier of the interface between the hole transport layer 24B and the blue light emitting layer 24D are suppressed and the injection efficiency of the hole supplied from the side of the lower electrode 12 to the blue light emitting layer 24D is enhanced. Specifically, the efficiency of hole injection to the blue light emitting layer 24D can be kept by setting 0.4 eV or lower as the energy difference between the ground state of the connection layer 24G (S0G) and the ground state of the hole transport layer 24B (S0B).

Specific preferable examples of the material to form the connection layer 24G include low-molecular materials shown in the following formulas (8) and (9).

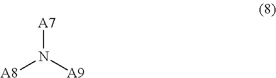

(A7 to A9 are each an aromatic hydrocarbon group, a heterocyclic group, or a derivative of them.)

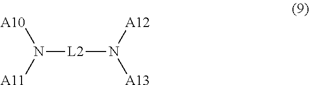

(L2 is a group in which 2 to 6 divalent aromatic ring groups are bonded. Specifically, it is a divalent group in which 2 to 6 aromatic rings are connected or a derivative thereof. A10 to A13 are each a group in which 1 to 10 aromatic hydrocarbon groups, heterocyclic groups, or derivatives thereof are bonded.)

Specific examples of the compound shown in formula (8) include compounds of the following formulas (8-1) to (8-48).

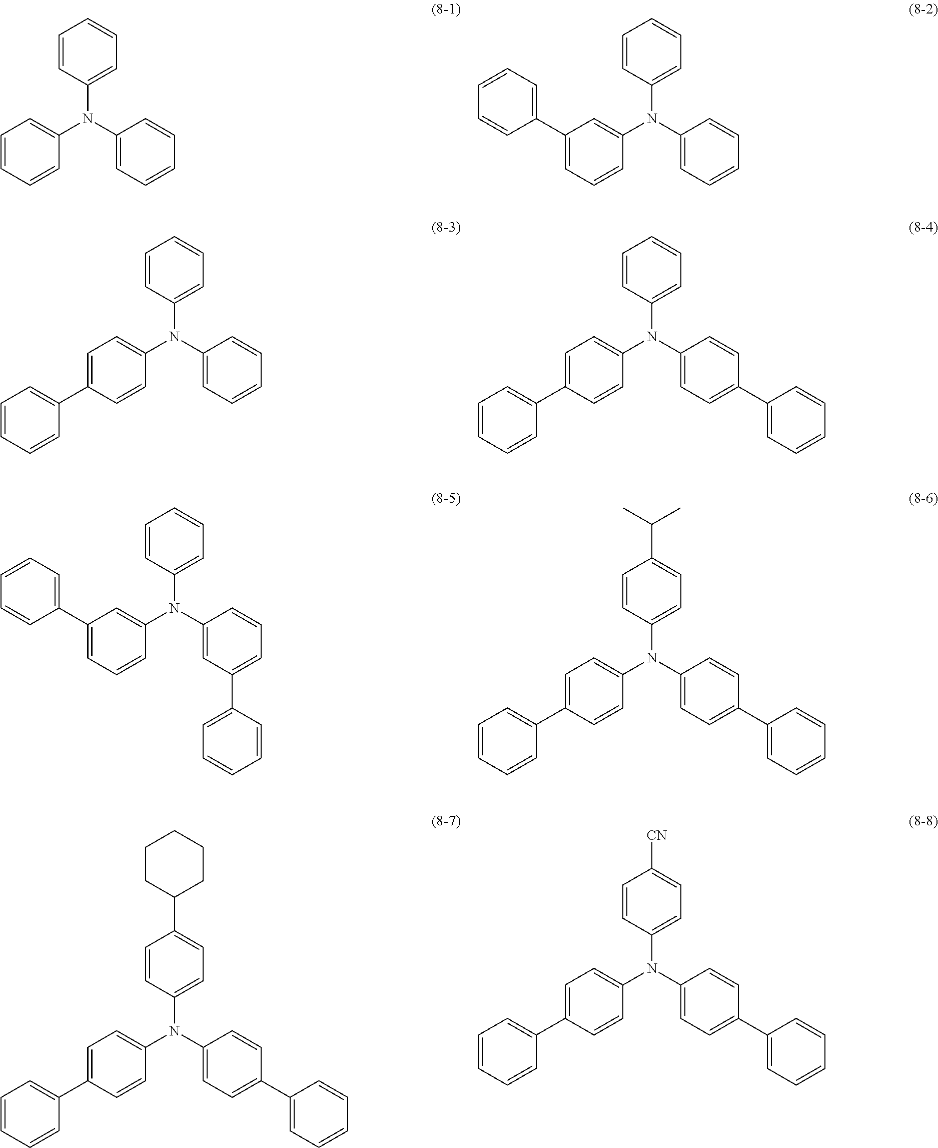

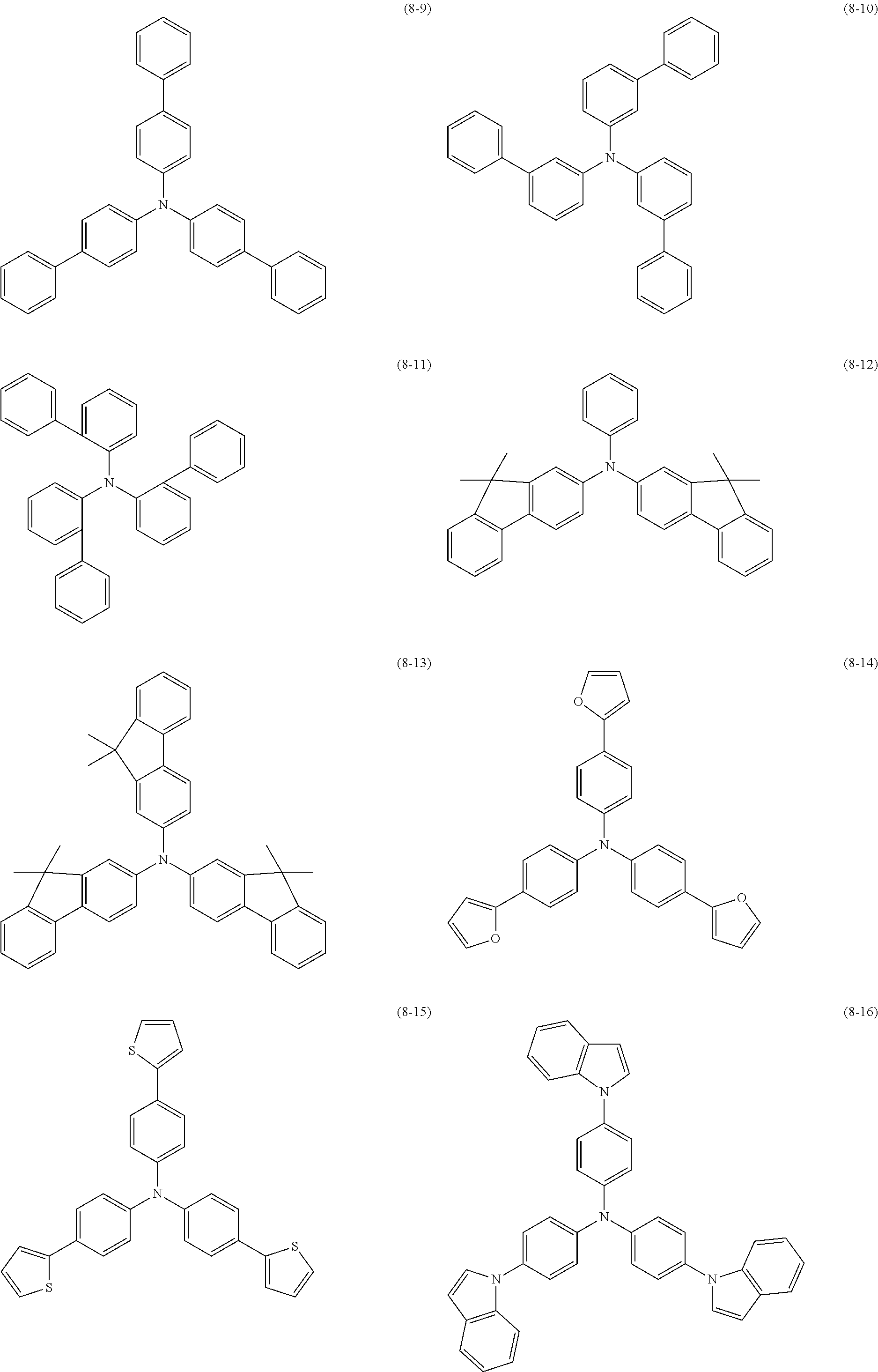

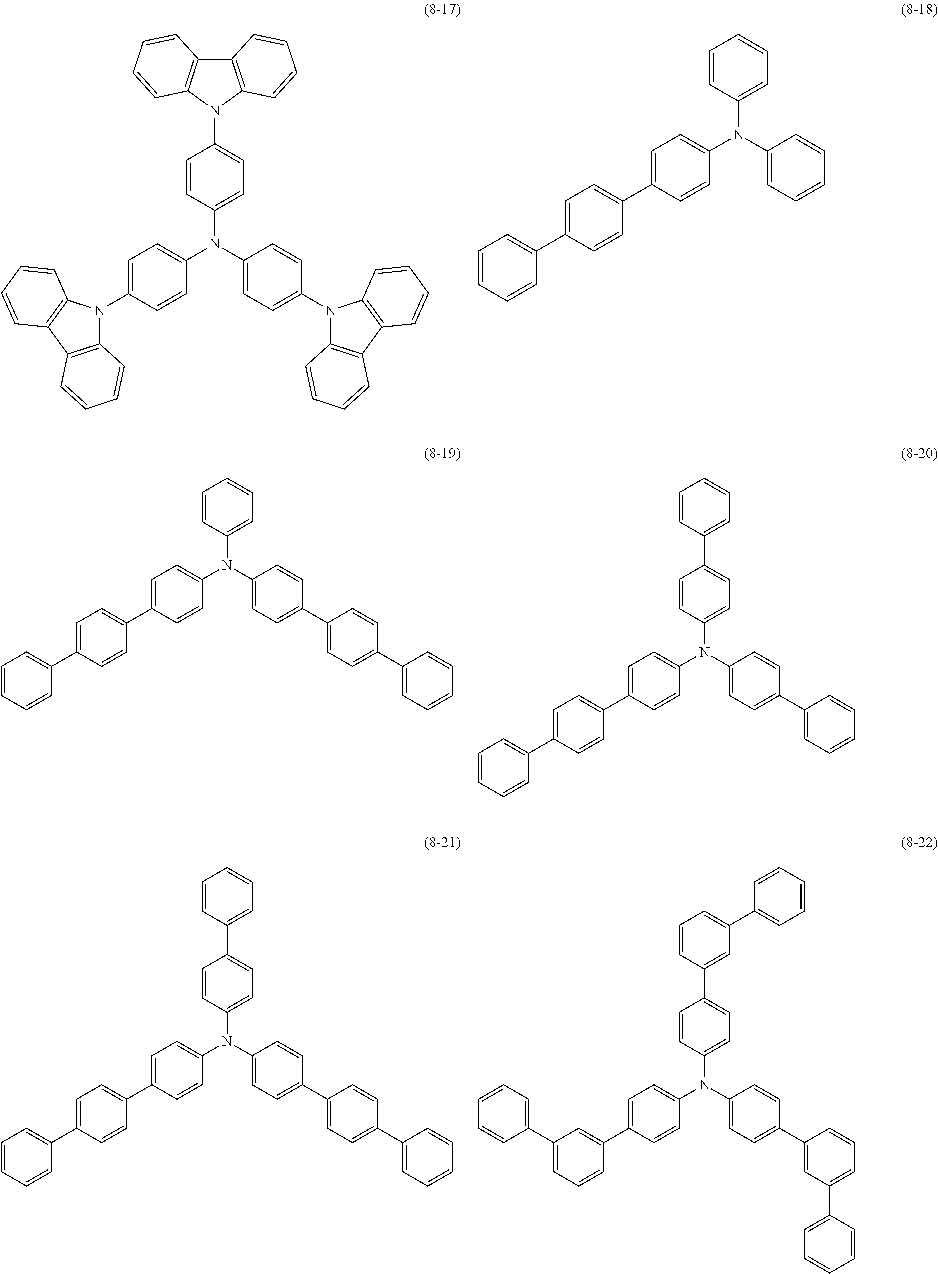

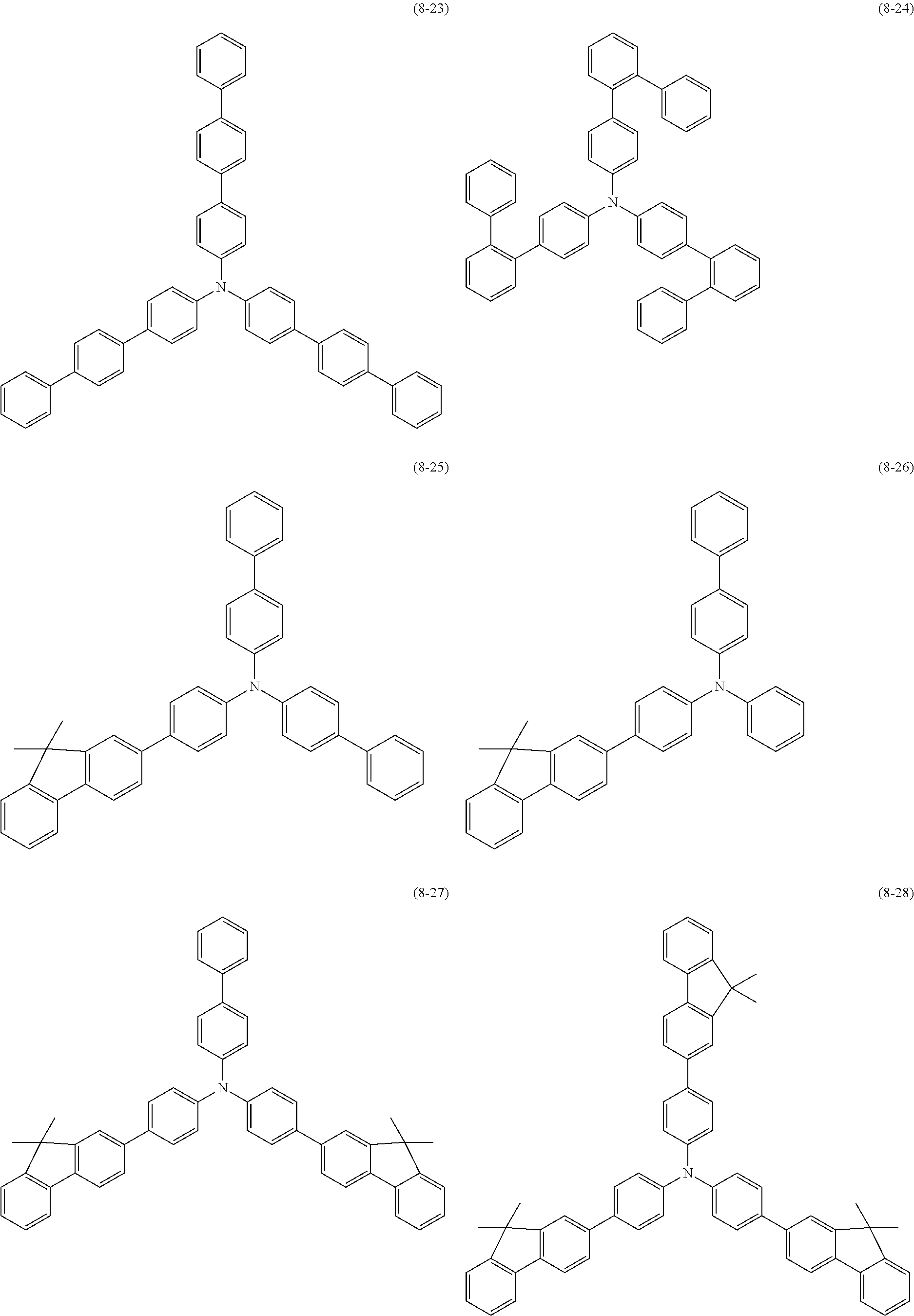

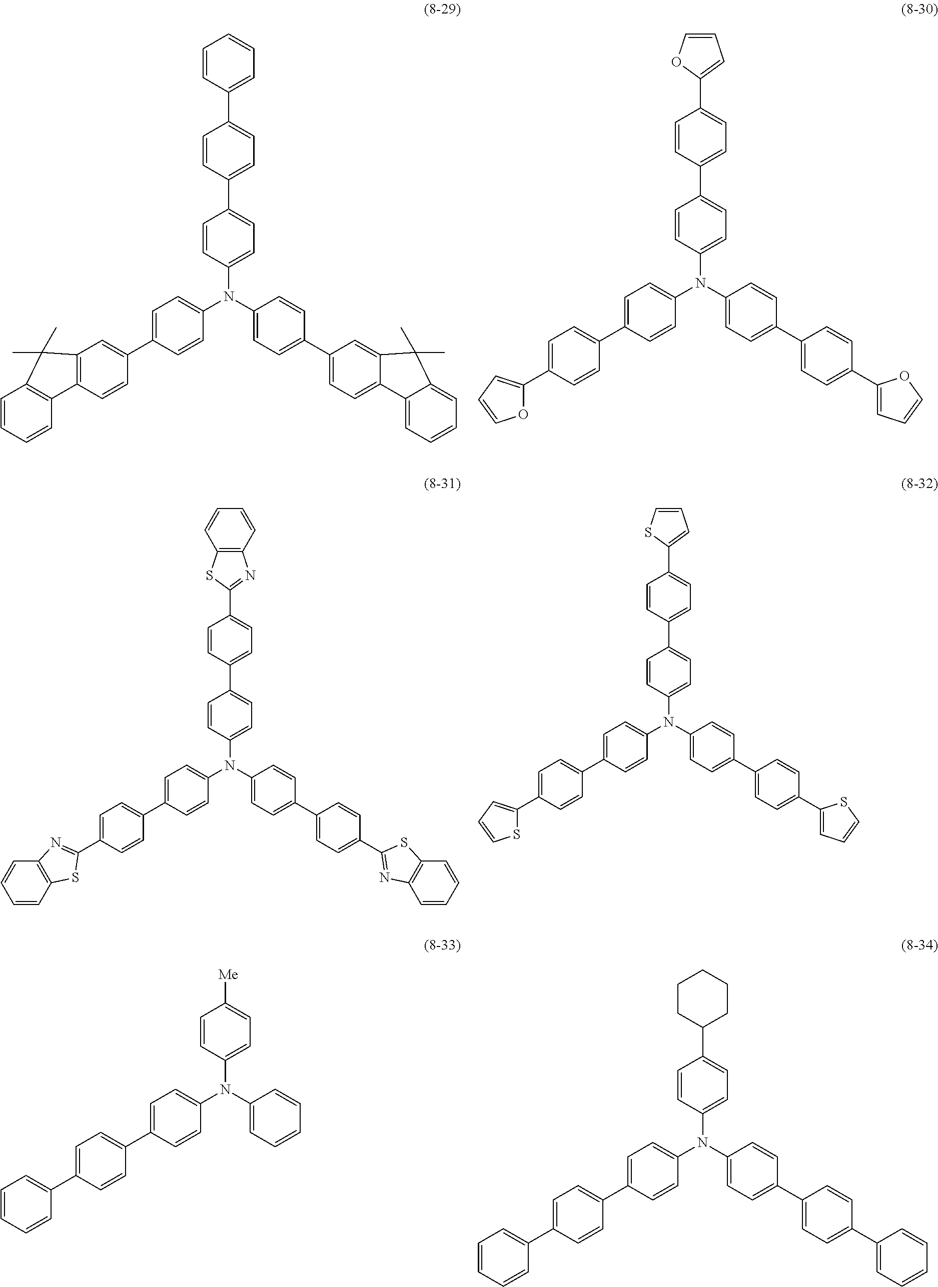

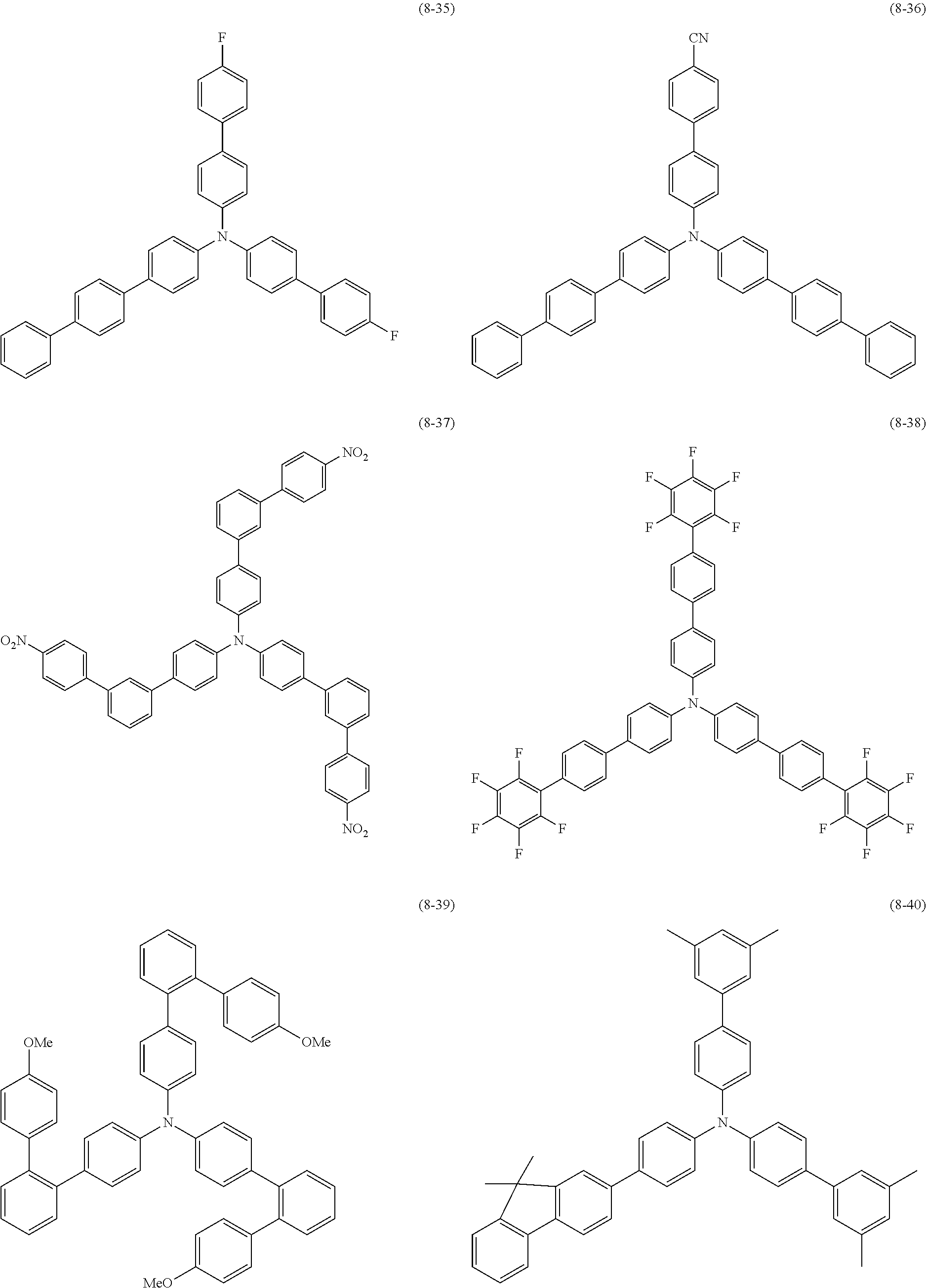

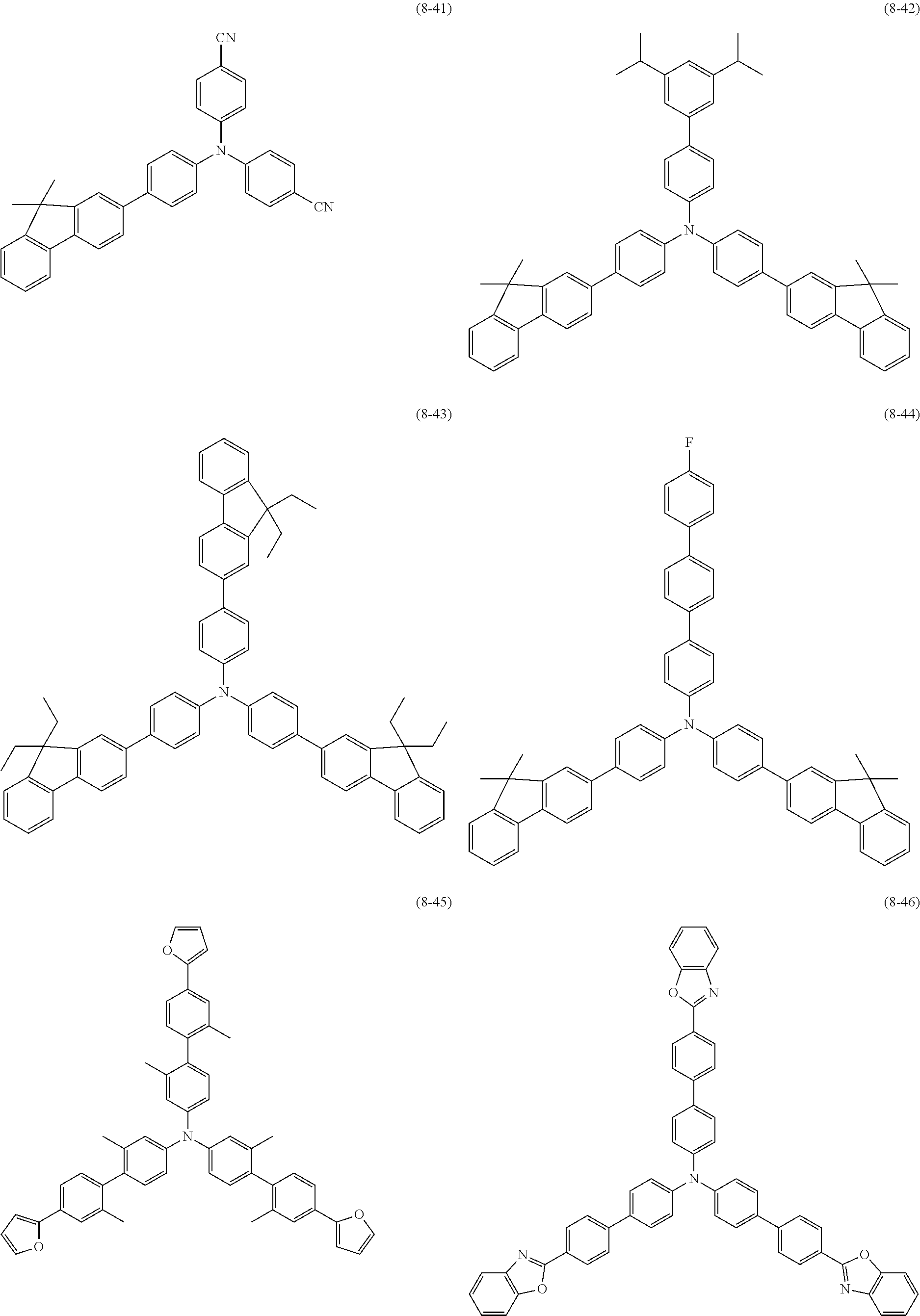

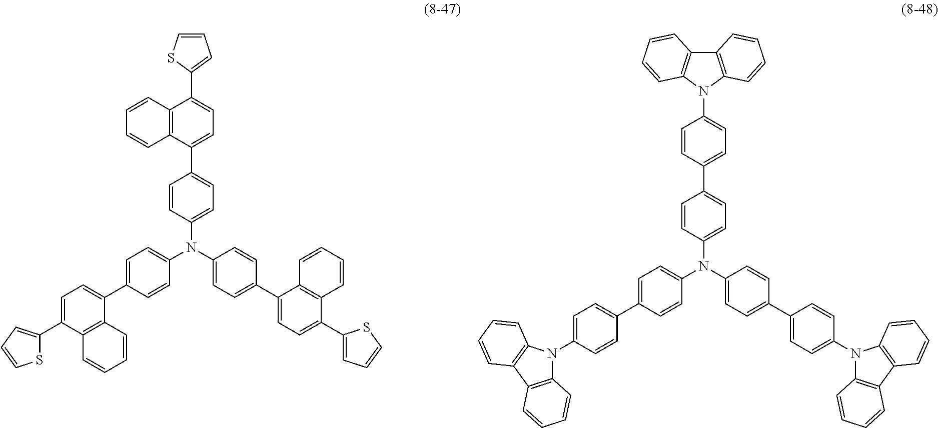

It is preferable to use, among the compounds shown in formula (8), amine compounds including an aryl group having the dibenzofuran structure and an aryl group having the carbazole structure. These amine compounds have high singlet excitation level and triplet excitation level and can effectively block the electron of the blue light emitting layer 24D. Thus, the emission efficiency is enhanced and electron injection to the hole transport layer 24B is suppressed. Accordingly, the lifetime characteristics are enhanced. Furthermore, the triplet excitons of the yellow light emitting layer 24C can be confined based on the high triplet exciton level to enhance the emission efficiency.

Specific examples of the amine compound including an aryl group having the dibenzofuran structure and an aryl group having the carbazole structure include compounds of the following formulas (8-49) to (8-323).

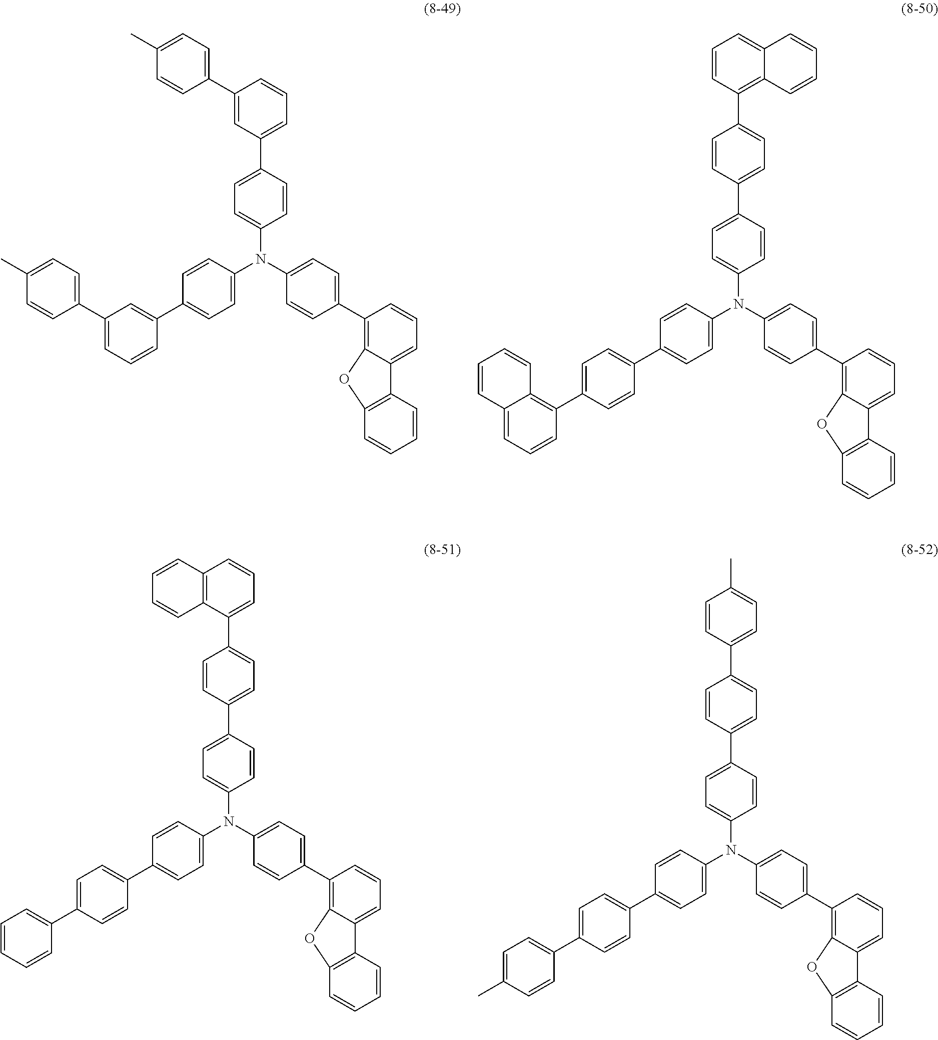

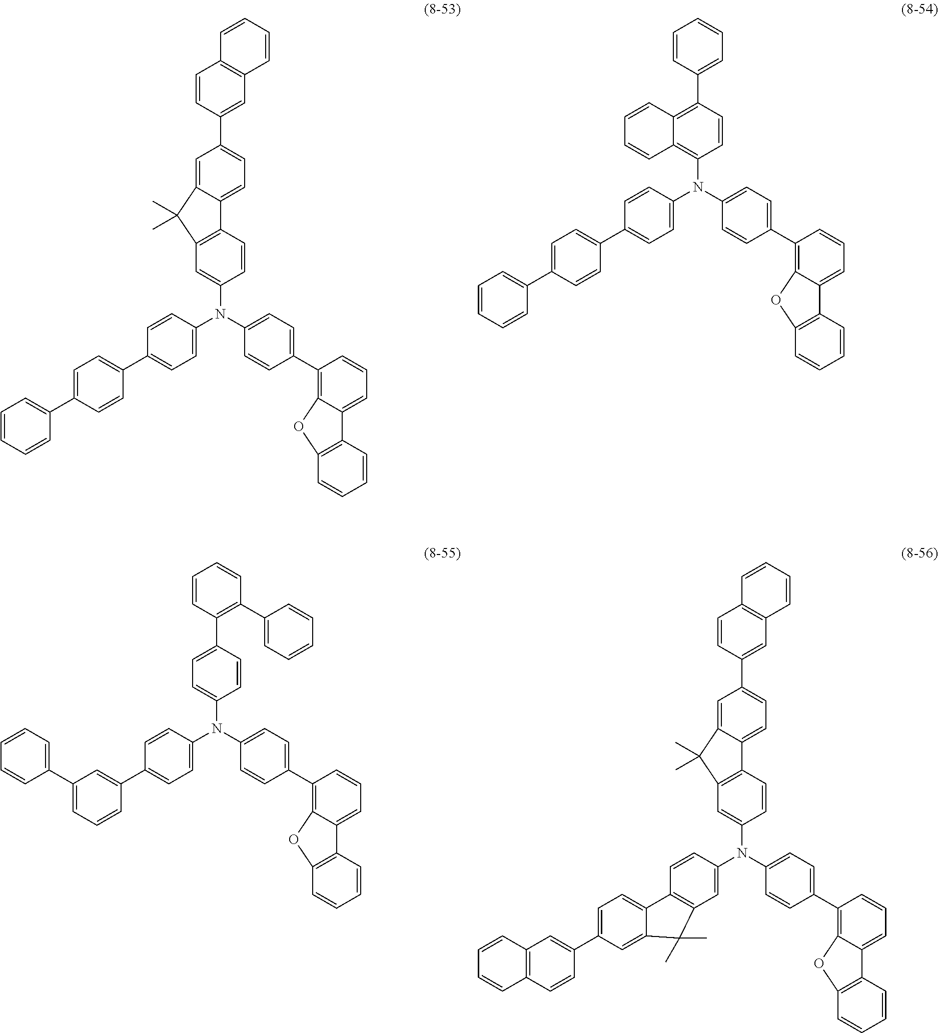

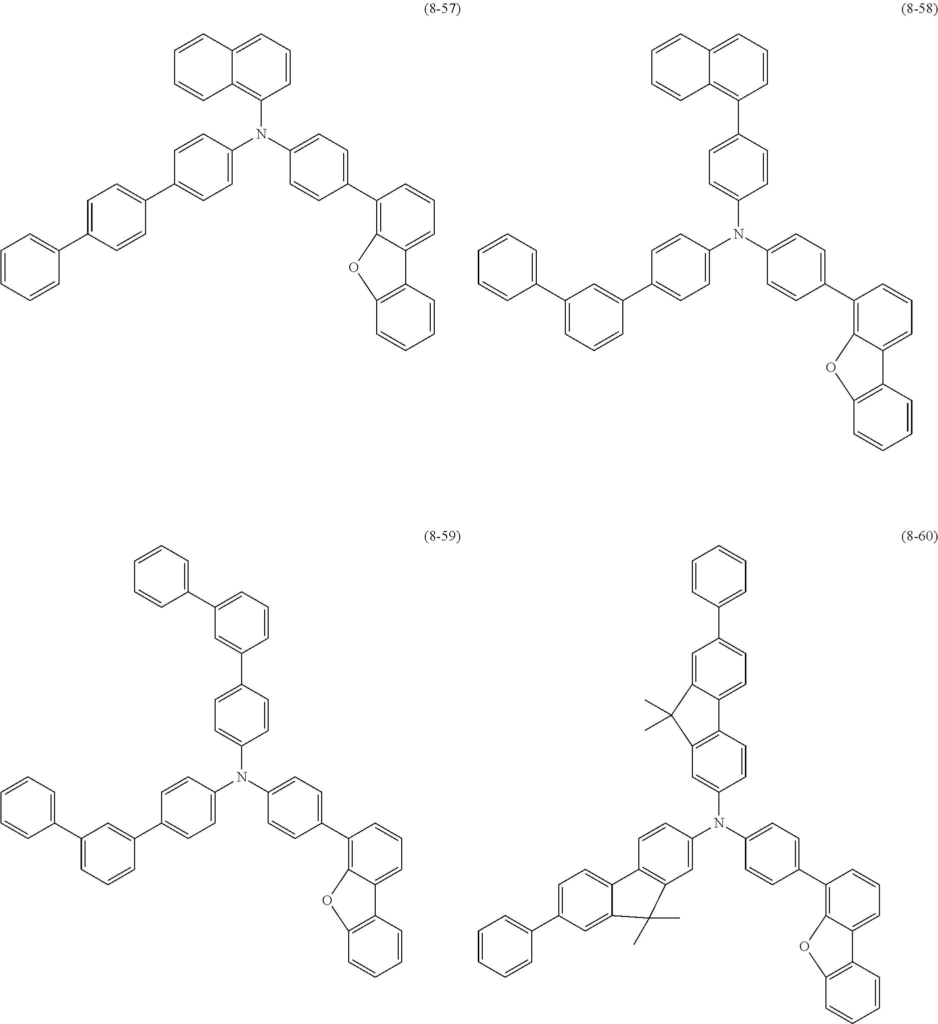

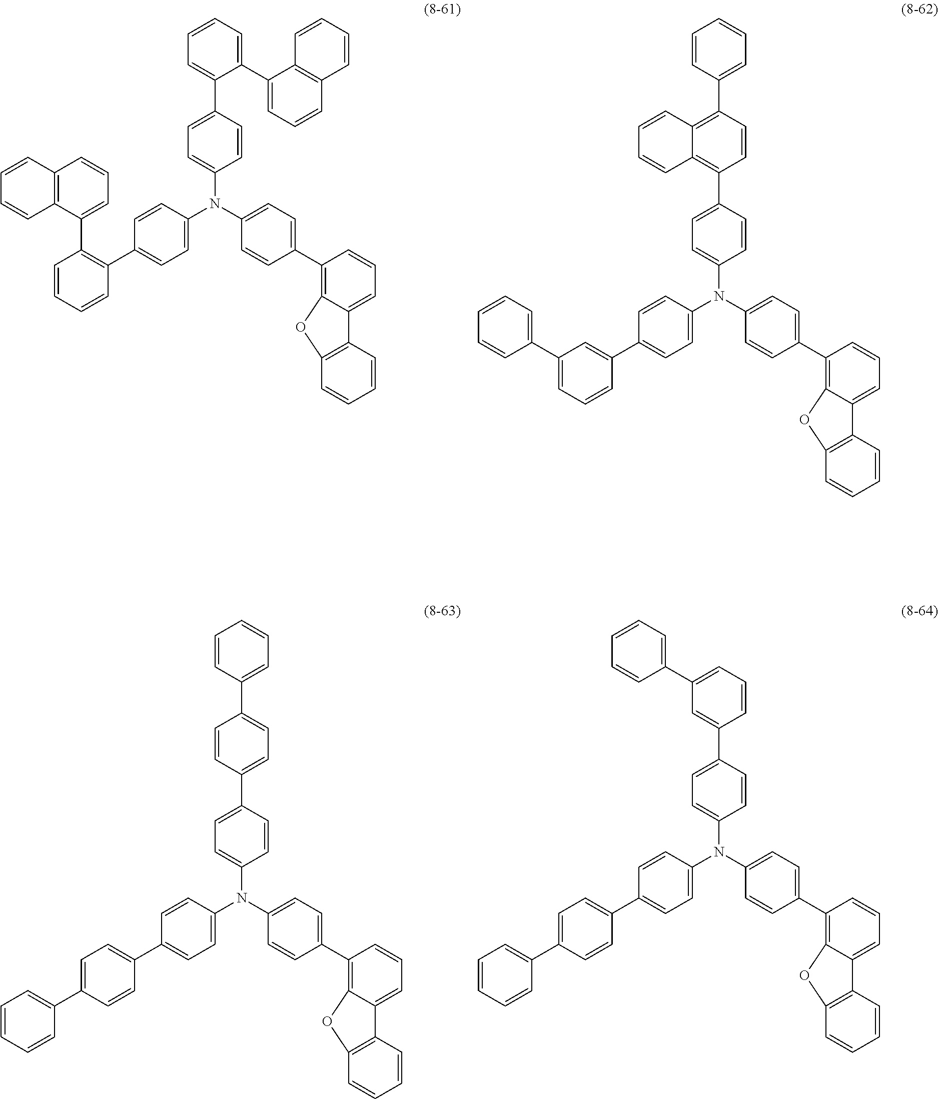

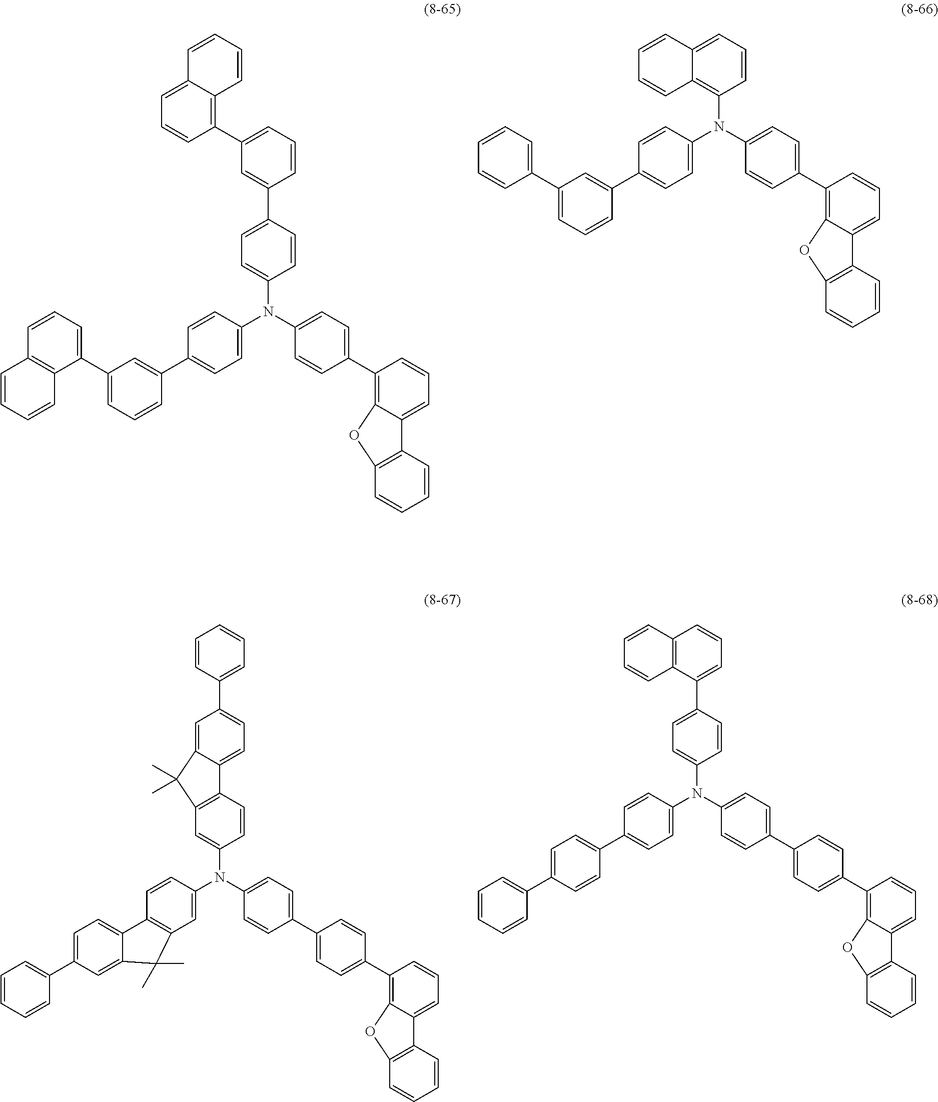

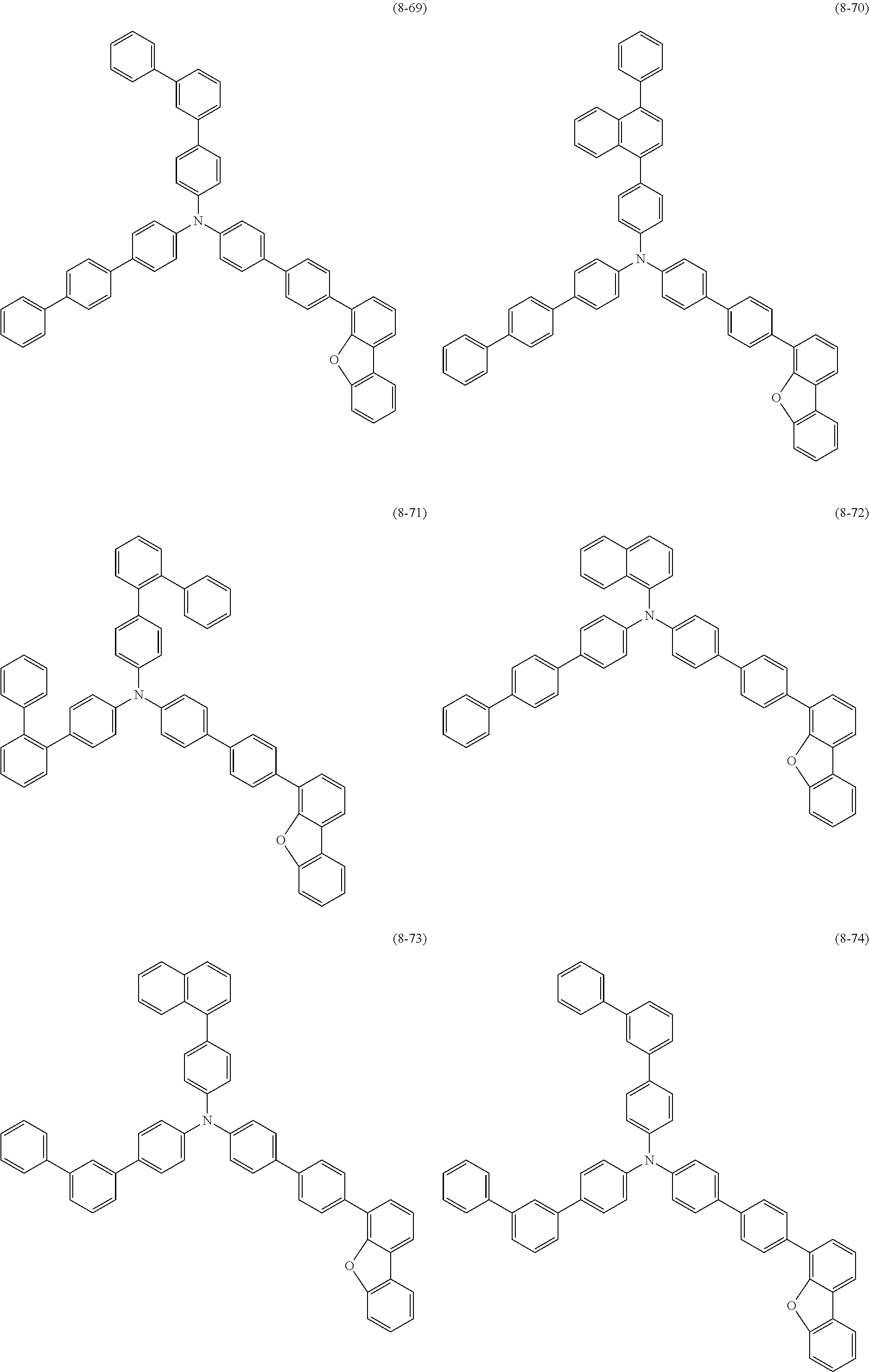

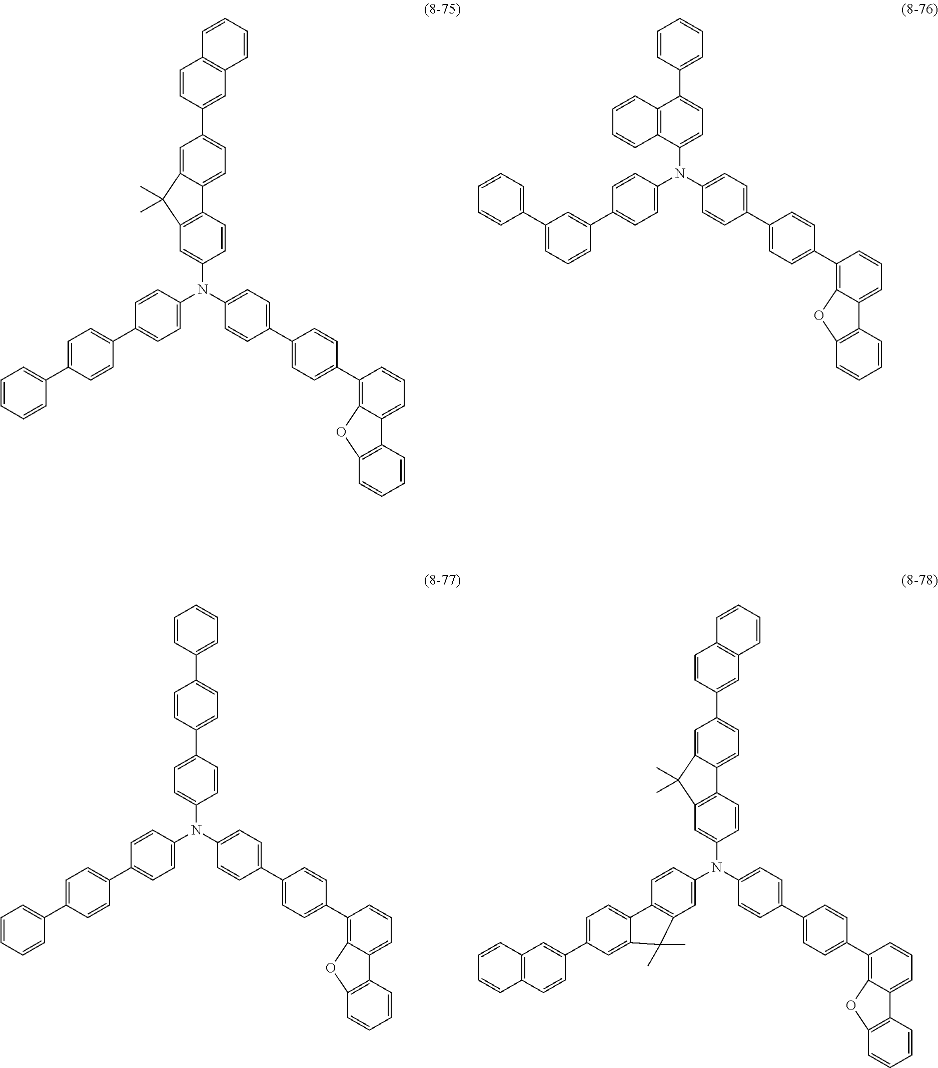

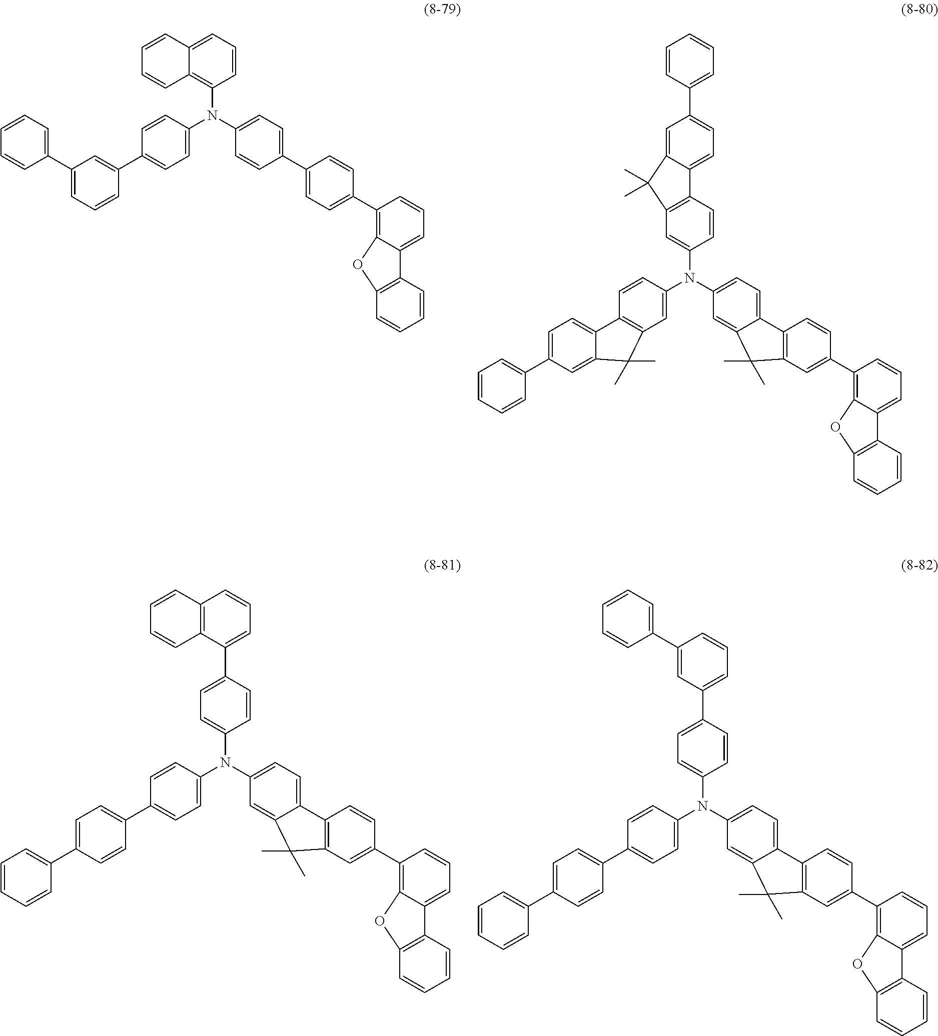

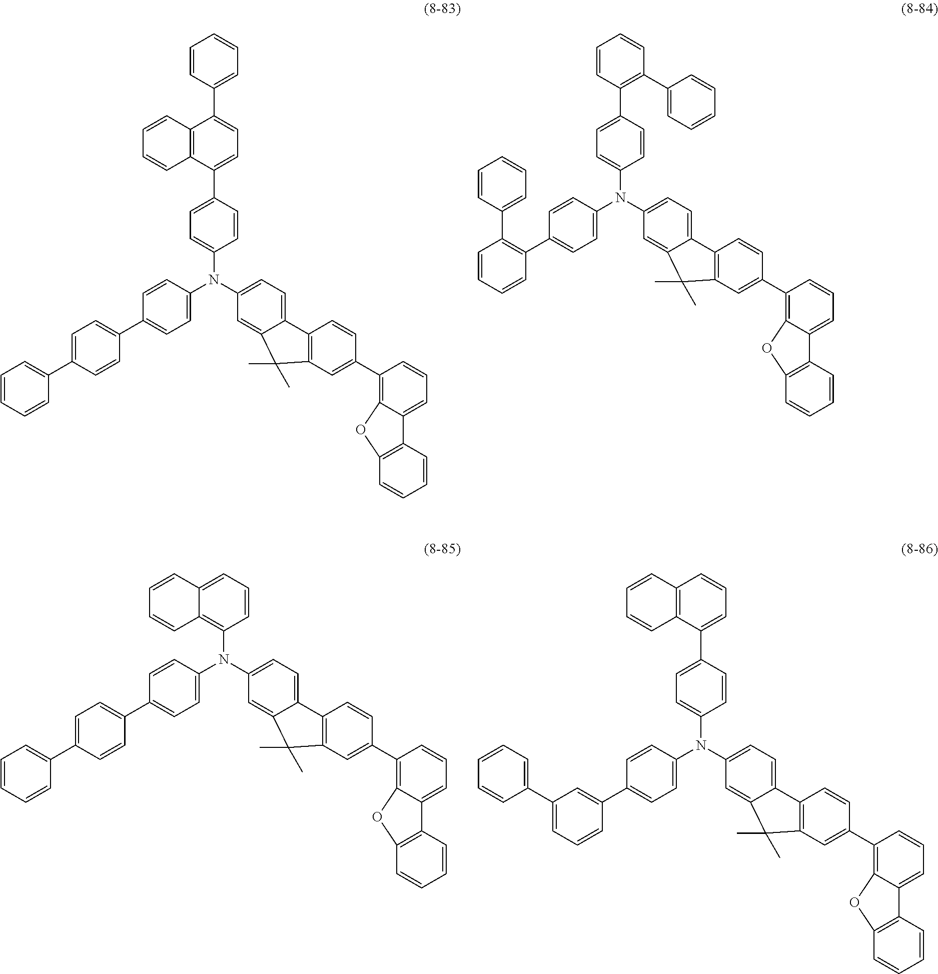

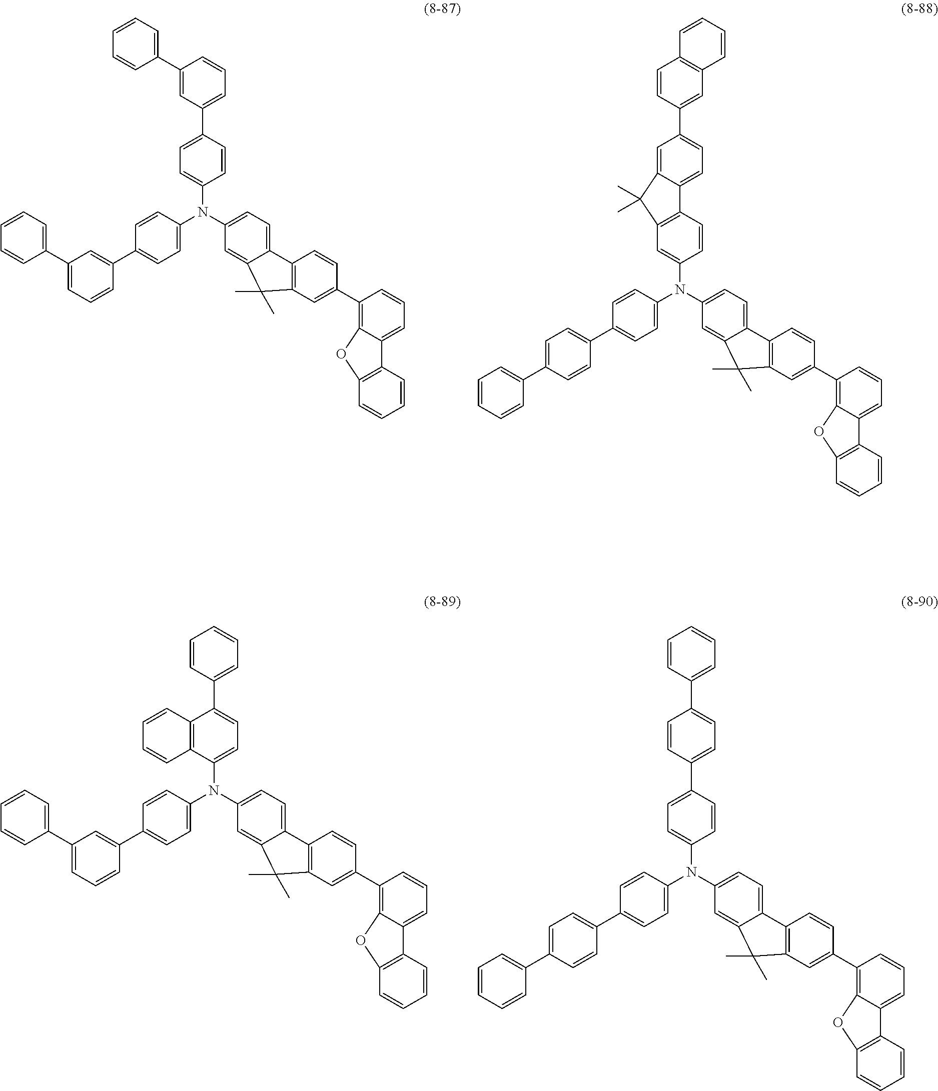

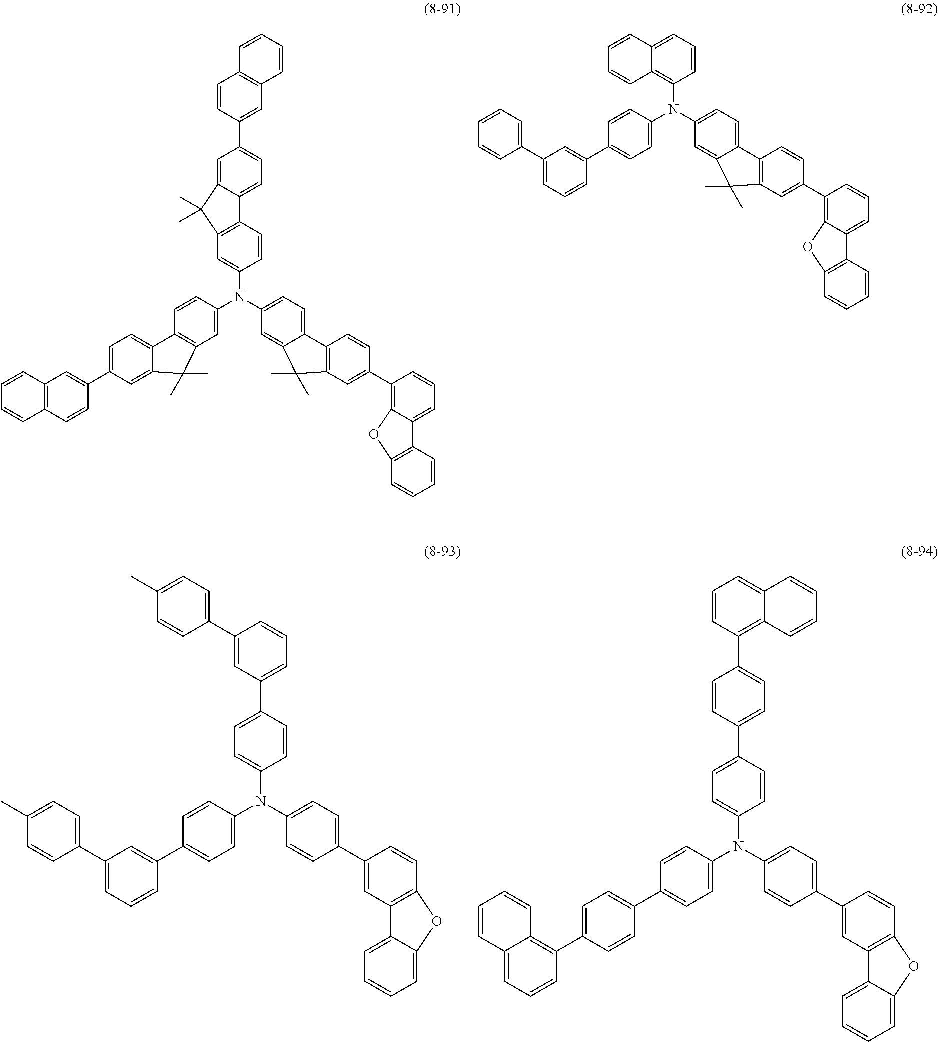

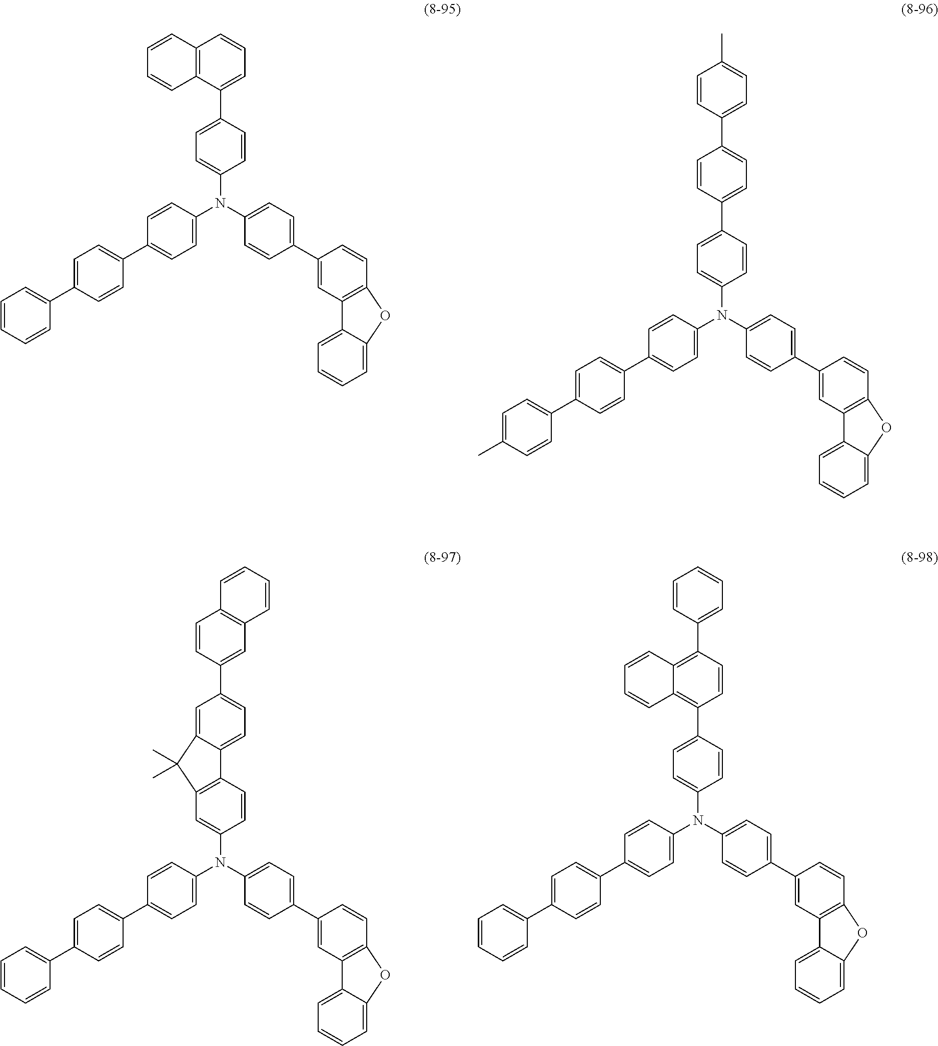

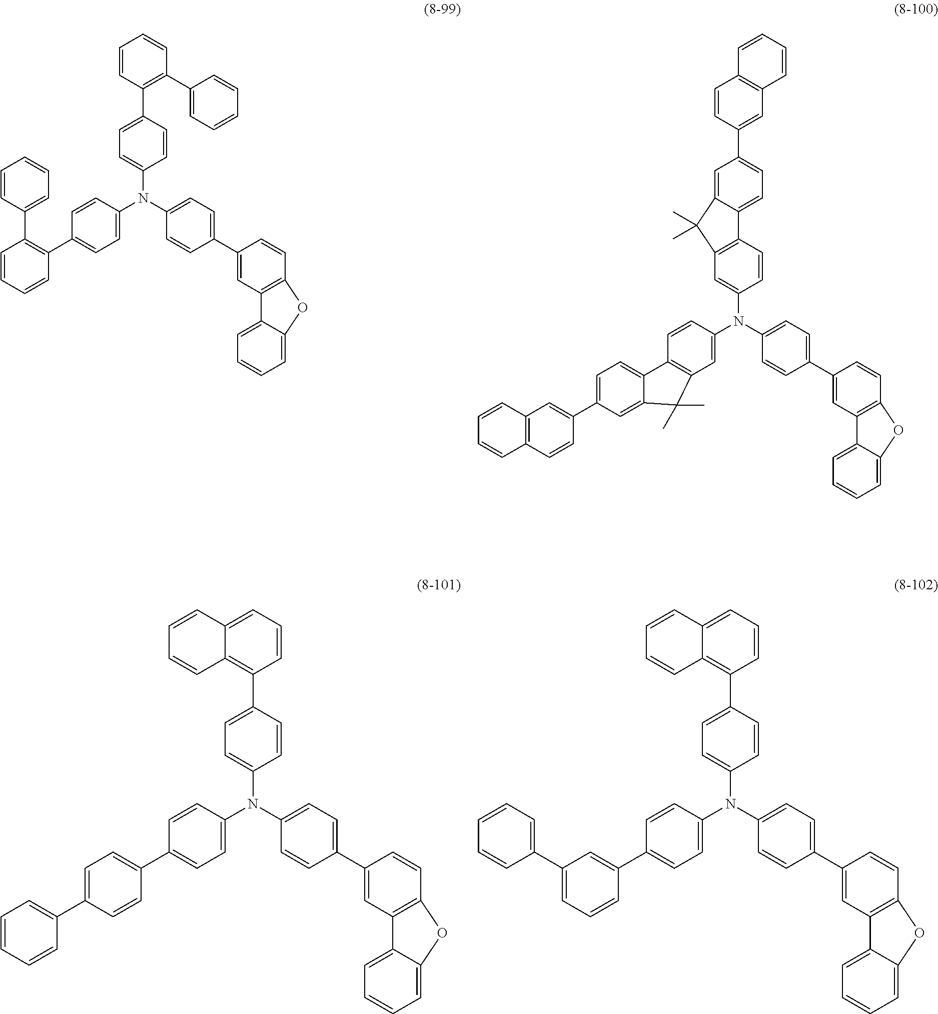

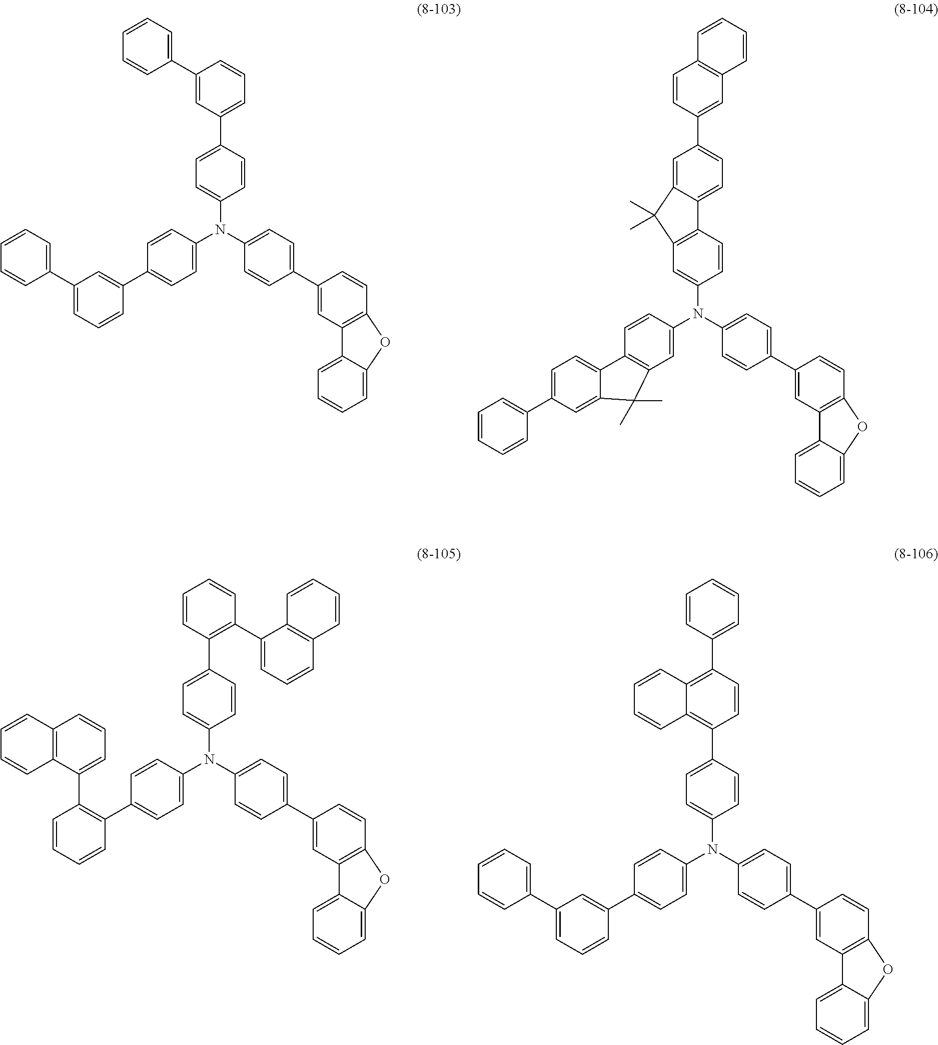

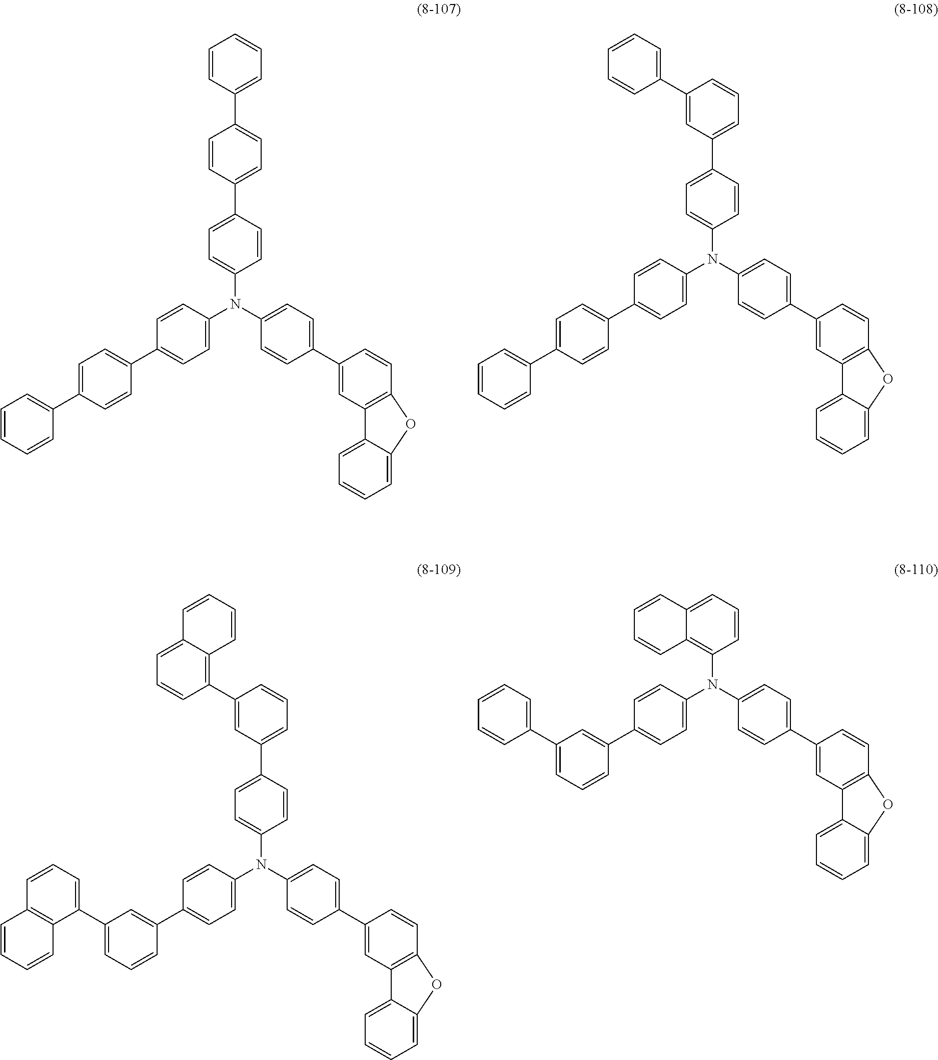

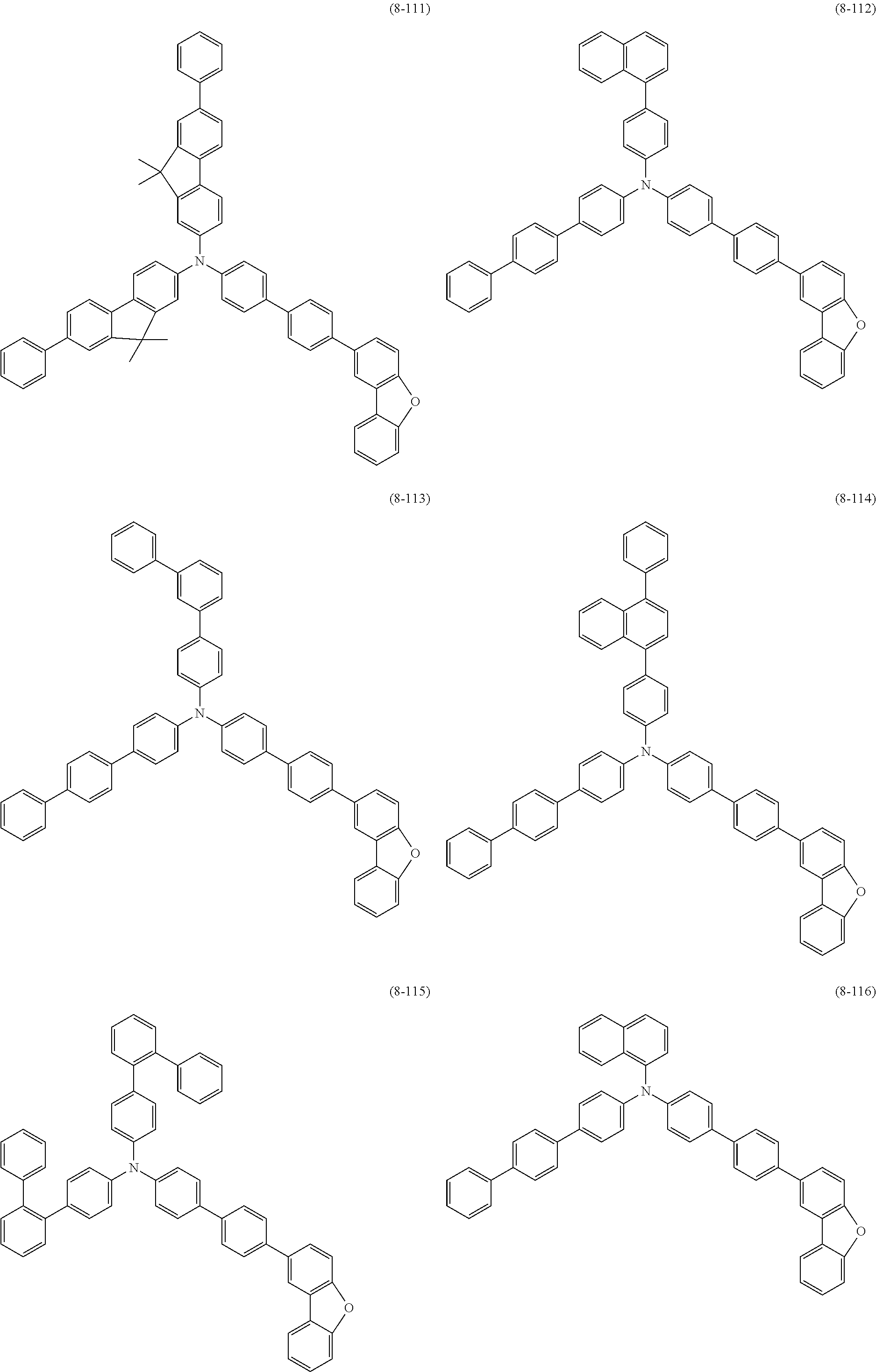

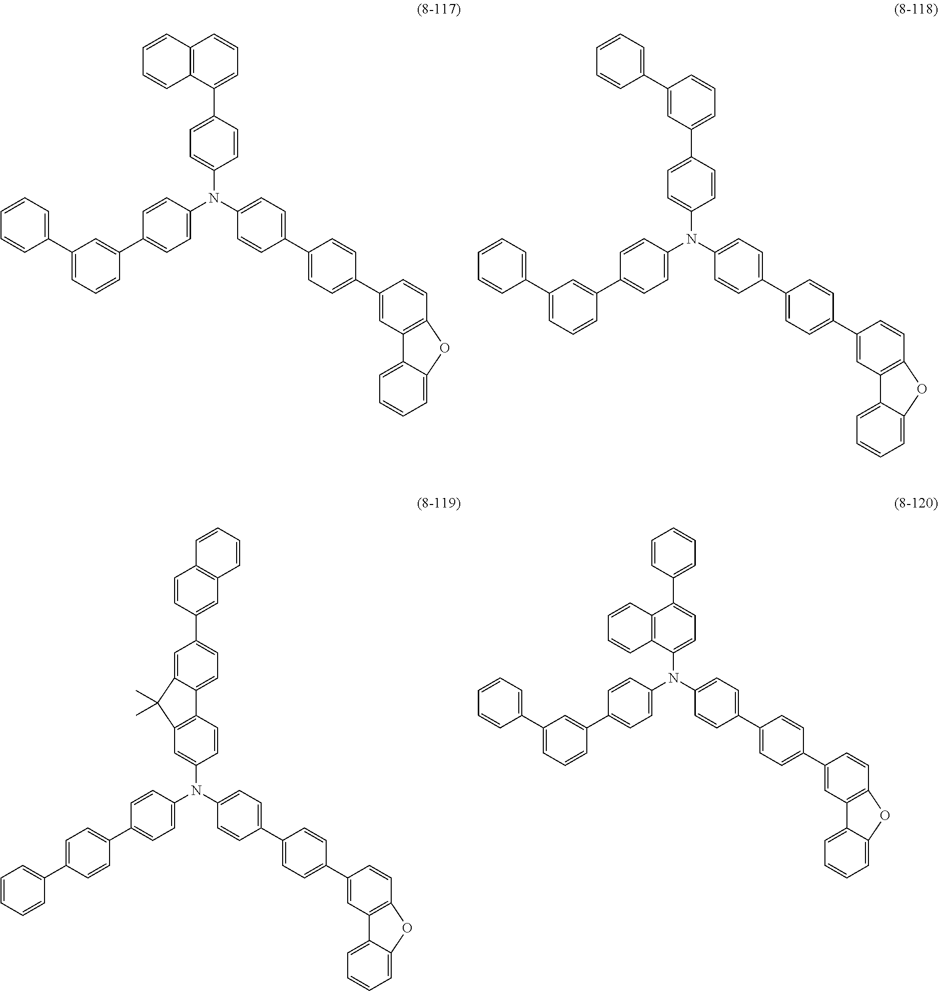

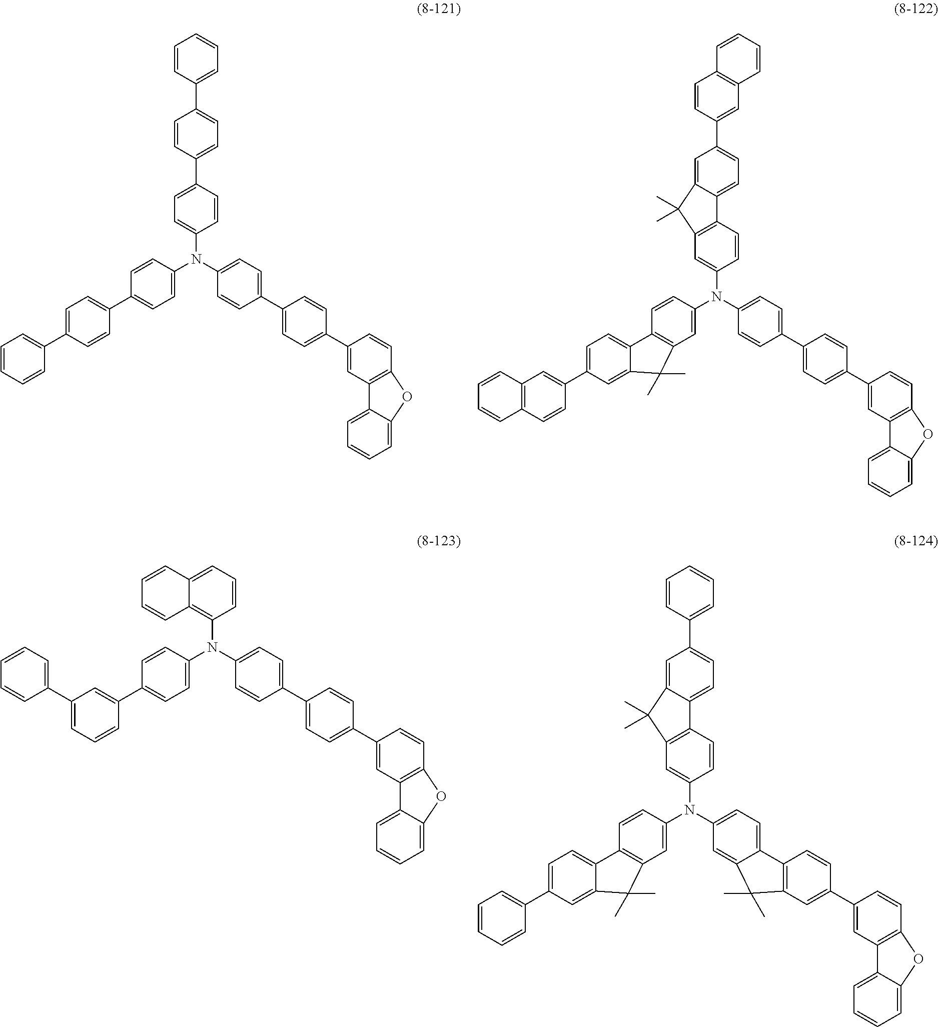

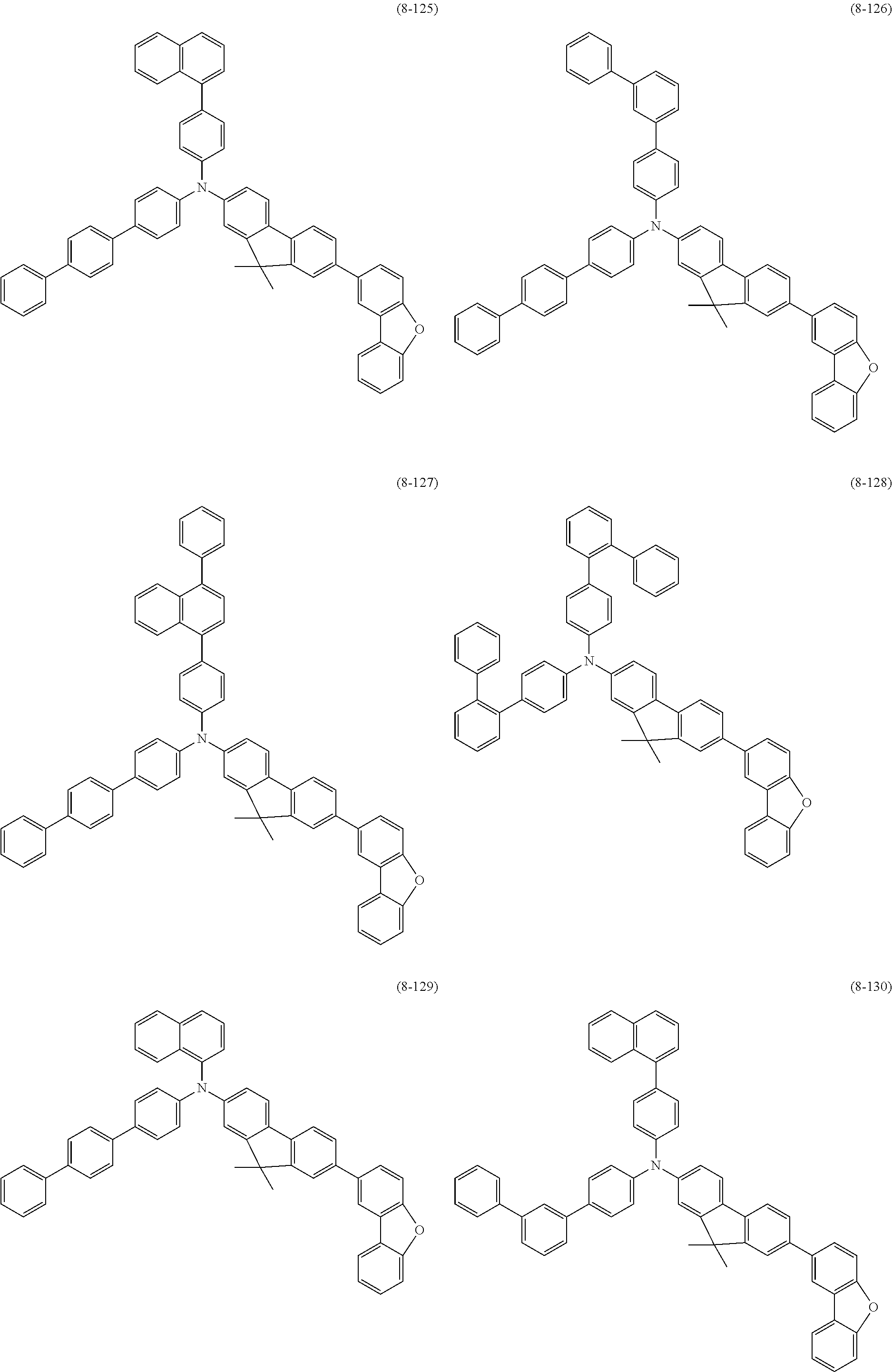

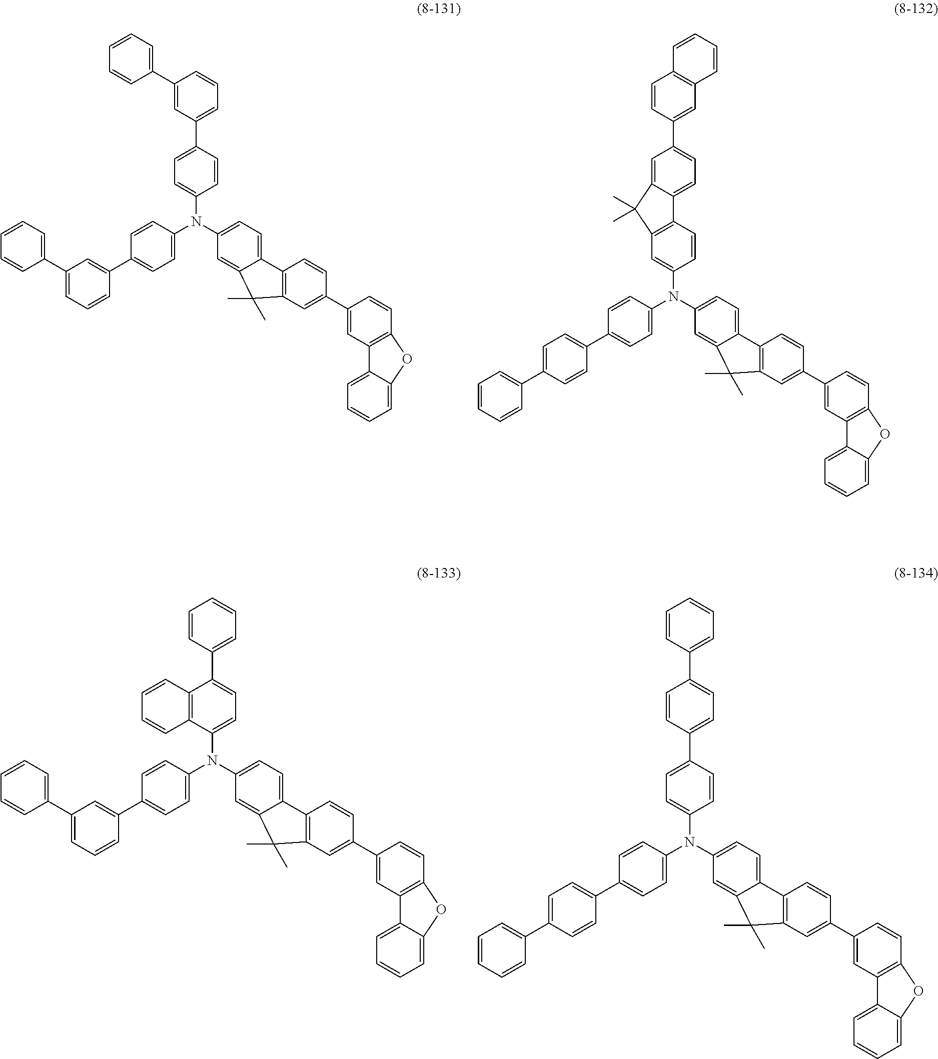

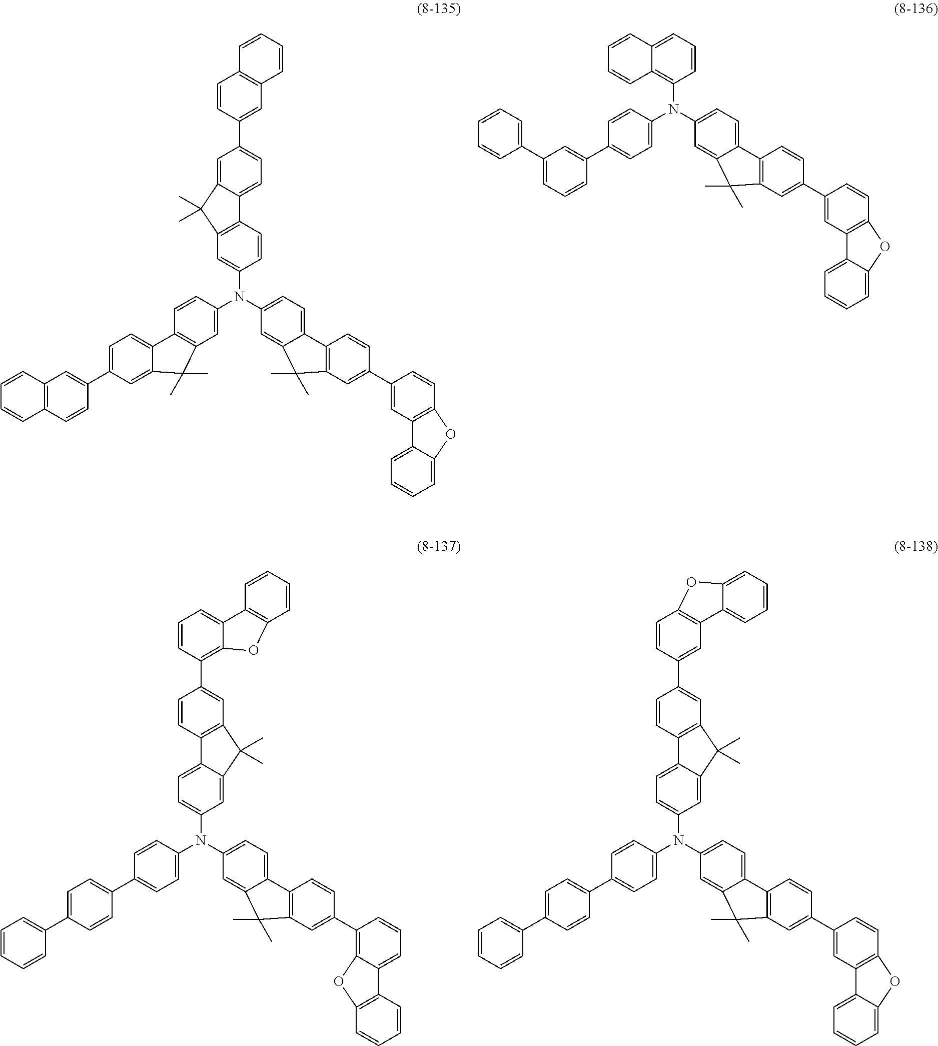

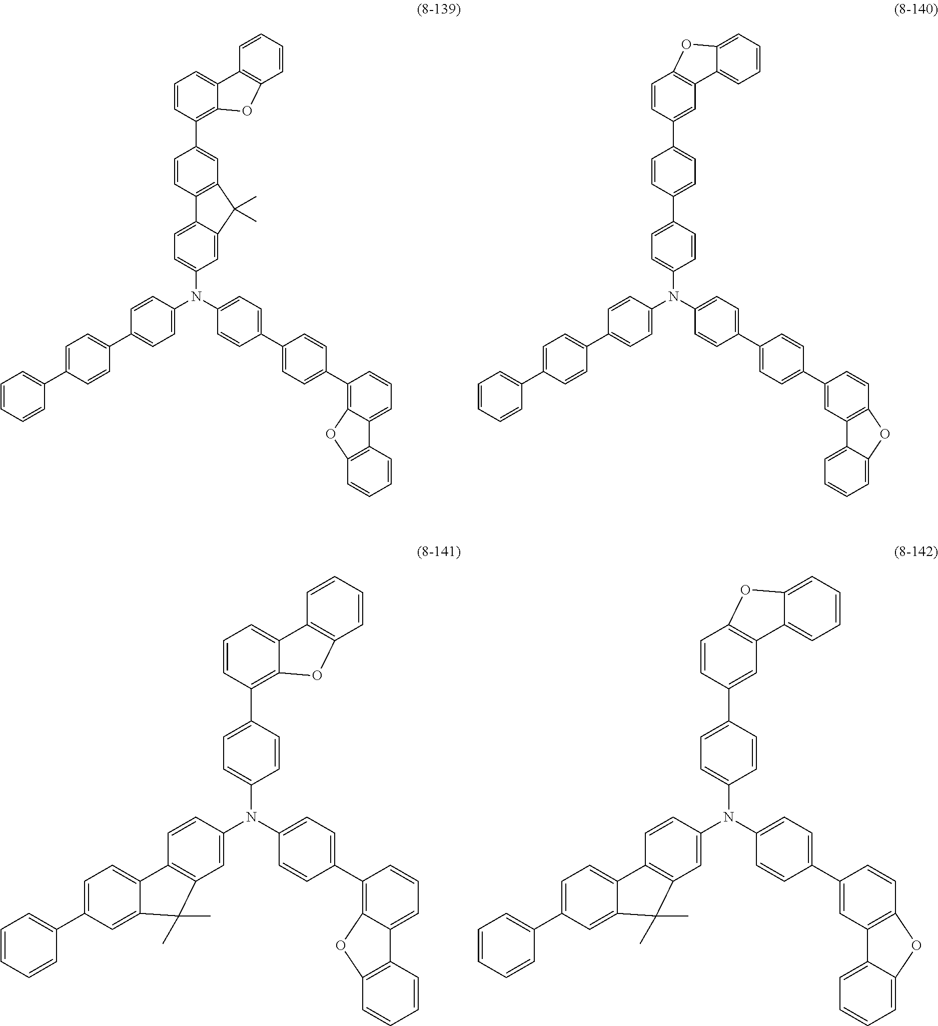

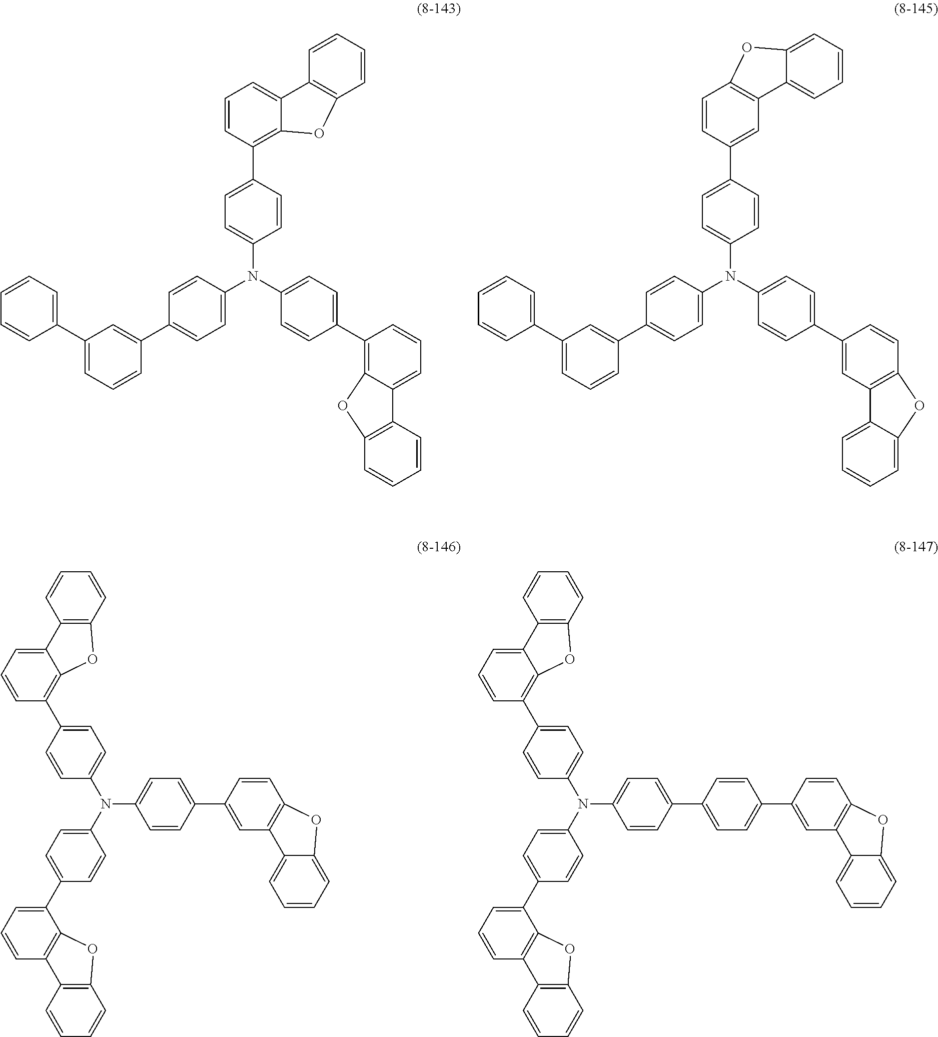

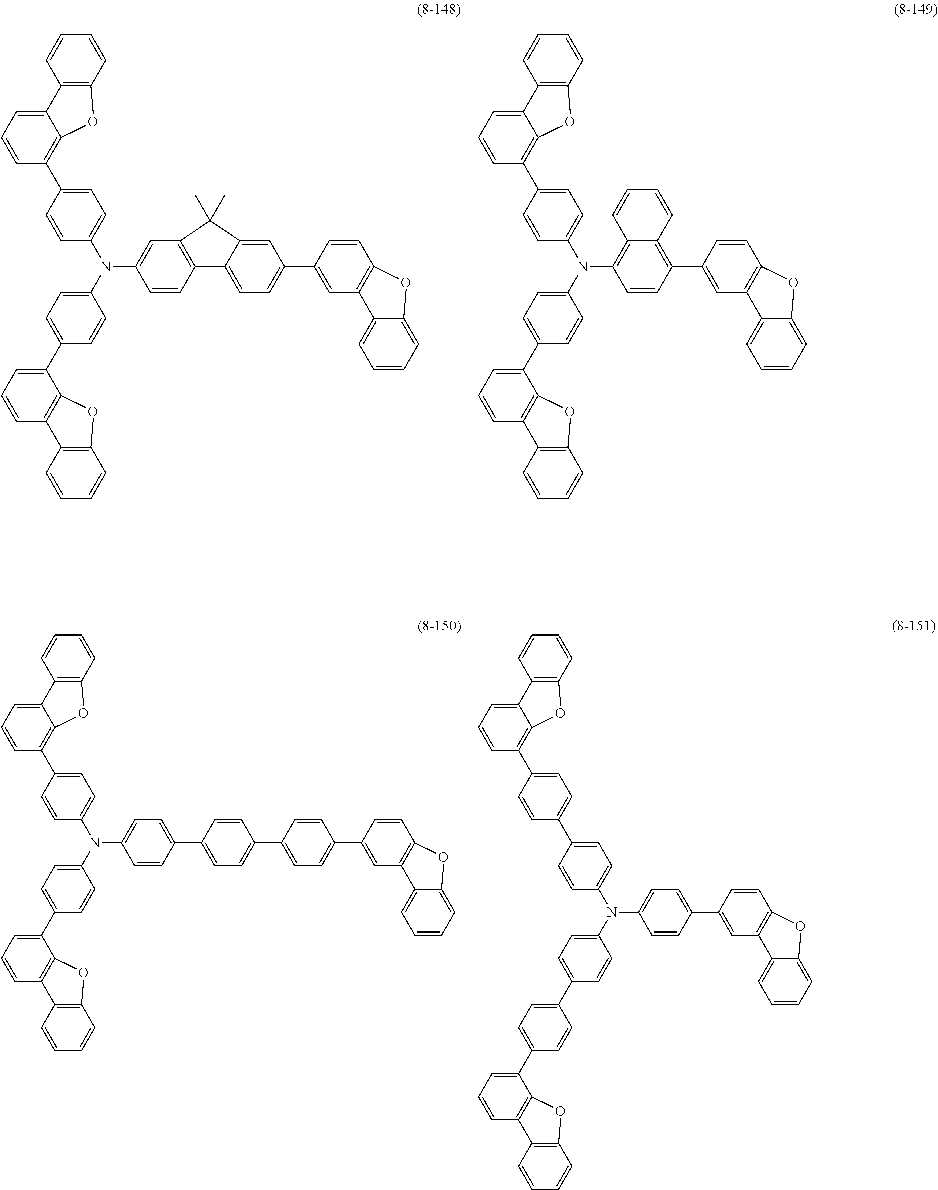

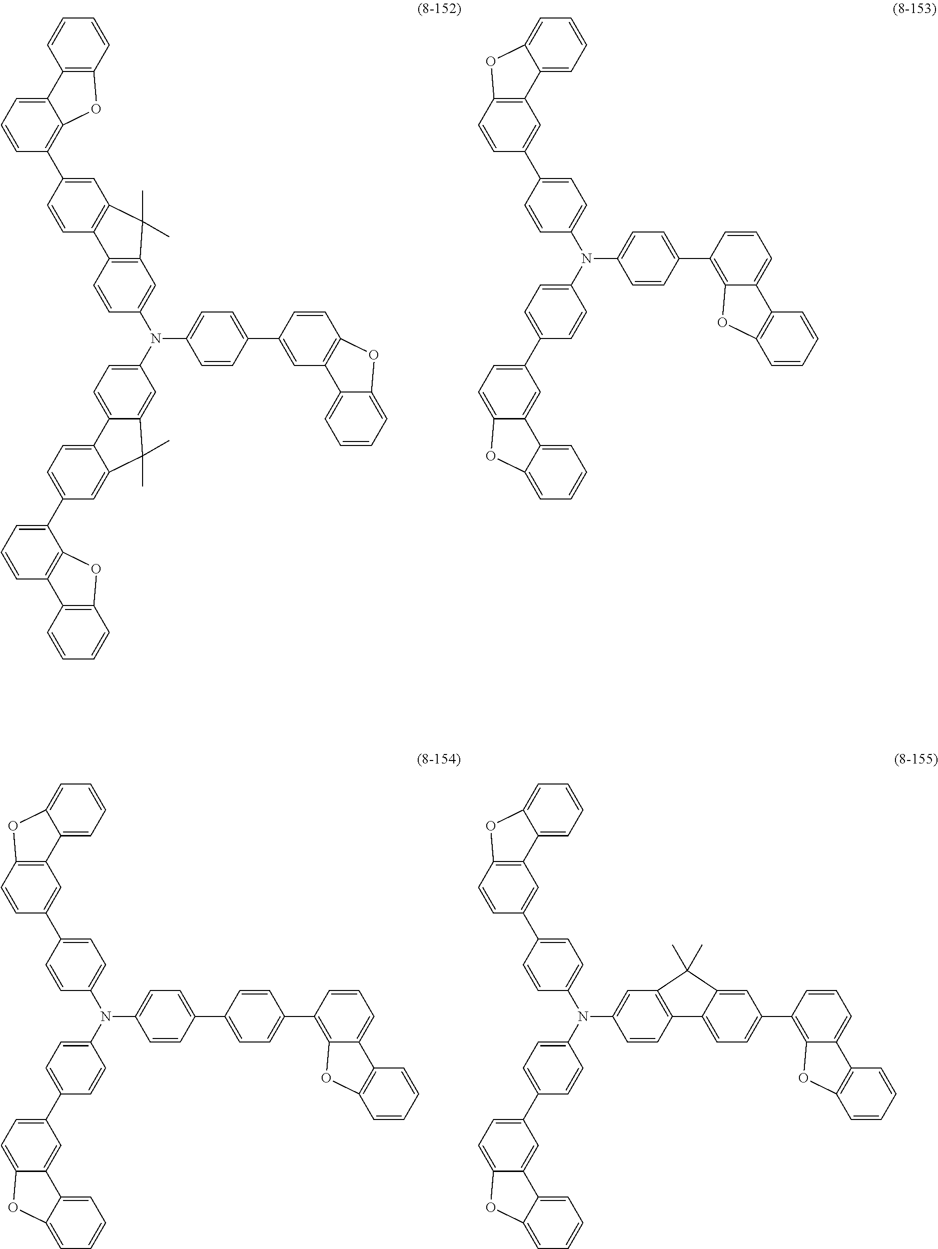

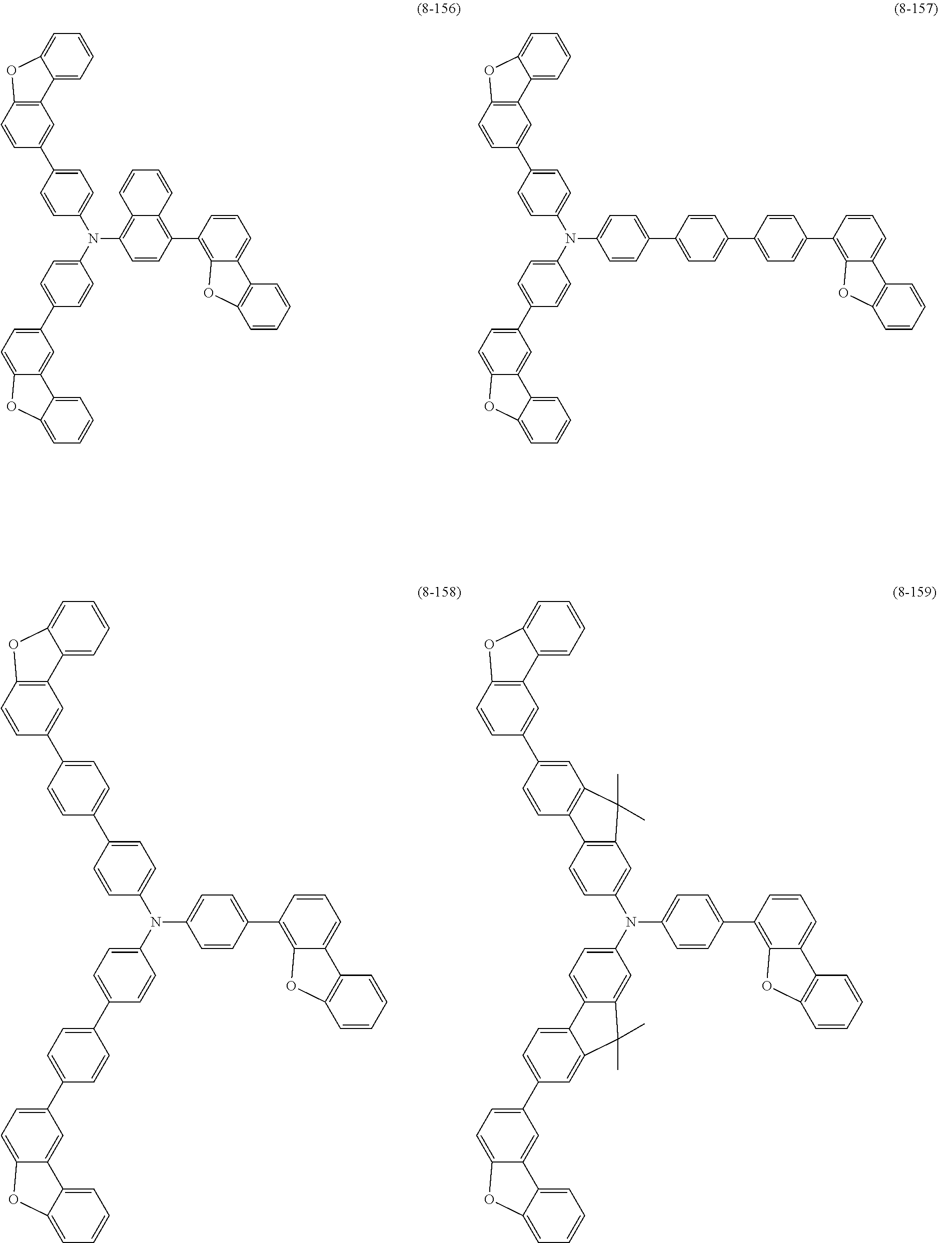

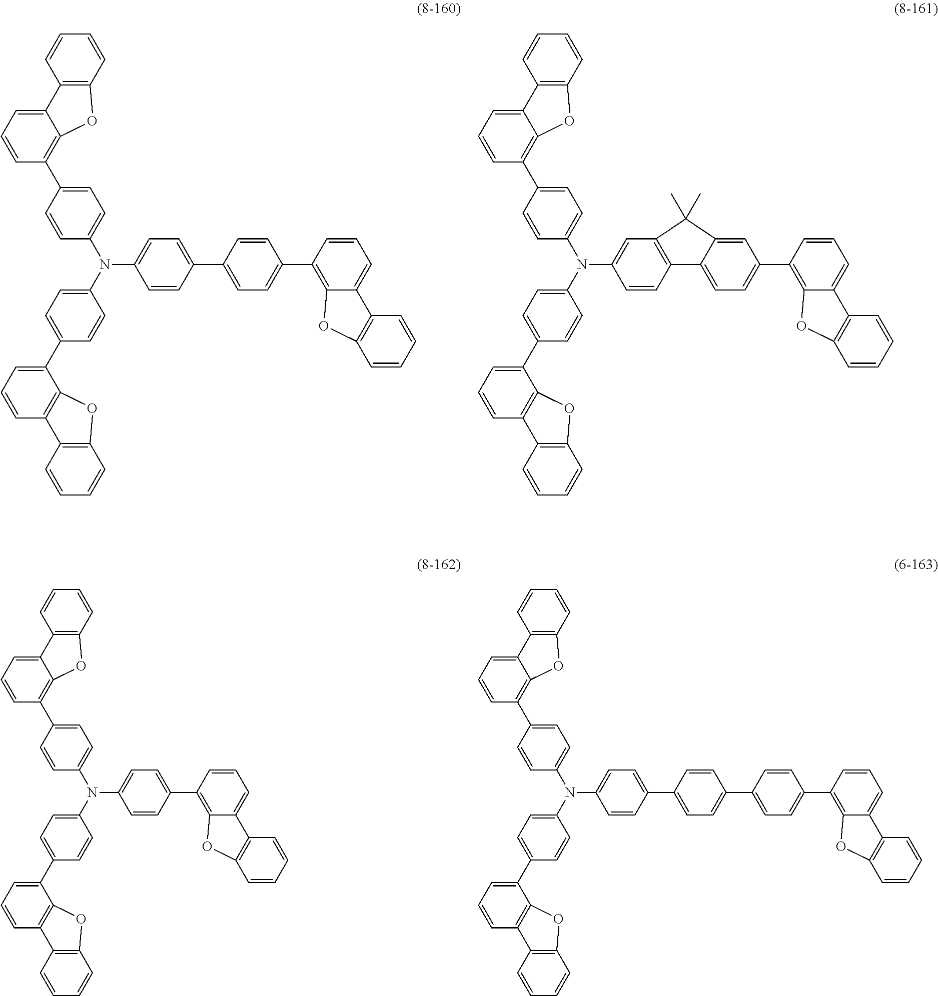

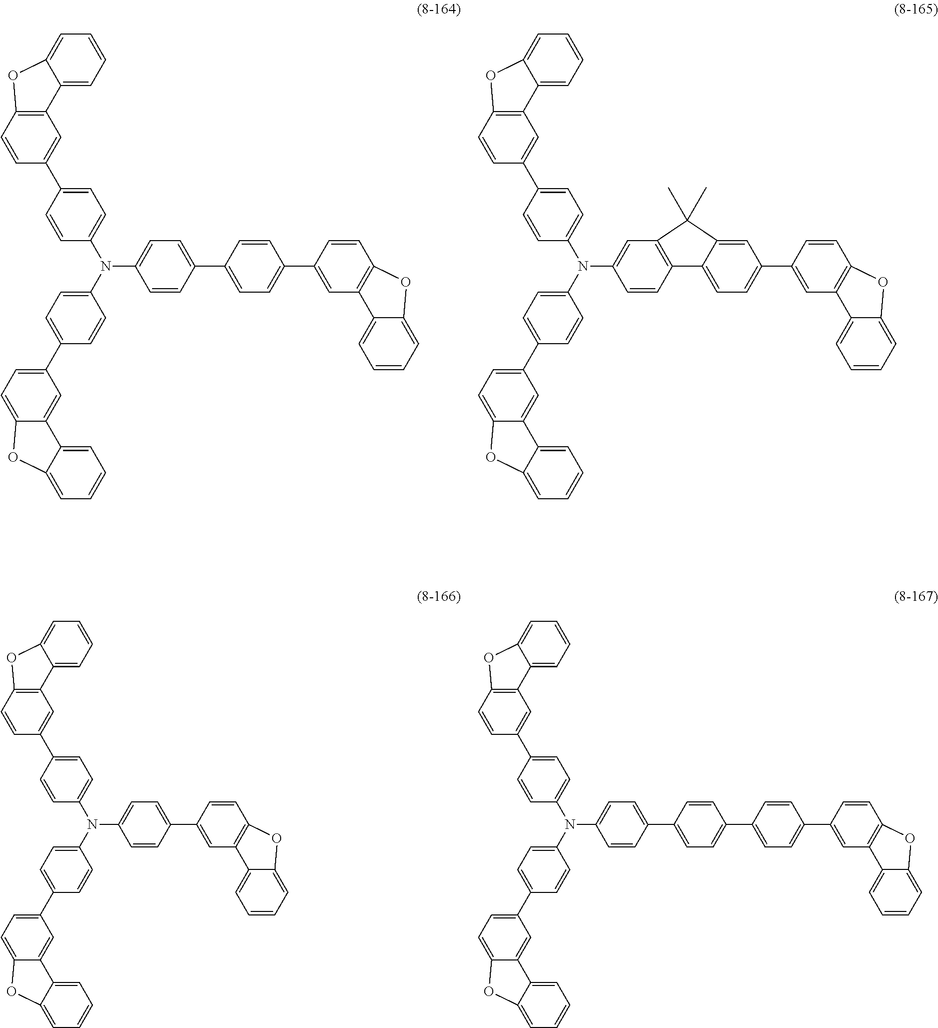

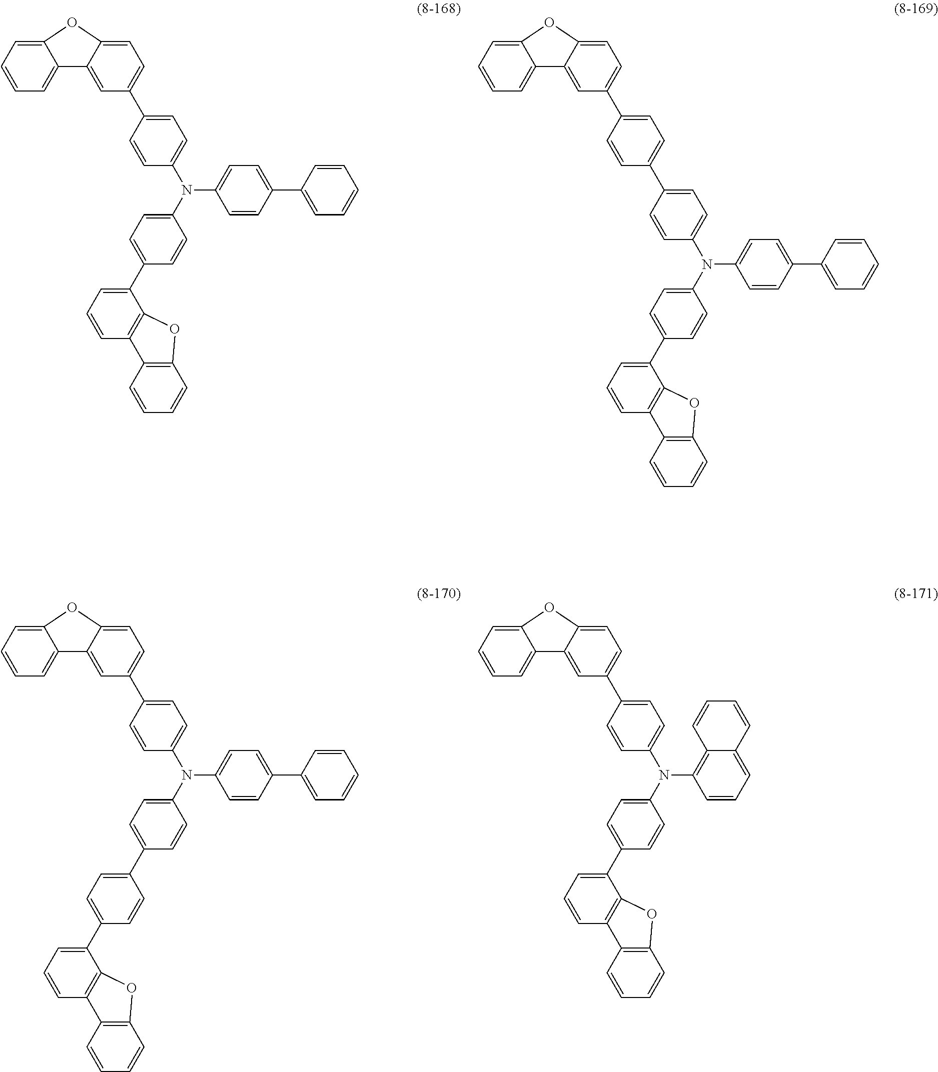

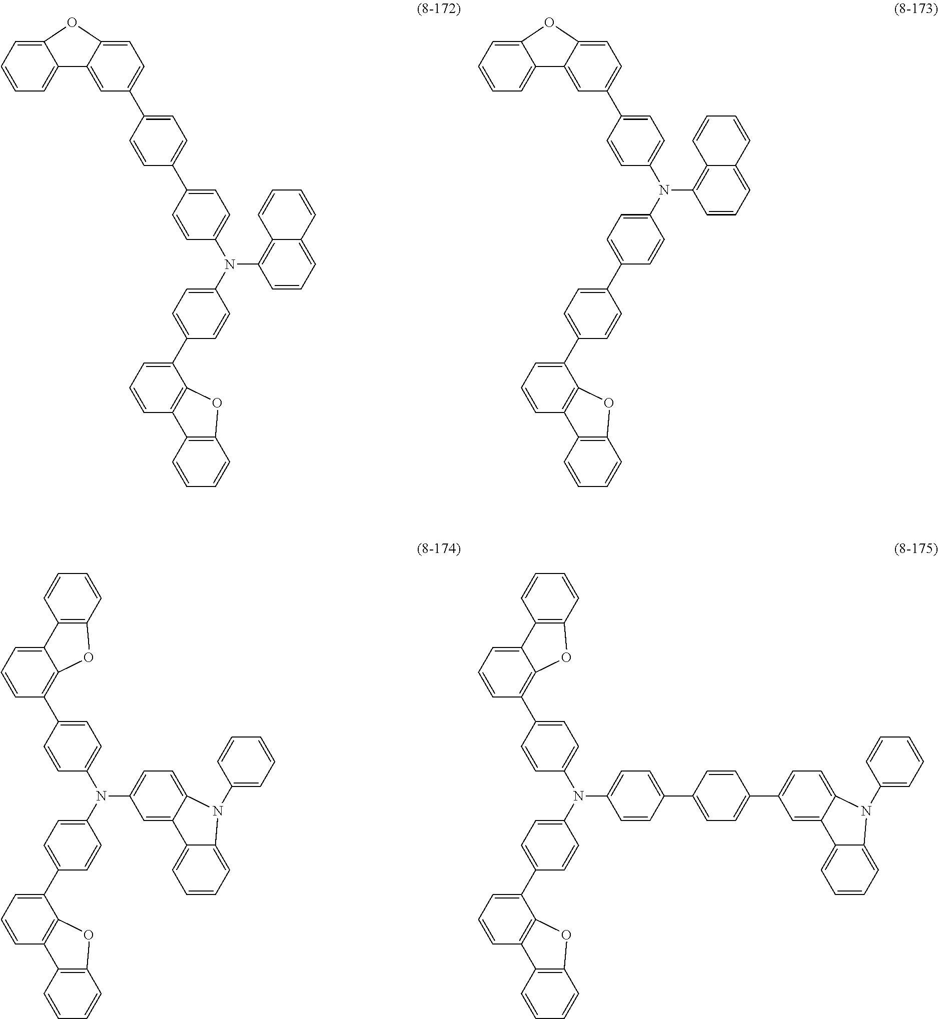

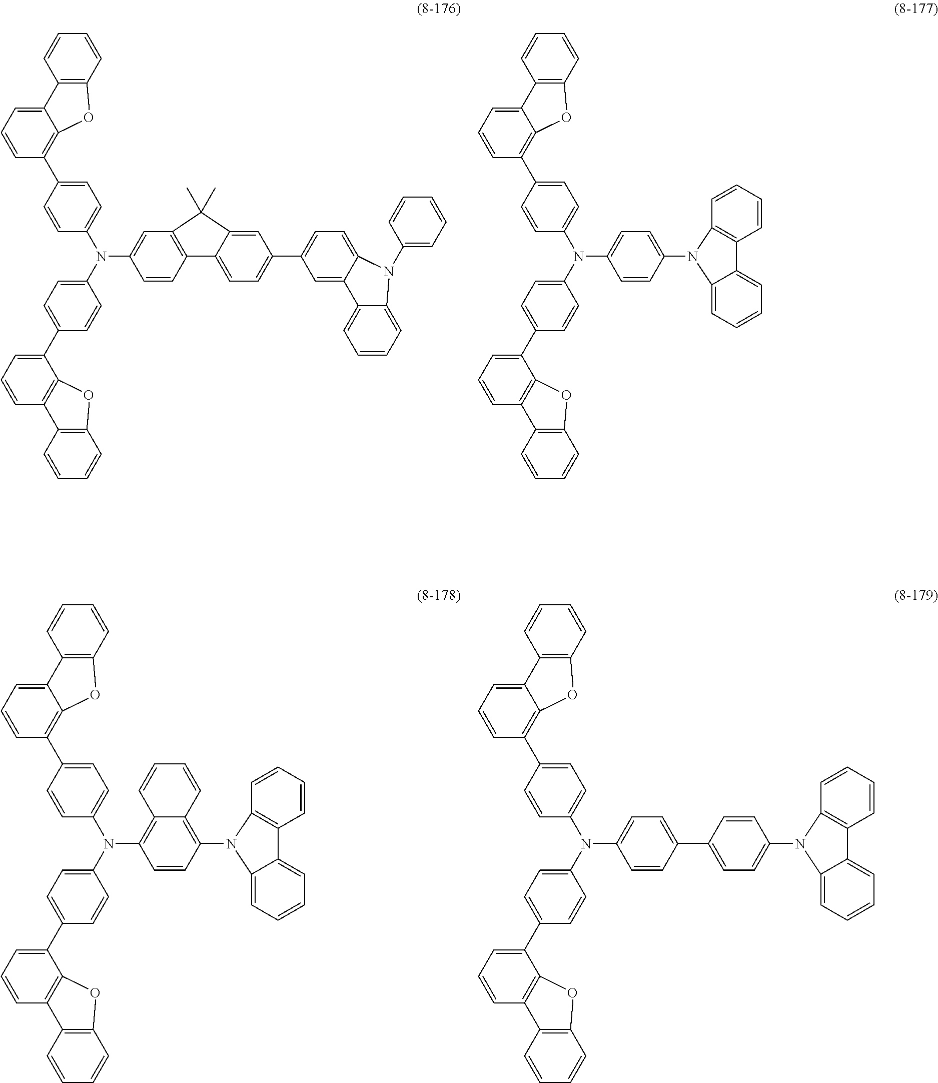

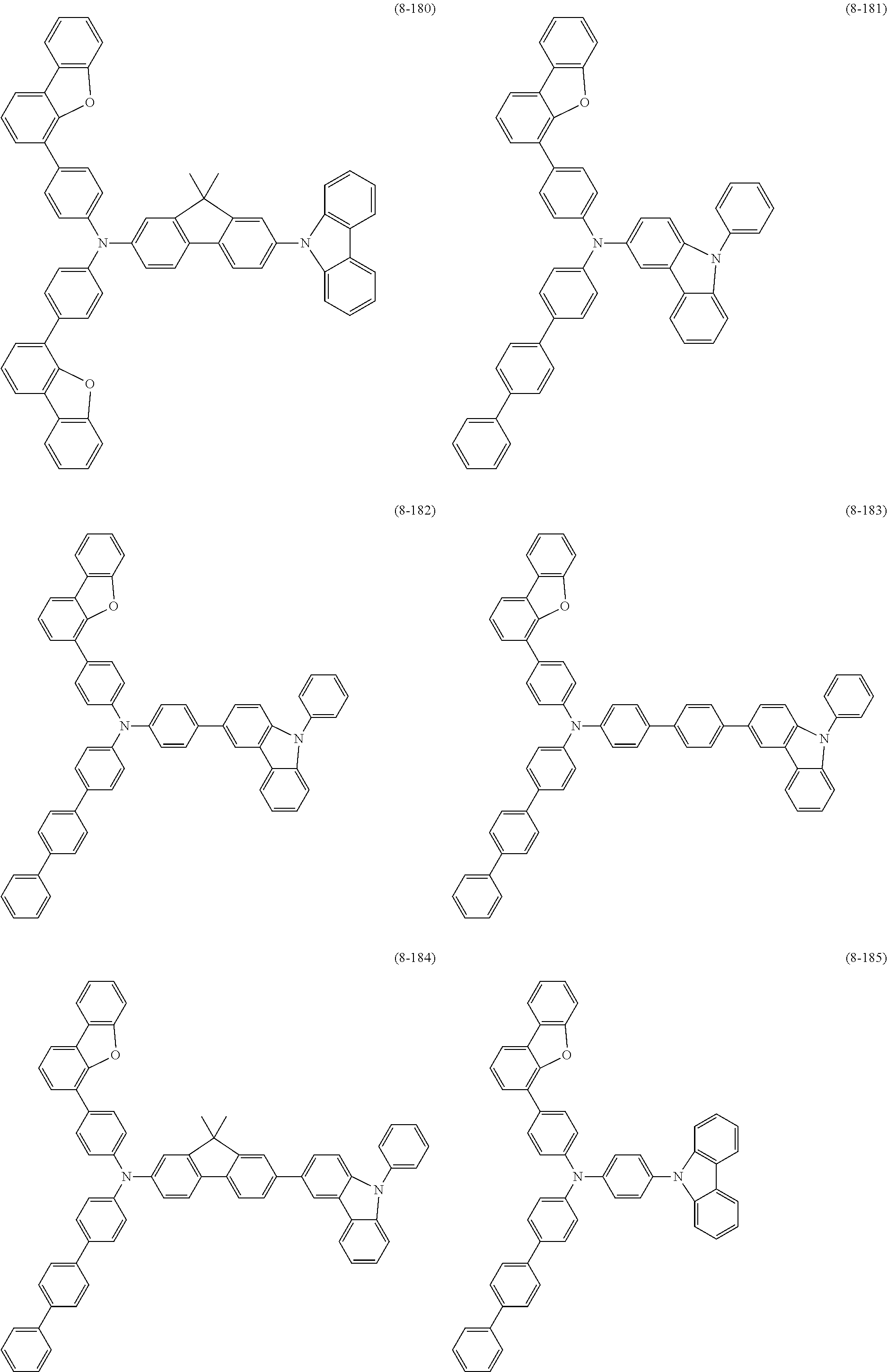

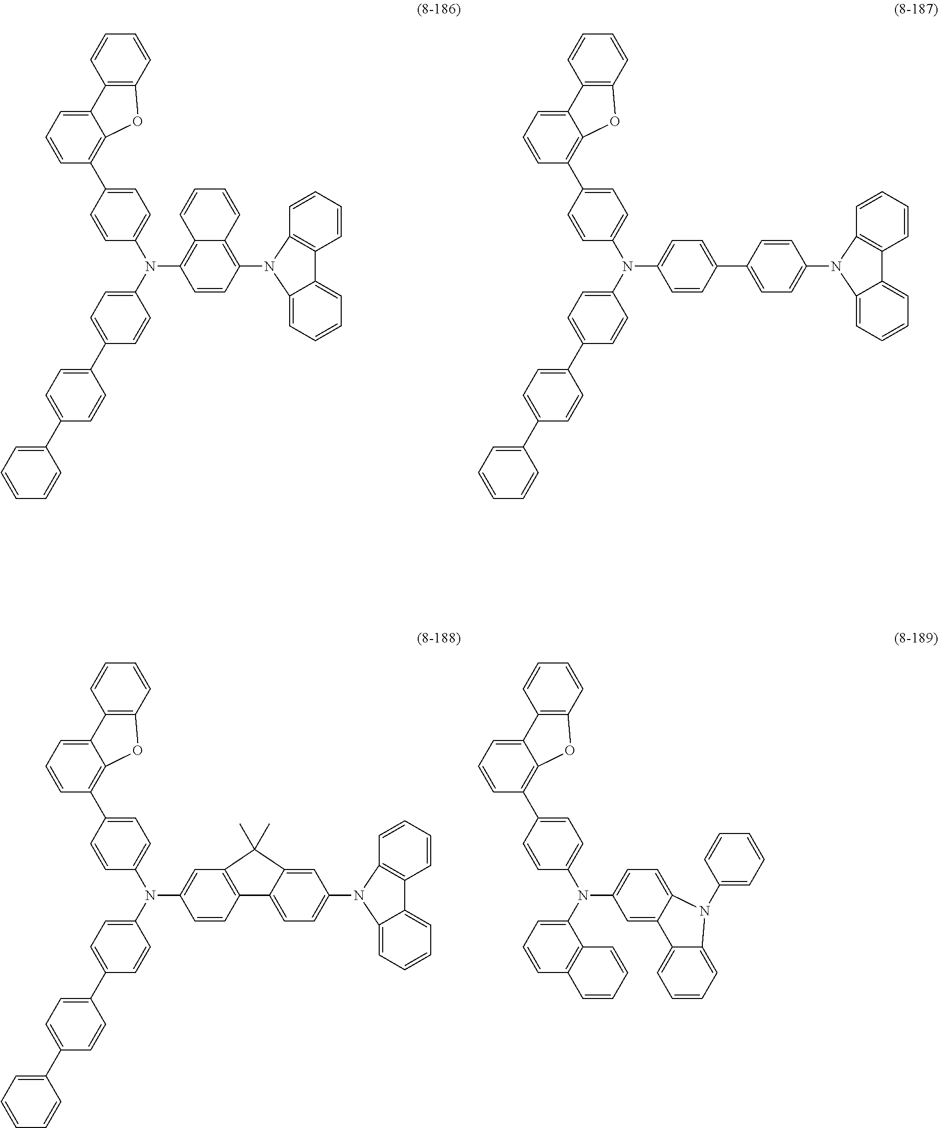

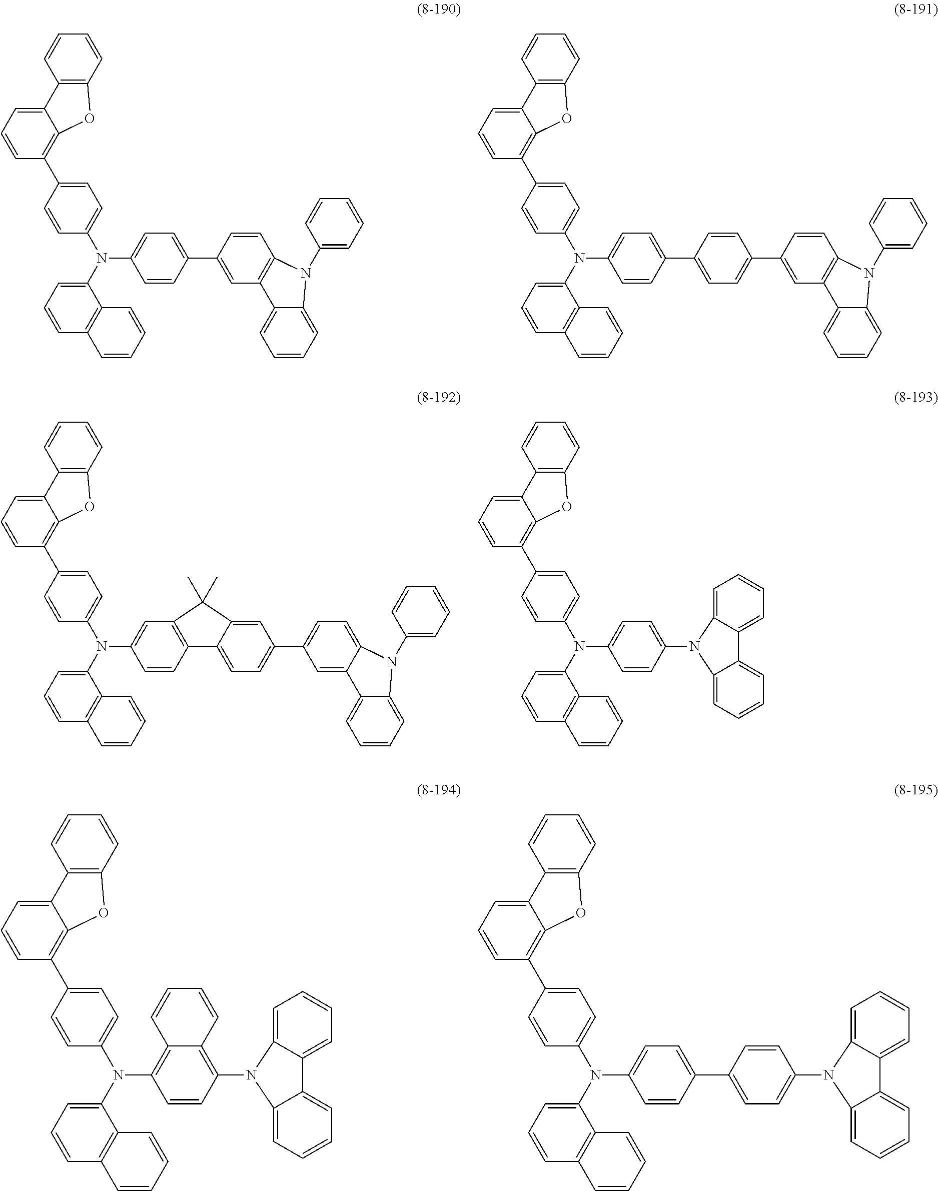

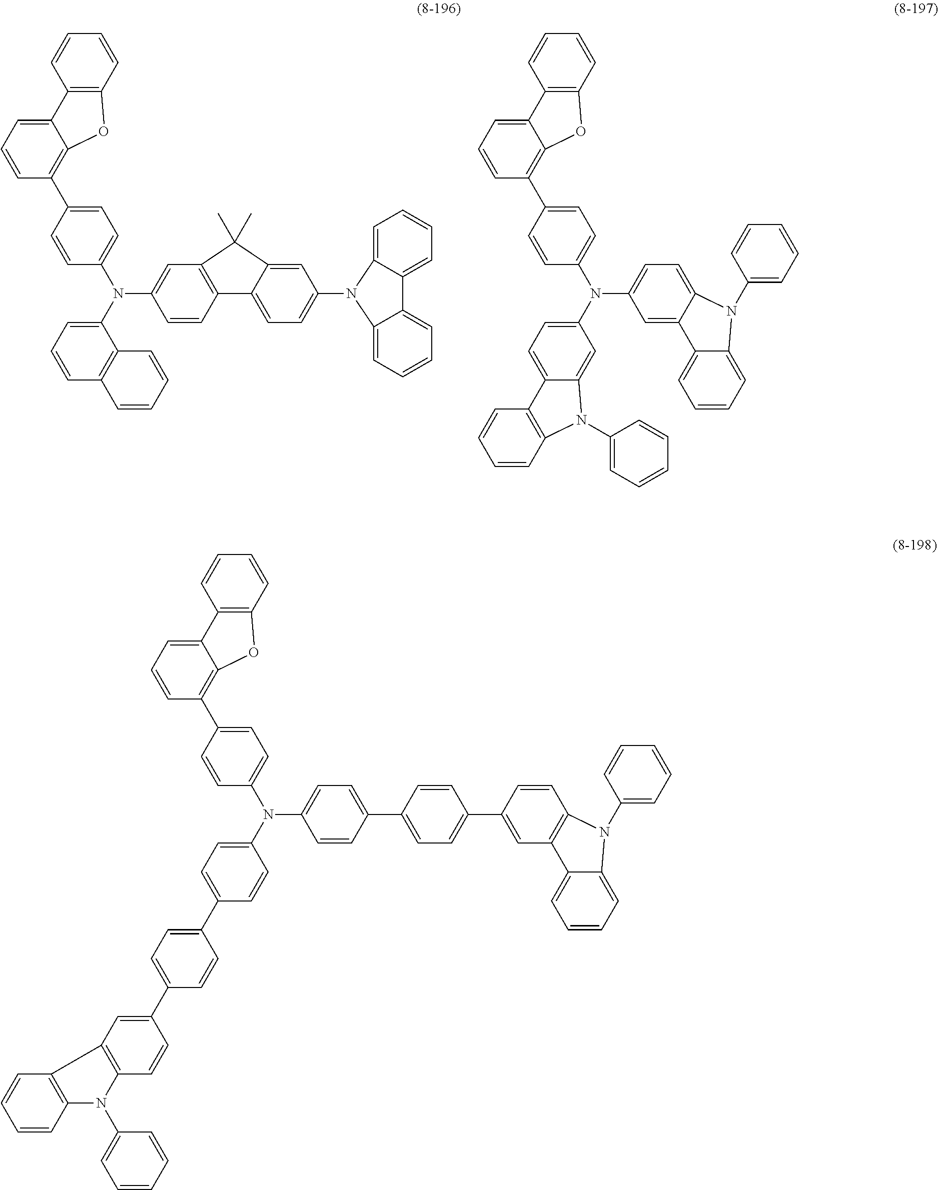

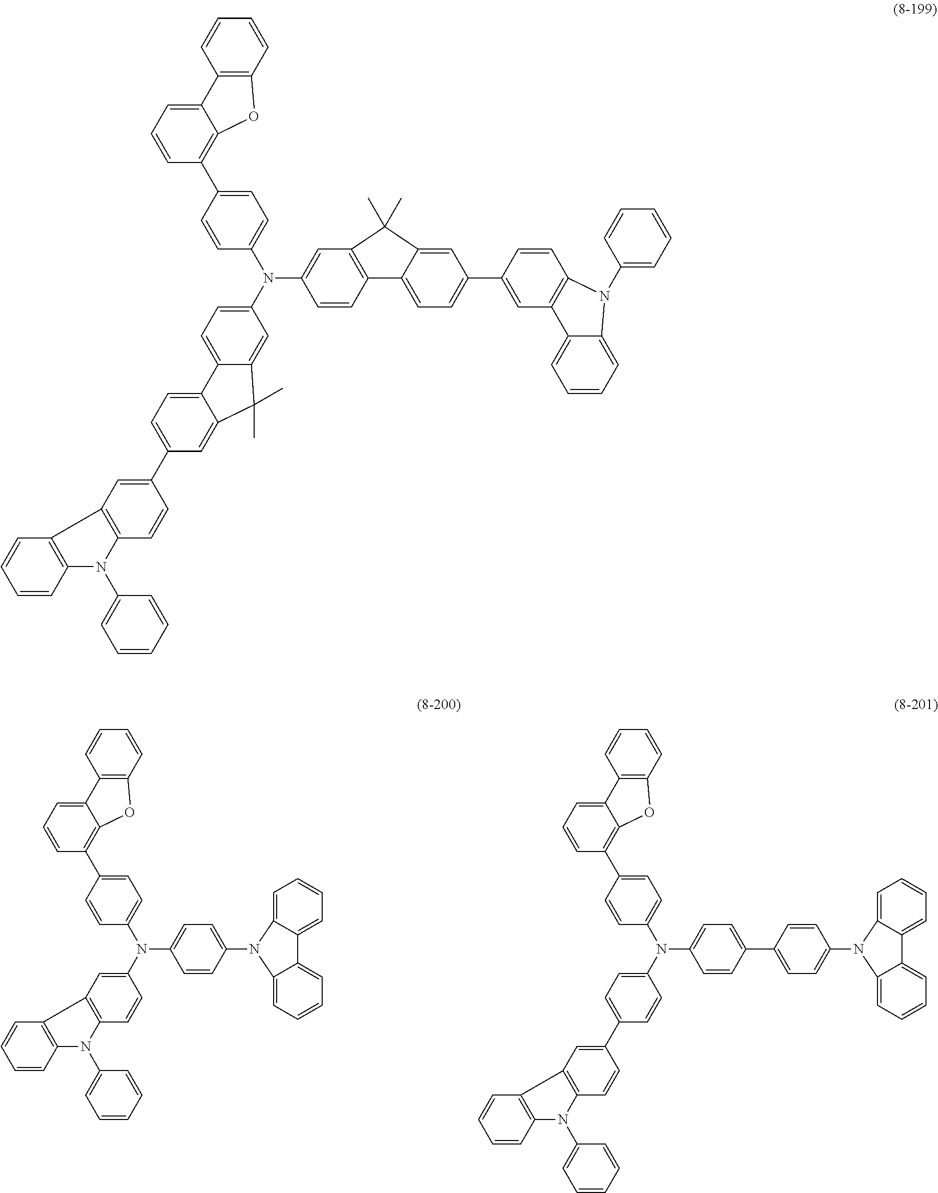

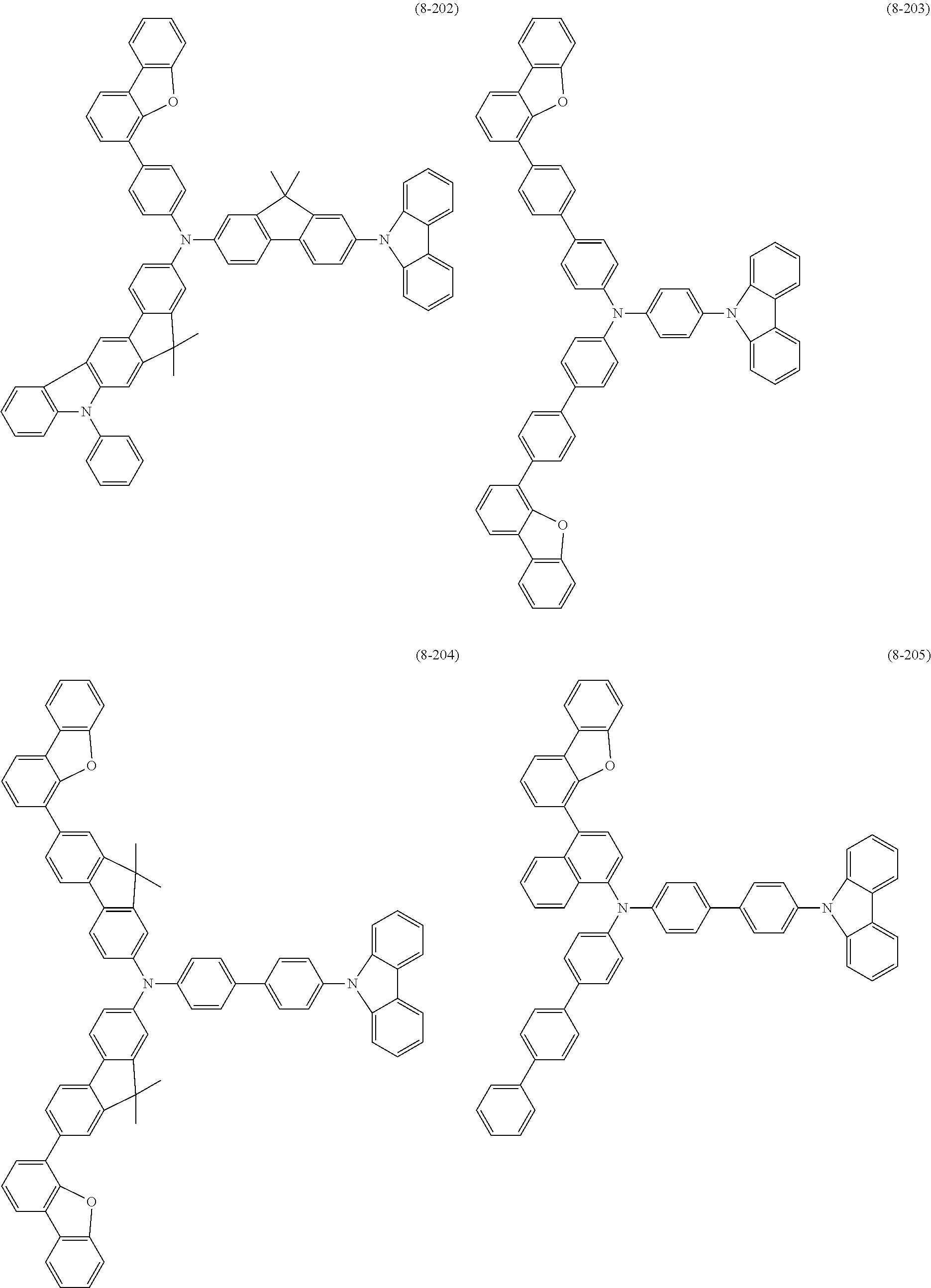

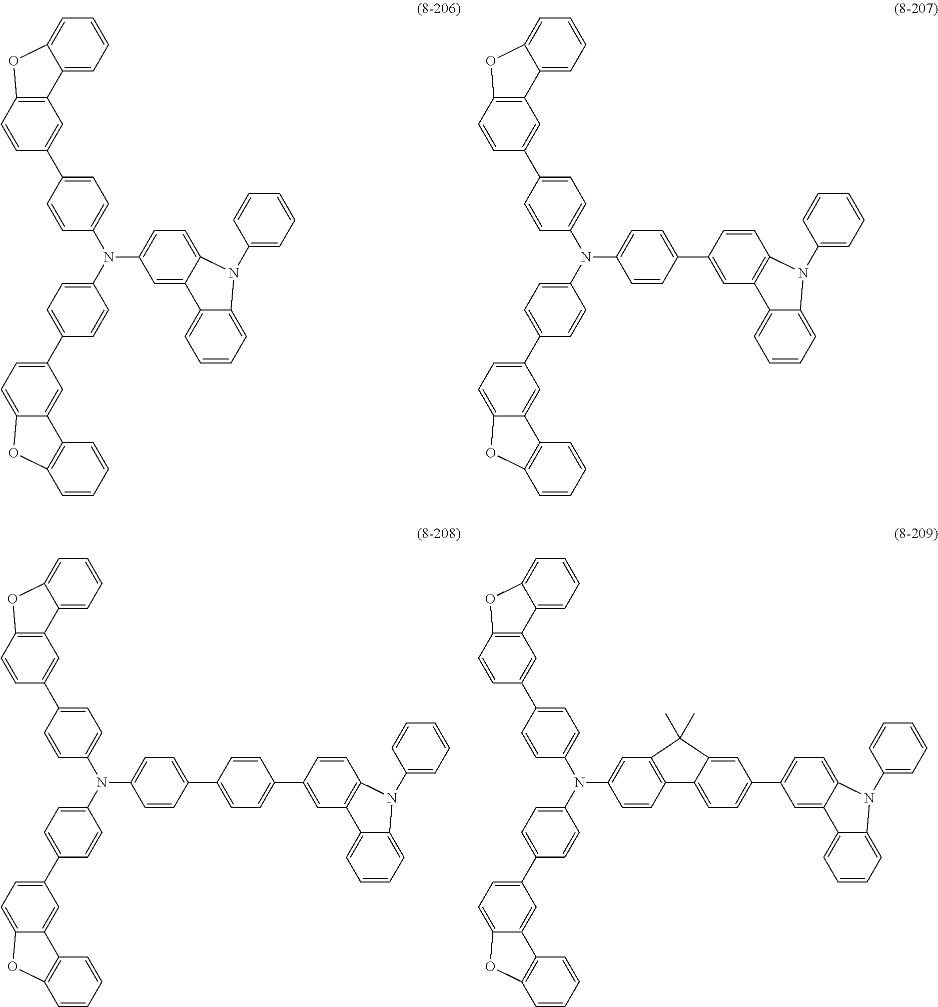

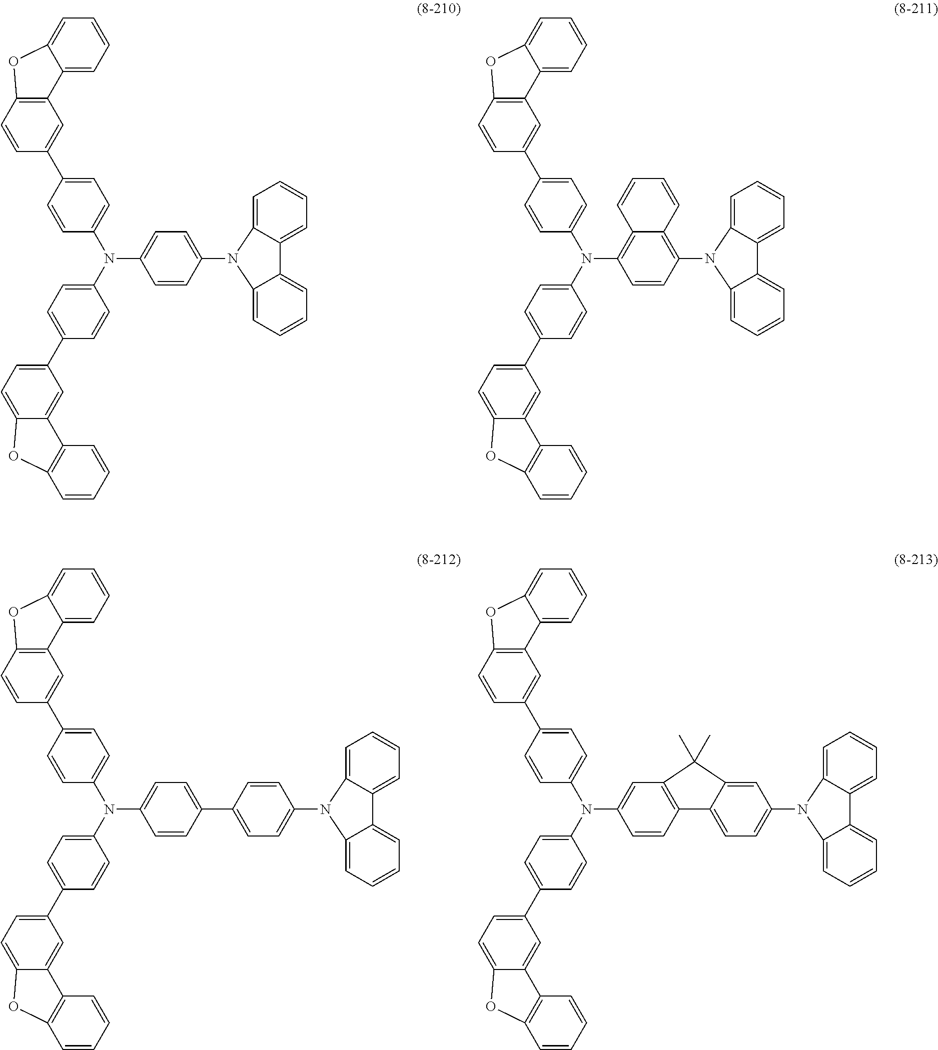

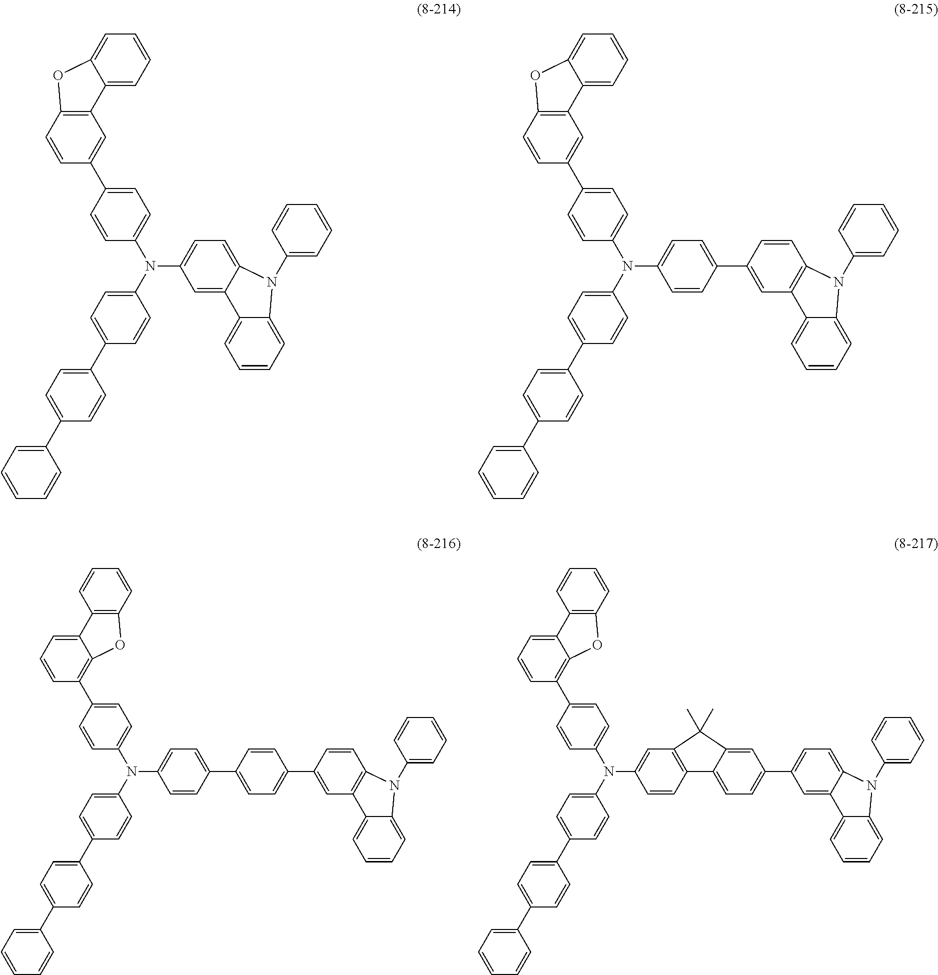

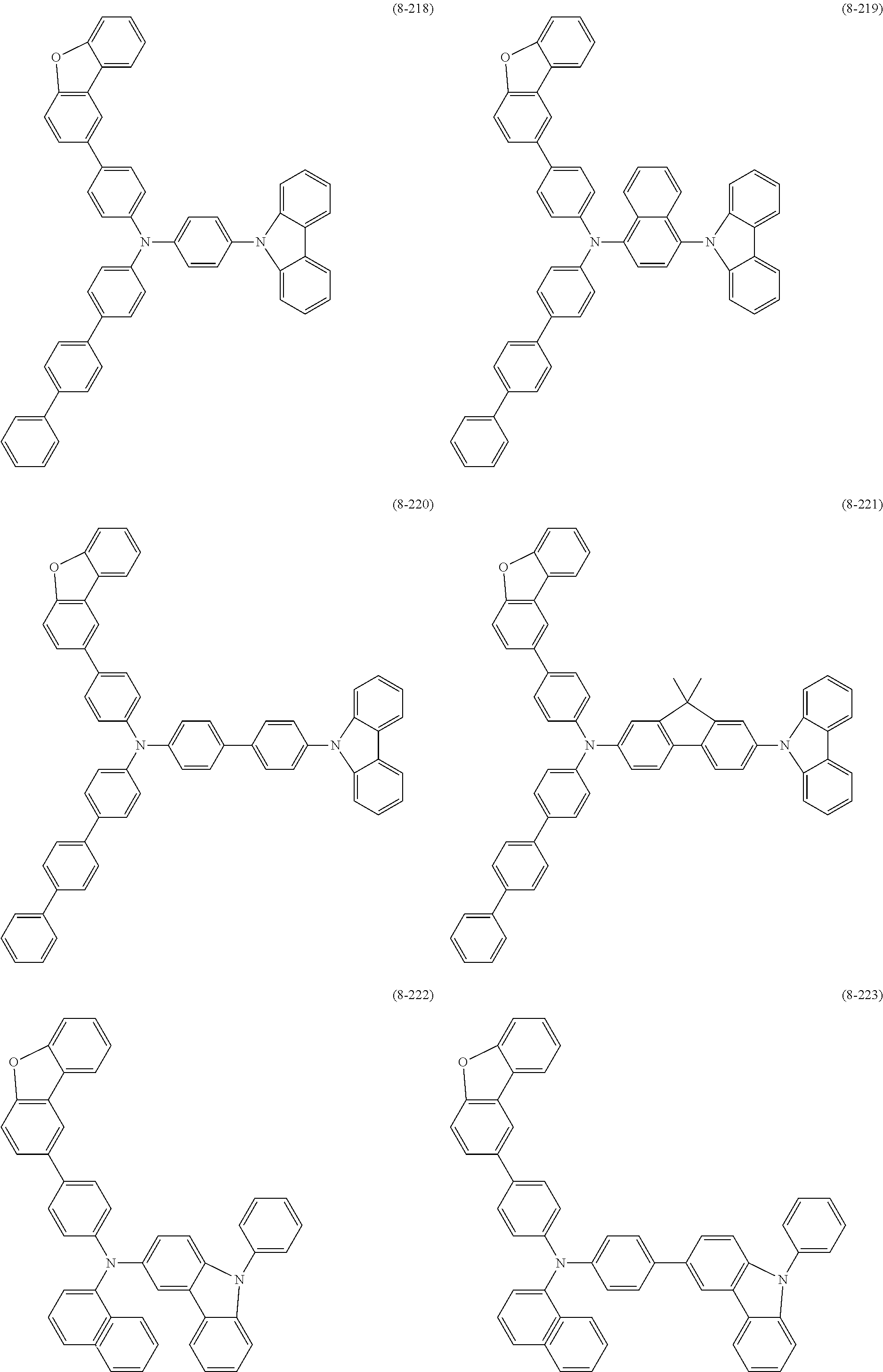

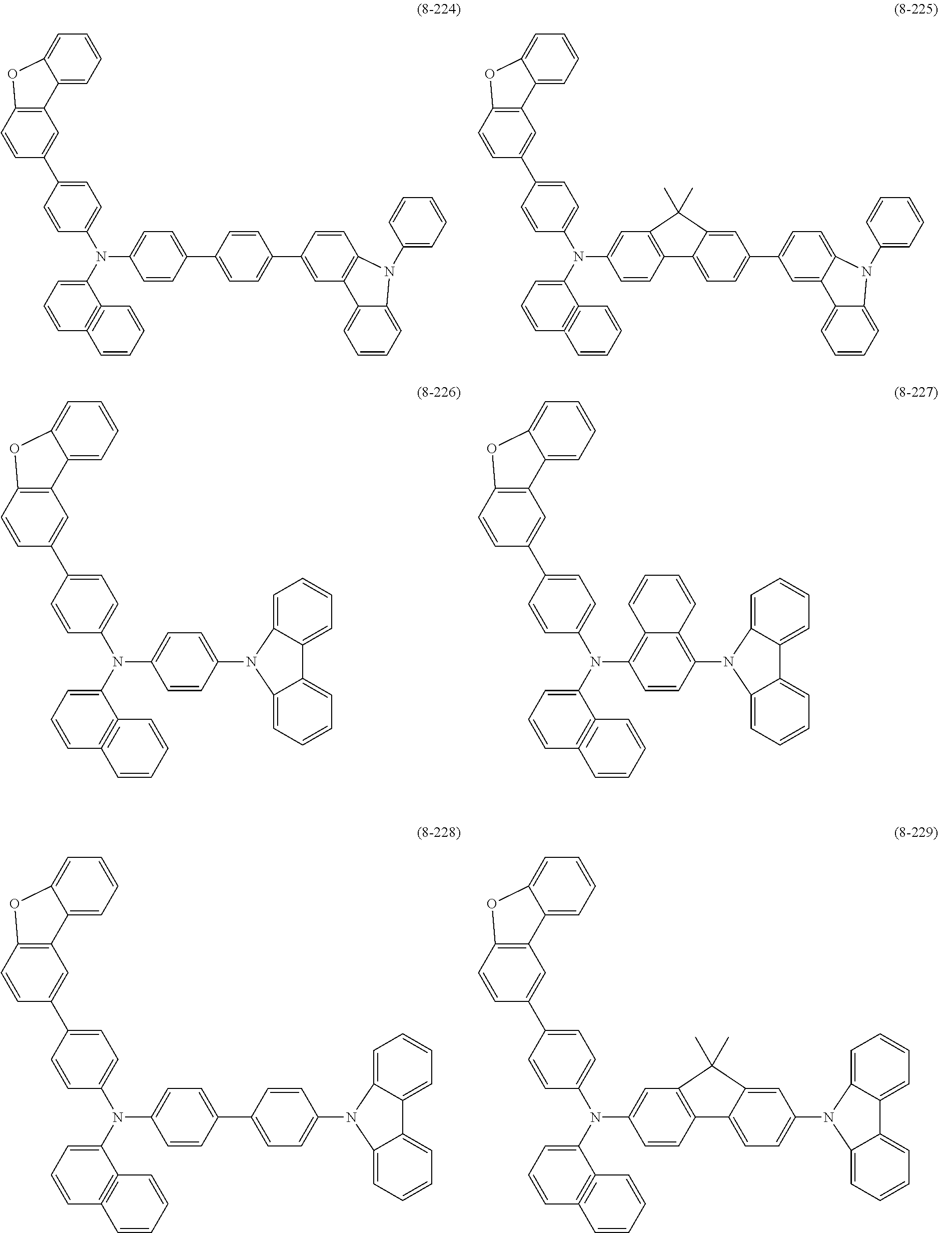

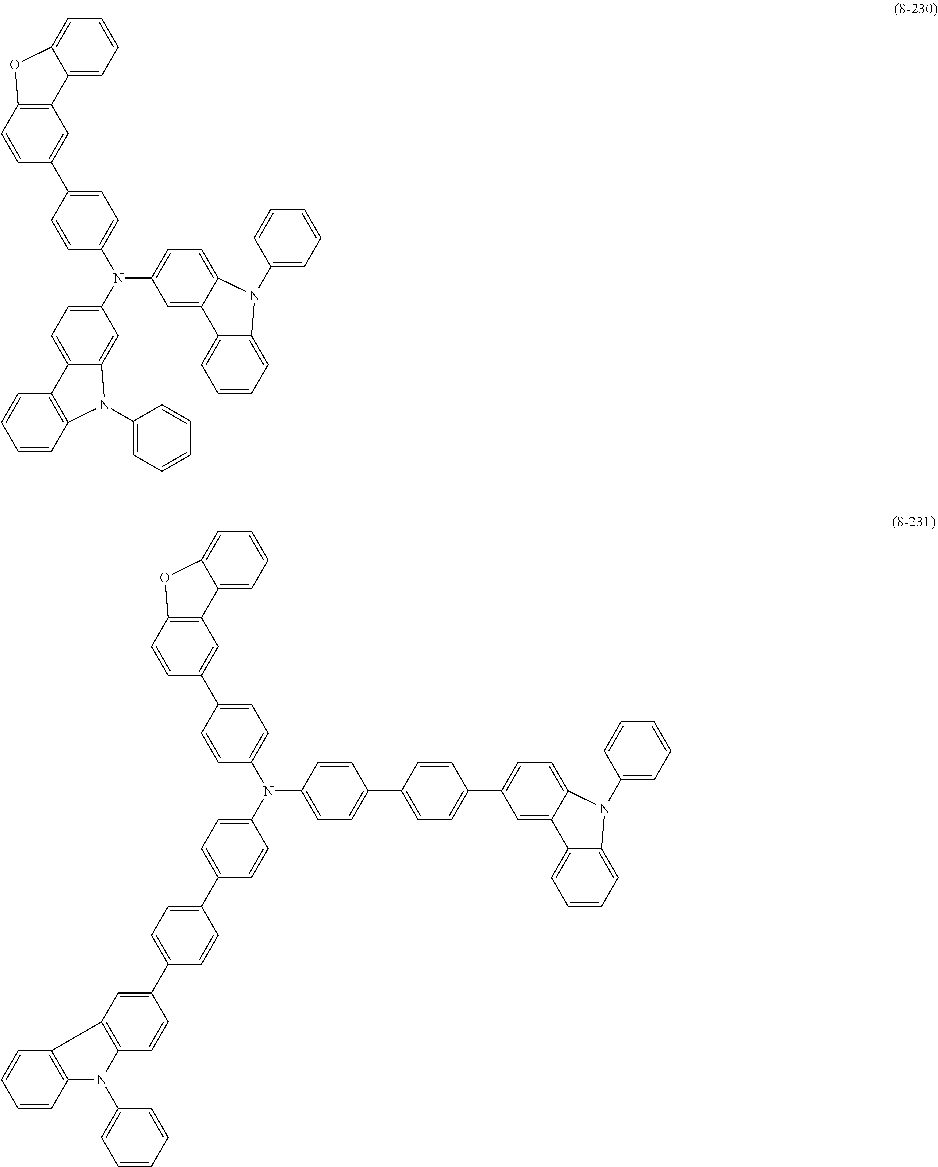

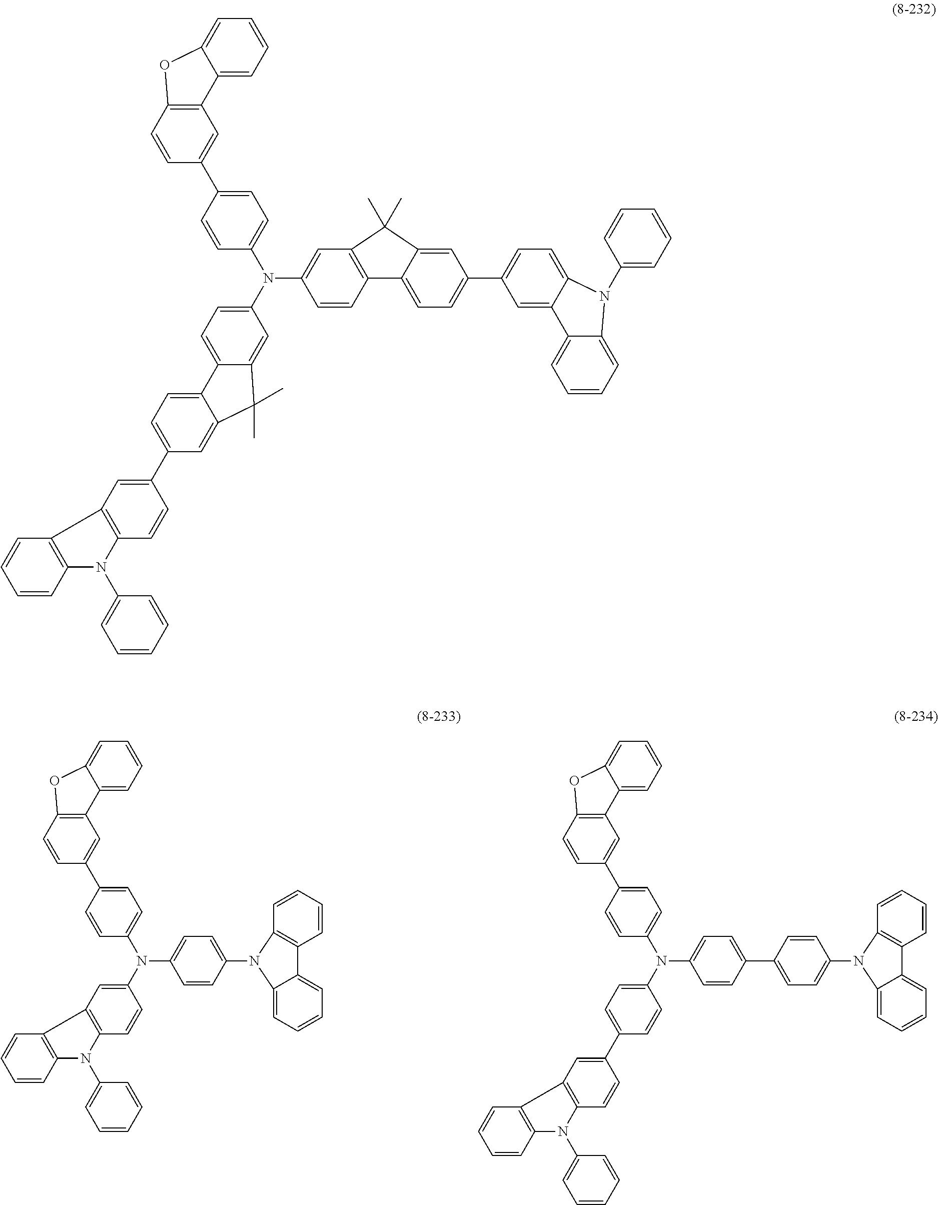

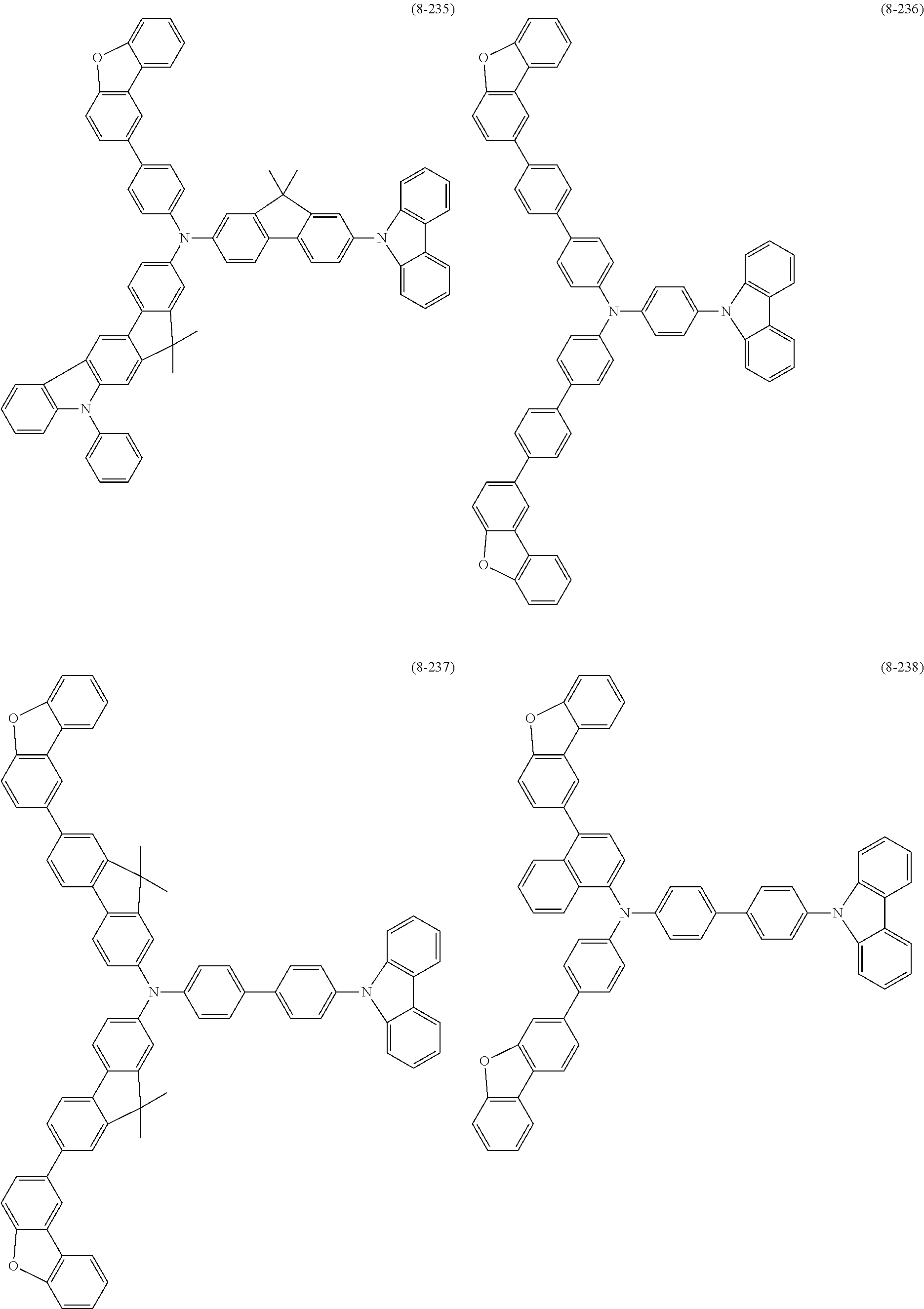

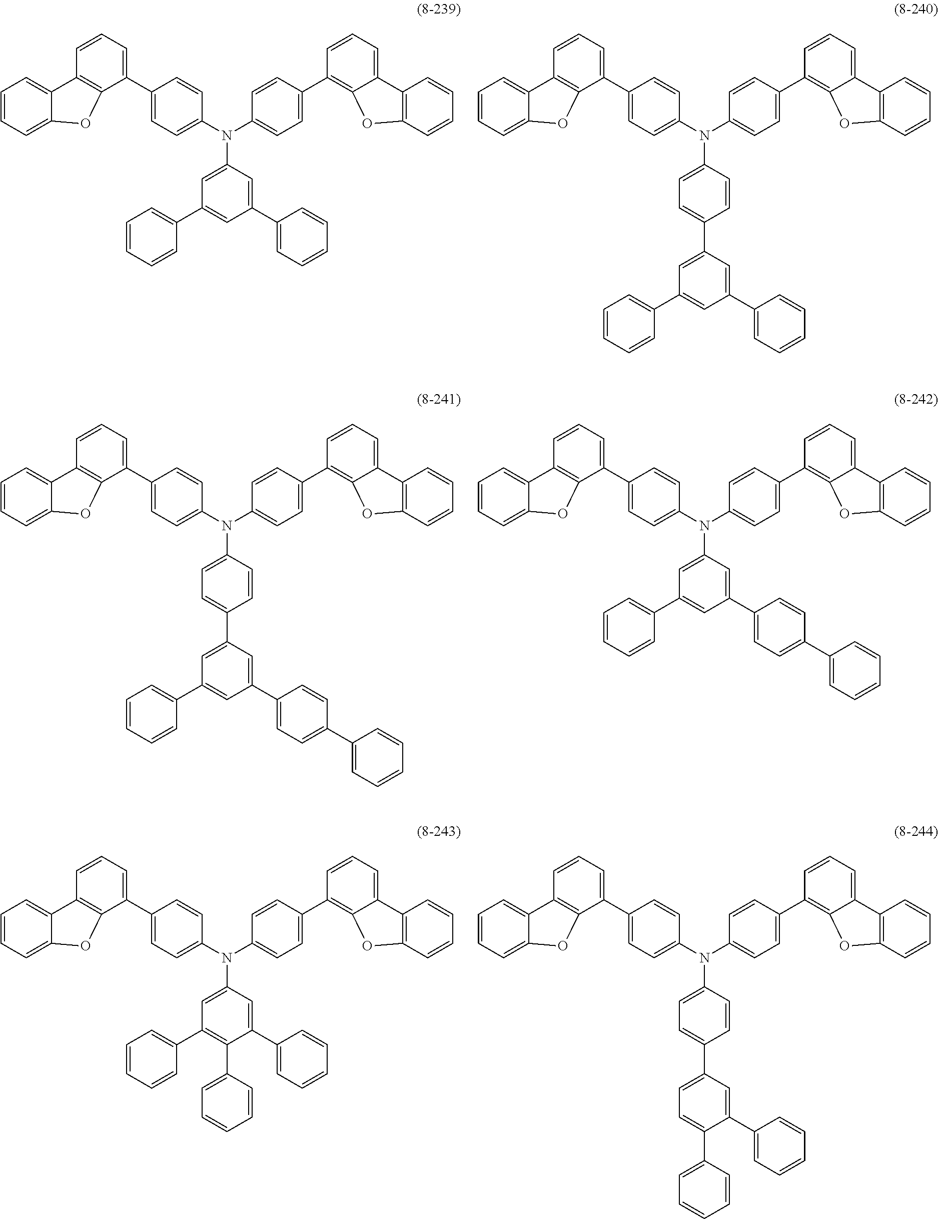

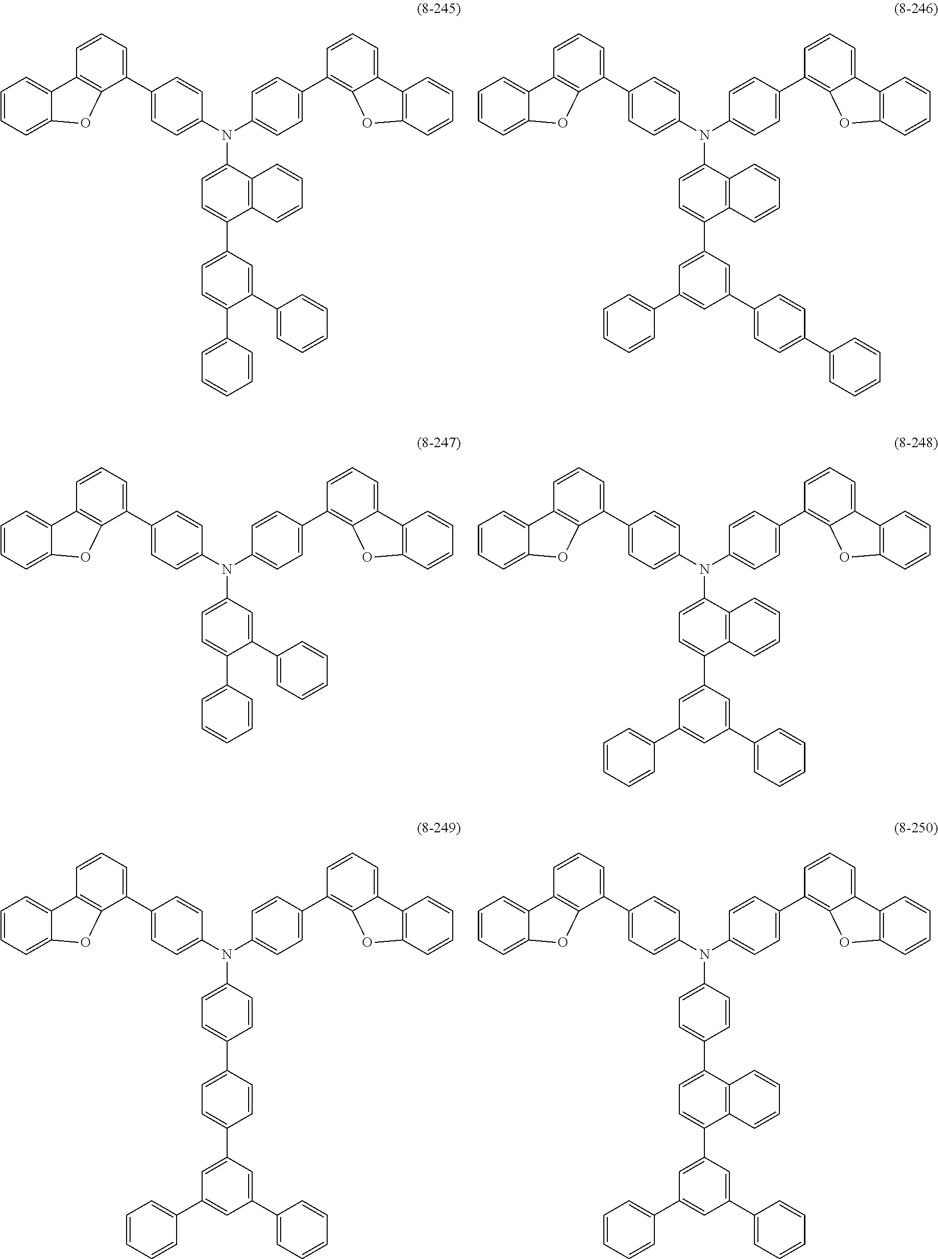

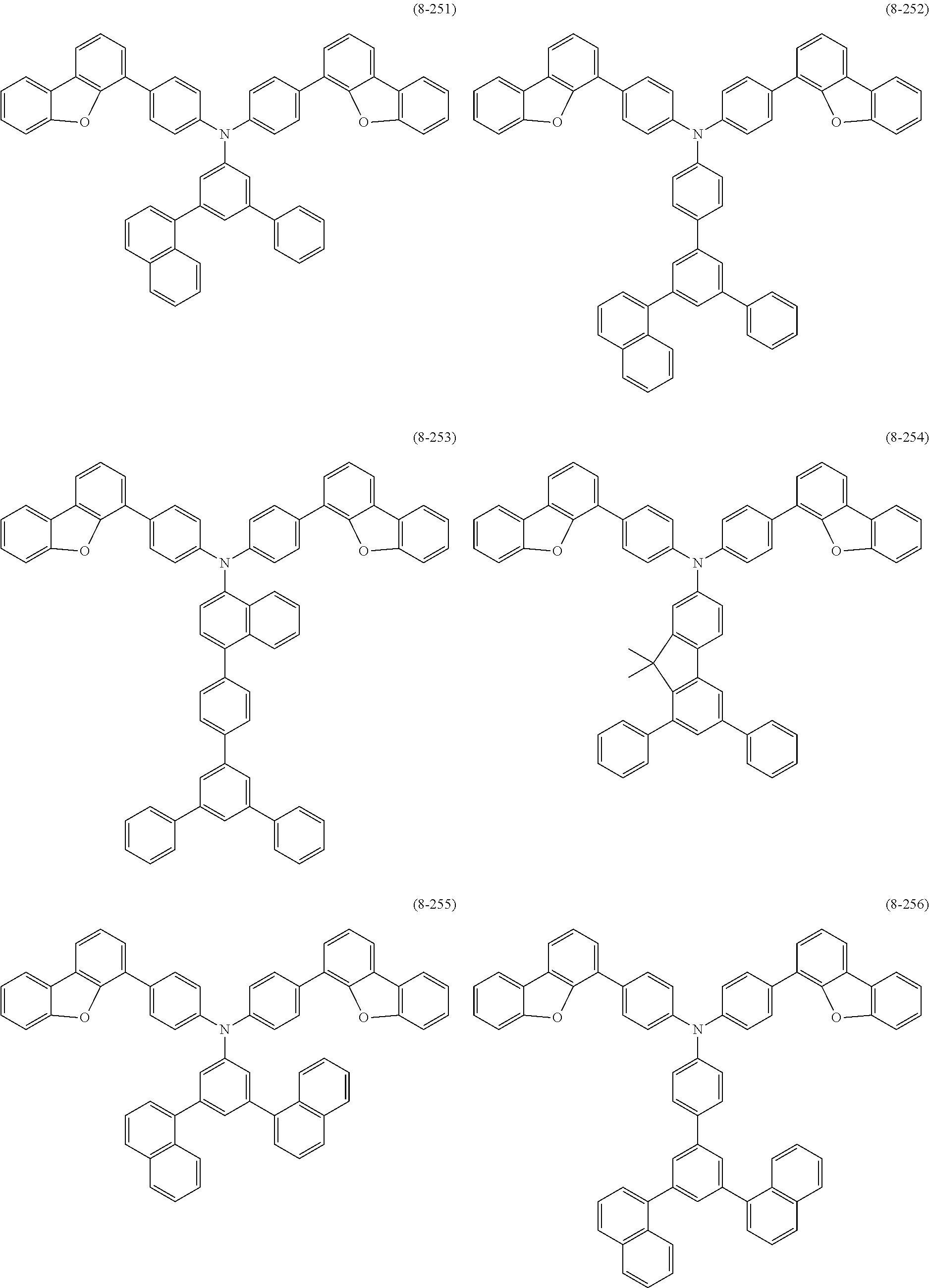

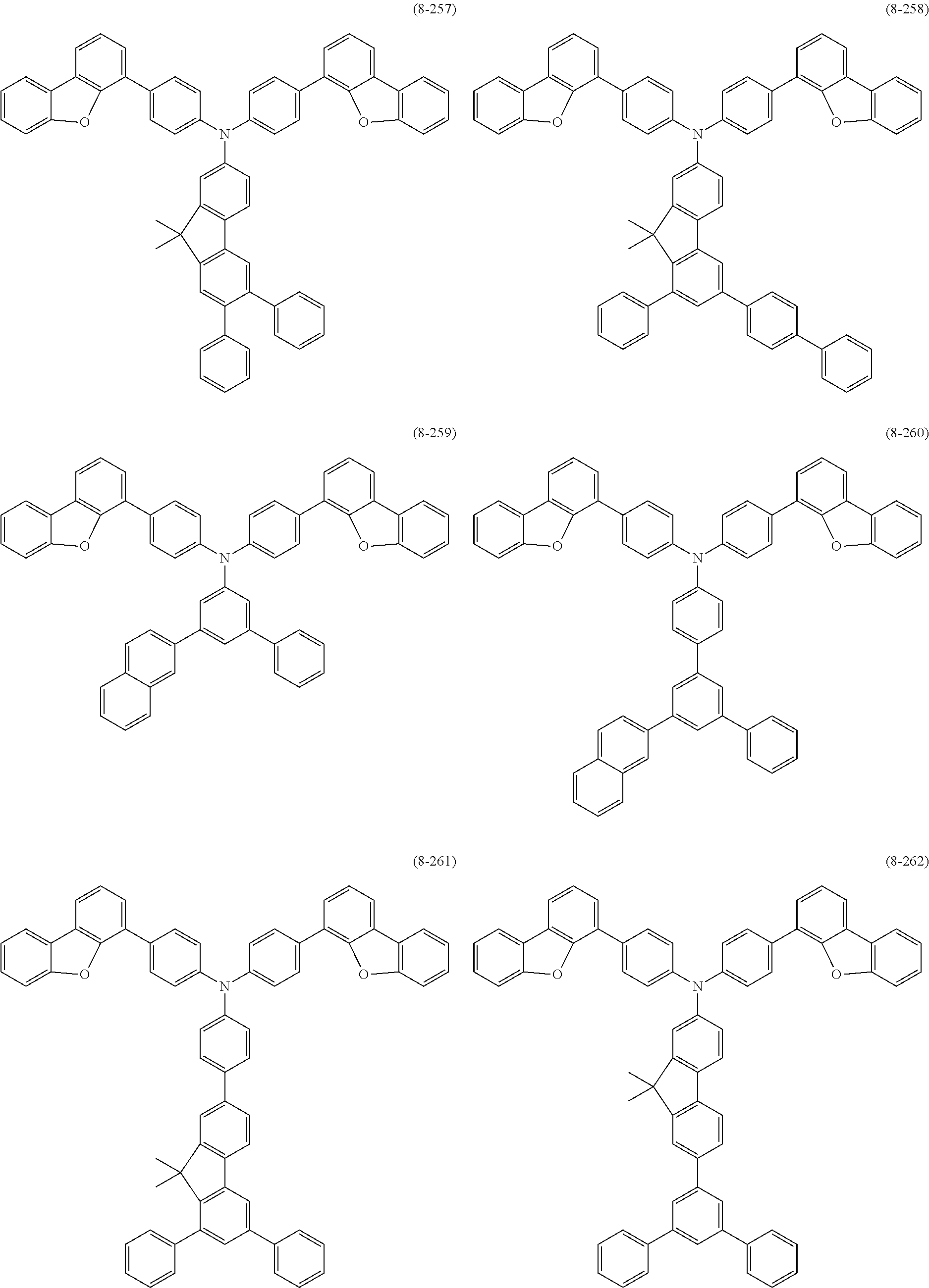

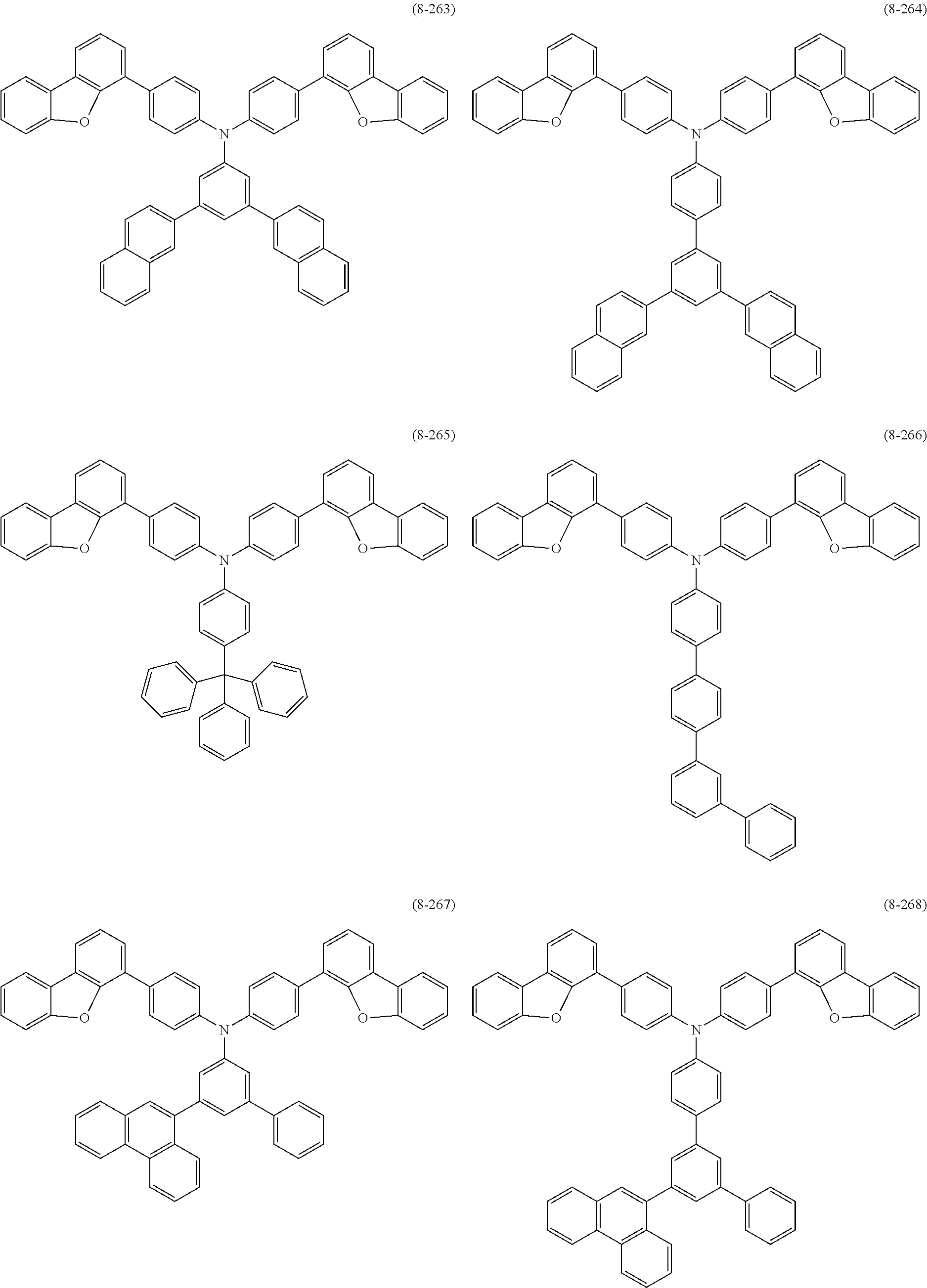

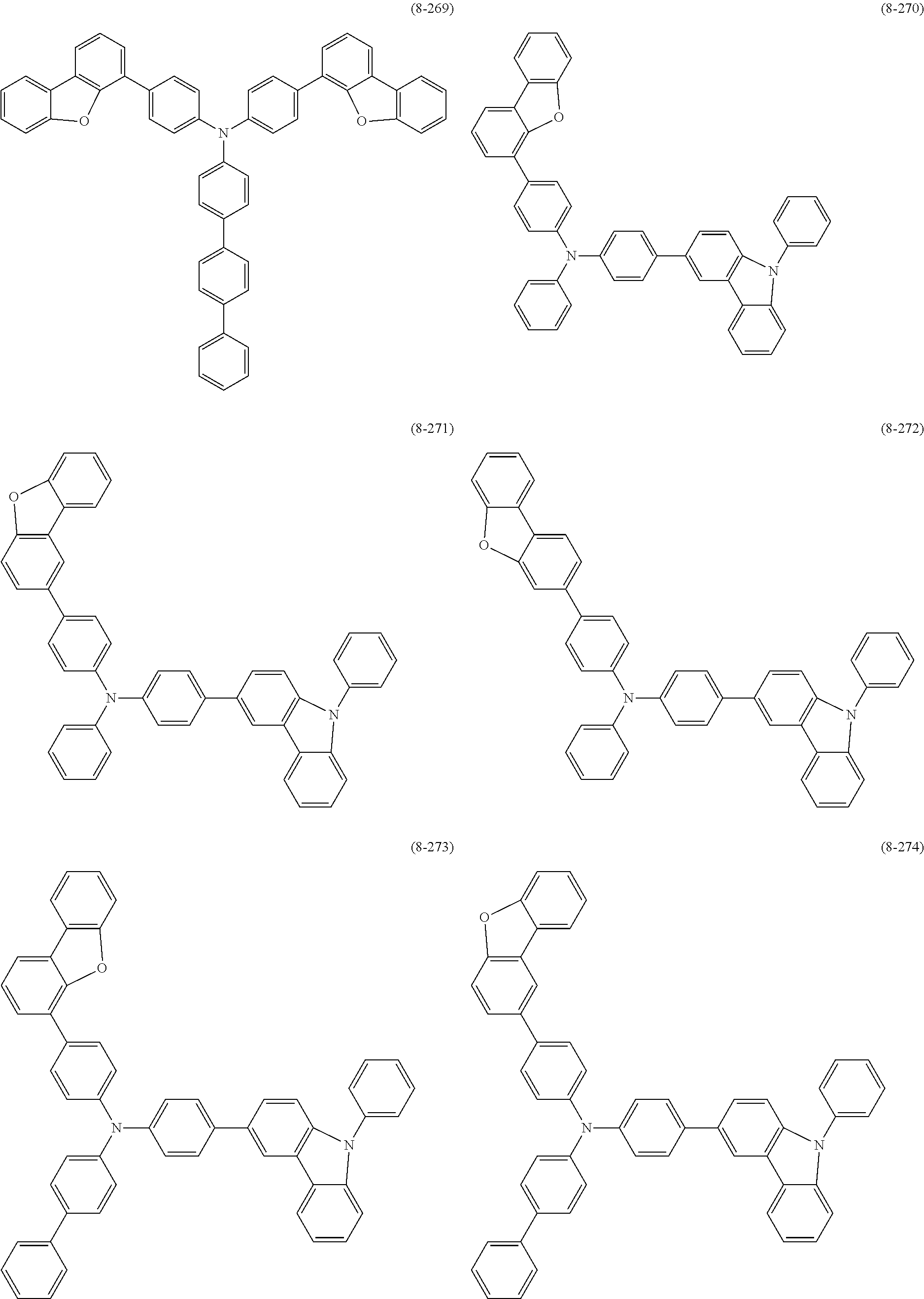

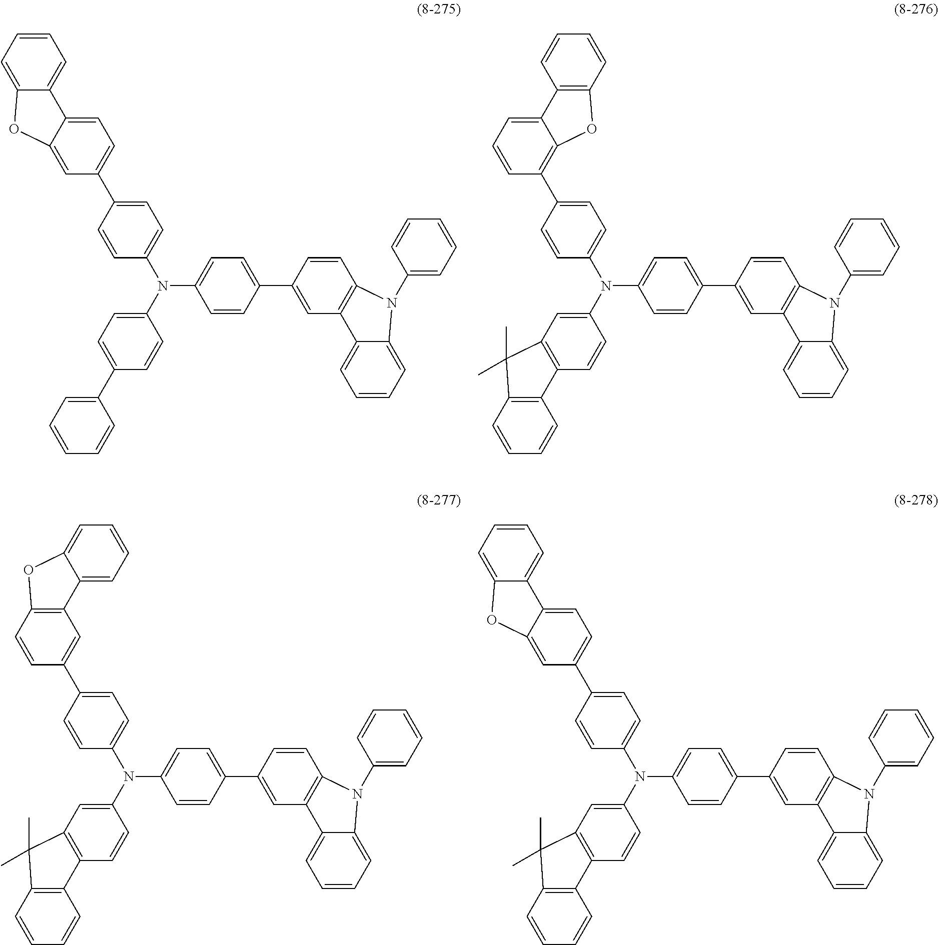

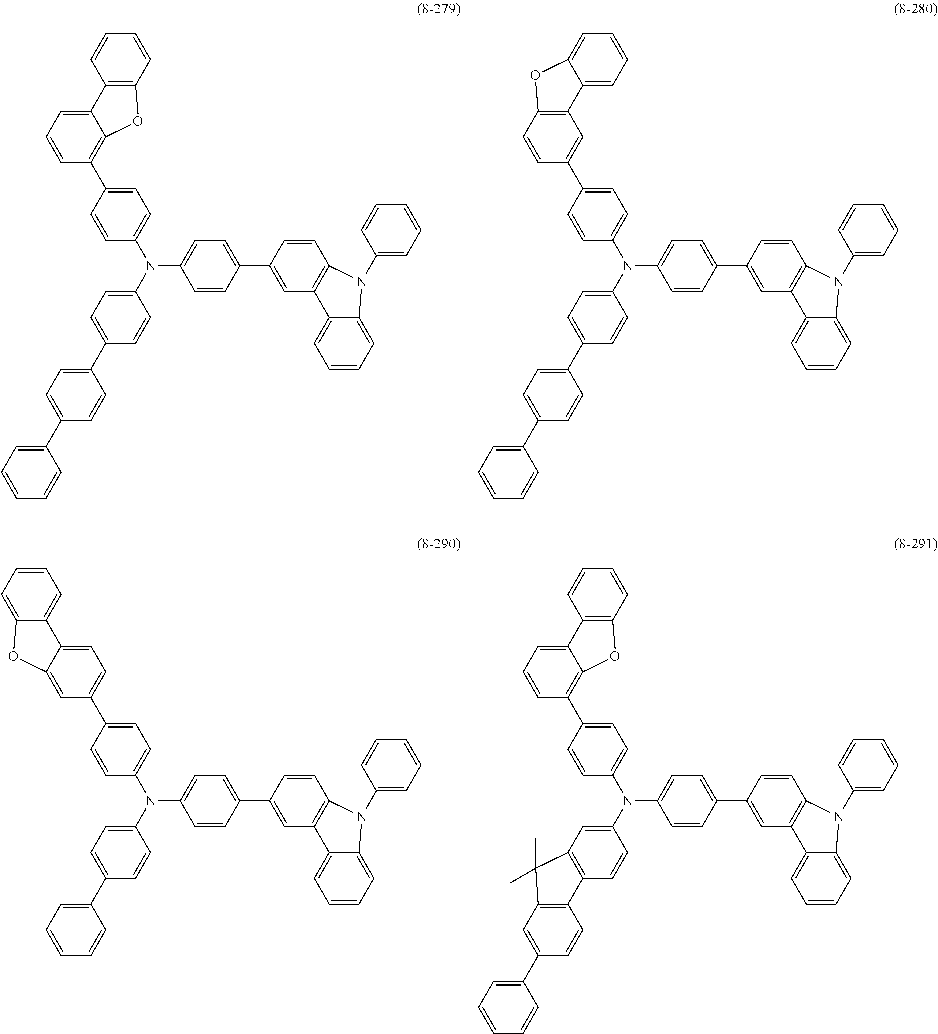

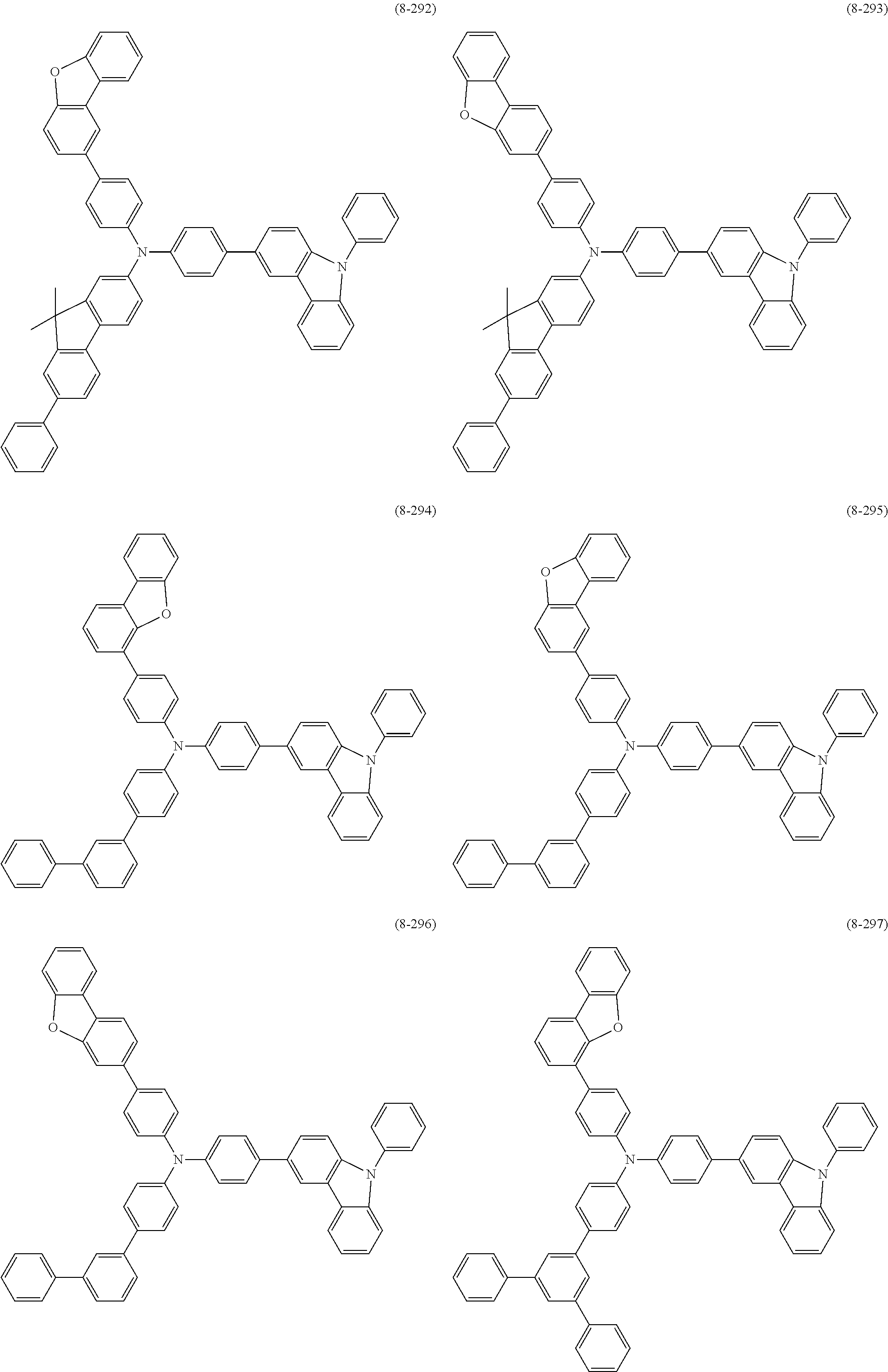

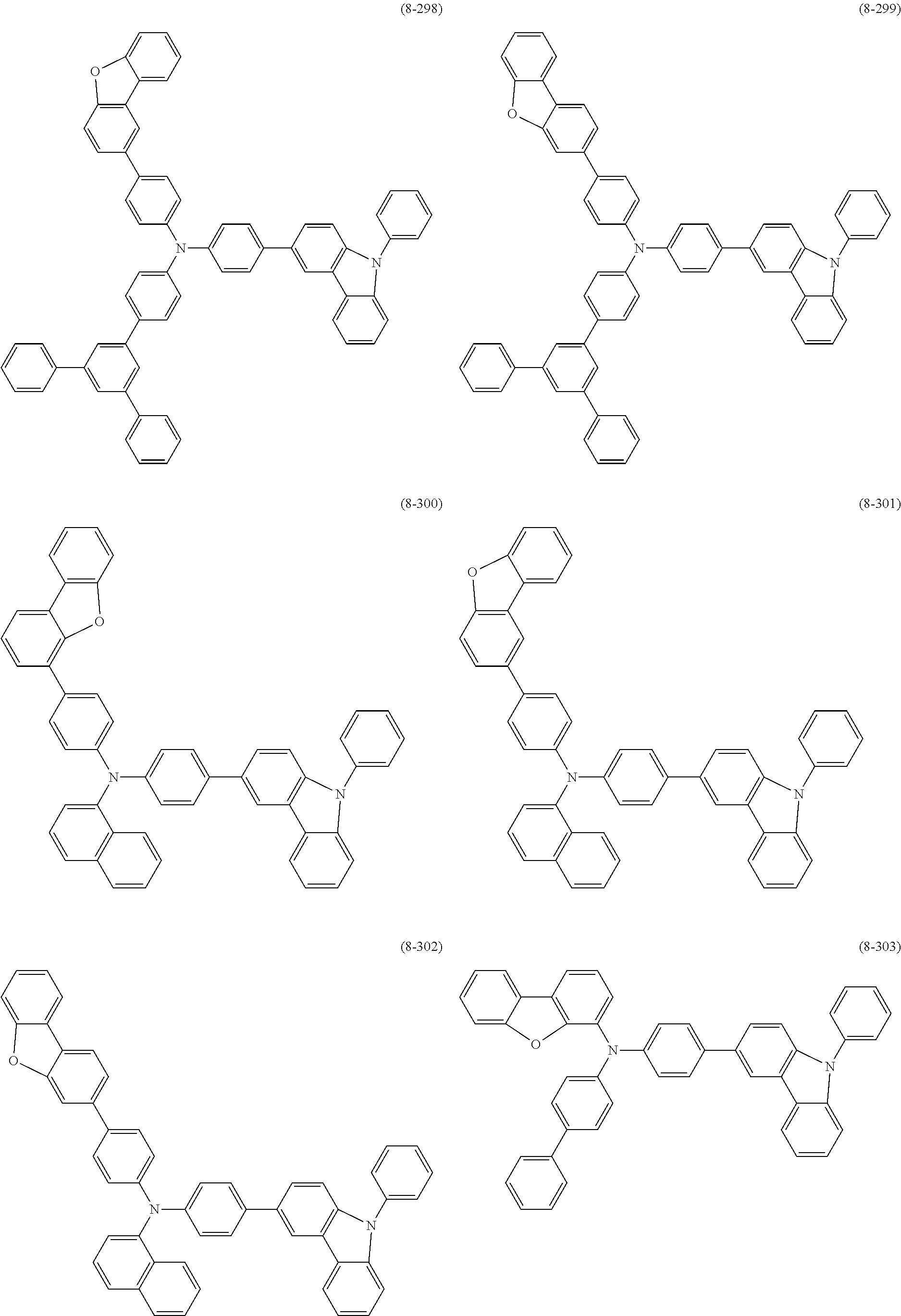

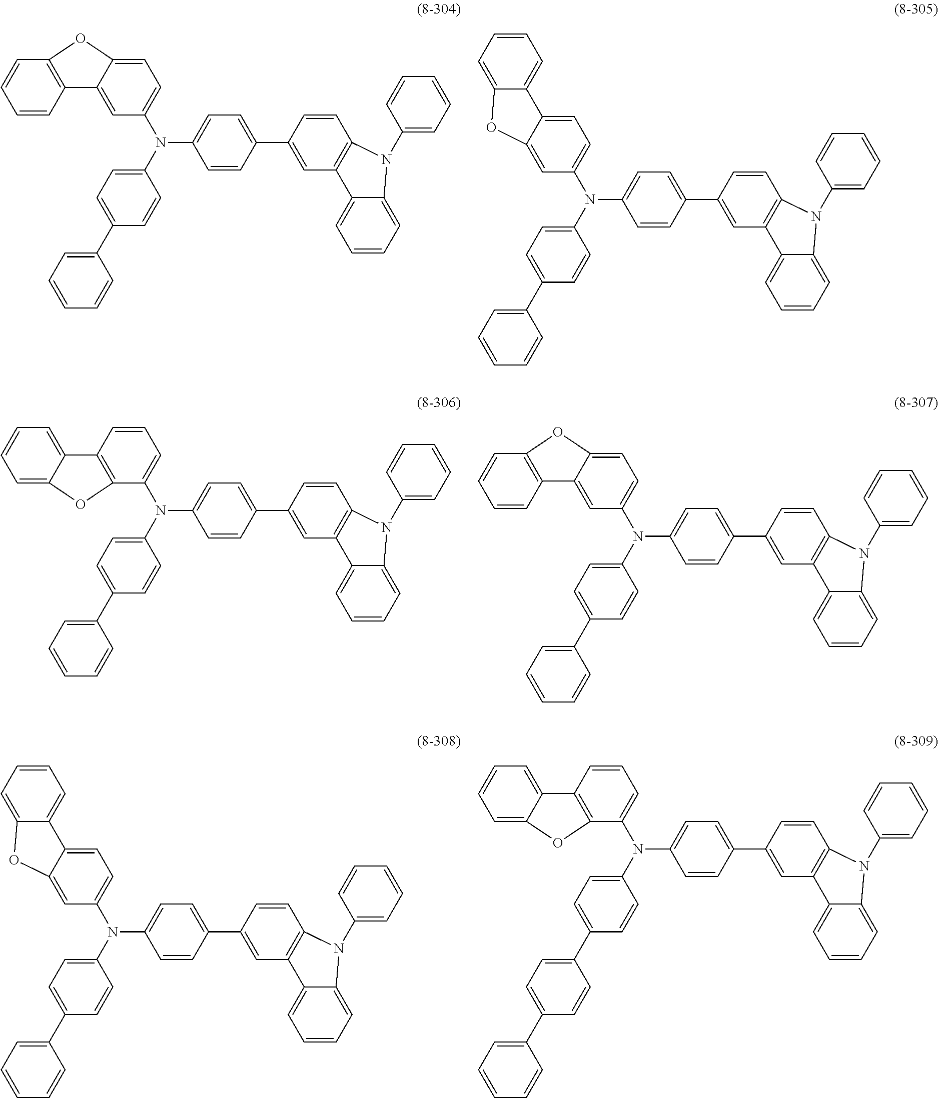

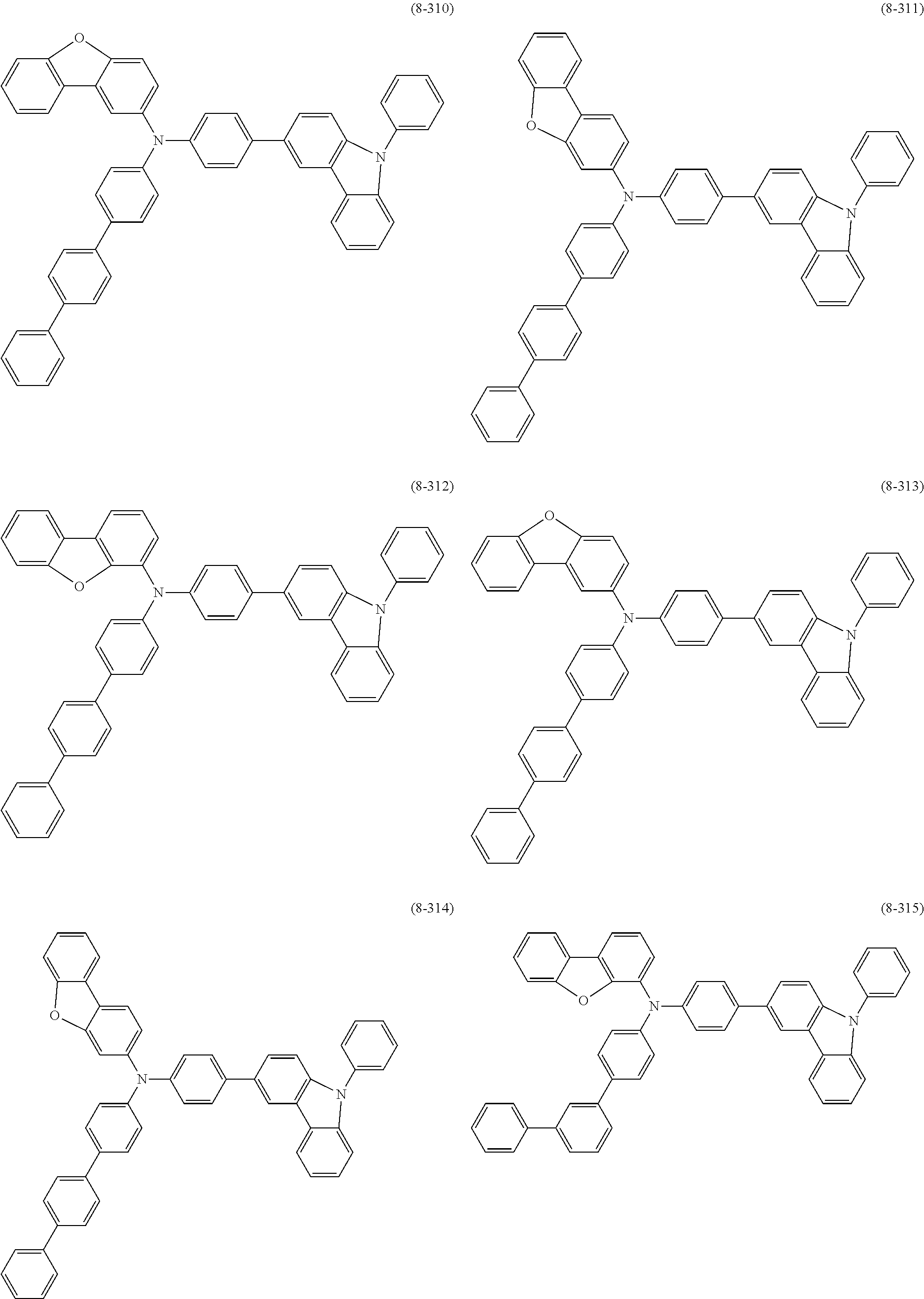

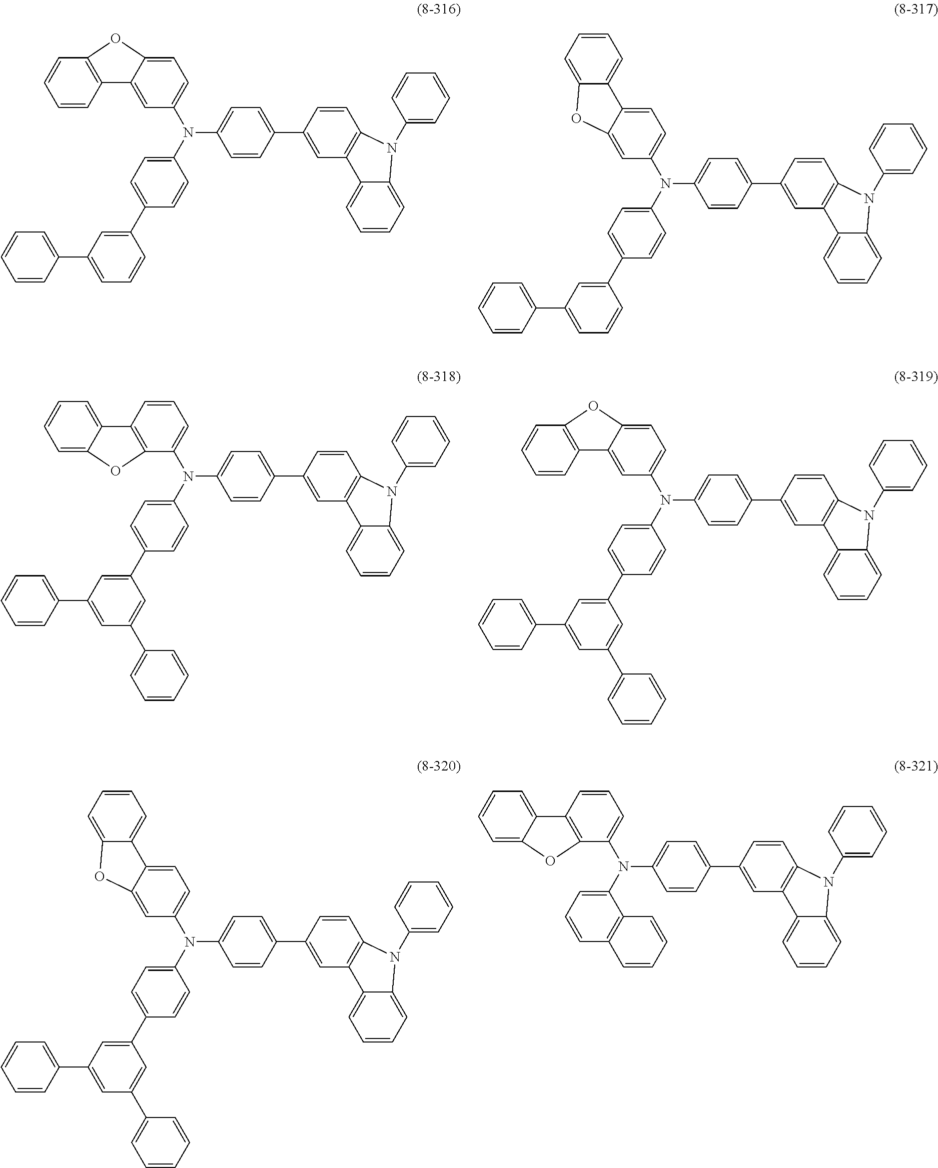

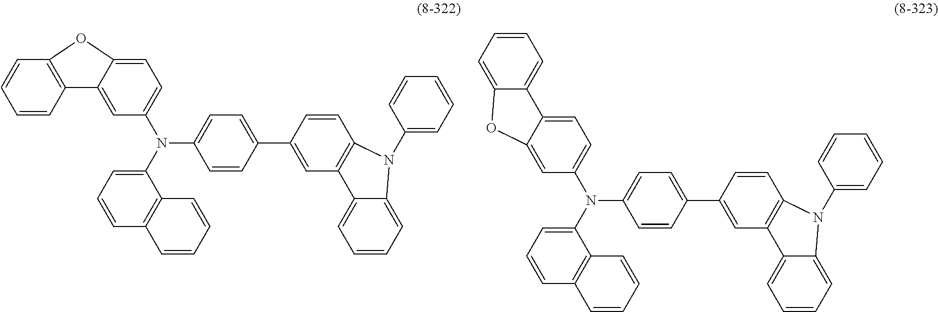

Specific examples of the compound shown in formula (9) include compounds of the following formulas (9-1) to (9-45).

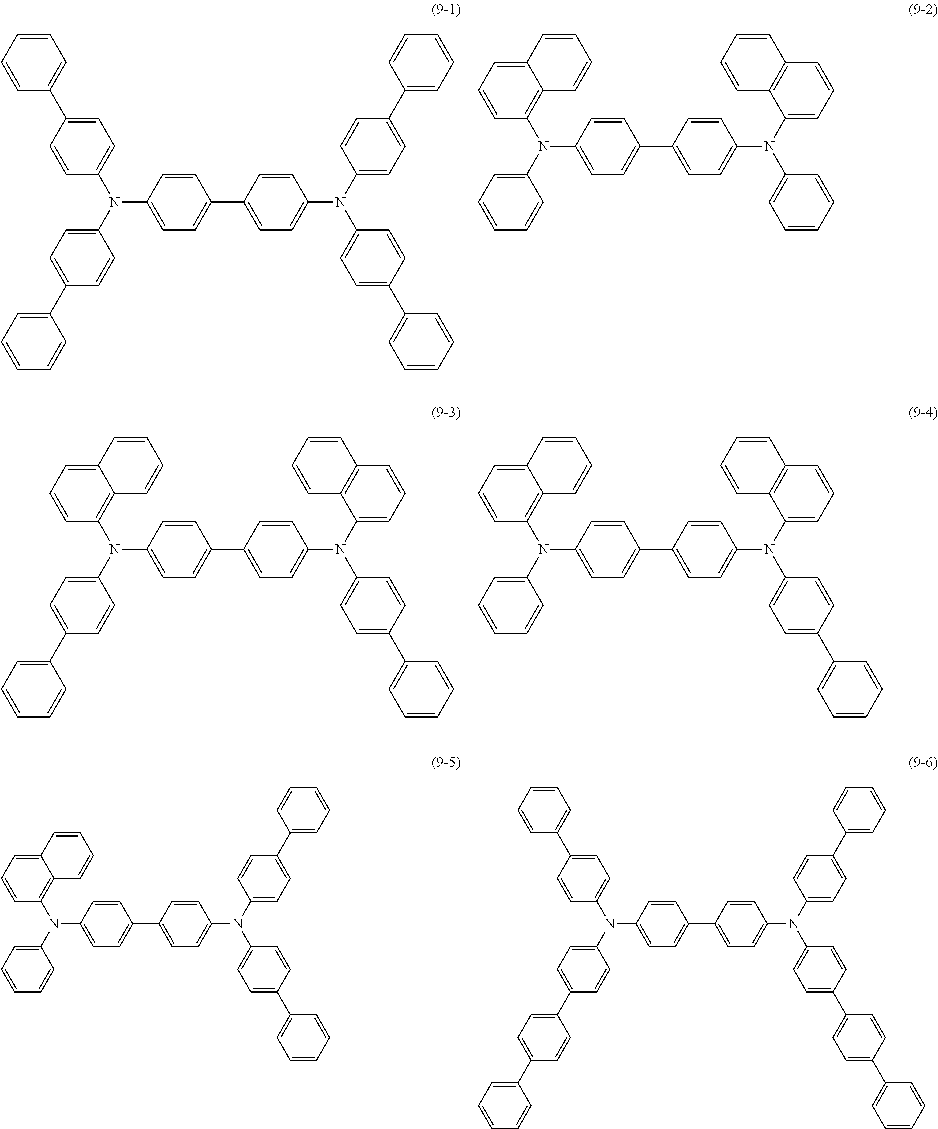

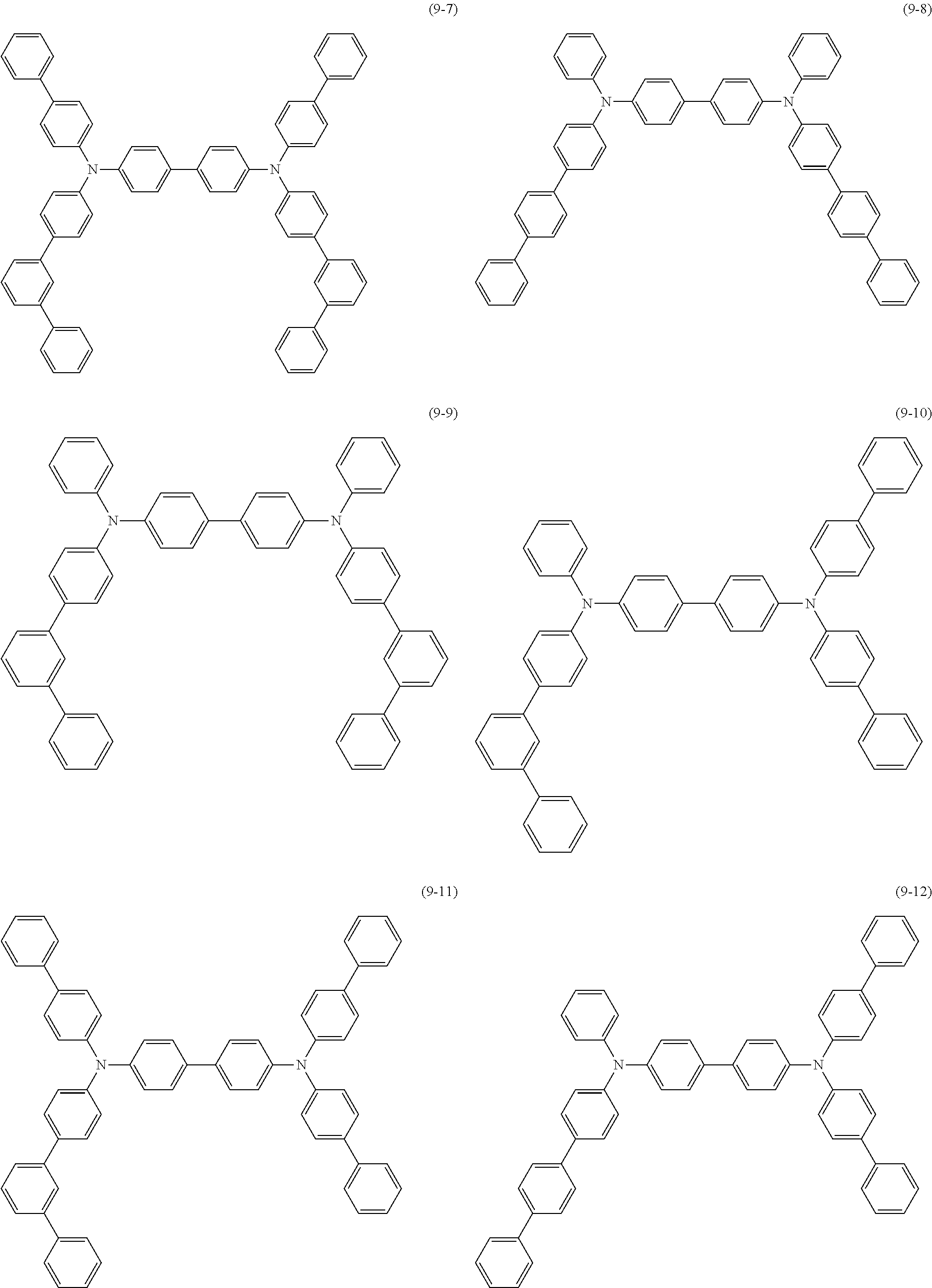

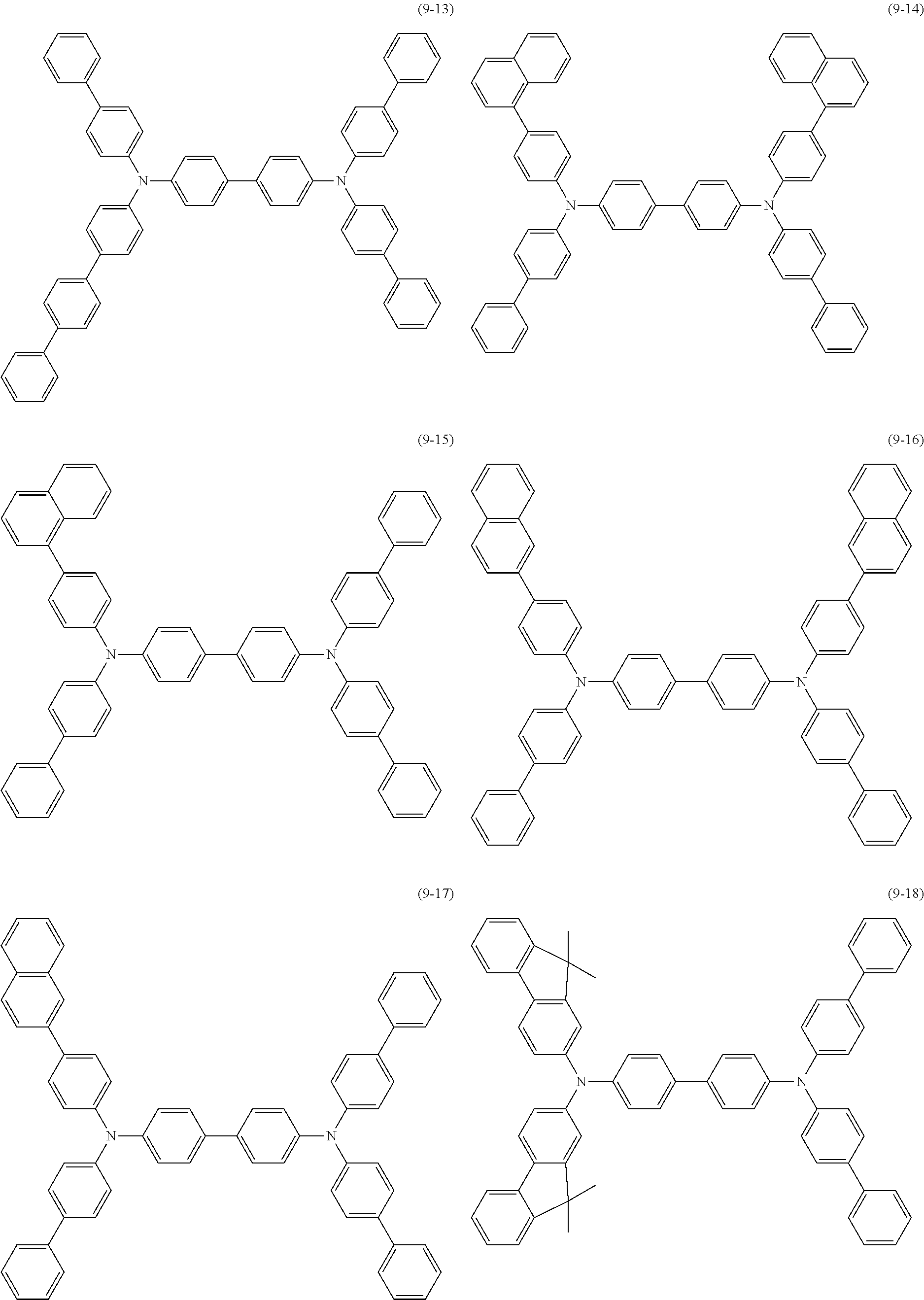

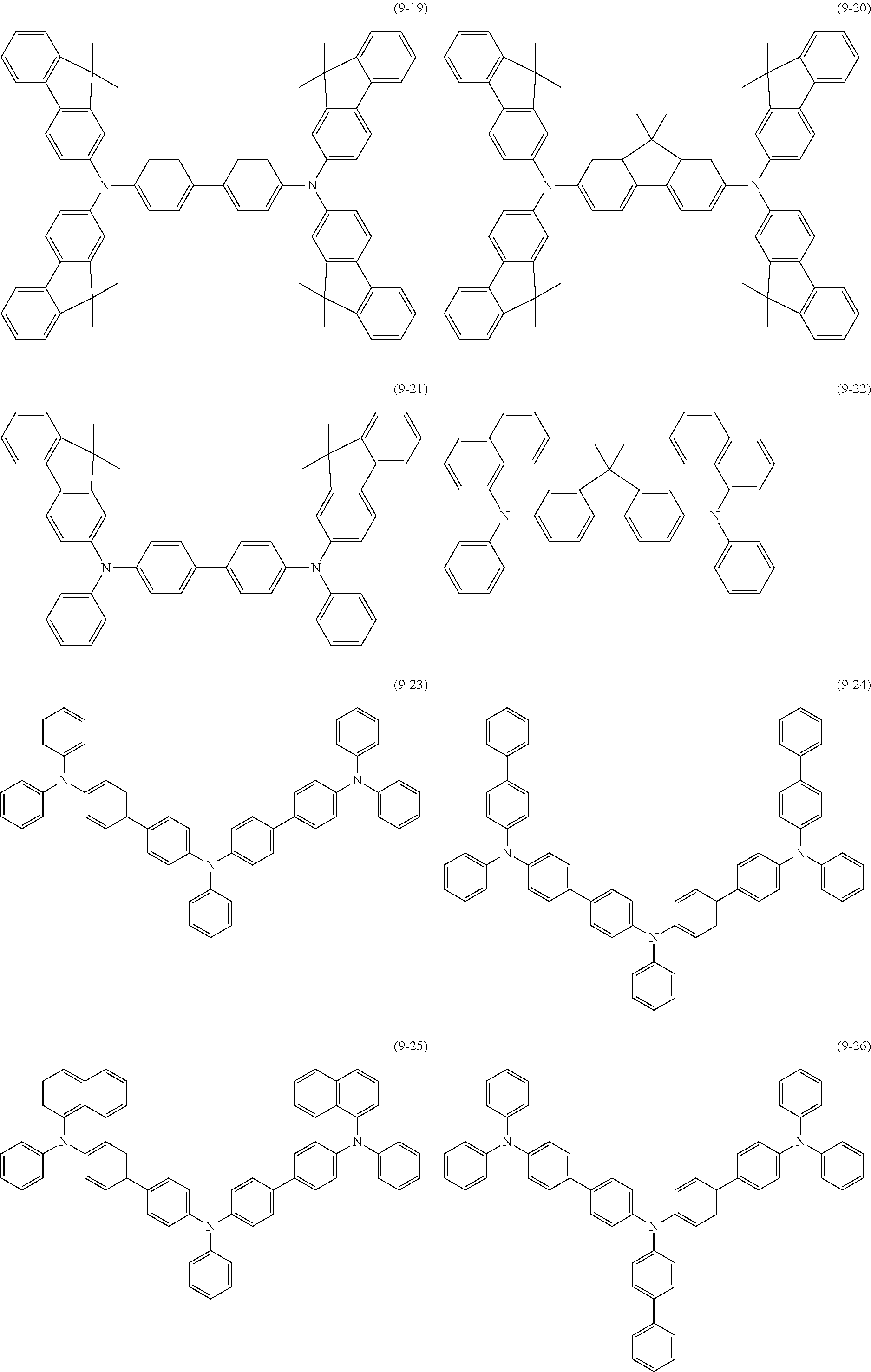

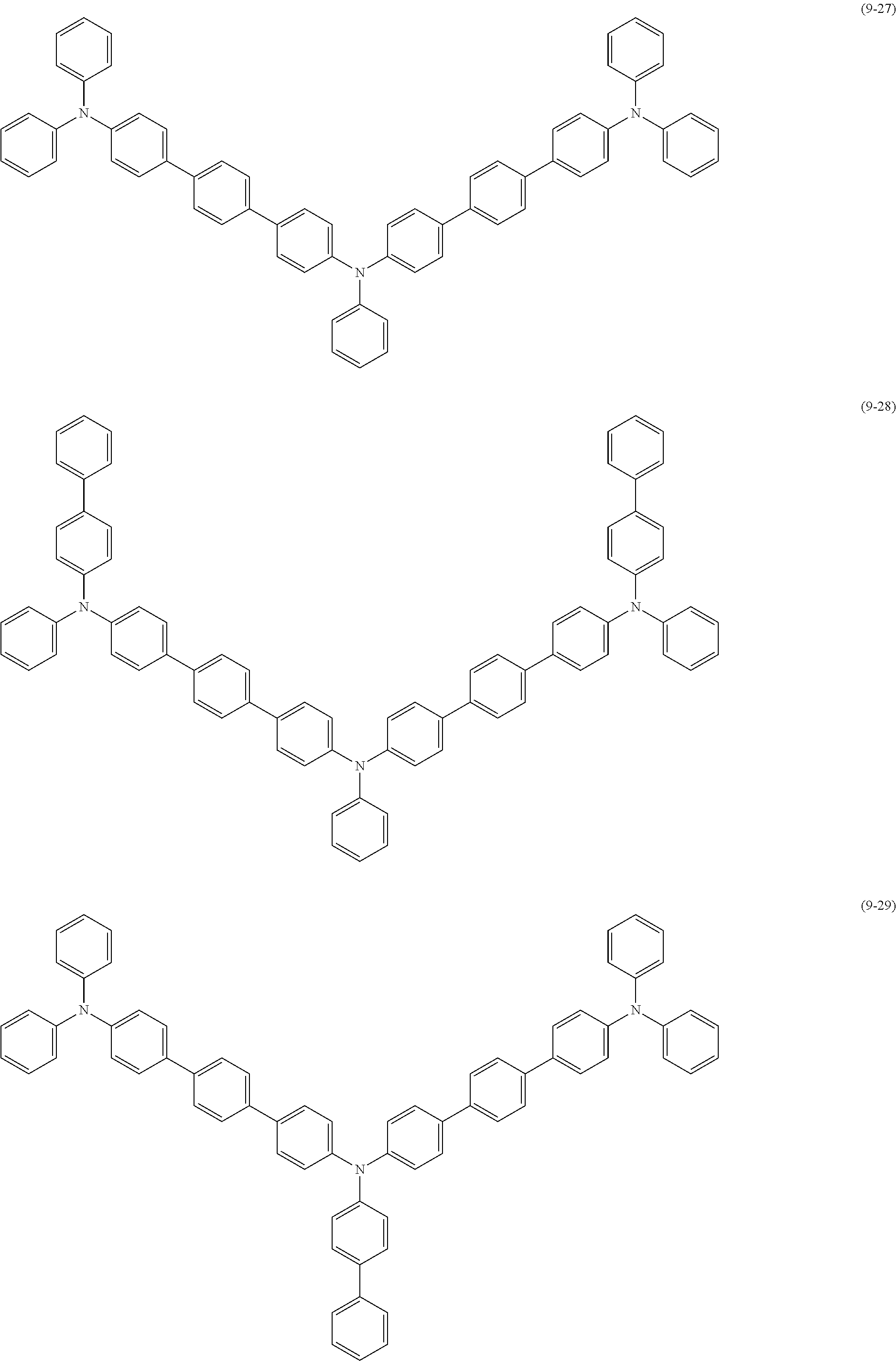

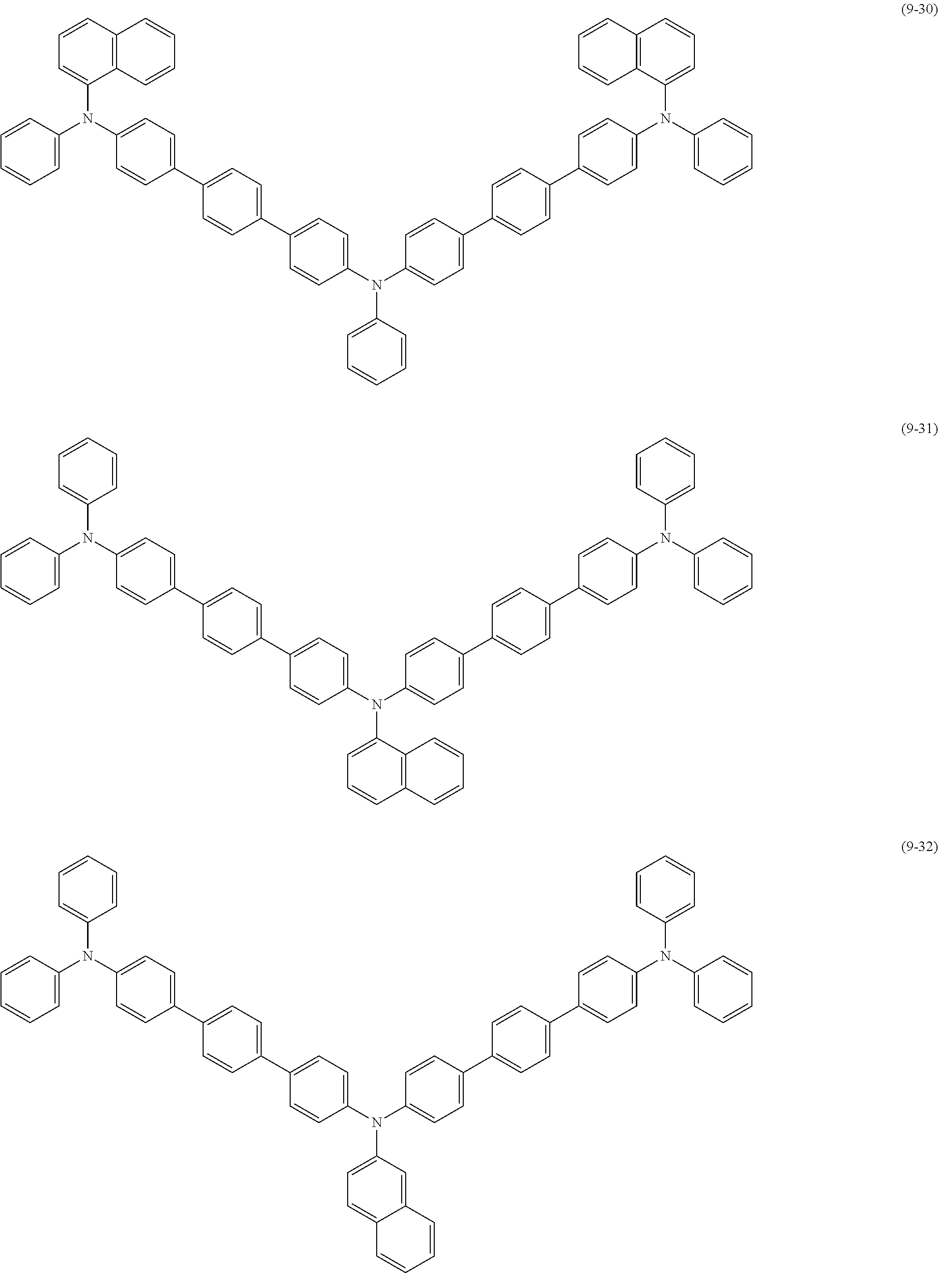

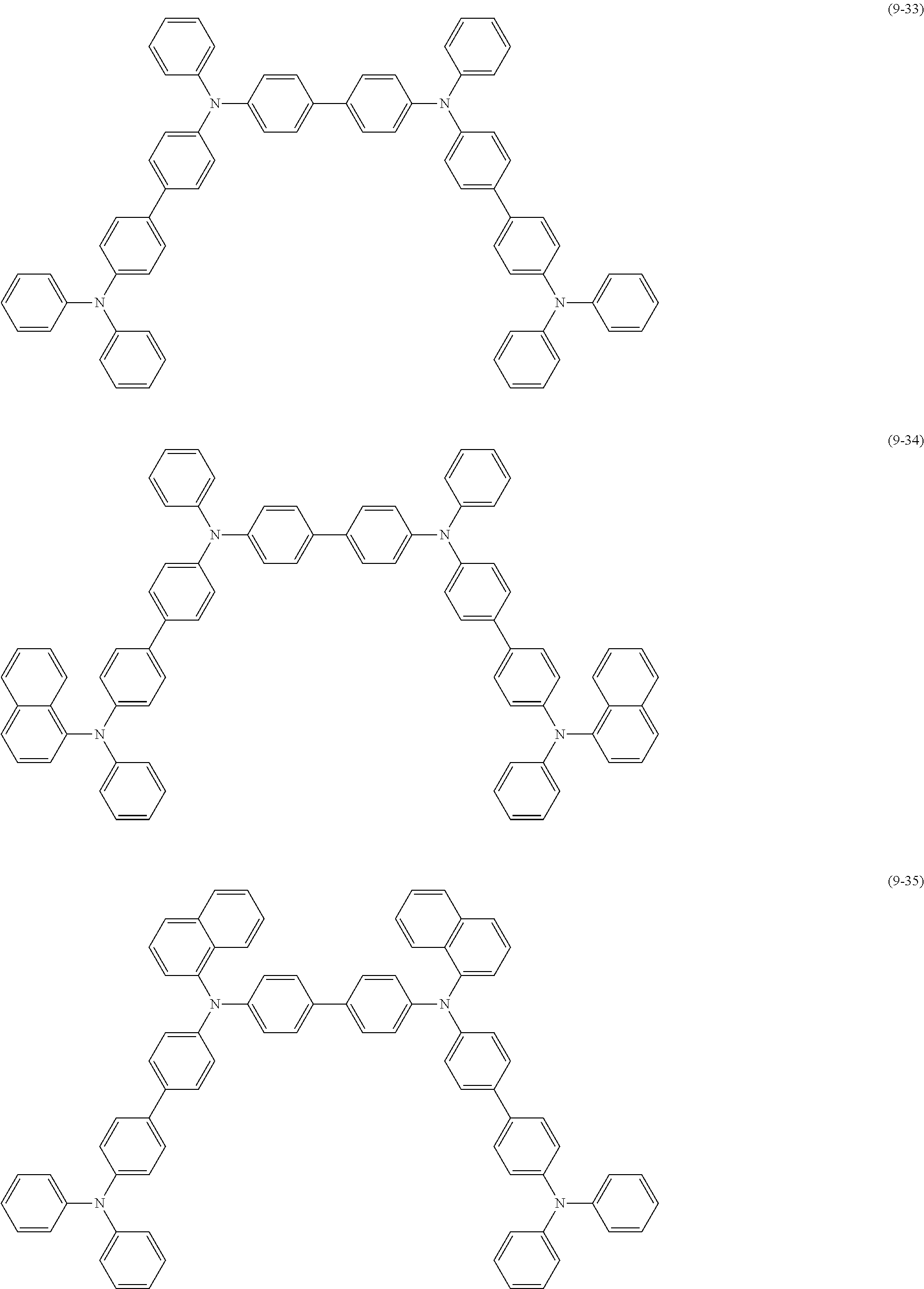

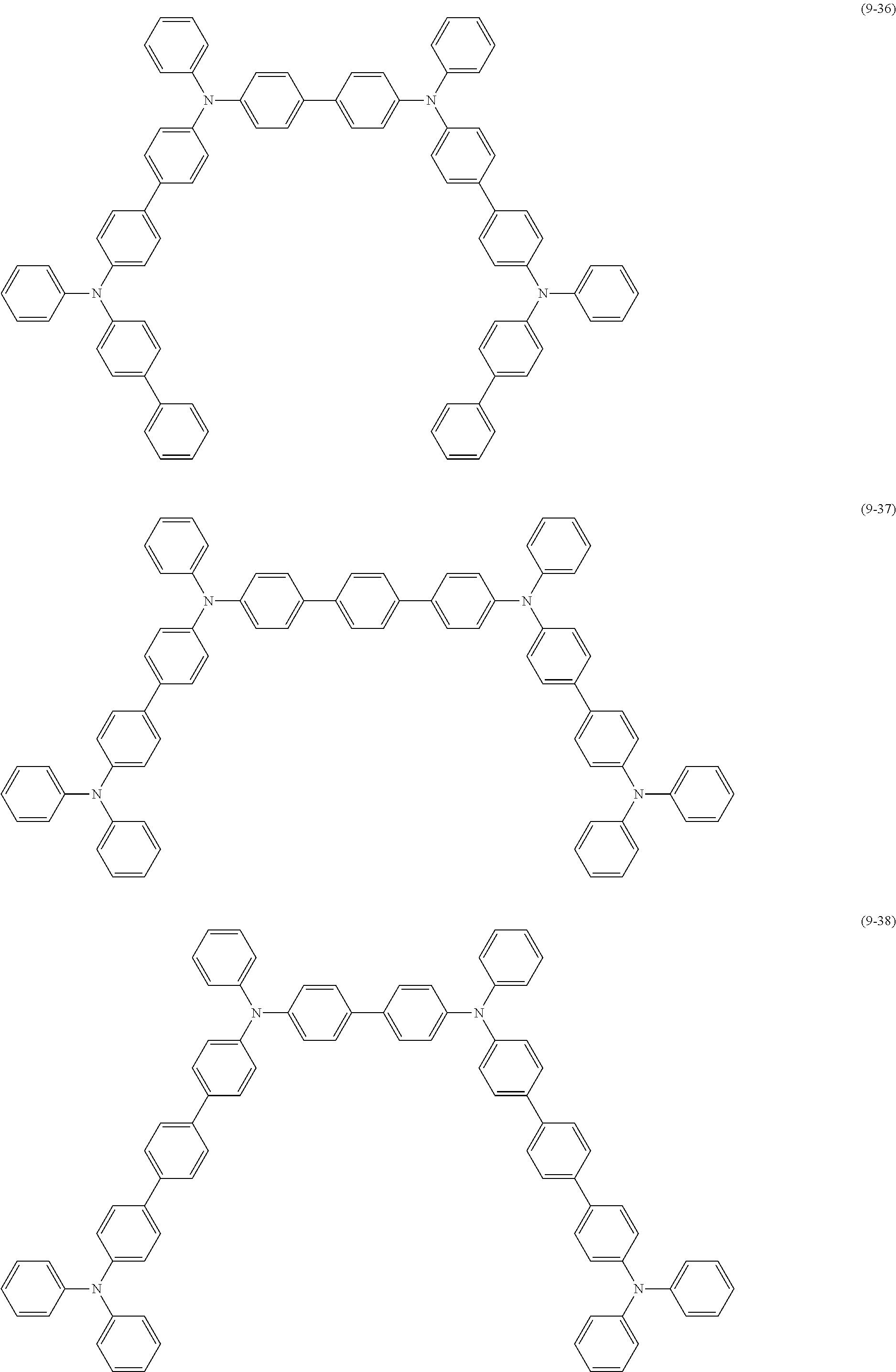

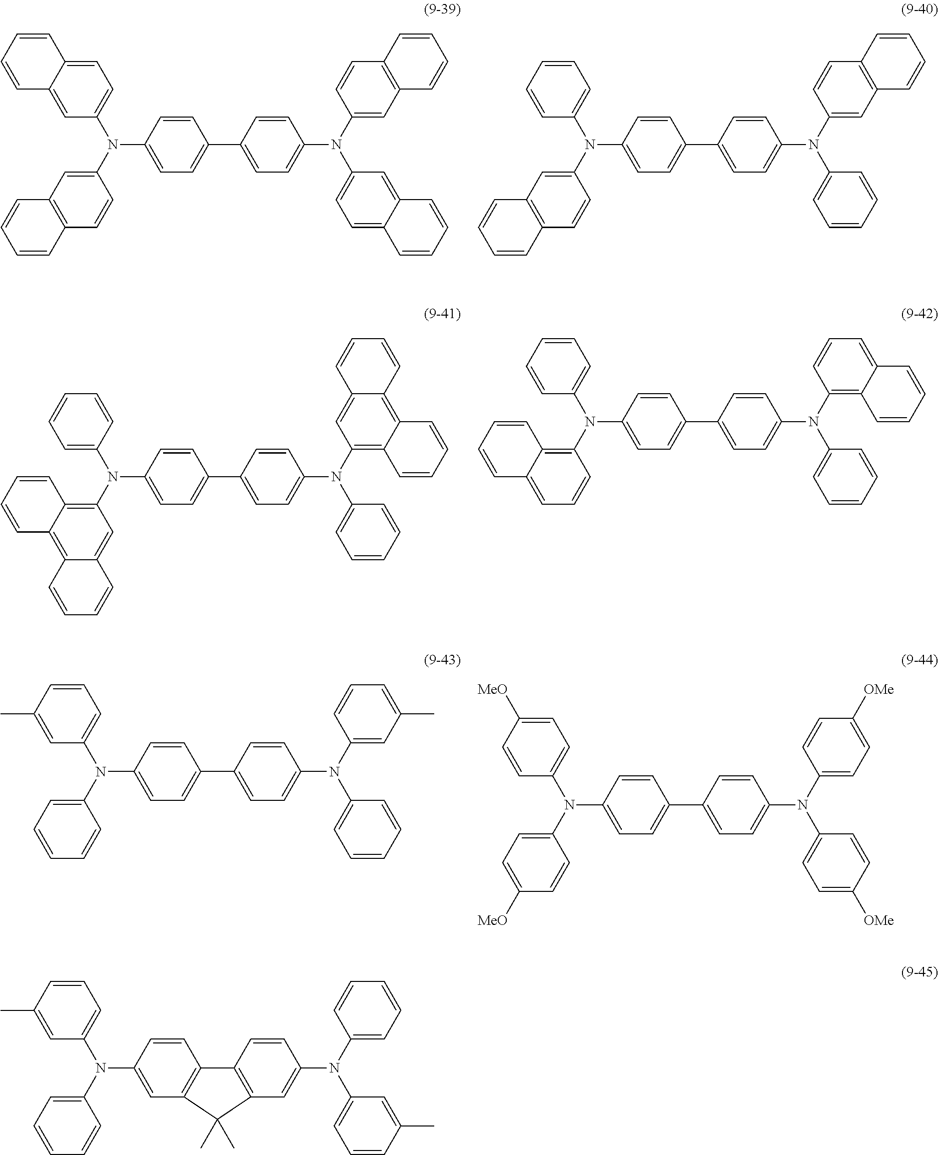

Besides the phosphorescent host materials shown in formulas (2-1) to (2-96), compounds of the following formulas (2-97) to (2-166) represented by the general formula of the above-described formula (2) can also be used. Although e.g. a compound having a carbazole group or an indole group is cited as the nitrogen-containing hydrocarbon group bonded to L1, the compound is not limited thereto. For example, an imidazole group may be used.

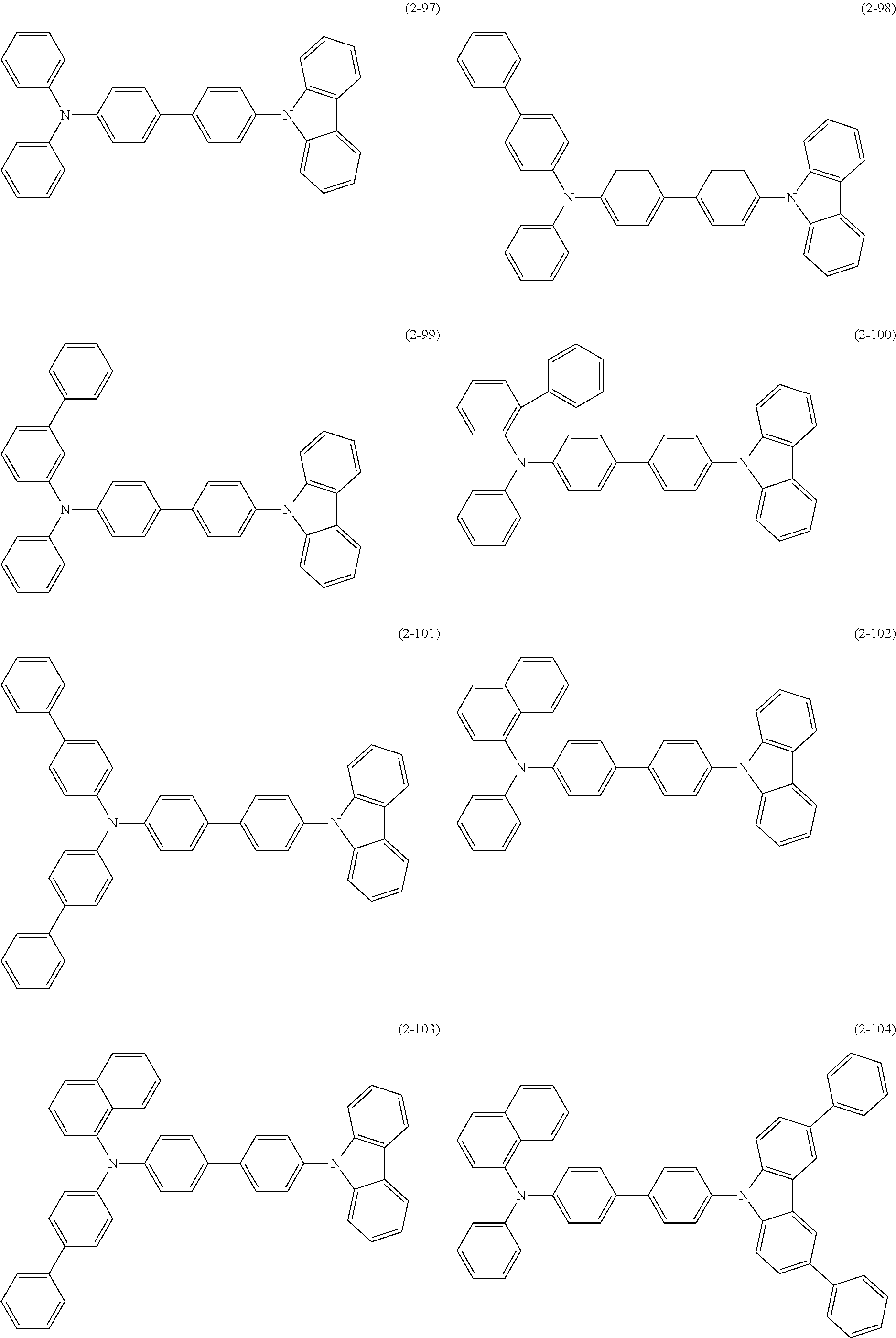

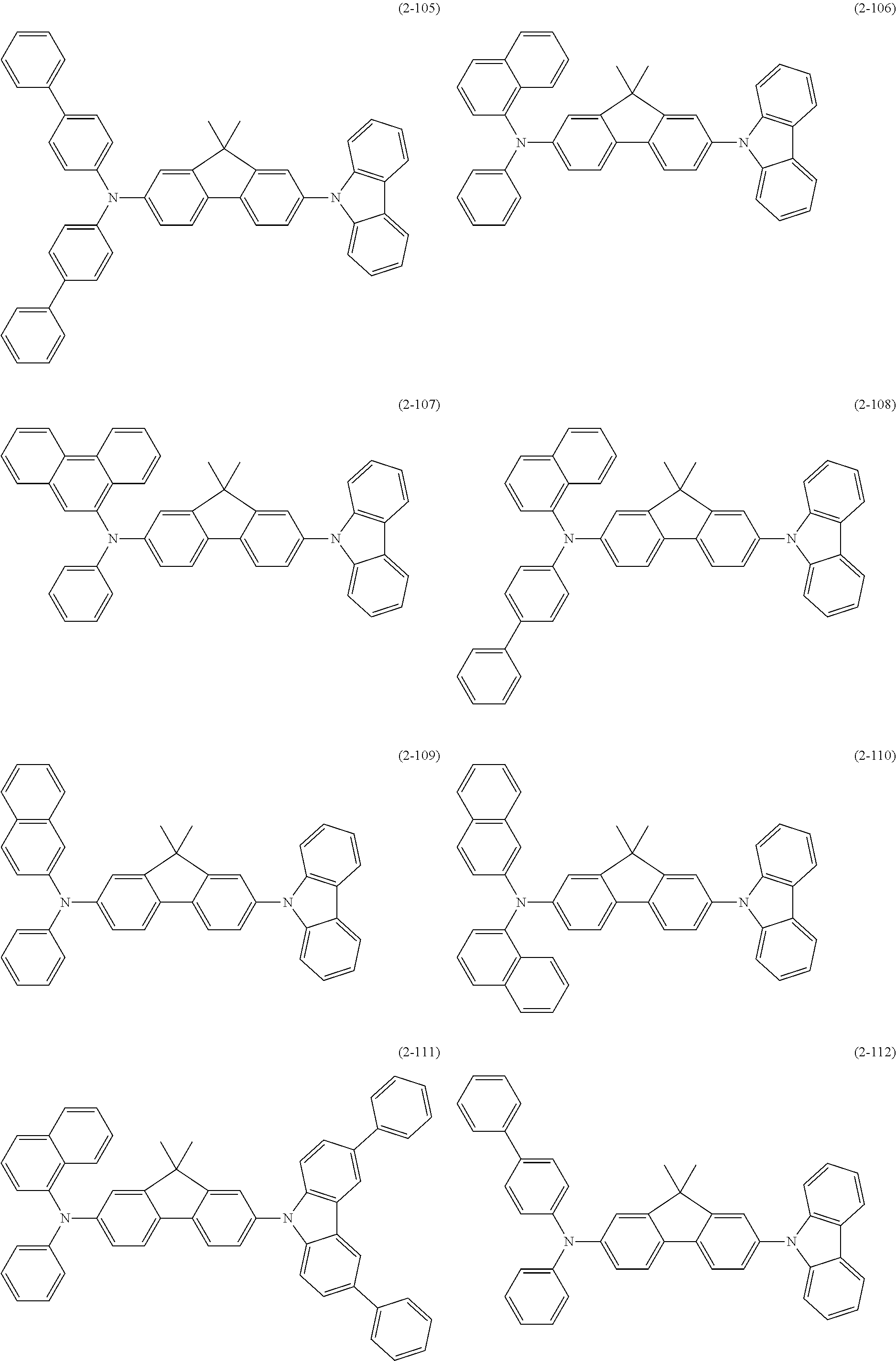

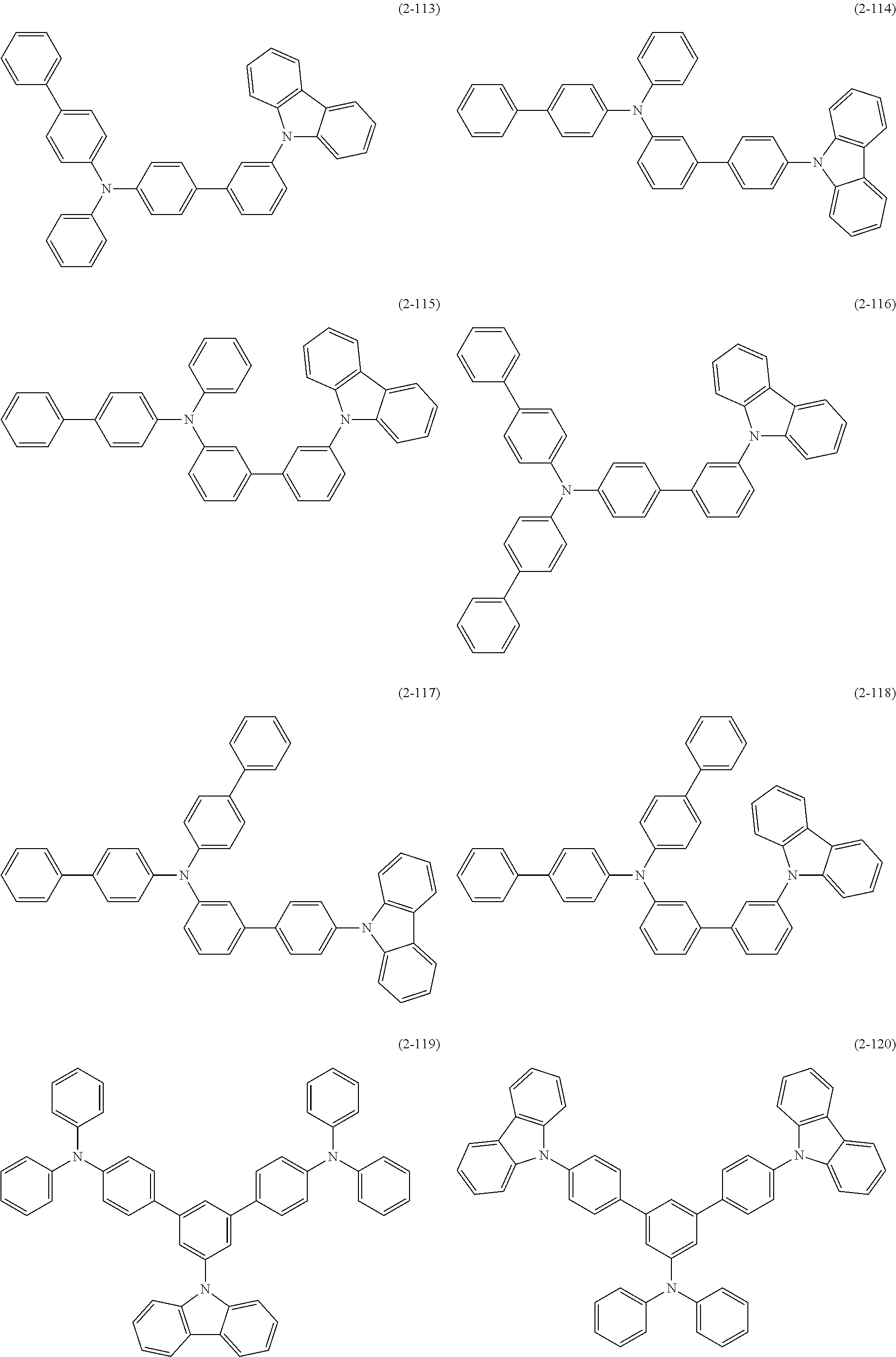

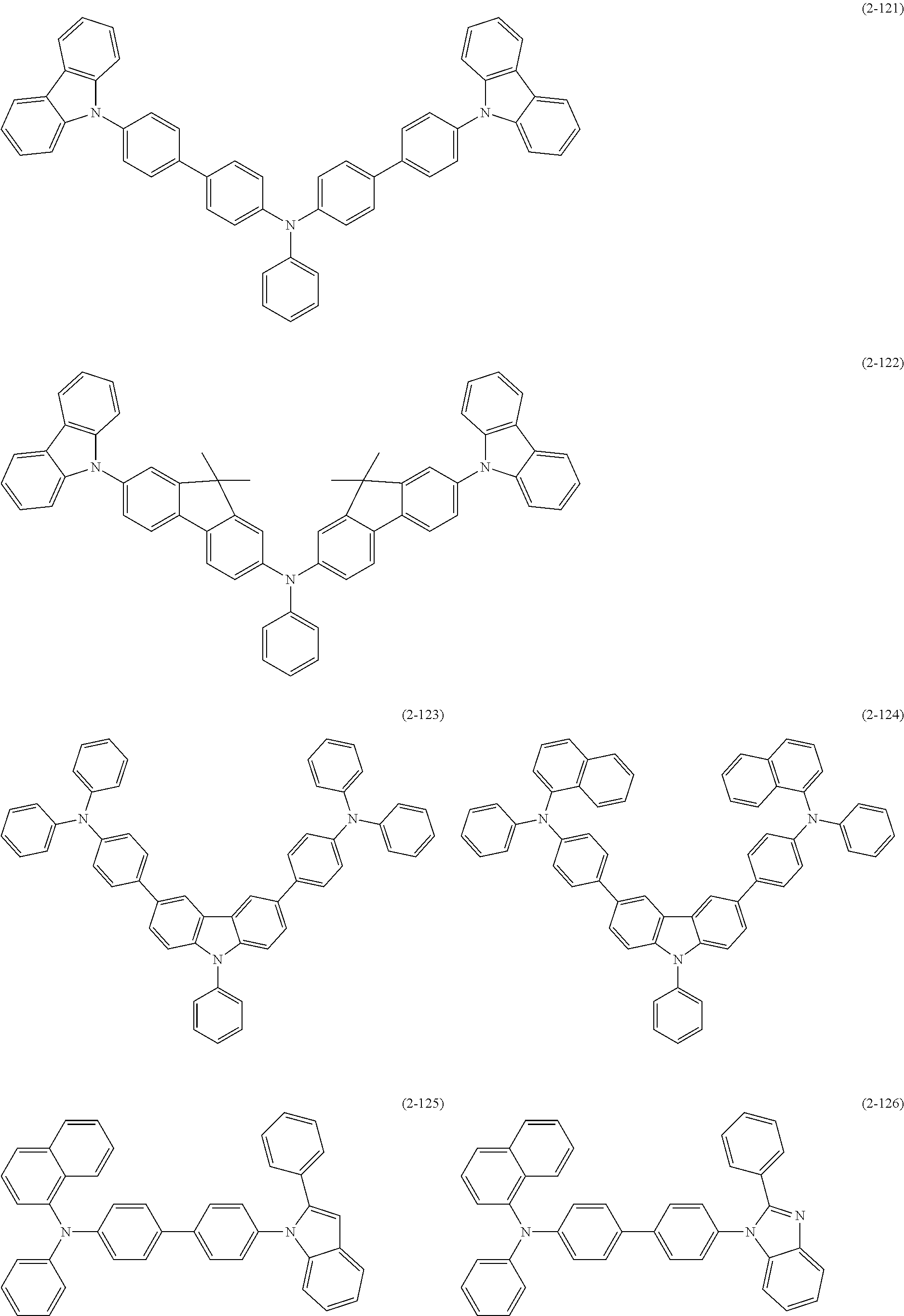

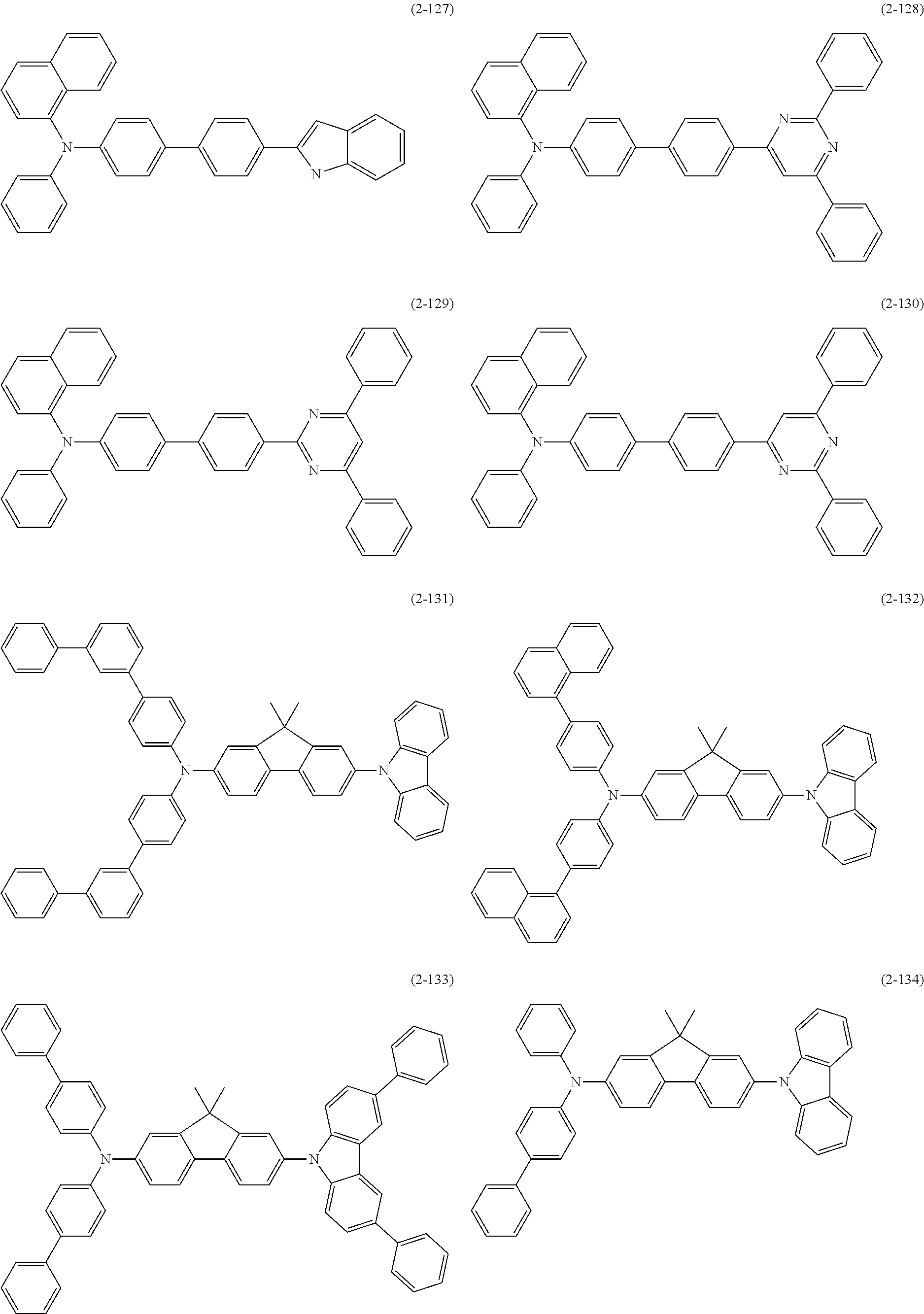

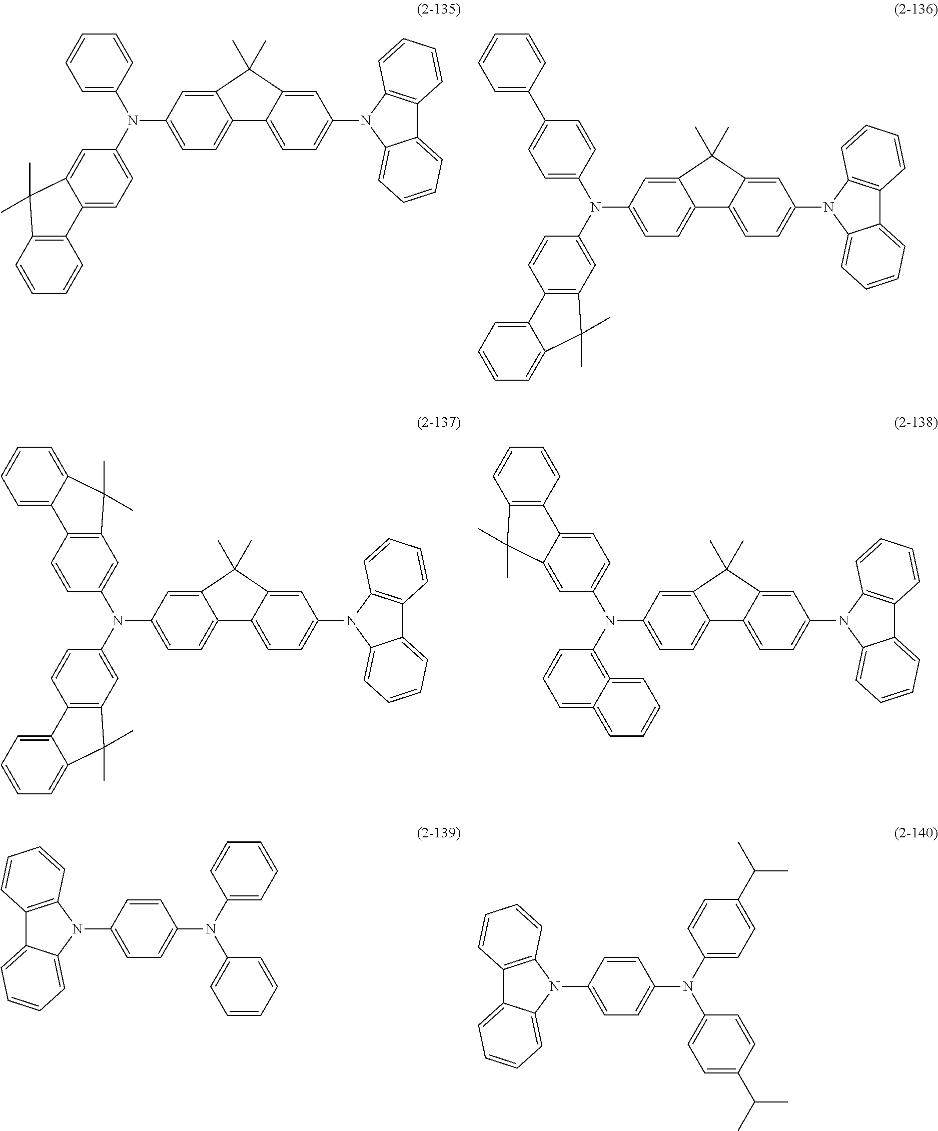

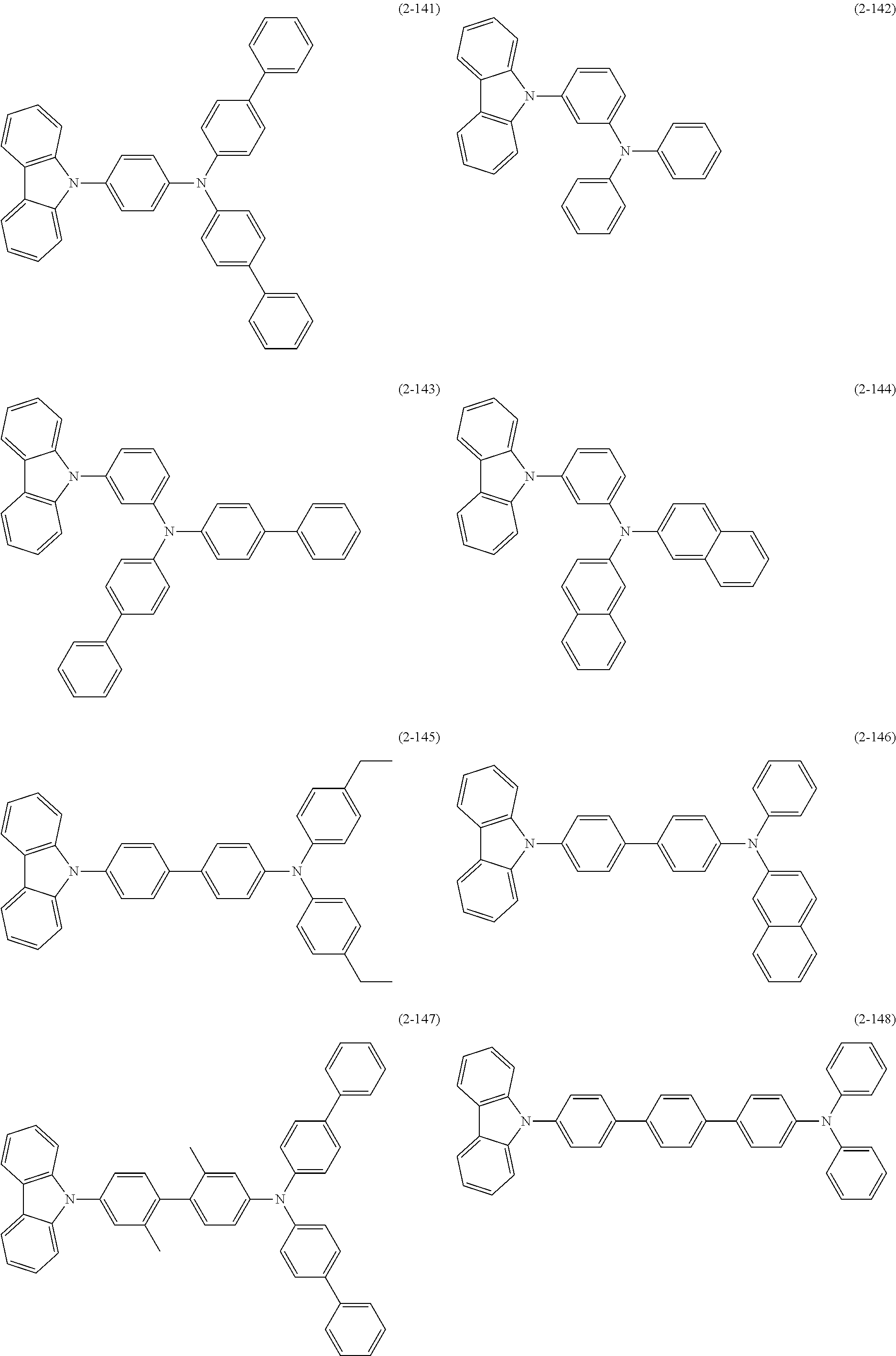

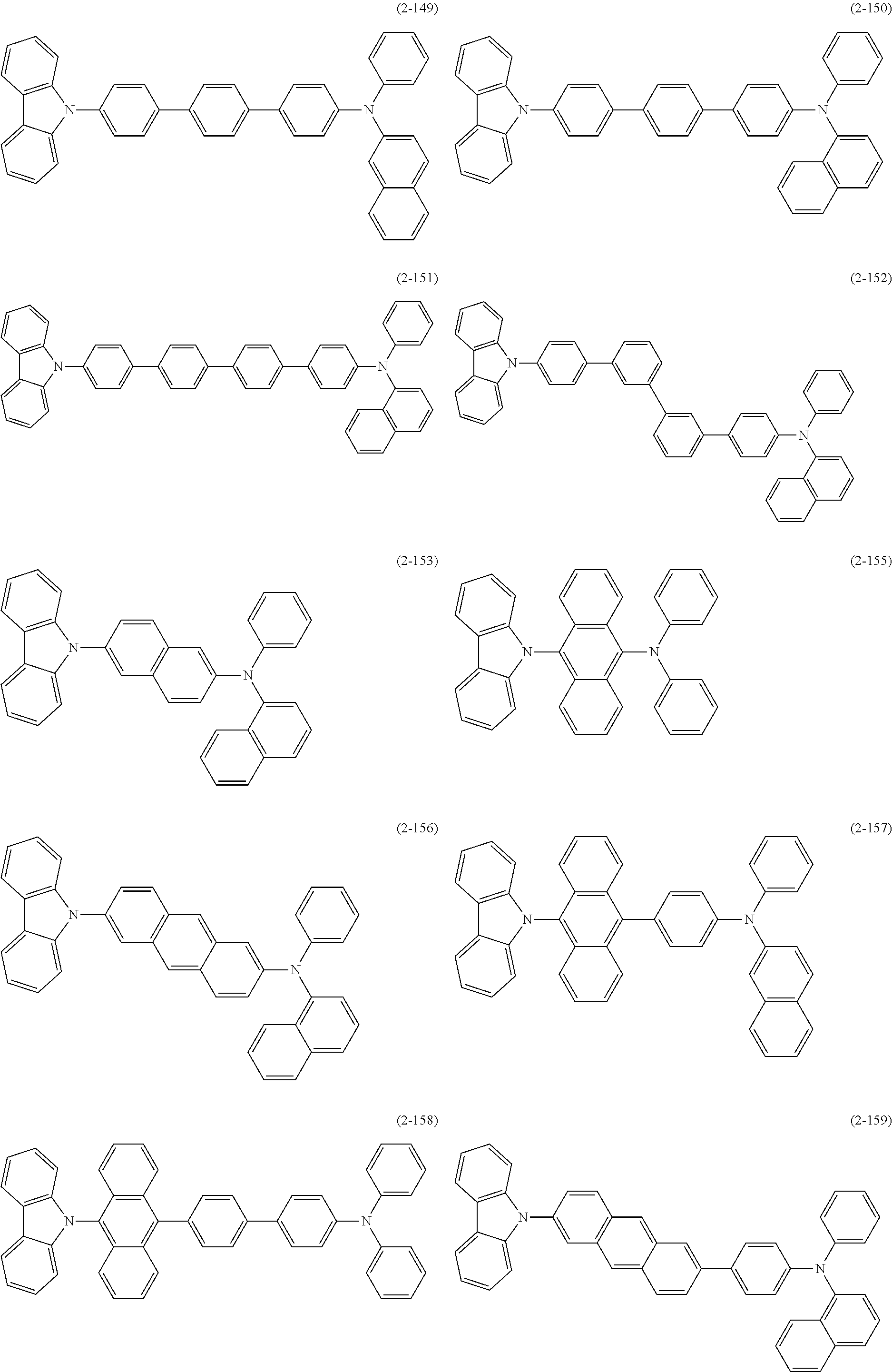

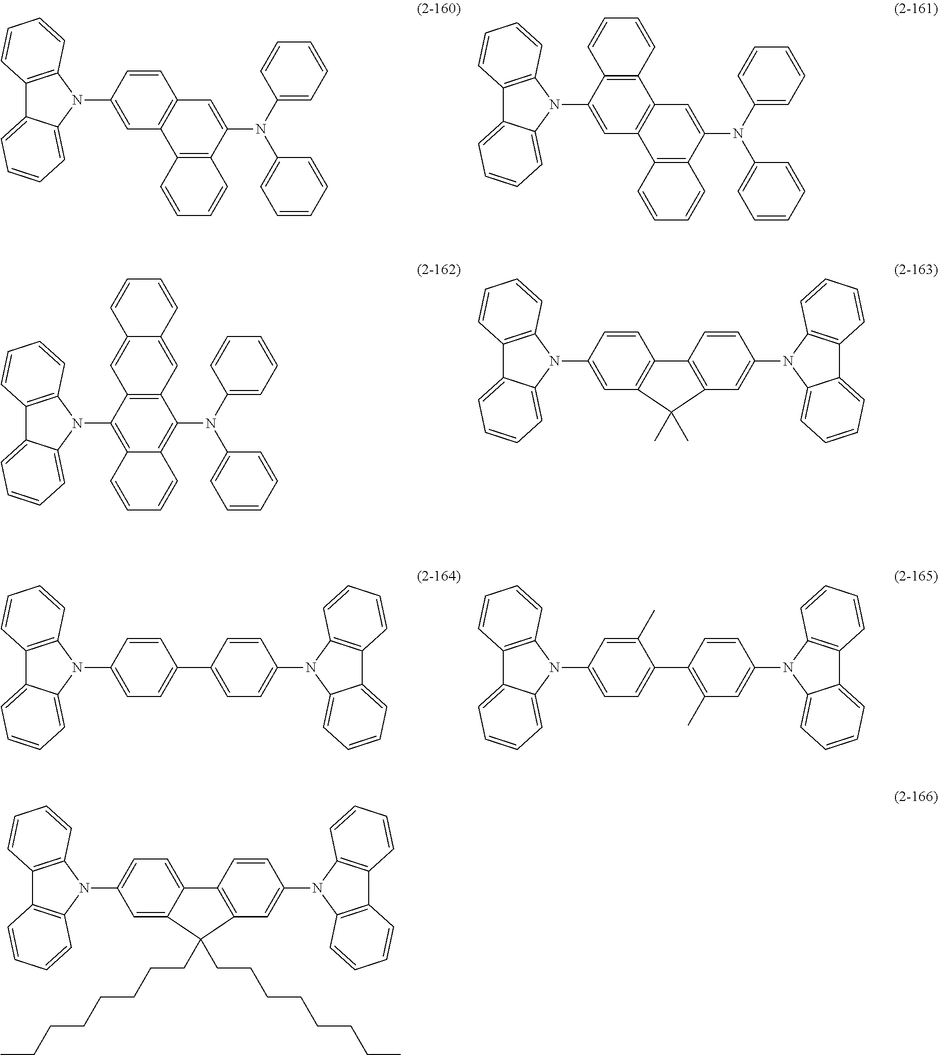

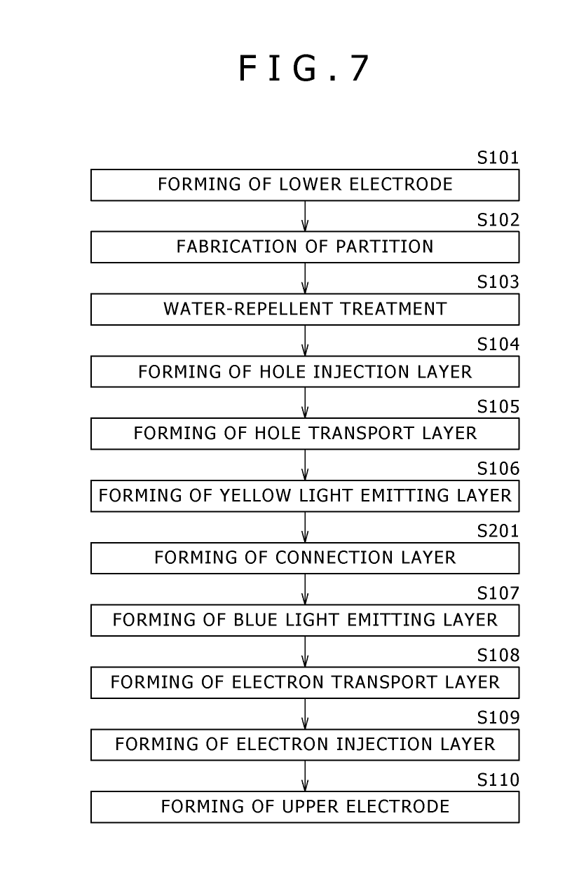

FIG. 7 shows the flow of a manufacturing method of the organic EL display device 2. Specifically, it can be manufactured in the following manner.

### (Step of Forming Connection Layer 24G)

After the yellow light emitting layer 24C is formed, the connection layer 24G composed of the above-described material is formed over the whole surfaces of the hole transport layer 24B and the yellow light emitting layer 24C at an evaporation rate of e.g. 0.1 to 2 Å/s (step S201).

In the organic EL display device 2 of the present embodiment, by providing the connection layer 24G between the hole transport layer 24B and the blue light emitting layer 24D, the injection efficiency of the hole supplied from the side of the lower electrode 12 to the blue light emitting layer 24D is enhanced. Furthermore, by providing the connection layer 24G between the yellow light emitting layer 24C and the blue light emitting layer 24D, diffusion of the triplet excitons into the blue light emitting layer 24D when the yellow light emitting layer 24C is composed of a phosphorescent material can be prevented, so that high-efficiency phosphorescence is obtained. This provides an advantageous effect that the emission efficiency is further enhanced in addition to the advantageous effects of the first embodiment.

### Third Embodiment

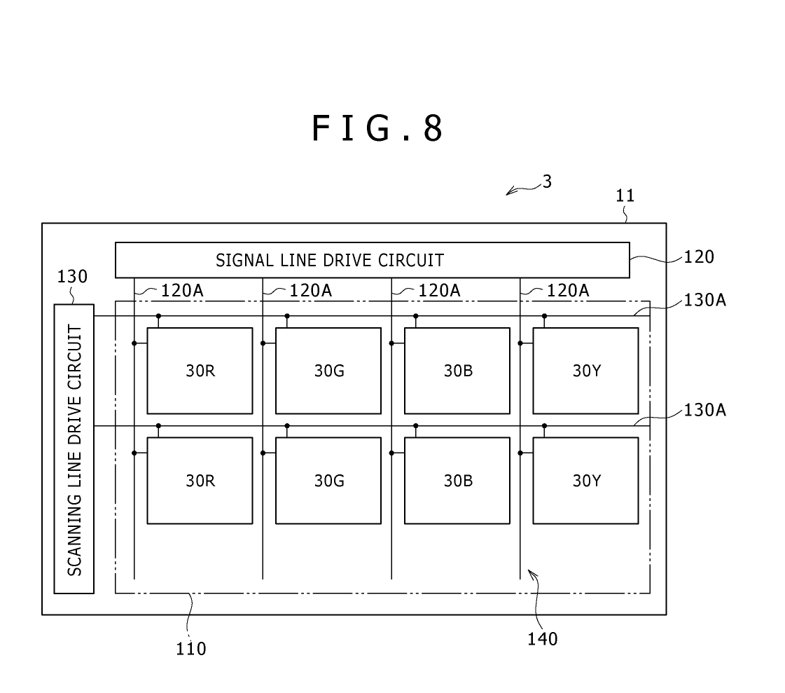

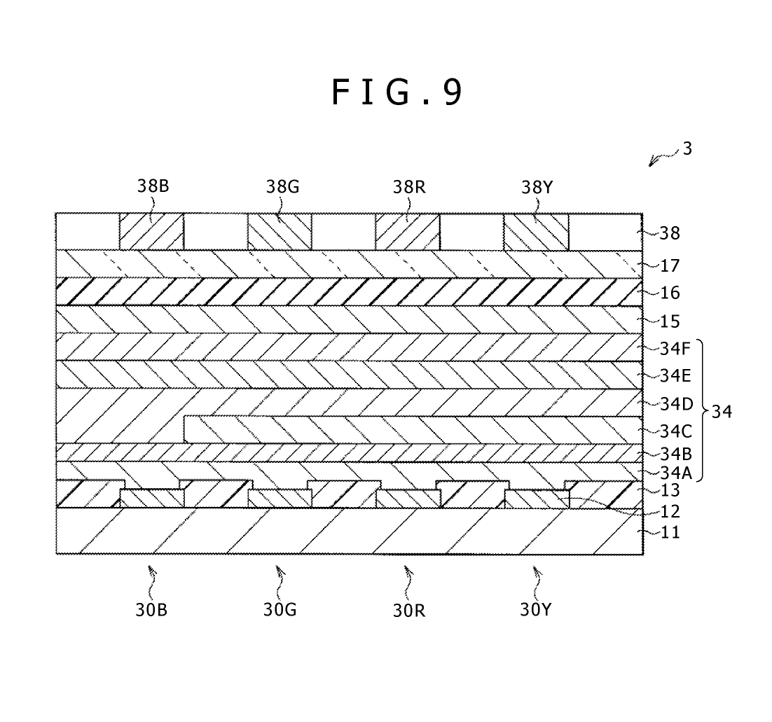

FIG. 8 shows the configuration of an organic EL display device 3 according to the third embodiment. FIG. 9 shows the sectional configuration of the display area of the organic EL display device 3. The organic EL display device 3 of the present embodiment is different from the above-described first embodiment in that a yellow light emitting element 30Y is added to a red organic EL element 30R, a green organic EL element 30G, and a blue organic EL element 30B to form a four-sub-pixel configuration. Each of the red organic EL element 30R, the green organic EL element 30G, the blue organic EL element 30B, and the yellow organic EL element 30Y has a configuration obtained by stacking the lower electrode 12 (first electrode) as the anode, the partition 13, an organic layer 34 including light emitting layers (yellow light emitting layer 34C and blue light emitting layer 34D), and the upper electrode 15 (second electrode) as the cathode in that order from the side of the substrate 11 with the intermediary of the drive transistor Tr1 of the above-described pixel drive circuit 140 and a planarization insulating film (not shown). Furthermore, the protective layer 16, the sealing substrate 17, and a color filter 38 are provided over the upper electrode 15 similarly to the above-described first and second embodiments. This color filter 38 has a red filter 38R, a green filter 38G, a blue filter 38B, and a yellow filter 38Y. They are disposed in turn corresponding to the red organic EL element 30R, the green organic EL element 30G, the blue organic EL element 30B, and the yellow organic EL element 30Y.

In the organic EL display device 3 of the present embodiment, the yellow light emitting layer 30Y is added to the red organic EL element 30R, the green organic EL element 30G, and the blue organic EL element 30B. Most of the above-described part near the black-body radiation line connecting blue and yellow (specifically, part near flesh color), having the second highest frequency after white, can be expressed by two colors, blue and yellow. That is, an advantageous effect that the power consumption can be further reduced is achieved in addition to the advantageous effects of the above-described first embodiment because organic EL elements of four colors do not need to be used to express the part near the black-body radiation line differently from the above-described organic EL display device using four colors, i.e. red, green, blue, and white. Furthermore, because the emission efficiency of blue and yellow is high, further reduction in the power consumption is permitted. That is, both of cost reduction and large reduction in the power consumption can be achieved.

### Fourth Embodiment

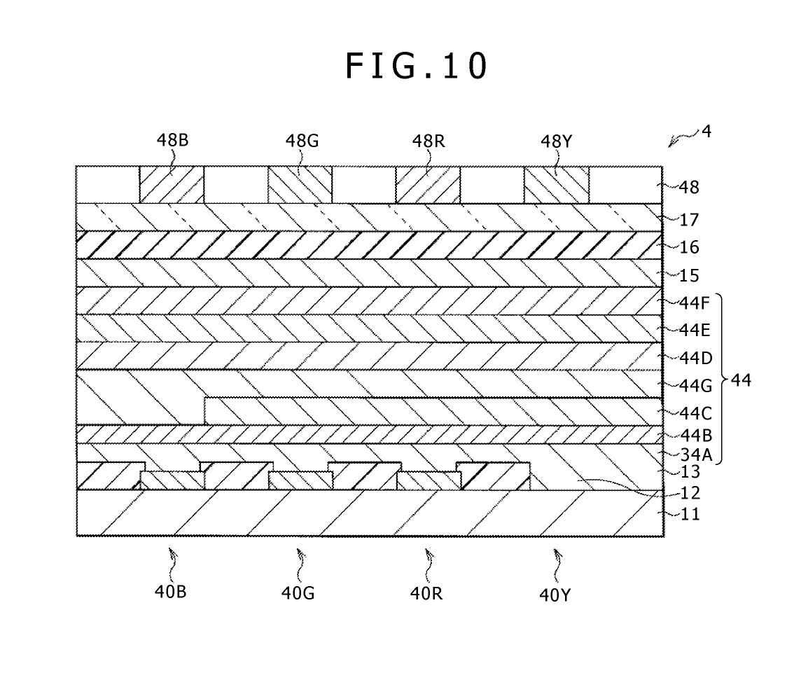

FIG. 10 shows the sectional configuration of the display area of an organic EL display device 4 according to the fourth embodiment. In the organic EL display device 4 of the present embodiment, each of a red organic EL element 40R, a green organic EL element 40G, a blue organic EL element 40B, and a yellow light emitting element 40Y has a configuration obtained by stacking the lower electrode 12 (first electrode) as the anode, the partition 13, an organic layer 44 including light emitting layers (yellow light emitting layer 44C and blue light emitting layer 44D), and the upper electrode 15 (second electrode) as the cathode in that order from the side of the substrate 11 with the intermediary of the drive transistor Tr1 of the above-described pixel drive circuit 140 and a planarization insulating film (not shown). The organic EL display device 4 of the present embodiment is different from the above-described third embodiment in that a connection layer 44G exists between the yellow light emitting layer 44C and the blue light emitting layer 44D.

The connection layer 44G of the present embodiment is to enhance the efficiency of hole injection to the blue light emitting layer 44D as with the connection layer 24G described in the second embodiment. The thickness of the connection layer 44G is e.g. preferably 2 nm to 30 nm and more preferably 5 nm to 15 nm although depending on the whole configuration of the element. Also as the material to form the connection layer 44G, the same material as that of the connection layer 24G can be used.

In the organic EL display device 4 of the present embodiment, by providing the connection layer 44G between the hole transport layer 44B and the blue light emitting layer 44D, the injection efficiency of the hole supplied from the side of the lower electrode 12 to the blue light emitting layer 44D is enhanced. Furthermore, by providing the connection layer 44G between the yellow light emitting layer 44C and the blue light emitting layer 44D, diffusion of the triplet excitons into the blue light emitting layer 44D when the yellow light emitting layer 44C is composed of a phosphorescent material can be prevented, so that high-efficiency phosphorescence is obtained. This provides an advantageous effect that the emission efficiency is further enhanced in addition to the advantageous effects of the third embodiment.

### Module and Application Examples

Application examples of the organic EL display devices 1 to 4 explained in the above-described first to fourth embodiments will be described below. The organic EL display devices 1 to 4 of the above-described embodiments can be applied to a display device in electronic apparatus in every field that displays a video signal input from the external or a video signal generated inside as image or video, such as television devices, digital cameras, notebook personal computers, portable terminal devices typified by cellular phones, and video camcorders.

### (Module)

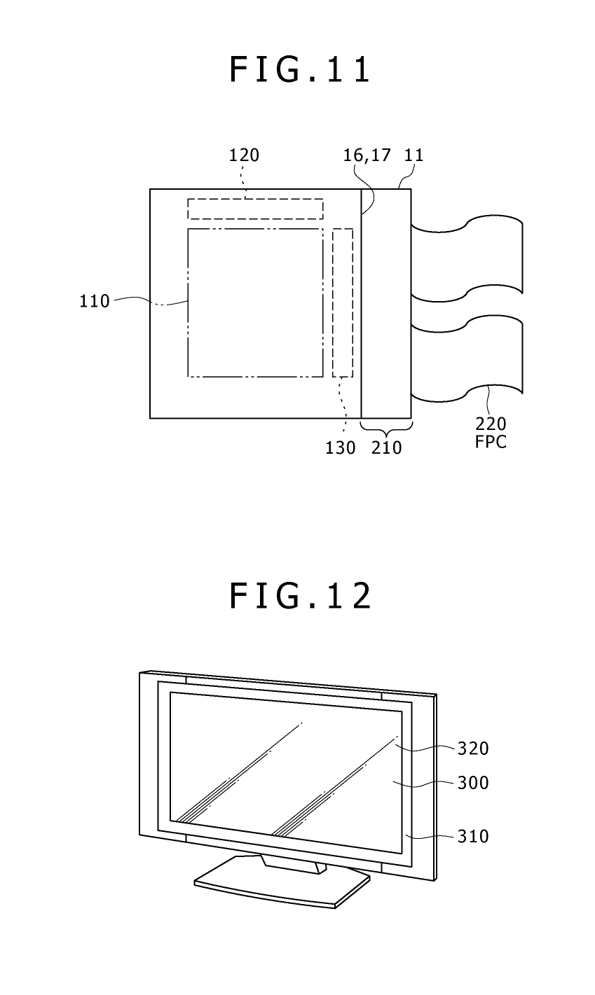

The organic EL display devices 1 to 4 of the above-described embodiments are incorporated into various pieces of electronic apparatus such as application examples 1 to 5 to be described later as a module shown in FIG. 11 for example. This module is obtained e.g. by setting an area 210 exposed from the protective layer 16 and the sealing substrate 17 along one side of the substrate 11 and forming an external connection terminal (not shown) in this exposed area 210 by extending the wiring of the signal line drive circuit 120 and the scanning line drive circuit 130. The external connection terminal may be provided with a flexible printed circuit (FPC) 220 for signal input/output.

### Application Example 1

FIG. 12 shows the appearance of a television device to which the organic EL display devices 1 to 4 of the above-described embodiments are applied. This television device has e.g. a video display screen section 300 including a front panel 310 and a filter glass 320, and this video display screen section 300 is configured by the organic EL display devices 1 to 4 according to the above-described embodiments.

### Application Example 2

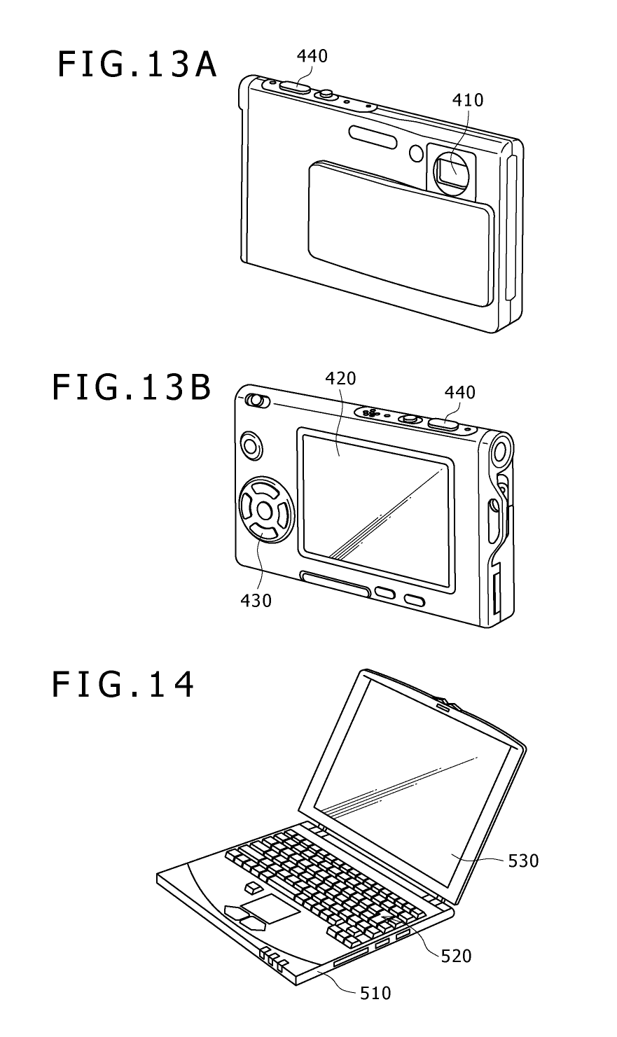

FIGS. 13A and 13B show the appearance of a digital camera to which the organic EL display devices 1 to 4 of the above-described embodiments are applied. This digital camera has e.g. a light emitter 410 for flash, a display section 420, a menu switch 430, and a shutter button 440, and the display section 420 is configured by the organic EL display devices 1 to 4 according to the above-described embodiments.

### Application Example 3

FIG. 14 shows the appearance of a notebook personal computer to which the organic EL display devices 1 to 4 of the above-described embodiments are applied. This notebook personal computer has e.g. a main body 510, a keyboard 520 for input operation of characters and so forth, and a display section 530 that displays images, and the display section 530 is configured by the organic EL display devices 1 to 4 according to the above-described embodiments.

### Application Example 4

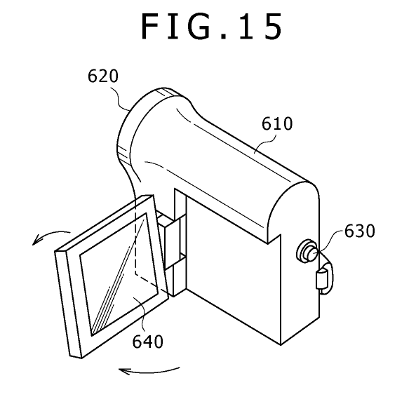

FIG. 15 shows the appearance of a video camcorder to which the organic EL display devices 1 to 4 of the above-described embodiments are applied. This video camcorder has e.g. a main body section 610, a lens 620 that is provided on the front face of this main body section 610 and is used for subject photographing, a start/stop switch 630 about photographing, and a display section 640, and the display section 640 is configured by the organic EL display devices 1 to 4 according to the above-described embodiments.

### Application Example 5

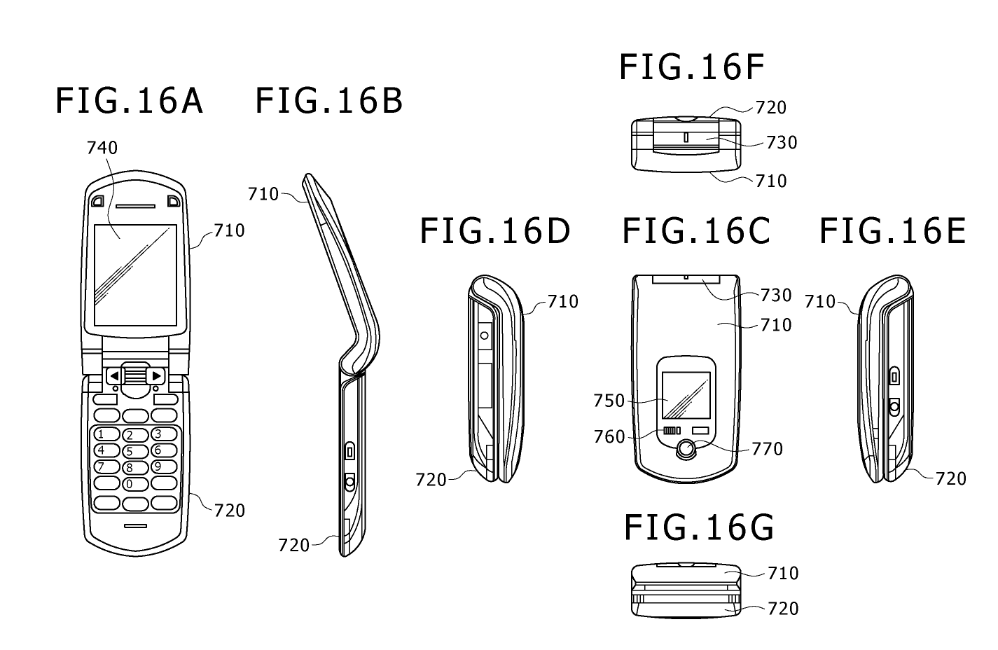

FIGS. 16A to 16G show the appearance of a cellular phone to which the organic EL display devices 1 to 4 of the above-described embodiments are applied. This cellular phone is made by coupling an upper chassis 710 with a lower chassis 720 by a coupling part (hinge part) 730 and has a display 740, a sub-display 750, a picture light 760, and a camera 770 for example. The display 740 or the sub-display 750 is configured by the organic EL display devices 1 to 4 of the above-described embodiments.

Techniques of the present disclosure are described above by taking the above-described first to fourth embodiments. However, the present disclosure is not limited to the above-described embodiments and so forth and various modifications are possible.

Furthermore, for example, the materials, thicknesses, film deposition methods, film deposition conditions, and so forth of the respective layers explained in the above-described embodiments are not limited. Other materials and thicknesses may be employed and other film deposition methods and film deposition conditions may be employed.

The above-described embodiments are explained by specifically taking the configurations of the organic EL elements 10R, 10G, 10B and so forth for example. However, all layers do not need to be included and another layer may be further included. For example, the light emitting layer 16C may be formed directly on the hole injection layer 14A by a coating system without forming the hole transport layer 14B on the hole injection layer 14A.

Furthermore, in the above-described embodiments, the electron transport layer 16G is formed as a single layer composed of one kind of material for example. However, the configuration is not limited thereto and the electron transport layer 16G may be formed of e.g. a mixed layer composed of two or more kinds of materials or a multilayer structure obtained by stacking layers composed of different materials.

In the above-described second embodiment, the color filter 18 having three colors of the red filter 28R, the green filter 28G, and the blue filter 28B is used. However, the blue filter 28B for the blue light emitting element 20B does not need to be provided as described in the first embodiment. Similarly, in the above-described third and fourth embodiments, light emitted from the yellow light emitting layer 34C (44C) and the blue light emitting layer 34D (44D) may be used as it is without providing the blue filter 38B (48B) and the yellow filter 38Y (48Y), out of the red filter 38R (48R), the green filter 38G (48G), the blue filter 38B (48B), and the yellow filter 38Y (48Y).

Moreover, there is no particular limitation to the arrangement of the red organic EL element 10R (20R, 30R, 40R), the green organic EL element 10G (20G, 30G, 40G), and the blue organic EL element 10B (20B, 30B, 40B) (and yellow organic EL element 30Y, 40Y) over the substrate 11. For example, the blue, red, green, and yellow organic EL elements are disposed in parallel in the above-described embodiments. However, the blue organic EL element may be disposed under or over the red, green, and yellow organic EL elements formed in parallel in such a manner as to be perpendicular to the longitudinal direction of the red, green, and yellow organic EL elements.

Moreover, in the above-described embodiments, an active-matrix display device is explained. However, an embodiment of the present disclosure can be applied also to a passive-matrix display device. In addition, the configuration of the pixel drive circuit for active-matrix driving is not limited to that explained in the above-described embodiments and capacitive element and transistor may be added according to need. In this case, in association with the change in the pixel drive circuit, a desired drive circuit may be added besides the above-described signal line drive circuit 120 and scanning line drive circuit 130.

The present technology contains subject matter related to that disclosed in Japanese Priority Patent Application JP 2011-068246 filed in the Japan Patent Office on Mar. 25, 2011, the entire content of which is hereby incorporated by reference.

What is claimed is:

1. An organic electroluminescence display device comprising:
a first electrode configured to be provided over a substrate for each of a first organic electroluminescence element of blue and a second organic electroluminescence element of another color;
a hole injection/transport layer configured to be provided over a whole surface of the first electrode and have a characteristic of at least one of hole injection and hole transportation;
a second organic light emitting layer of another color configured to be provided on an area on the hole injection/transport layer except an area opposed to the first organic electroluminescence element of blue;
a first organic light emitting layer of blue configured to be provided over whole surfaces of the hole injection/transport layer and the second organic light emitting layer;
an electron injection/transport layer configured to be provided over a whole surface of the first organic light emitting layer and have a characteristic of at least one of electron injection and electron transportation;
a second electrode configured to be provided on the electron injection/transport layer; and
a color filter configured to be provided over the second electrode and have a single color or a plurality of colors in at least part of an area above the second organic electroluminescence element.

2. The organic electroluminescence display device according to claim 1, wherein
a connection layer exists between the hole injection/transport layer and the first organic light emitting layer and between the second organic light emitting layer and the first organic light emitting layer.

3. The organic electroluminescence display device according to claim 2, wherein
the connection layer contains a low-molecular material.

4. The organic electroluminescence display device according to claim 1, wherein
the second organic light emitting layer has at least one peak wavelength in any region in a region from 500 nm to 750 nm.

5. The organic electroluminescence display device according to claim 1, wherein
light of at least two colors is extracted from a light emission color of the second organic light emitting layer by providing the color filter.

6. The organic electroluminescence display device according to claim 1, wherein
one pixel is composed of two sub-pixels formed by dividing a light emission color of the second organic light emitting layer into two colors by the color filter and a blue sub-pixel formed of the first organic electroluminescence element.

7. The organic electroluminescence display device according to claim 1, wherein
one pixel is composed of three sub-pixels formed by dividing a light emission color of the second organic light emitting layer into three colors by the color filter and a blue sub-pixel formed of the first organic electroluminescence element.

8. The organic electroluminescence display device according to claim 1, wherein
the hole injection/transport layer is provided as a common layer on the first electrodes of the first organic electroluminescence element and the second organic electroluminescence element across a whole surface.

9. A manufacturing method of an organic electroluminescence display device, the method comprising:
forming a plurality of first electrodes over a substrate for each of a first organic electroluminescence element of blue and a second organic electroluminescence element of another color;
forming a hole injection/transport layer that is provided over whole surfaces of the first electrodes and has a characteristic of at least one of hole injection and hole transportation by coating or evaporation;
forming a second organic light emitting layer of another color on an area on the hole injection/transport layer except an area opposed to the first organic EL element of blue by coating or evaporation;
forming a first organic light emitting layer of blue on the hole injection/transport layer and the second organic light emitting layer by an evaporation method;
forming an electron injection/transport layer having a characteristic of at least one of electron injection and electron transportation over a whole surface of the first organic light emitting layer by an evaporation method;
forming a second electrode over a whole surface of the electron injection/transport layer; and
forming a color filter that is provided over the second electrode and has a single color or a plurality of colors in at least part of an area above the second organic electroluminescence element of another color.

10. The manufacturing method of an organic electroluminescence display device according to claim 9, wherein
a connection layer is formed by evaporation between the hole injection/transport layer and the first organic light emitting layer and between the second organic light emitting layer and the first organic light emitting layer.

11. The manufacturing method of an organic electroluminescence display device according to claim 9, wherein
the coating is based on any of a spin coating method, an ink-jet method, a nozzle coating method, a slit coating method, and a microsyringe in each of which direct drawing is performed by a discharge system.

12. The manufacturing method of an organic electroluminescence display device according to claim 9, wherein
the coating is based on any of relief printing, flexo printing, offset printing, and gravure printing in each of which a plate is used.

13. The manufacturing method of an organic electroluminescence display device according to claim 9, wherein
the coating is based on a spray system in which an organic electroluminescence material is sprayed and applied to different areas separately from each other with use of a high-definition mask.

14. The manufacturing method of an organic electroluminescence display device according to claim 9, wherein
the second organic light emitting layer is formed by a metal mask method or a laser transfer method.
